(19) United States
(12) Patent Application Publication
(10) Pub. No.: US 2025/0299535 A1
(43) Pub. Date: Sep. 25, 2025

(54) INTELLIGENT ADVANTAGE SPIN TECHNIQUES IMPLEMENTED IN WAGER-BASED GAMES CONDUCTED ON ELECTRONIC GAMING DEVICES

(71) Applicant: Tech (Macau) Limited, Macau (MO)

(72) Inventors: Jay Chun, Hong Kong (HK); Hon Man Au, Coloane (MO); David Y. So, Macau (MO)

(73) Assignee: Tech (Macau) Limited, Macau (MO)

(21) Appl. No.: 19/004,180

(22) Filed: Dec. 27, 2024

Related U.S. Application Data
(60) Provisional application No. 63/569,085, filed on Mar. 22, 2024.

(51) Int. Cl. G07F 17/32; G07F 17/34

(52) U.S. Cl. CPC G07F 17/3267; G07F 17/34

(57) ABSTRACT

Various aspects disclosed herein are directed to intelligent advantage spin techniques implemented in wager-based games conducted on electronic gaming devices. The intelligent advantage spin techniques may be incorporated into wager-based slot games for offering players various types of re-spin opportunities via the use of Advantage Spin (AVS) credits, loyalty points, or game credits. During gameplay, the system provides real-time analysis of game outcomes, identifying strategic moments such as near-miss scenarios to dynamically present customized advantage spin offers to players. Players can leverage AVS credits to selectively re-spin individual reels and/or symbols. AVS credits may also be employed as promotional incentives, redeemable across different game themes or EGMs, and can persist across gaming sessions, different EGMs, different venues, etc. Integration with systems like TITO and player loyalty accounts ensures seamless credit management, allowing casinos to issue, track, and incentivize credits based on both gaming and non-gaming activities.

### RELATED APPLICATION DATA

The present application claims benefit, pursuant to the provisions of 35 U.S.C. § 119, of U.S. Provisional Application Ser. No. 63/569,085 (Attorney Docket No. LTG1P005P), titled “ELECTRONIC GAMING DEVICE AND INTELLIGENT ADVANTAGE SPIN TECHNIQUES IMPLEMENTED IN A WAGER-BASED GAMING NETWORK”, naming Chun et al. as inventors, and filed 22 Mar. 2024, the entirety of which is incorporated herein by reference for all purposes.

### BACKGROUND

Electronic Gaming Machines (EGMs) or gaming devices are integral to the wagering game industry, offering an array of games including, but not limited to, slot games, video poker, video blackjack, roulette, video bingo, keno, and other varieties commonly found in casinos and similar venues. The operation of EGMs involves players creating a credit balance through the input of money or other forms of monetary credit, subsequently making monetary wagers against this balance on the outcomes of primary or base game instances. In numerous instances, achieving specific winning combinations or triggering events in the base game enables players to access secondary games or bonus rounds, which present further opportunities to secure additional game instances, credits, awards, jackpots, progressives, and the like. The awards accrued from winning outcomes are generally recredited to the player's balance, available for retrieval at the end of the gaming session or upon the player's decision to cash out.

Slot games, in particular, are presented to players via an assortment of symbols organized within a grid or matrix in a row-by-column format. Winning outcomes are determined by the alignment of specific symbol combinations along predetermined paths, or paylines, within the matrix, with such combinations being conspicuously highlighted to aid player identification. The corresponding awards for these combinations are delineated in a pay-table accessible to players. It is common for players to adjust their wagers to cover various numbers of paylines and/or to modify the bet amount per line, thereby potentially influencing the occurrence rate of winning combinations, the accessibility to secondary games, and the magnitude of awarded amounts.

The determination of game outcomes is typically entrusted to a random number generator (RNG), which ensures the randomness of each game instance. This system is designed to return a predetermined percentage of wagered amounts to players (RTP=return to player) over a multitude of game plays, maintaining the fairness and integrity of the gaming experience. The initiation of play triggers the RNG to select a game outcome at random, with corresponding symbols chosen to match this outcome. It is noteworthy that certain games incorporate an element of skill, introducing a non-random component to the game dynamics.

### BRIEF DESCRIPTION OF THE DRAWINGS

FIG. 1 is a schematic block diagram illustrating an example of a network configuration for a plurality of gaming devices according to some embodiments.

FIG. 2A is a perspective view of a gaming device 100 illustrating various physical features of the device.

FIG. 2B is a functional block diagram that schematically illustrates an electronic relationship of various elements of the gaming device 100.

FIG. 2C illustrates various functional modules that may be stored in a memory device of the gaming device 100.

FIG. 2D illustrates a handheld device.

FIG. 2E illustrates a standalone gaming device 100.

FIG. 3A is a block diagram depicting various functional elements of an EGM in an example embodiment.

FIG. 3B depicts a casino gaming environment in an example embodiment.

FIG. 4 is a diagram of components of a system for providing online gaming in an example embodiment.

FIG. 5 illustrates, in block diagram form, an implementation of a game processing architecture algorithm that implements a game processing pipeline for the play of a game in accordance with various implementations described herein.

FIG. 6 illustrates an example embodiment of a Gaming Network 600 which may be configured or designed to implement various automated money laundering detection and reporting techniques described and/or referenced herein.

FIG. 7 shows an example block diagram of an electronic gaming system 700 in accordance with a specific embodiment.

FIG. 8 shows electronic gaming table 760 with various features, in accordance with a specific embodiment.

FIG. 9 shows a block diagram of electronic gaming device 900, in accordance with a specific embodiment.

FIG. 10 is a simplified block diagram of an exemplary intelligent electronic gaming system 1000 in accordance with a specific embodiment.

FIG. 11 is a simplified block diagram of an exemplary mobile gaming device 1100 in accordance with a specific embodiment.

FIG. 12 illustrates an example of a functional block diagram of a Casino Gaming Server System in accordance with a specific embodiment.

FIG. 13 illustrates an alternate example embodiment of a Gaming Network 1300 which may be configured or designed to implement various automated money laundering detection and reporting techniques described and/or referenced herein.

FIG. 14 shows a block diagram illustrating components of a gaming system which may be used for implementing various aspects of example embodiments.

FIG. 15 illustrates an example embodiment of an Advantage Spin Award Procedure based on non-game play triggers associated with a player's account.

FIG. 16 illustrates an example embodiment of an Advantage Spin Award Procedure triggered by gameplay activities associated with a player's account.

FIG. 17 illustrates an example embodiment of an EGM Advantage Spin Meter Management Procedure associated with a player's account.

FIG. 18 illustrates an example embodiment of an EGM Advantage Spin Offer/Execution Procedure associated with a player's account.

FIG. 19 illustrates an example embodiment of an Intelligent Game Analysis and Advantage Spin Offer Generation Procedure associated with a player's account.

FIG. 20 illustrates an example embodiment of an Advantage Spin Award Procedure based on non-game play triggers, utilizing Advantage Spin Credit Vouchers.

FIG. 21 illustrates an example embodiment of an Advantage Spin Award Procedure based on gameplay triggers, utilizing Advantage Spin Credit Vouchers.

FIG. 22 illustrates an example embodiment of an EGM Advantage Spin Meter Management Procedure associated with Advantage Spin Credit Vouchers.

FIG. 23 illustrates an example embodiment of an EGM Advantage Spin Offer/Execution Procedure associated with Advantage Spin Credit Vouchers.

FIG. 24 illustrates an example embodiment of an Intelligent Game Analysis and Advantage Spin Offer Generation Procedure associated with Advantage Spin Credit Vouchers.

FIG. 25 illustrates an example embodiment of an Advantage Spin Game Play Procedure.

FIG. 26 illustrates an example embodiment of an Advantage Spin Credit Tracking and Usage Procedure.

FIG. 27 illustrates an example embodiment of an Advantage Spin Pricing/Cost Lookup Table in which the cost of initiating advantage reel or symbol spin activities is dynamically calculated based on the denomination value of the wager-based game being played on an Electronic Gaming Machine (EGM).

FIG. 28 illustrates an example embodiment of an Advantage Spin Pricing/Cost Lookup Table detailing the pricing structure for initiating advantage reel and symbol spin activities through Advantage Spin Reel/Symbol Credits (ARSC/ASSC) on Electronic Gaming Machines (EGMs).

FIG. 29 illustrates an example embodiment of an Advantage Spin Pricing/Cost Lookup Table detailing the pricing structure for initiating Advantage Spin activities through the expenditure of Player Loyalty Points (LP) on Electronic Gaming Machines (EGMs).

FIG. 30 illustrates an example embodiment of an Advantage Spin Pricing/Cost Lookup Table detailing the pricing structure for initiating Advantage Spin activities using game credits (GC) or cash equivalents on Electronic Gaming Machines (EGMs).

FIG. 31 shows an example embodiment of a portion of a wager-based gaming network 3100, designed for deployment at casino venues.

FIG. 32 illustrates an example embodiment of a gaming network scenario depicting the dynamic interaction between a player's account and multiple Electronic Gaming Machines (EGMs) with respect to the transfer, utilization, and management of advantage spin credits.

FIG. 33 shows an example embodiment of Advantage Spin Credit Voucher in which Advantage Spin Voucher Credits are represented in terms of monetary values.

FIG. 34 shows an example embodiment of Advantage Spin Credit Voucher in which Advantage Spin Voucher Credits are represented in terms of credits for predefined advantage spin types.

FIG. 35 shows an example embodiment of Advantage Spin Credit Voucher in which Advantage Spin Voucher Credits are represented in terms of non-monetary Advantage Spin points/credits.

FIG. 36 shows an example embodiment of Advantage Spin Credit Voucher in which Advantage Spin Voucher Credits are represented in terms of non-monetary player loyalty points/credits.

FIG. 37 details an operational scenario within a casino gaming network, where various credit types, including cash and Advantage Spin credits, are deposited into an Electronic Gaming Machine (EGM).

FIG. 38 illustrates a process and system configuration for executing the withdrawal, or “cash out,” of credit balances from an Electronic Gaming Machine (EGM) through the issuance of two distinct types of vouchers: a cash credit voucher and an advantage spin credit voucher.

FIG. 39 illustrates an example embodiment of a graphical user interface (GUI) designed for a wager-based slot game, showcasing the integration of the Advantage Spin Credit system.

FIG. 40 illustrates an example graphical user interface (GUI) of an Electronic Gaming Machine (EGM) in a wager-based slot game environment, showcasing the display and processing features associated with Advantage Spin credits.

FIG. 41 presents an example graphical user interface (GUI) of an Electronic Gaming Machine (EGM) during a cash-out scenario involving Advantage Spin credits.

FIG. 42 illustrates a process and system configuration for depositing both a cash credit voucher and an Advantage Spin credit voucher into an Electronic Gaming Machine (EGM).

FIG. 43 illustrates an example embodiment of a procedural flow for the withdrawal or “cash-out” of credit meter balances from an Electronic Gaming Machine (EGM), detailing the issuance of two distinct types of vouchers: a Cash Credit Voucher and an Advantage Spin Credit Voucher.

FIG. 44 depicts a graphical user interface (GUI) for a wager-based slot game, illustrating the interaction between the player and the system when an Advantage Spin Credit Voucher is inserted into an Electronic Gaming Machine (EGM).

FIG. 45 illustrates a graphical user interface (GUI) for a wager-based slot game, showcasing the processing and integration of an Advantage Spin Credit Voucher that adds Advantage Symbol Spin Credits to the EGM.

FIG. 46 illustrates a graphical user interface (GUI) for a wager-based slot game, showcasing the processing of an Advantage Spin Credit Voucher that contains both Advantage Reel Spin Credits and Advantage Symbol Spin Credits.

FIG. 47 illustrates a graphical user interface (GUI) for a wager-based slot game, depicting the process of cashing out Advantage Spin credits from an Electronic Gaming Machine (EGM).

FIG. 48 illustrates a graphical user interface (GUI) designed for a wager-based slot game, depicting the display of results following the player's initiation of a first spin on the EGM.

FIG. 49 illustrates a graphical user interface (GUI) for a wager-based slot game that dynamically presents an Advantage Spin Offer based on the real-time analysis of a near miss condition.

FIG. 50 depicts an example embodiment of an alternate Advantage Spin Offer graphical user interface (GUI) designed for a wager-based slot game.

FIG. 51 depicts a graphical user interface (GUI) for a wager-based slot game, illustrating the system response and interface updates following the player's acceptance of an Advantage Spin Offer.

FIG. 52 illustrates the graphical user interface (GUI) for a wager-based slot game, showcasing the display of the outcome following the execution of a first re-spin of Reel #1.

FIG. 53 illustrates a graphical user interface (GUI) for a wager-based slot game that dynamically presents a new Advantage Spin Offer based on the outcome from a previously initiated re-spin of Reel #1.

FIG. 54 illustrates a graphical user interface (GUI) for a wager-based slot game, presenting the execution of a second re-spin of Reel #1 after the player has accepted an Advantage Spin Offer.

FIG. 55 illustrates a graphical user interface (GUI) for a wager-based slot game, presenting the outcome of a second re-spin of Reel #1 executed using an Advantage Spin Credit.

FIG. 56 illustrates a graphical user interface (GUI) for a wager-based slot game, showcasing the system's ability to dynamically present an Advantage Spin Offer following real-time analysis of game events to identify a near miss condition.

FIG. 57 illustrates a graphical user interface (GUI) for a wager-based slot game, showcasing the presentation of multiple Advantage Spin Offers generated dynamically based on the outcome of a prior spin event.

FIG. 58 illustrates a graphical user interface (GUI) for a wager-based slot game, showcasing the execution of an Advantage Spin Offer generated in response to the detection of a near miss or near hit condition during an active gaming session.

FIG. 59 illustrates a graphical user interface (GUI) for a wager-based slot game, presenting the process and outcome of executing a symbol-specific re-spin using Advantage Symbol Spin Credits.

FIG. 60 illustrates a graphical user interface (GUI) for a wager-based slot game, presenting the outcomes following the re-spin of Symbol #2.

FIG. 61 depicts a graphical user interface (GUI) for a wager-based slot game, presenting an Advantage Spin Offer generated in response to a near miss condition identified after the re-spin of Symbol #2.

FIG. 62 depicts an example embodiment of a graphical user interface (GUI) for a wager-based slot game that showcases multiple concurrent Advantage Spin offers.

FIG. 63 illustrates an example embodiment of a graphical user interface (GUI) and system process for the simultaneous deposit of a Cash Credit Voucher and an Advantage Spin Credit Voucher into an Electronic Gaming Machine (EGM).

FIG. 64 illustrates an example embodiment of the graphical user interface (GUI) and system process for withdrawing credit balances from an Electronic Gaming Machine (EGM).

FIG. 65 illustrates an example embodiment of a graphical user interface (GUI) and system process for handling the insertion and processing of an Advantage Spin Credit Voucher within an Electronic Gaming Machine (EGM).

FIG. 66 illustrates an example embodiment of a graphical user interface (GUI) for a wager-based slot game, specifically designed to process and display transactions involving Advantage Spin Credit Vouchers.

FIG. 67 illustrates an example embodiment of a graphical user interface (GUI) for a wager-based slot game, specifically depicting the cash-out process for Advantage Spin credits initiated during an active gaming session.

FIG. 68 illustrates an example embodiment of a graphical user interface (GUI) for a wager-based slot game, highlighting the presentation of gameplay outcomes following the initiation of a slot reel spin.

FIG. 69 depicts an example embodiment of a graphical user interface (GUI) for a wager-based slot game, highlighting the processes and interactions involved in identifying and executing an Advantage Spin (or re-spin) opportunity triggered by a “near miss” or “near hit” condition.

FIG. 70 illustrates an example embodiment of a graphical user interface (GUI) for a wager-based slot game, focusing on the execution of an Advantage Spin re-spin opportunity.

FIG. 71 illustrates an example embodiment of a graphical user interface (GUI) for a wager-based slot game, focusing on the presentation of outcomes resulting from an Advantage Spin event, such as the first re-spin of Reel #1.

FIG. 72-96 continue to showcase graphical user interfaces, Advantage Spin scenarios, and procedural flows involving re-spins, cash-outs, and integration of spin credit systems.

FIG. 72 illustrates an example embodiment of a graphical user interface (GUI) for a wager-based slot game, demonstrating the presentation of a new Advantage Spin Offer following the outcome of a prior Advantage Spin event, such as the first re-spin of Reel #1.

FIG. 73 illustrates an example embodiment of a graphical user interface (GUI) for a wager-based slot game, showcasing the presentation of multiple Advantage Spin Offers following the outcome of a prior Advantage Spin event, such as the first re-spin of Reel #1.

FIG. 74 illustrates an example embodiment of a graphical user interface (GUI) for a wager-based slot game, detailing the presentation and execution of an Advantage Spin opportunity triggered by the detection of a near-miss (or near-hit) condition during an active gaming session.

FIG. 75 illustrates an example embodiment of a graphical user interface (GUI) for a wager-based slot game, focusing on the execution of an Advantage Spin event targeting a specific symbol, Symbol #2.

FIG. 76 illustrates an example embodiment of a graphical user interface (GUI) for a wager-based slot game, focusing on the presentation of the outcome of a re-spin targeting a specific symbol, Symbol #2.

FIG. 77 illustrates an example embodiment of a graphical user interface (GUI) for a wager-based slot game, focusing on the presentation of a new Advantage Spin Offer generated following the outcome of a prior Advantage Spin event, such as the first re-spin of Reel #1.

FIG. 78 illustrates an example embodiment of a graphical user interface (GUI) for a wager-based slot game, showcasing an alternate implementation of Advantage Spin Offers generated based on the outcome of a previous spin.

FIG. 79 illustrates an example embodiment of a graphical user interface (GUI) for a wager-based slot game, showcasing a hybrid approach to Advantage Spin Offers.

FIG. 80 illustrates an example embodiment of a graphical user interface (GUI) for a wager-based slot game, showcasing a dynamic presentation of multiple Advantage Spin Offers.

FIG. 81 illustrates an example embodiment of a graphical user interface (GUI) for a wager-based slot game, showcasing a feature-rich Advantage Spin Offer allowing players to re-spin a selected reel while holding a specific symbol displayed on that reel.

FIG. 82 illustrates an example embodiment of a graphical user interface (GUI) for a wager-based slot game, showcasing a flat-rate Advantage Spin Offer that enables players to select and re-spin up to a specified maximum number of reels for a fixed cost.

FIG. 83 illustrates an example embodiment of a graphical user interface (GUI) for a wager-based slot game, featuring an Incremental Cost Advantage Spin Offer that allows players to select and re-spin up to a specified maximum number of reels at a fixed cost per reel.

FIG. 84 illustrates an example embodiment of a graphical user interface (GUI) for a wager-based slot game, highlighting a flat-rate Advantage Spin Offer that allows players to strategically select and hold up to a specified maximum number of displayed slot reel symbols while re-spinning all non-held symbols.

FIG. 85 illustrates an example embodiment of a graphical user interface (GUI) for a wager-based slot game, showcasing the execution phase of a Symbol Hold/Spin Advantage Spin Offer.

FIG. 86 depicts an example embodiment of a graphical user interface (GUI) for a wager-based slot game, demonstrating the functionality of the Advantage Spin system in an incremental cost embodiment.

FIG. 87 illustrates a graphical user interface (GUI) designed for a wager-based slot game, demonstrating the dynamic capabilities of the Advantage Spin system to respond to near-miss scenarios.

FIG. 88 illustrates a graphical user interface (GUI) designed for a wager-based slot game, demonstrating the execution phase of an Advantage Spin opportunity.

FIG. 89 illustrates a graphical user interface (GUI) for a wager-based slot game, showcasing the Advantage Spin system's ability to present a targeted offer following a near-miss event involving multiple symbols.

FIG. 90 illustrates a graphical user interface (GUI) for a wager-based slot game, demonstrating the execution phase of a multi-symbol Advantage Spin opportunity.

FIG. 91 illustrates a graphical user interface (GUI) designed for a wager-based slot game, showcasing the process by which an Electronic Gaming Machine (EGM) integrates Advantage Spin credits from a physical or digital Advantage Spin Credit Voucher into its credit system.

FIG. 92 illustrates a graphical user interface (GUI) designed for a wager-based slot game, depicting the integration and management of Advantage Symbol Spin Credits during an active gaming session.

FIG. 93 illustrates a graphical user interface (GUI) for a wager-based slot game, demonstrating the simultaneous management of multiple credit types.

FIG. 94 illustrates a graphical user interface (GUI) for a wager-based slot game, showcasing the process of transferring Loyalty Points from a player's account to the Electronic Gaming Machine's (EGM) Advantage Spin Loyalty Point meter.

FIG. 95 depicts a graphical user interface (GUI) for a wager-based slot game, showcasing the dynamic presentation of an Advantage Spin Offer in response to a near-miss event.

FIG. 96 illustrates a graphical user interface (GUI) for a wager-based slot game, presenting an Advantage Spin Offer in response to a near-miss event.

Additional Figures depict various system diagrams, flow diagrams, and screenshots of graphical user interfaces which have been configured or designed to facilitate, enable, initiate, and/or perform one or more operation(s), action(s), and/or feature(s) of the Advantage Spin techniques described herein.

### DETAILED DESCRIPTION OF EXAMPLE EMBODIMENTS

### Overview

Various aspects described or referenced herein are directed to different methods, systems, and computer program products directed to electronic gaming devices and intelligent advantage spin techniques implemented in a wager-based gaming networks.

Various aspects described or referenced herein are directed to different techniques for facilitating enhanced gaming sessions using advantage spin mechanics.

One aspect disclosed herein is directed to a computerized gaming system for facilitating enhanced gaming sessions using advantage spin mechanics, comprising: at least one hardware processor; a non-transient memory storing instructions; a display device coupled to the hardware processor; at least one input interface for receiving input from a user; the processor being configured to execute instructions stored in the memory for causing the gaming system to carry out: initiating, at the system, a first active gaming session of a wager-based first slot game, the first slot game including a first set of slot reels, wherein each slot reel includes a respective plurality of symbols; executing a first spin of the first set of slot reels in response to a first input from a first player; determining and displaying, on the display device, a first game outcome of the first spin of the first set of slot reels, the first game outcome comprising a first array of slot game symbols arranged in a first configuration; causing a computerized game analysis engine to analyze the first game outcome in substantially real-time to identify a first advantage spin activity which may be initiated by the first player in response to the first game outcome; determining and selecting, in substantially real-time, a first set of selected symbols from the first array of slot game symbols for participation in the first advantage spin activity, wherein the first set of selected symbols includes at least one selected symbol from the first array of slot game symbols, wherein the first advantage spin activity includes executing a randomized spin of only the first set of selected symbols; calculating, in substantially real-time, a first credit type and a first quantity of credits to be consumed in order to fund execution of the first advantage spin activity during the first active gaming session; generating, by the gaming system in substantially real-time, a first advantage spin offer for allowing the first player to execute the first advantage spin activity, wherein the first advantage spin offer includes: (i) a first offer to execute the randomized spin of only the first set of selected symbols, and (ii) a first advantage spin offer price specifying the first credit type and the first quantity of credits to be consumed for funding execution of the first advantage spin activity; displaying details relating to the first advantage spin offer to the first player, including the first offer and the first advantage spin offer price; causing the gaming system to execute the first advantage spin activity, wherein execution of the first advantage spin activity includes executing the randomized spin of only the first set of selected symbols; causing the gaming system to consume the first quantity of credits of the first credit type for funding execution of the first advantage spin activity; and determining and displaying, on the display device, a second game outcome resulting from the execution of the first advantage spin activity, the second game outcome comprising a second array of slot game symbols arranged in a second configuration.

In at least one embodiment, the gaming system is further operable to cause the at least one processor to execute additional instructions for: causing the computerized game analysis engine to analyze the first game outcome in substantially real-time to identify a second advantage spin activity which may be initiated by the first player in response to the first game outcome; determining and selecting, in substantially real-time, a second set of selected symbols from the first array of slot game symbols for participation in the second advantage spin activity, wherein the second set of selected symbols includes at least one selected symbol from the first array of slot game symbols, wherein the second advantage spin activity includes executing a randomized spin of only the second set of selected symbols; calculating, in substantially real-time, a second credit type and a second quantity of credits to be consumed in order to fund execution of the second advantage spin activity during the first active gaming session; generating, by the gaming system in substantially real-time, a second advantage spin offer for allowing the first player to execute the second advantage spin activity, wherein the second advantage spin offer includes: (i) a second offer to execute the randomized spin of only the second set of selected symbols, and (ii) a second advantage spin offer price specifying the second credit type and the second quantity of credits to be consumed for funding execution of the second advantage spin activity; displaying details relating to the second advantage spin offer to the first player, including the second offer and the second advantage spin offer price; displaying a graphical user interface configured or designed to enable the first player to provide at least one second input to the gaming system, wherein the at least one second input includes at least one of: (i) accepting the first advantage spin offer; (ii) accepting the second advantage spin offer; (iii) declining the first advantage spin offer; and/or (iv) declining the second advantage spin offer.

In at least one embodiment, the gaming system includes a cash credit meter and an advantage spin credit meter; the gaming system being further operable to cause the at least one processor to execute additional instructions for: adjusting at least one cash credit of the first cash credit meter as a result of the execution of the first spin of the first set of slot reels; adjusting at least one advantage spin credit of the first advantage spin credit meter as a result of the execution of the first advantage spin activity.

In at least one embodiment, the gaming system is further operable to cause the at least one processor to execute additional instructions for: managing and tracking transactions at the first EGD involving a plurality of different credit types, including a cash credit type which is redeemable for cash, and an advantage spin credit type having no cash value; wherein the first advantage spin offer price specifies the first quantity of advantage spin credits to be consumed for funding execution of the first advantage spin activity; and wherein the first EGD is configured or designed to accept the use of advantage spin credits to facilitate additional gameplay actions not executable with cash credits, including targeted advantage spin opportunities presented via a graphical user interface.

In at least one embodiment, the gaming system includes a plurality of hardware components, including at least one of: a tablet computing device; a mobile computing device; a smartphone device; a desktop computer system; a laptop computer system; and/or an electronic gaming machine.

In at least one embodiment, the gaming system is further operable to cause the at least one processor to execute additional instructions for: enabling the first player to modify the selection of the first set of selected symbols from the first array of slot game symbols for participation in the first advantage spin activity; and modifying, before execution of the first advantage spin activity, the selection of the first set of selected symbols for participation in the first advantage spin activity in response to a second set of input from the first player.

In at least one embodiment, the gaming system is further operable to cause the at least one processor to execute additional instructions for: enabling the first player to modify the selection of the first set of selected symbols from the first array of slot game symbols for participation in the first advantage spin activity; modifying, before execution of the first advantage spin activity, the selection of the first set of selected symbols for participation in the first advantage spin activity in response to a second set of input from the first player; and wherein the first set of selected symbols are arranged in a vertical column of the first array of slot game symbols.

In at least one embodiment, the gaming system is further operable to cause the at least one processor to execute additional instructions for: calculating a first win amount based on the first configuration of the first array of slot game symbols representing first game outcome; and wherein the selection of the of the first set of selected symbols for participation in the first advantage spin activity is determined based on a probability of increasing a win amount for the first player based on possible outcomes of the randomized spin of only the first set of selected symbols.

In at least one embodiment, the gaming system is further operable to cause the at least one processor to execute additional instructions for: calculating the first advantage spin offer price based, at least in part, on at least one of: a current bet denomination value, and/or a number of lines played in the active game.

In at least one embodiment, the gaming system is further operable to cause the at least one processor to execute additional instructions for: causing the gaming system to determine, using a first set of predefined criteria, whether advantage spin game play activity is permitted to be conducted in the first active gaming session; preventing advantage spin game play activity from being conducted in the first active gaming session in response to determining, based on the first set of predefined criteria, that advantage spin game play activity is not permitted to be conducted in the first active gaming session.

In at least one embodiment, the gaming system is further operable to cause the at least one processor to execute additional instructions for: causing the gaming system to determine, using a first set of predefined criteria, whether advantage spin game play activity is permitted to be conducted in the first active gaming session; identifying a first game theme or first game title associated with the first active gaming session; determining, using the first set of predefined criteria and the first game theme or first game title, whether advantage spin game play activity is permitted to be conducted during the first active gaming session.

Another aspect disclosed herein is directed to a computerized gaming system implemented in a wager-based gaming network, the system comprising: at least one interface for communicating with a casino management system and a plurality of electronic, wager-based gaming machines (EGDs) within the network; the plurality of EGDs including a first EGD having a first electronic display, and a second EGD having a second electronic display, the second EGD being different from first EGD; the casino management system being configured or designed to manage and track transactions in the network involving a plurality of different credit types, including a cash credit type which is redeemable for cash, and an advantage spin credit type having no cash value; at least one hardware processor; a non-transient memory storing executable instructions; the system being operable to cause the at least one processor to execute instructions stored in the memory for: initiating, at the first EGD, a first gaming session of a first wager-based game for a first player, the first EGD comprising a first cash credit meter for tracking cash credit related transactions at the first EGD, and a first advantage spin credit meter for tracking advantage spin credit related transactions at the first EGD; tracking, at the first EGD in substantially real-time, cash credit related transactions at the first EGD; tracking, at the first EGD in substantially real-time, advantage spin credit related transactions at the first EGD; processing, at the first EGD, a first deposit transaction involving a first amount of cash credits, wherein the processing of the first deposit transaction includes adjusting a value of the first cash meter to reflect a deposit of the first amount of cash credits; processing, at the first EGD, a second deposit transaction involving a second amount of advantage spin credits, wherein the processing of the second deposit transaction includes adjusting a value of the first advantage spin credit meter to reflect a deposit of the second amount of advantage spin credits; adjusting at least one cash credit of the first cash credit meter in response to game play activity at the first EGD; adjusting at least one advantage spin credit of the first advantage spin credit meter in response to game play activity at the first EGD; detecting at least one predefined game session-ending condition at the first EGD; causing the first EGD to initiate, in response to detecting the at least one predefined game session-ending condition, a first credit withdrawal process, including: (i) determining a third amount of advantage spin credits to be withdrawn from the first EGD, (ii) electronically transferring, via the network, the third amount of advantage spin credits from the first EGD to at least one of: an advantage spin credit management system, a first player account, or a first advantage spin credit voucher; identifying a fourth amount of advantage spin credits for withdrawal from a first external source and deposit to the second EGD, the first external source being one of: the advantage spin credit management system, the first player account, or the first advantage spin credit voucher; causing the fourth amount of advantage spin credits to be electronically withdrawn from the first external source and electronically deposited to the second EGD, the second EGD comprising a second cash credit meter for tracking cash credit related transactions at the second EGD, and a second advantage spin credit meter for tracking advantage spin credit related transactions at the second EGD; processing, at the second EGD, a fourth deposit transaction involving a deposit of the fourth amount of advantage spin credits to the second EGD, wherein the processing of the fourth deposit transaction includes adjusting a value of the second advantage spin credit meter to reflect the deposit of the fourth amount of advantage spin credits; initiating, at the second EGD, a second gaming session of a second wager-based game; executing game play activity at the second EGD using at least one advantage spin credit associated with the fourth deposit; and wherein the second EGD is configured or designed to accept the use of advantage spin credits to facilitate additional gameplay actions, including targeted advantage spin opportunities presented via a graphical user interface.

In at least one embodiment, the gaming system is further operable to cause the at least one processor to execute additional instructions for: synchronizing credit-related data from the first EGD with the casino management system via the network, wherein the synchronization enables substantially real-time updates of the first player's available advantage spin credit balance across multiple different EGDs connected to the network.

In at least one embodiment, the gaming system is further operable to cause the at least one processor to execute additional instructions for: causing the system to generate a third unique identifier representing the third amount of advantage spin credits withdrawn from the first EGD; and causing the system to authenticate and validate the fourth deposit transaction using the third unique identifier.

In at least one embodiment, the gaming system is further operable to cause the at least one processor to execute additional instructions for: causing the fourth amount of advantage spin credits to be electronically withdrawn from the first player account and electronically deposited to the second EGD.

In at least one embodiment, the gaming system is further operable to cause the at least one processor to execute additional instructions for: causing the fourth amount of advantage spin credits to be electronically redeemed from a physical or digital advantage spin credit voucher and electronically deposited to the second EGD.

In at least one embodiment, the system of claim B10 wherein the at least one predefined game session-ending condition is triggered by at least of: a cashout request initiated by the first player; the first credit meter having a zero value; or a free spin credit meter at the first EGD having a value of zero.

In at least one embodiment, the gaming system is further operable to cause the at least one processor to execute additional instructions for: synchronizing cash credit-related data from the first EGD with the casino management system via the network, wherein the synchronization enables substantially real-time updates of the first player's available cash credit balance across multiple different EGDs connected to the network; and synchronizing advantage spin credit-related data from the first EGD with the casino management system via the network, wherein the synchronization enables substantially real-time updates of the first player's available advantage spin credit balance across multiple different EGDs connected to the network.

In at least one embodiment, the gaming system is further operable to cause the at least one processor to execute additional instructions for: causing the system to determine, using a first set of predefined criteria, whether at least a portion of the advantage spin credits associated with the fourth deposit transaction are eligible for funding gameplay activity at the second EGD.

In at least one embodiment, the gaming system is further operable to cause the at least one processor to execute additional instructions for: causing the system to determine, using a first set of predefined criteria, whether at least a portion of the advantage spin credits associated with the fourth deposit transaction are eligible for funding gameplay activity at the second EGD; and preventing a first portion of advantage spin credits associated with the fourth deposit transaction from being eligible for funding specific gameplay activity at the second EGD.

In at least one embodiment, the gaming system is further operable to cause the at least one processor to execute additional instructions for: processing, at the second EGD, a fifth deposit transaction involving a deposit of at least one promotional advantage spin credit to the second EGD, the at least one promotional advantage spin credit having associated therewith a first set of restriction criteria; causing the system to determine, using the first set of restriction criteria, whether the at least one promotional advantage spin credit is eligible for funding gameplay activity of the second gaming session; and preventing the at least one promotional advantage spin credit from being eligible for funding gameplay activity of the second gaming session.

In at least one embodiment, the gaming system is further operable to cause the at least one processor to execute additional instructions for: processing a request to deposit at least one promotional advantage spin credit at the second EGD, the at least one promotional advantage spin credit having associated therewith a first set of restriction criteria; causing the system to determine, using the first set of restriction criteria, whether the at least one promotional advantage spin credit is eligible for funding gameplay activity at the second EGD; and preventing the at least one promotional advantage spin credit from being deposited at the second EGD in response to determining that the at least one advantage spin credit is not eligible for funding gameplay activity at the second EGD.

In at least one embodiment, the gaming system is further operable to cause the at least one processor to execute additional instructions for: withdrawing at least a portion of advantage spin credits from a first player account during an active or inactive gaming session; transferring the withdrawn advantage spin credits to one or more of a physical advantage spin credit voucher or a digital advantage spin credit voucher; facilitating usage or redemption of the physical or digital advantage spin credit voucher across at least one of: a plurality of EGDs, a plurality of different gaming devices, a plurality of different game types, or a plurality of different casino venues.

The Advantage Spin technology stands as a groundbreaking innovation in the casino gaming industry, redefining the slot machine experience with an emphasis on strategic depth and interactive engagement. This advanced system is designed to significantly enhance player engagement not only through gameplay but also by integrating their activities within the casino environment into a rewarding experience. A notable aspect of this technology is its ability to transform traditional slot machine interactions into a dynamic and strategic gaming sessions offering numerous Advantage Spin or re-spin opportunities.

Various objects, features and advantages of the various aspects described or referenced herein will become apparent from the following descriptions of its example embodiments, which descriptions should be taken in conjunction with the accompanying drawings.

### Notable Features of Advantage Spin Technology

### Re-Spin Opportunities Utilizing Various Credits

Central to the Advantage Spin system is the innovative capability of Electronic Gaming Machines (EGMs) to offer players diverse opportunities for re-spinning selected slot reels and/or symbols. This feature is ingeniously designed to utilize a range of credits, including advantage spin credits, game credits, and player loyalty points, providing players with a flexible approach to enhancing their gameplay. This flexibility ensures that players may leverage their accumulated rewards and points in a manner that significantly impacts their game strategy and potential winnings, thereby adding a layer of anticipation and excitement to every spin.

### Real-Time Analysis for Enhanced Gameplay

Another standout feature of the Advantage Spin technology is the sophisticated real-time analysis conducted by EGM slot machines. This system is adept at scrutinizing current game state data to pinpoint occurrences of near miss or near hit events or conditions. Such events crucially provide opportunities for an Advantage Spin (or re-spin), injecting a strategic element into the gameplay. By identifying these notable moments, the system not only heightens the gaming experience but also offers players the chance to alter the course of their game, adding a thrilling dimension of strategy and chance interplay.

### Generation of Targeted Advantage Spin Offers

Following the identification of a potential re-spin opportunity, the Advantage Spin system is capable of generating tailored Advantage Spin Offers. These offers detail the specific conditions under which the re-spin may be initiated, including the types and quantities of credits required. Presented often as time-sensitive proposals, these offers compel players to make strategic decisions swiftly, further engaging them in their gameplay. This feature epitomizes the system's goal of creating an immersive and interactive slot machine experience, where players are not merely passive participants but active strategists in pursuit of victory.

### Advantage Spin Features, Benefits and Technological Innovations

The Advantage Spin technology is a revolutionary enhancement in the gaming industry, particularly for casinos looking to increase player engagement and add depth to the slot machine experience. This technology integrates a sophisticated system that rewards players not just for their gameplay but also for their overall engagement within the casino property. Players are treated to a richer, more engaging slot machine experience that rewards not just based on the outcome of spins but also on strategic decisions and overall engagement with the casino. This approach significantly enhances the perceived value of their visit, fostering greater satisfaction and loyalty.

For casinos, this technology serves as a potent tool for driving patron engagement and retention. By offering a gameplay experience that rewards a wide range of activities and introduces strategic depth, casinos may encourage repeat visits and prolonged engagement on the casino floor. The real-time analysis and dynamic offers keep the gameplay exciting and unpredictable, leading to increased playtime and, consequently, revenue.

Below is a brief summary that elucidates the myriad features, functions, benefits, advantages, and innovative use cases of the Advantage Spin technology.

### Advantage Spin Conditions and Credit Deduction Methods

Players become eligible for one or more advantage spins (e.g., selected reel and/or symbol re-spins) under predefined conditions, thereby adding excitement and a layer of strategy as players anticipate these opportunities. Various methods are provided for funding re-spins, including the use of normal slot tickets, “Advantage Spin” tickets from the TITO system, cash, or deducting from a player's membership card, which includes loyalty points and a separate Wallet. This flexibility in funding options ensures that players may engage with the feature regardless of their preferred payment method, enhancing accessibility and inclusivity.

### Identifying and Rewarding Patron Engagement

Advantage Spin focuses on acknowledging and rewarding patrons for their broad spectrum of activities within the casino premises, transcending the confines of traditional gameplay rewards. It initiates this by pinpointing active promotions and defining precise criteria for awarding Advantage Spin credits, ensuring continuous patron engagement and a valued presence on the casino floor.

### Monitoring and Analyzing Non-Gameplay Activities

The system meticulously monitors and tracks a patron's non-gameplay activities at the casino property. This includes dining, attending shows, or simply visiting different parts of the casino. It then analyzes these activities to determine if they meet the set criteria for awarding Advantage Spin credits. This holistic view of patron engagement recognizes and incentivizes a broader spectrum of activities, encouraging patrons to explore and enjoy all the amenities a casino has to offer. The system may track and monitor non-gameplay activities of patrons, such as dining, attending shows, or exploring the casino. It assesses these activities against predefined criteria to determine eligibility for Advantage Spin credits, thereby incentivizing patrons to immerse themselves fully in what the casino has to offer, promoting a well-rounded entertainment experience.

### Issuance of Advantage Spin Credits

Upon satisfying the criteria, patrons may be issued a first amount of Advantage Spin credits through an Advantage Spin Credit Voucher. This process not only rewards but also directly influences the player's decision to engage further with gaming machines, offering a tangible incentive to continue their gaming experience.

### Membership Card Integration

The system's seamless integration with players' membership cards for credit deduction further personalizes the gaming experience. It allows for the deduction of credits directly from loyalty points and a dedicated Wallet, deepening the connection between the player and the casino's broader rewards ecosystem.

### Advantage Spin Flow Procedures

The Advantage Spin encompasses a detailed set of flow procedures, including the issuance of credit vouchers through both physical and digital means, ensuring a smooth and understandable process for redeeming and utilizing Advantage Spins. From the initial insertion and recognition of a ticket to the authentication, validation, value verification, credit assignment, and strict adherence to security and compliance standards, every step is meticulously designed to enhance user experience and maintain integrity.

### TITO Credit Voucher Embodiments

With multiple embodiments for the voucher credits, including monetary credits, credits for predefined Advantage SPIN types, and non-monetary Advantage Spin points/credits, the system offers unparalleled flexibility. This diversity caters to various player preferences and strategies, broadening the feature's appeal.

### Advantage Spin Award Procedures

Distinct procedures for awarding Advantage Spin credits based on both non-game play and game play triggers enrich the gameplay experience. Whether through external activities within the casino or specific in-game conditions, these procedures ensure that players have ample opportunities to gain Advantage Spins, fostering a deeper engagement with the casino's offerings.

### Seamless Voucher Integration and Credit Allocation

When a patron wishes to use their Advantage Spin credits, the Electronic Gaming Machine reads the voucher, identifying notable details like the Voucher ID, Validation Code, and the credit values. The EGM then communicates with the ASCMS to authenticate and validate the voucher, ensuring the credits are legitimate and correctly assigned to the player's session. Upon successful validation, the EGM determines and adds the specified types and values of Advantage Spin credits to the credit meter, seamlessly integrating the rewards into the gaming experience.

### Advantage Spin TITO Credit Voucher Embodiments

The system offers several embodiments for implementing voucher credits:
Monetary Credits: Implemented via monetary values, offering a direct and understandable value proposition to players.
Predefined Spin Types: Offering credits for specific spin types introduces a tailored gaming experience.
Non-monetary Credits: Implementation via non-monetary points or credits for Advantage Spin, diversifying the rewards system and encouraging continued play.
Loyalty points: Implementation via player/patron loyalty points or credits for Advantage Spin, diversifying the rewards system and encouraging continued play.

Each embodiment caters to different player preferences and strategies, broadening the appeal of the Advantage Spin feature.

Enhancing Gameplay with Real-Time Analysis

The Advantage Spin system enhances active gaming sessions by continuously monitoring and analyzing the game state. It identifies occurrences of near-miss or near-hit conditions in real-time, which significantly contributes to the dynamic gaming experience. This real-time analysis is notable in determining the types and quantities of Advantage Spin credits required to fund execution of an identified re-spin opportunity.

### Dynamic Advantage Spin Offers

The EGM then generates a targeted Advantage Spin Offer for the identified opportunity, detailing the specific costs in terms of Advantage Spin credits and/or game credits needed. These offers, potentially limited-time, may may require player input within a specified interval, adding an element of urgency and excitement to the gameplay. If the player elects to proceed, the EGM initiates the necessary procedures to secure funding from the player's Advantage Spin credit meter and executes the identified Advantage Spin opportunity.

### Enhanced Player Engagement Features

The inclusion of strategic options, such as the ability to select specific lines or symbols for a re-spin, introduces an element of control and customization into the slot gaming experience. This, combined with features like flexible activation, opt-out options, and external triggers, significantly enhances player engagement by blending chance with strategy.

### Replay Value and Strategic Depth

Advantage Spin technology not only enriches the immediate gaming experience but also adds significant replay value to slot games. With its unpredictable nature, strategic decision-making opportunities, and the integration of multiple rounds and player choice in reel-spinning direction, it transforms every game session into a unique and compelling narrative.

### Mutual Benefits for Patrons and Casinos

For patrons, Advantage Spin introduces a deeper, more engaging slot machine experience, rewarding both gameplay and wider casino engagement, which may significantly heighten the perceived value of their visit and foster greater loyalty. Casinos benefit from a robust system that drives engagement, potentially increasing cross-property revenue and encouraging repeat visits through real-time analysis and dynamic offers, which keep gameplay both exciting and unpredictable.

### Strategic Gameplay Innovations

The strategic decision-making opportunity presented when the Advantage Spin symbol appears adds depth to the gameplay. Players may choose to buy an extra spin, select specific lines or symbols for a re-spin, or even opt out, offering control over their gaming strategy. This level of interaction significantly enhances player engagement by introducing decision-making elements outside the standard game mechanics.

### Re-Spin Conditions

Central to the Advantage Spin system is the concept of re-spin conditions, where players become eligible for a re-spin under certain predefined circumstances. This not only augments player engagement by adding an additional layer of anticipation but also increases the excitement factor, as each spin holds the potential for triggering this lucrative option.

### Credit Deduction Methods

The technology offers versatile methods for players to fund their re-spins, including using normal slot tickets, Advantage Spin tickets from the TITO system, cash, or deducting from loyalty points and a separate Wallet on their membership card. This multi-faceted approach ensures that all players, regardless of their preferred method of transaction, may easily engage with the feature.

### External Triggers and Novel Features

Incorporating external triggers like club member privileges or specific game-based rewards introduces novel gameplay features that expand beyond the traditional slot machine experience. This includes enabling players to choose which reels to re-spin, further customizing their strategy and enhancing their engagement with the game.

### Benefits and Advantages

The Advantage Spin technology brings numerous benefits to both patrons and casinos. For patrons, it offers a richer, more engaging gaming experience that rewards not just gameplay but overall engagement with the casino, enhancing the perceived value of their visit. The system's ability to issue rewards based on a wide array of activities encourages exploration and enjoyment of all the services a casino offers, potentially increasing overall patron satisfaction and loyalty.

For casinos, the Advantage Spin system provides a powerful tool for driving patron engagement and loyalty. By rewarding a wide range of activities, casinos may increase cross-property revenue and encourage repeat visits. The technology's real-time analysis and dynamic offers keep gameplay exciting and unpredictable, potentially leading to increased play time and, consequently, revenue.

### A Paradigm Shift in Casino Gaming

The Advantage Spin technology represents a significant leap forward in casino gaming. By integrating sophisticated tracking, analysis, and reward systems, it creates a more immersive, rewarding, and engaging experience for casino patrons, encouraging both gameplay and broader engagement with casino amenities. This innovative approach not only enhances the player's experience but also offers casinos a novel way to increase patron loyalty and spend, marking a win-win advancement in casino entertainment technology.

Through its visionary approach to integrating gameplay with broader casino engagement, Advantage Spin sets a new benchmark for slot machine technology, promising an enriched gaming landscape that prioritizes strategic depth, player recognition, and immersive engagement.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that may be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

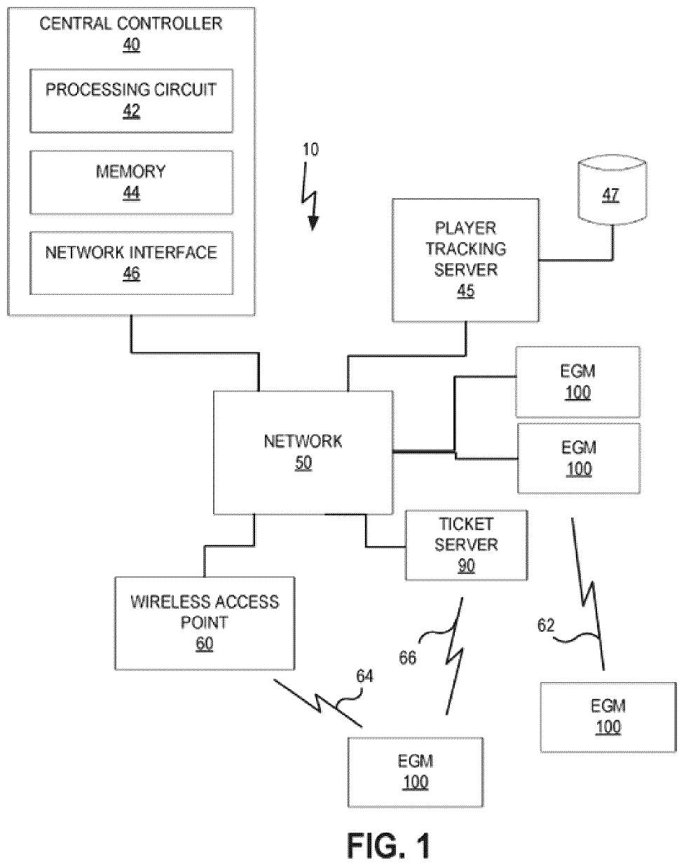

FIG. 1 illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A Player Account server 45 may also be connected through the data communication network 50. The Player Account server 45 may manage a Player Account that tracks the player's gameplay and spending and/or other player preferences and customizations, manages loyalty awards for the player, manages funds deposited or advanced on behalf of the player, and other functions. Player information managed by the Player Account server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

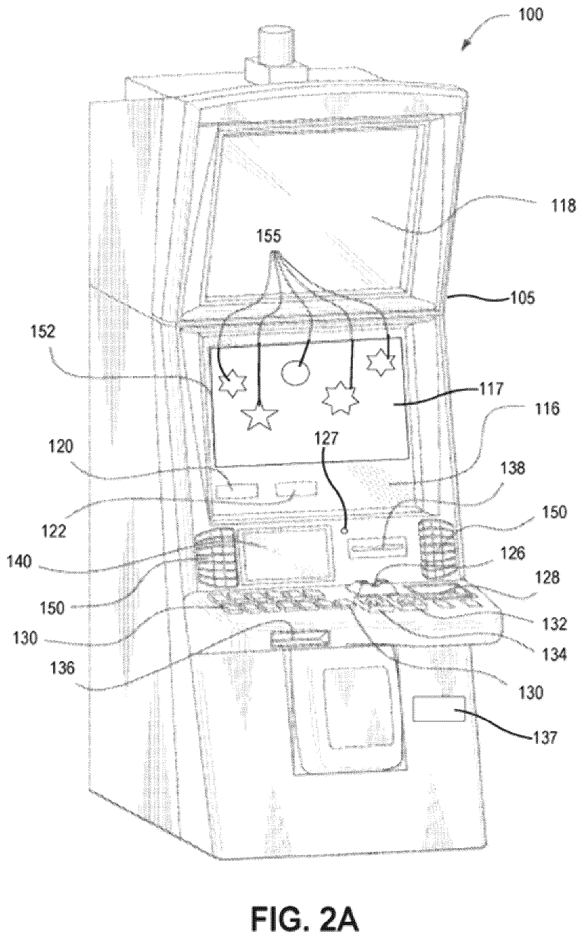

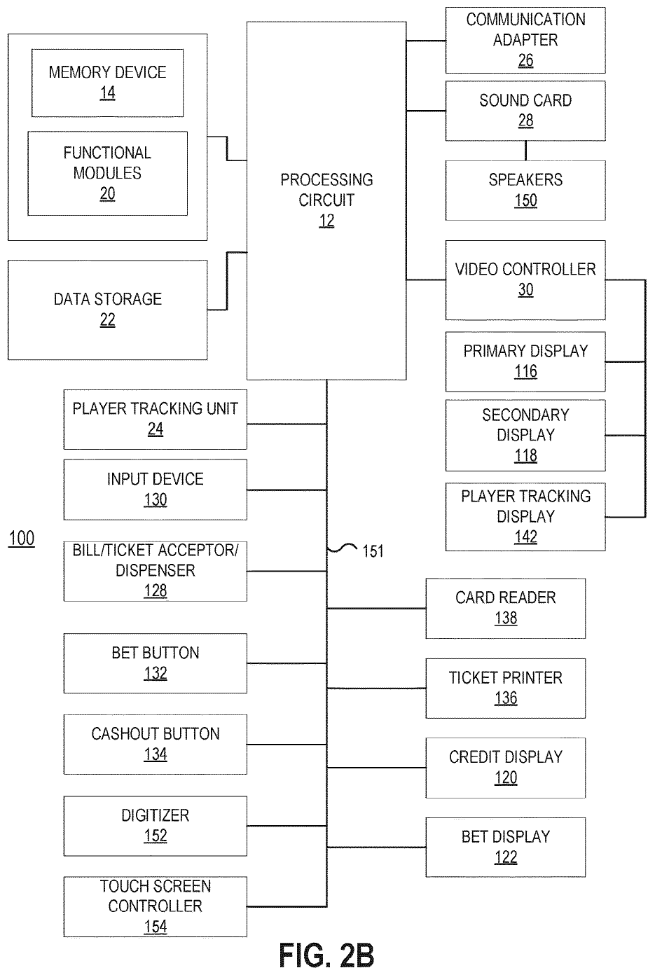

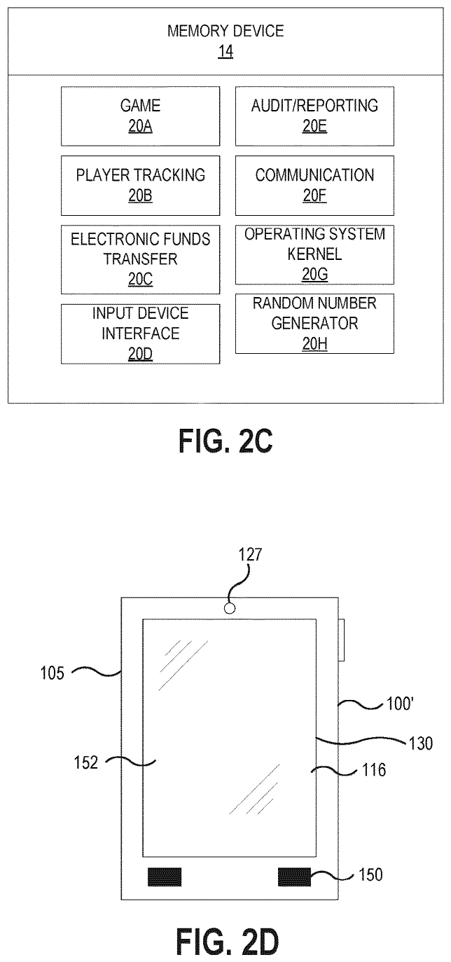

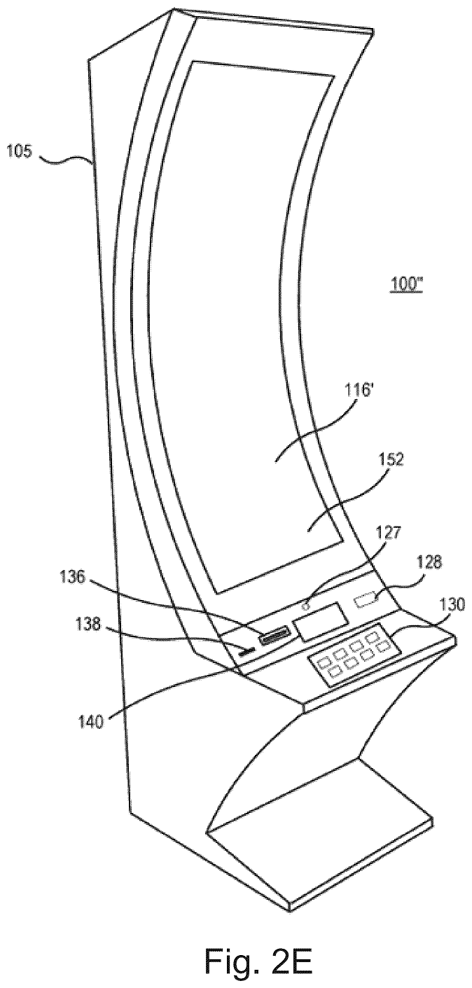

Embodiments herein may include different types of gaming devices. Various embodiments are illustrated in FIGS. 2A-E.

FIG. 2A is a perspective view of a gaming device 100 illustrating various physical features of the device.

FIG. 2B is a functional block diagram that schematically illustrates an electronic relationship of various elements of the gaming device 100.

FIG. 2C illustrates various functional modules that may be stored in a memory device of the gaming device 100.

FIG. 2D illustrates a handheld device.

FIG. 2E illustrates a standalone gaming device 100.

The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a Player Account display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The Player Account display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the Player Account display 142, the credit display 120 and the bet display 122 may be displayed in one or more portions of one or more other displays that display other game related visual content. For example, one or more of the Player Account display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the Player Account display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a Player Account unit 24 for managing communications and functionality between the processor circuit 12 and certain peripherals and components. Player Account units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which may include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EE PROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a Player Account module 20B, an electronic funds transfer module 20C, an input device interface 20D, an audit/reporting module 20E, a communication module 20F, an operating system kernel 20G and a random number generator 20H. The Player Account module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

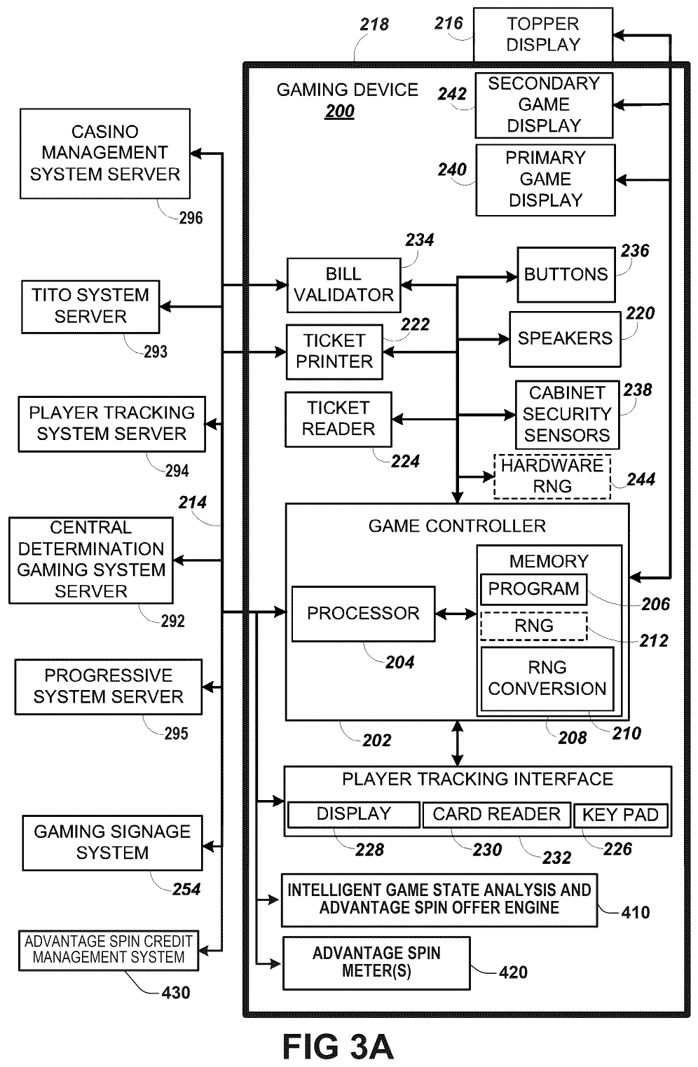

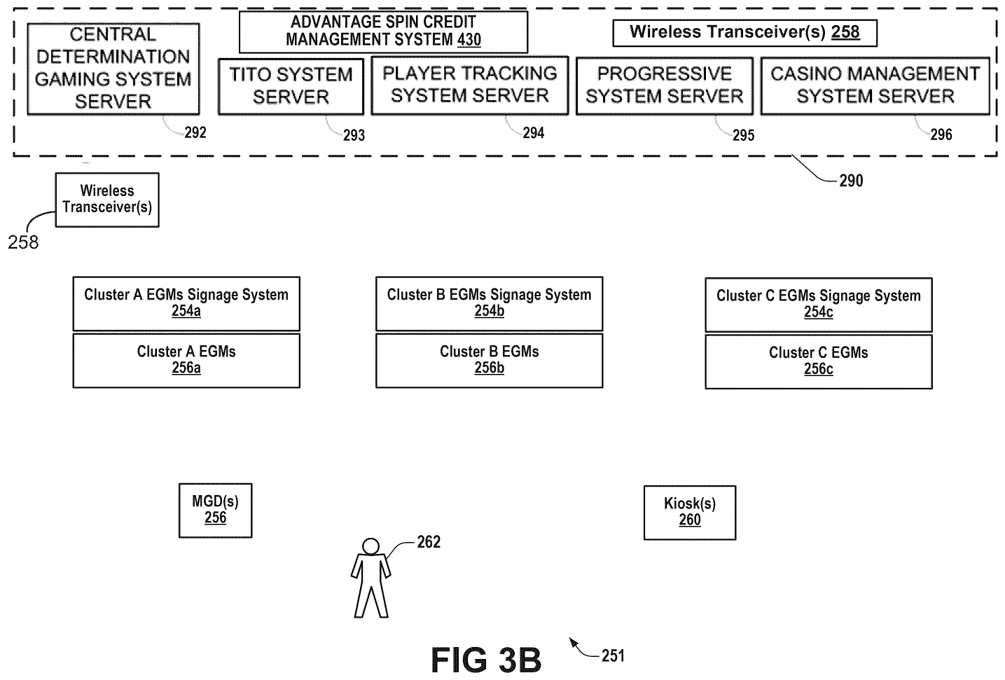

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits may be deposited in or transferred from the gaming device 100′ electronically.

FIG. 2E illustrates a standalone gaming device 100, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a Player Account display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

In some embodiments, in response to receiving a wager from a user of a gaming device, a gaming system displays, on a display device of the gaming device, a graphical interface for a wagering game. The graphical interface includes a plurality of game symbols arranged in an array (also referred to herein as a grid) of a plurality of lines (also referred to herein as rows) of game symbols. Based on the array, a game result for the wagering game is determined. A game award is provided to the user in response to the game result indicating a winning game result. In some examples, a winning game result occurs when the grid of game symbols includes a winning shape formed by a combination of game symbols.

In additional or alternative embodiments, subsequent play (or subsequent stages) of the wagering game includes generating a new array based on the array. For example, the winning combination of game symbols may be removed and replaced (e.g., the previously displayed symbols may cascade down to fill the removed slots in the array). These and other aspects will be described in greater detail below.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 3A is a block diagram depicting various functional elements of a gaming device 200 (e.g., an EGM) in an example embodiment. All or parts of gaming device 200 shown may be used to implement any one of the example gaming devices depicted in FIGS. 1 and 2A-E.

Communication between or among the gaming devices and/or the server computers 290, may be direct or indirect using one or more communication protocols. As an example, gaming devices 100 and the server computers 290 may communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks may allow gaming devices to communicate with one another and/or the server computers 290 using a variety of communication-based technologies, such as radio frequency (RF) (e.g., wireless fidelity (WiFi®) and Bluetooth®), cable TV, satellite links and the like.

In some implementation, server computers 290 may not be necessary and/or preferred. For example, in one or more implementations, a stand-alone gaming device may implement one or more aspects of the present disclosure. However, it is typical to find multiple EGMs connected to networks implemented with one or more of the different server computers 290 described herein.

The server computers 290 may include a central determination gaming system server 292, a ticket-in-ticket-out (TITO) system server 293, a Player Account system server 294, a progressive system server 295, and/or a casino management system server 296. Gaming devices may include features to enable operation of any or all servers for use by the player and/or operator (e.g., the casino, resort, gaming establishment, tavern, pub, etc.). For example, game outcomes may be generated on a central determination gaming system server 292 and then transmitted over the network to any of a group of remote terminals or remote gaming devices that utilize the game outcomes and display the results to the players.

As shown in FIG. 3A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a Player Account interface 232. Player Account interface 232 may include a keypad 226 for entering information, a Player Account display 228 for displaying information (e.g., an illuminated or video display), a card reader 230 for receiving data and/or communicating information to and from media or a device such as a smart phone enabling Player Account. FIG. 3A also depicts utilizing a ticket printer 222 to print tickets for a TITO system server 293. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 may be a central processing unit (CPU) that has one or more multi-core processing units and memory mediums (e.g., cache memory) that function as buffers and/or temporary storage for data. Alternatively, processor 204 may be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 3A illustrates that game controller 202 includes a single processor 204, game controller 202 is not limited to this representation and instead may include multiple processors 204 (e.g., two or more processors).

FIG. 3A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 3A illustrates that game controller 202 includes a single memory 208, game controller 202 may include multiple memories 208 for storing program instructions and/or data.

Memory 208 may store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that may be translated into machine code in a format that may be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 may be set up to generate one or more game instances based on instructions and/or data that gaming device 200 exchanges with one or more remote gaming devices, such as a central determination gaming system server 292. For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 292 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences may may require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 3A illustrates that gaming device 200 may include an RNG 212 that utilizes hardware and/or software to generate RNG outcomes that lack any pattern. The RNG operations are often specialized and non-generic in order to comply with regulatory and gaming requirements. For example, in a slot game, game program 206 may initiate multiple RNG calls to RNG 212 to generate RNG outcomes, where each RNG call and RNG outcome corresponds to an outcome for a reel. In another example, gaming device 200 may be a Class II gaming device where RNG 212 generates RNG outcomes for creating Bingo cards. In one or more implementations, RNG 212 may be one of a set of RNGs operating on gaming device 200. More generally, an output of the RNG 212 may be the basis on which game outcomes are determined by the game controller 202. Game developers may vary the degree of true randomness for each RNG (e.g., pseudorandom) and utilize specific RNGs depending on game requirements. The output of the RNG 212 may include a random number or pseudorandom number (either is generally referred to as a “random number”).

In FIG. 3A, RNG 212 and hardware RNG 244 are shown in dashed lines to illustrate that RNG 212, hardware RNG 244, or both may be included in gaming device 200. In one implementation, instead of including RNG 212, gaming device 200 may include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 may be a random number generator that securely produces random numbers for cryptography use. The gaming device 200 then uses the secure random numbers to generate game outcomes for one or more game features. In another implementation, the gaming device 200 may include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game may use one or more lookup tables (also called weighted tables) as part of a technical solution that satisfies regulatory requirements for randomness and RTP. In particular, a lookup table may integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table may involve engineering decisions with respect to how RNG outcomes are mapped to game outcomes for a given game feature, while still satisfying regulatory requirements for RTP. Configuring a lookup table may also involve engineering decisions about whether different game features are combined in a given entry of the lookup table or split between different entries (for the respective game features), while still satisfying regulatory requirements for RTP and allowing for varying levels of game volatility.

FIG. 3A illustrates that gaming device 200 includes an RNG conversion engine 210 that translates the RNG outcome from RNG 212 to a game outcome presented to a player. To meet a designated RTP, a game developer may set up the RNG conversion engine 210 to utilize one or more lookup tables to translate the RNG outcome to a symbol element, stop position on a reel strip layout, and/or randomly chosen aspect of a game feature. As an example, the lookup tables may regulate a prize payout amount for each RNG outcome and how often the gaming device 200 pays out the prize payout amounts. The RNG conversion engine 210 may utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 3A also depicts that gaming device 200 is connected over network 214 to Player Account system server 294. Player Account system server 294 is used to track play (e.g., amount wagered, games played, time of play and/or other quantitative or qualitative measures) for individual players so that an operator may reward players in a loyalty program. The player may use the Player Account interface 232 to access his/her account information, activate free play, and/or request various information. Player Account or loyalty programs seek to reward players for their play and help build brand loyalty to the gaming establishment. The rewards typically correspond to the player's level of patronage (e.g., to the player's playing frequency and/or total amount of game plays at a given casino). Player Account rewards may be complimentary and/or discounted meals, lodging, entertainment and/or additional play. Player Account information may be combined with other information that is now readily obtainable by a casino management system.

When a player wishes to play the gaming device 200, he/she may insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player may add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that may be perceived by the player. These effects add to the excitement of a game, which makes a player more to enjoy the playing experience. Auditory effects include various sounds that are projected by the speakers 220. Visual effects include flashing lights, strobing lights or other patterns displayed from lights on the gaming device 200 or from lights behind the information panel.

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, at least some gaming devices may include or be coupled to one or more wireless transmitters, receivers, and/or transceivers that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between one or more gaming devices and a mobile device. After establishing a secure wireless connection between the gaming device and the mobile device, the wireless transmitter or transceiver does not send and/or receive application data to and/or from the mobile device. Rather, the mobile device communicates with gaming devices using another wireless connection (e.g., WiFi® or cellular network). In another implementation, a wireless transceiver establishes a secure connection to directly communicate with the mobile device. The mobile device and/or gaming device(s) send and receive data utilizing the wireless transceiver instead of utilizing an external network. For example, the mobile device would perform digital wallet transactions by directly communicating with the wireless transceiver. In one or more implementations, a wireless transmitter may broadcast data received by one or more mobile devices without establishing a pairing connection with the mobile devices.

The Intelligent Game State Analysis and Advantage Spin Offer Engine 410 represents a notable component within gaming systems, designed to enhance player engagement and decision-making. This engine performs real-time analysis of gameplay to identify instances where players are close to winning combinations, known as near misses. Utilizing sophisticated algorithms, it assesses the current game state, including player actions, game outcomes, and potential win scenarios. Based on this analysis, the engine dynamically generates offers for Advantage Spins, presenting players with opportunities to potentially convert near misses into wins. These targeted offers are crafted to incentivize player interaction by providing strategic choices, such as whether to accept an extra spin for a chance at enhancing their game outcome. The engine seamlessly integrates with the gaming ecosystem, ensuring a fluid and engaging player experience while maintaining the balance between chance and strategy.

Advantage Spin Meter(s) 420 function as integral components of the gaming machine's interface, meticulously tracking and displaying the accumulated Advantage Spin credits that players earn during gameplay. These meters are a visual representation of the player's current Advantage Spin credit balance, enabling them to easily ascertain how many extra spins they have at their disposal for use within the game. The meter(s) update in real-time, reflecting credits earned through gameplay events or promotional activities, as well as deductions when credits are utilized. The design and operation of these meters are geared towards enhancing player engagement by providing clear, immediate feedback on their Advantage Spin status. This encourages strategic gameplay, as players may make informed decisions on when to use their credits to maximize potential game outcomes. Furthermore, the Advantage Spin Meter(s) serve as a constant reminder of the added value and excitement that the Advantage Spin feature brings to their gaming experience.

The Advantage Spin Credit Management System 430 is a sophisticated component designed to manage the issuance, redemption, and tracking of TITO vouchers specifically for Advantage Spin credits. Operating within the broader casino management system, this server ensures a seamless and secure exchange of Advantage Spin credits between the player, gaming machines, and the casino's financial accounts. It authenticates vouchers, preventing fraud and ensuring that each voucher is redeemed only once. The server also plays a notable role in enhancing the player's experience by facilitating the easy conversion of Advantage Spin credits into physical or digital vouchers. This allows players to cash out their credits or move them between machines, thereby providing flexibility and convenience. Additionally, the server collects data on voucher usage, which may be analyzed for insights into player preferences and behavior, aiding in the optimization of promotional strategies and game offerings.

The Advantage Spin Credit Management System operates as a core mechanism within gaming environments, specifically catering to the management and operational integrity of the Advantage Spin features. It is responsible for the seamless processing and validation of TITO vouchers that players use to engage with the Advantage Spin functionality. This includes the notable tasks of verifying the authenticity of vouchers, ensuring they have not been previously redeemed, and are not counterfeit. The server's operations are integral to maintaining a secure and trustworthy gaming environment, where players may confidently participate in the exchange of Advantage Spin credits for physical or digital vouchers. It also facilitates the tracking and reporting of transactions related to Advantage Spin credits, providing valuable data for casino management to analyze trends, player engagement, and the overall effectiveness of the Advantage Spin feature. Through its robust functionality, the Advantage Spin Credit Management System 430 significantly enhances the player experience by offering convenience, security, and trust in their gaming transactions.

It will be appreciated that the present disclosure is not limited only to those implementations shown in the Figures. For example, not all gaming devices suitable for implementing implementations of the present disclosure necessarily include top wheels, top boxes, information panels, cashless ticket systems, and/or Player Account systems. Further, some suitable gaming devices have only a single game display that includes only a mechanical set of reels and/or a video display, while others are designed for bar counters or tabletops and have displays that face upwards. Gaming devices may also include other processors that are not separately shown. Using FIG. 3A as an example, gaming device 200 may include display controllers (not shown in FIG. 3A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 3B depicts a casino gaming environment in an example embodiment. In this example, the casino 251 includes banks (e.g., 252a, 252b, 252c) of EGMs. In this example, each bank 252 of EGMs includes a corresponding gaming signage system (e.g., 254a, 254b, 254c). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 290, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 292, one of the EGMs, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 293. For example, the TITO system server 293 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the Player Account system server 294. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

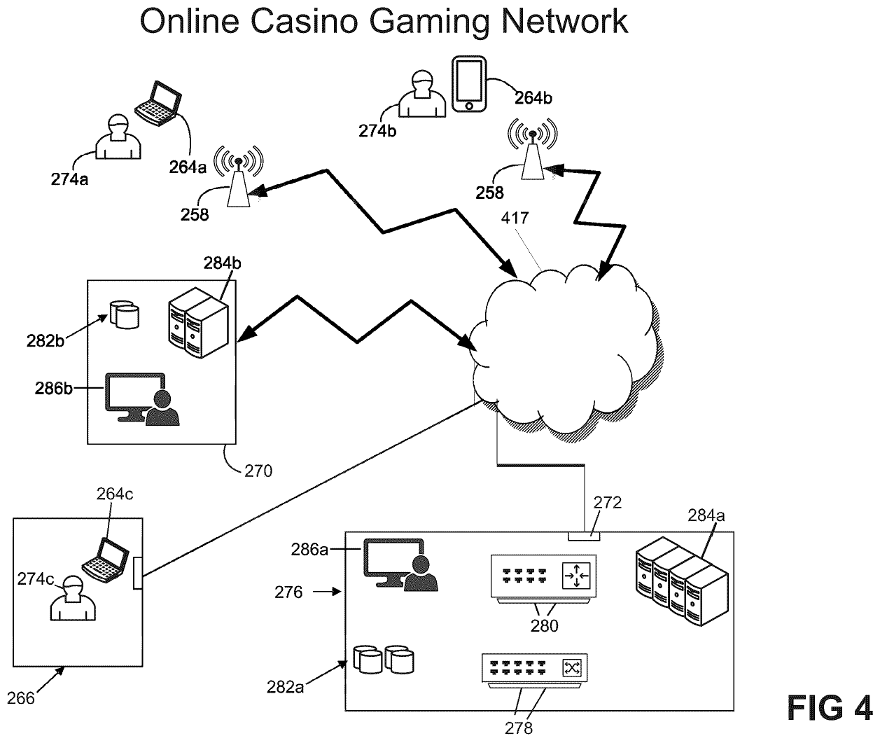

FIG. 4 is a diagram of components of a system for providing online gaming in an example embodiment. As with other Figures presented in this disclosure, the numbers, types and arrangements of gaming devices shown in FIG. 4 are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 4. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 4, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, Player Account information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

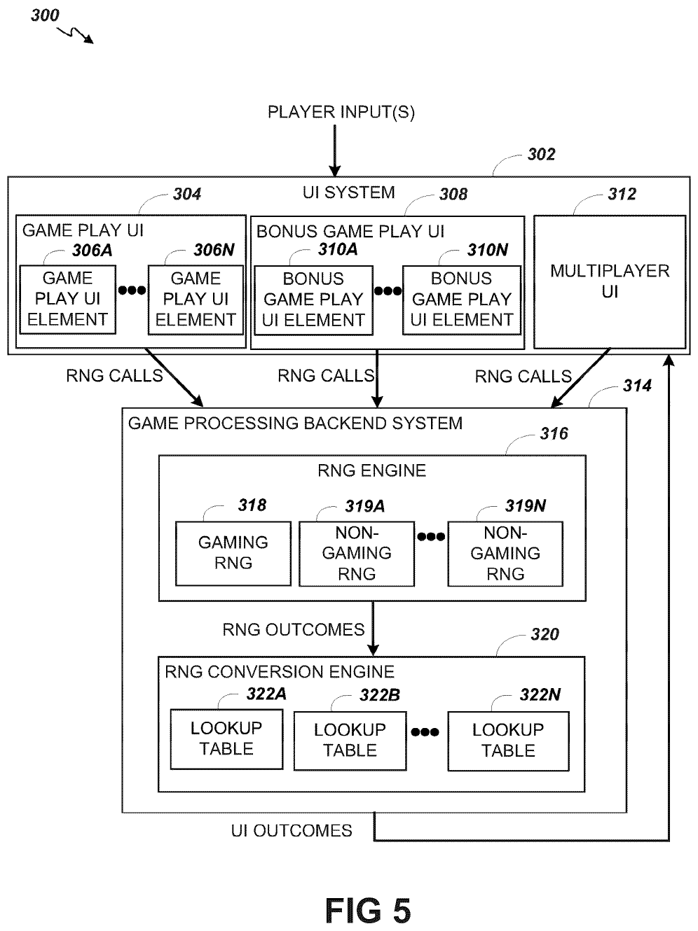

FIG. 5 illustrates, in block diagram form, an implementation of a game processing architecture 300 that implements a game processing pipeline for the play of a game in accordance with various implementations described herein. As shown in FIG. 5, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 may implement the game processing pipeline using a gaming device, such as gaming device 200 of FIG. 3A. Alternatively, portions of the gaming processing architecture 300 may implement the game processing pipeline using a gaming device and one or more remote gaming devices, such as central determination gaming system server 292 shown in FIG. 3B.

The UI system 302 includes one or more UIs that a player may interact with. The UI system 302 may include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 5 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 may transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N may differ from the bonus game play UI elements 310A-310N.

FIG. 5 also illustrates that UI system 302 may include a multiplayer UI 312 purposed for game play that differs or is separate from the typical base game. For example, multiplayer UI 312 may be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device may be collectively linked to determine a tournament outcome. To enhance a player's gaming experience, tournament mode may modify and synchronize sound, music, reel spin speed, and/or other operations of the gaming devices according to the tournament game play. After tournament game play ends, operators may switch back the gaming device from tournament mode to a primary game mode to present the base game. Although FIG. 5 does not explicitly depict that multiplayer UI 312 includes UI elements, multiplayer UI 312 may also include one or more multiplayer UI elements.

Based on the player inputs, the UI system 302 may generate RNG calls to a game processing backend system 314. As an example, the UI system 302 may use one or more application programming interfaces (APIs) to generate the RNG calls. To process the RNG calls, the RNG engine 316 may utilize gaming RNG 318 and/or non-gaming RNGs 319A-319N. Gaming RNG 318 may corresponds to RNG 212 or hardware RNG 244 shown in FIG. 3A. As previously discussed with reference to FIG. 3A, gaming RNG 318 often performs specialized and non-generic operations that comply with regulatory and/or game requirements. For example, because of regulation requirements, gaming RNG 318 may correspond to RNG 212 by being a cryptographic RNG or pseudorandom number generator (PRNG) (e.g., Fortuna PRNG) that securely produces random numbers for one or more game features. To securely generate random numbers, gaming RNG 318 may collect random data from various sources of entropy, such as from an operating system (OS) and/or a hardware RNG (e.g., hardware RNG 244 shown in FIG. 3A). Alternatively, non-gaming RNGs 319A-319N may not be cryptographically secure and/or be computationally less expensive. Non-gaming RNGs 319A-319N may, thus, be used to generate outcomes for non-gaming purposes. As an example, non-gaming RNGs 319A-319N may generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 3A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 may utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables may be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system may update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

Further described herein are network-based systems and methods for seamlessly operating multi-vendor gaming devices and management systems within a casino.

Electronic gaming machines (EGMs), electronic gaming tables (EGTs), or other types of gaming devices provide a variety of wagering games such as slot games, video poker games, video blackjack games, roulette games, video bingo games, keno games and other types of games that are frequently offered at casinos and other locations. EGMs and EGTs are made by a variety of different manufactures, including but not limited to Aristocrat (ATI), Light and Wonder (LNW), International Game Technology (IGT), Konami Gaming, etc. Many EGMs/EGTs communicate with slot machine interface boards (SMIBs) via the slot accounting system (SAS) or the game to system (G2S) protocol. Further, there are a number of different casino monitoring/management systems (CMS) that are provided by the different EGM/EGT manufactures. The result of the incompatible frontend and backend is that when a casino buys EGMs/EGTs from vendor A, and installs the CMS system from vendor A to manage and control the casino's various EGMs/EGTs, then the casino may be locked into vendor A's solution, as interoperability between the gaming machines, their SMIBs, and management solutions from different vendors is generally non-existent. This limits the options that casinos have regarding management system solutions that deviate from the already installed base of vendor A's management solution.

Gaming devices (e.g., EGMs, EGTs, bar tops, gaming servers, mobile devices, mobile game devices, etc.), may be a device located in a physical casino and/or at remote locations for online gaming. Gaming devices are made by a variety of different vendors, with the different vendors typically providing a closed management system for monitoring and controlling that vendor's gaming device. A SMIB is used within an EGM/Ts to allow the EGM/Ts to connect to a system server. However, SMIBs made by different vendors are proprietary, and may use different controllers, power supplies, connectors, hardware, board sizes, and proprietary communication protocols. Each vendor's SMIB is designed to connect its proprietary management system to its EGM/Ts and to all other manufacturers' EGM/Ts. For instance, there is a SMIB from supplier A designed to connect to supplier A's machines, and to supplier B's, C's, and D's machines, a SMIB from supplier B designed to connect to supplier B's machines as well as to supplier A's, C's, and D's machines, etc. Once a casino decides to network its casino floor, it is locked into one vendor's hardware and software solutions.

For example, a casino may initially select an implementation from supplier A, with supplier A's SMIBs installed in the EGM/Ts that communicate with supplier A's CMS. As used herein, a CMS refers to any backend system or software service designed to operate with a casino's gaming device network such as a casino accounting system, a ticket voucher system, a player account system, a social network system, a responsible gaming system, a marketing system, a bonus system, a progressive system, a concierge system, and/or a Remote Gaming System (RGS). Generally, RGS is a solution for vendors and operators that enables implementation and distribution of online, mobile, and server-based gaming content.

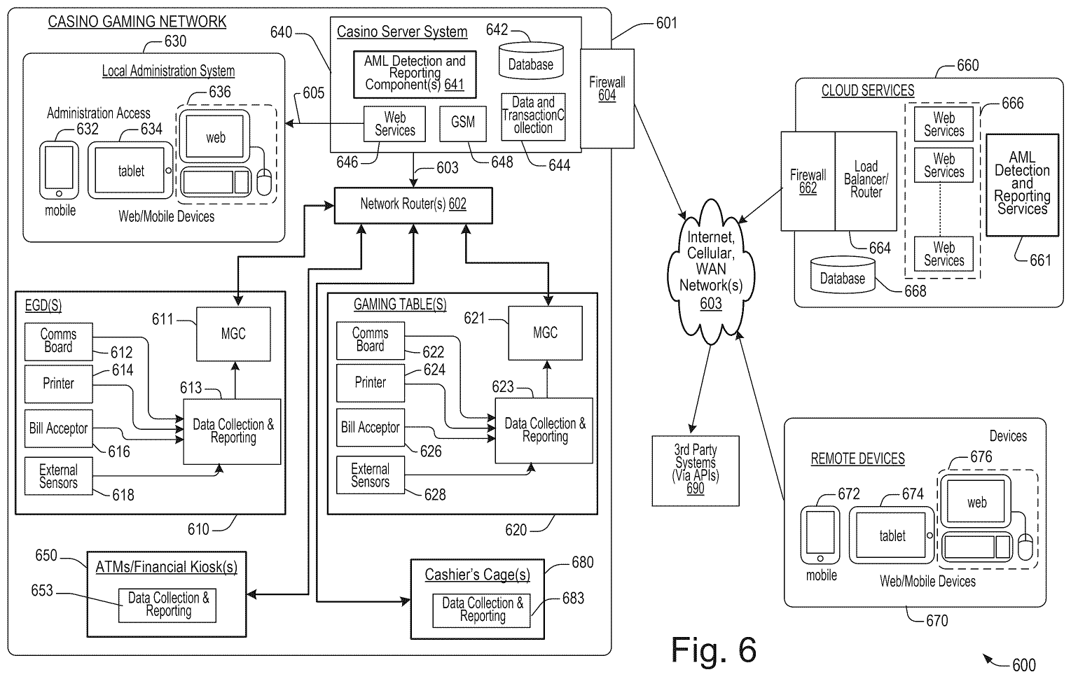

FIG. 6 illustrates a simplified block diagram of a specific example embodiment of a Gaming Network 600 which may be configured or designed to implement various automated money laundering detection and reporting techniques described and/or referenced herein. As described in greater detail herein, different embodiments of gaming networks may be configured, designed, and/or operable to provide various different types of operations, functionalities, and/or features generally relating to automated money laundering detection and reporting techniques. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 600 may include a plurality of different types of components, devices, modules, processes, systems, etc., which, for example, may be implemented and/or instantiated via the use of hardware and/or combinations of hardware and software. For example, as illustrated in the example embodiment of FIG. 6, the Gaming Network may include one or more of the following types of systems, components, devices, processes, etc. (or combinations thereof):
Casino Gaming Network(s) 601. In at least one embodiment, the Casino Gaming Network 601 may include or may correspond to one or more gaming network(s), systems, components, devices, etc., which are associated with one or more casino gaming establishments such as, for example, Harrah's Casino (Las Vegas), Caesars Palace (Las Vegas), The Palazzo (Las Vegas), etc. In at least one embodiment, a Casino Gaming Network may be associated with a real-world, physical casino which is located at a particular geographic location. In some embodiments, the Casino Gaming Network may include multiple gaming networks associated with multiple casino gaming establishments at different physical locations (such as, for example, Harrah's Casino Las Vegas, Harrah's Casino New Orleans, Harrah's Casino Atlantic City, etc.).
Internet, Cellular, and WAN Network(s) 603.
3rd Party Systems 690. In at least one embodiment, one or more 3rd Party Systems may include remote server system(s)/service(s), which, for example, may be configured or designed to provide various types of services described and/or referenced herein. In at least one embodiment, one or more 3rd Party Systems may communicate with other components, devices, systems of the Gaming Network via APIs and/or other types of standardized (and/or proprietary) communication protocols. Examples of various types of 3^{rd} Party Systems may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Automated money laundering detection and reporting services;
   Remote Database System(s) which, for example, may be operable to store and provide access to various types of information and data described herein.
Remote Device(s) 670—In at least one embodiment, the Remote Device(s) may be operable to provide administration and customer remote access to other components, devices, systems of the Gaming Network. According to different embodiments, one or more Remote Device may be configured or designed to perform and/or implement various types of functions, operations, actions, and/or other features such as those described or referenced herein (e.g., such as those illustrated and/or described with respect to FIG. 6).
Cloud Services 660—In at least one embodiment, Cloud Services may include a plurality of different public and/or provide computing clouds which, for example, may reside at different physical and/or geographic locations, and which may each be configured or designed to provide different types of services. For example, as illustrated in the example embodiment of FIG. 6, Cloud Services 660 may include functionality for performing and/or implementing ML Analysis, Detection and Reporting Services such as one or more of those described herein.

According to specific embodiments, the at least some of the computing clouds may include several different types of local area networks such as, for example, a backbone LAN which may be utilized for providing localized communication between various local network elements within a given computing cloud, and an internet LAN which, for example, may be utilized for providing WAN or Internet access to various local network elements within the computing cloud. In at least one embodiment, one or more of the computing clouds may be operable to host a variety of different types of applications and/or other software for performing various types of services such as, for example, one or more of those described herein. Additionally, in at least one embodiment, one or more of the computing clouds may be operable to provide various types of database services such as, for example, data storage, database queries, data access, etc. As illustrated in the example embodiment of FIG. 6, cloud services network 660 may include one or more of the following components, devices, and/or systems (or combinations thereof): firewall components 662, load balancer and router components 664, Web services components 666, database components 668, AML detection and reporting components 661.

As illustrated in the example embodiment of FIG. 6, the Casino Gaming Network 601 may include one or more of the following types of systems, components, devices, processes, etc. (or combinations thereof):
Casino Server System(s) 640
Local Administration System(s) 630
Electronic Gaming Machine(s) (EGMs) 610
Gaming Table(s) 620
ATMs/Financial Kiosk(s) 650
Cashier's Cage(s) 680
Network Router(s) 602

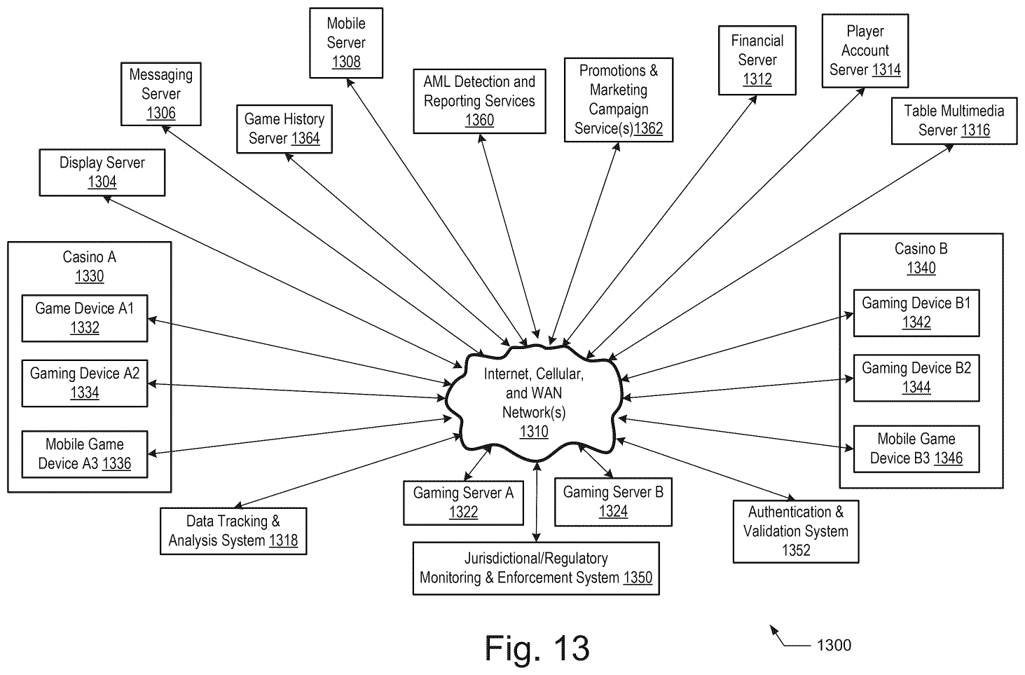

According to different embodiments, the Casino Server System(s) may include various systems, components, and/or devices for facilitating, initiating, and/or performing various operation(s), action(s), feature(s), and/or other functionality, such as, for example, one or more of the following (or combinations thereof):
Display Server System(s) (e.g., 1304, FIG. 13). In at least one embodiment, the Display Server System(s) may be configured or designed to implement and/or facilitate management of content (e.g., graphics, images, text, video fees, etc.) to be displayed and/or presented at one or more EGDs (or at one or more groups of EGDs), dealer displays, administrator displays, etc.
Table Multimedia Server System(s) (e.g., 1316). In at least one embodiment, the Table Multimedia Server System(s) may be configured or designed to generate, implement and/or facilitate management of content (e.g., graphics, images, text, video fees, audio feeds, etc.), which, for example, is to be streamed or provided to one or more EGDs (or to one or more groups of EGDs).
Messaging Server System(s) (e.g., 1306). In at least one embodiment, the Messaging Server System(s) may be configured or designed to implement and/or facilitate management of messaging and/or other communications among and between the various systems, components, devices, EGDs, players, dealers, administrators, and/or other personnel of the gaming network.
Mobile Server System(s) (e.g., 1308). In at least one embodiment, the Mobile Server System(s) may be configured or designed to implement and/or facilitate management of communications and/or data exchanged with various types of mobile devices, including for example: player-managed mobile devices (e.g., smart phones, PDAs, tablets, mobile computers), casino-managed mobile devices (e.g., mobile gaming devices), etc.
AML Detection and Reporting Service(s) (e.g., 1360). In at least one embodiment, the AML Detection and Reporting Service(s) may be configured or designed to include functionality for facilitating, enabling, initiating, and/or performing various types of AML Detection and Reporting operation(s), action(s), and/or feature(s) such as one or more of those described herein.
Financial Server System(s) (e.g., 1312). In at least one embodiment, the Financial Server System(s) may be configured or designed to implement and/or facilitate tracking, management, reporting, and storage of financial data and financial transactions relating to one or more wager-based gaming sessions. For example, at least some Financial Server System(s) may be configured or designed to track of the game accounting (money in, money out) for a virtual table game being played, and may also be configured or designed to handle various financial transactions relating to player wagers and payouts. For example, in at least one embodiment, Financial Servers may be configured or designed to monitor each remote player's account information, and may also manage or handle funds transfers between each player's account and the active game server (e.g., associated with the player's game session).
Player Account Server System(s) (e.g., 1314). In at least one embodiment, the Player Account Server System(s) may be configured or designed to implement and/or facilitate management and exchange of Player Account information associated with one or more EGDs, gaming sessions, etc. In at least one embodiment, a Player Account Server System may include at least one database that tracks each player's hands, wins/losses, bet amounts, player preferences, etc., in the network. In at least one embodiment, the presenting and/or awarding of promotions, bonuses, rewards, achievements, etc., may be based on a player's play patterns, time, games selected, bet amount for each game type, etc. A Player Account Server System may also help establish a player's preferences, which assists the casino in their promotional efforts to: award player comps (loyalty points); award free game play credits, free/additional reel spin opportunities; decide which promotion(s) are appropriate; generate bonuses; etc.
Data Tracking & Analysis System(s) (e.g., 1318). In at least one embodiment, the Data Tracking & Analysis System(s) may be configured or designed to implement and/or facilitate management and analysis of game data. For example, in one embodiment the Data Tracking & Analysis System(s) may be configured or designed to aggregate multisite virtual game table trends, local wins, jackpots, etc.
Gaming Server System(s) (922, (e.g., 1324). In at least one embodiment, different game servers may be configured or designed to be dedicated to one or more specifically designated type(s) of game(s) (e.g., Baccarat, Black Jack, Poker, Mahjong, Pai-gow, Chess, etc.). Each game server has game logic to host one of more virtual table game sessions. At least some game server(s) may also capable of keeping track of the game accounting (money in, money out, games won, game lost, etc.) for a virtual table game being played, and/or for updating the Financial Servers at the end of each game. The game servers may also operable to generate the virtual table graphics primitives (e.g., game pieces and game states), and may further be operable to update the remote EGDs when a game state change (e.g., new card dealt, player upped the ante, player folds/busts, etc.) has been detected.
Jurisdictional/Regulatory Monitoring & Enforcement System(s) (e.g., 1350). In at least one embodiment, the Jurisdictional/Regulatory Monitoring & Enforcement System(s) may be configured or designed to handle tracking, monitoring, reporting, and enforcement of specific regulatory requirements relating to wager-based gameplay activities in one or more jurisdictions.
Authentication & Validation System(s) (e.g., 1352). According to different embodiments, the Authentication & Validation System(s) may be configured or designed to determine and/or authenticate the identity of the current player at a given EGD. For example, in one embodiment, the current player may be required to perform a log in process at the EGD in order to access one or more features. Alternatively, the EGD may be adapted to automatically determine the identity of the current player based upon one or more external signals such as, for example, scanning of a barcode of a Player Account card, an RFID tag or badge worn by the current player which provides a wireless signal to the EGD for determining the identity of the current player. In at least one implementation, various security features may be incorporated into the EGD to prevent unauthorized players from engaging in certain types of activities at the EGD. In some embodiments, the Authentication & Validation System(s) may be configured or designed to authenticate and/or validate various types of hardware and/or software components, such as, for example, hardware/software components residing at a remote EGDs, game play information, wager information, player information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Game History Server(s) (e.g., 1364). In at least one embodiment, the Game History Server(s) may be configured or designed to track all (or selected) game types and game play history for all (or selected) virtual game tables. In at least one embodiment, a Game History Server may be configured or designed to assists the remote players in selecting a table by, for example, displaying the win/loss statistics of the tables selected by the player as potential candidates to participate. In some embodiments, a Game History Server may also assist the casino manager in case of disputes between players and the casino by, for example, providing the ability to “replay” (e.g., by virtually recreating the game events) the game in dispute, step by step, based on previously stored game states.
Database components 642, which, for example, may be configured or designed to include functionality for storing and/or providing access to various types of information, events, and/or conditions such as, for example, one or more of the following (or combinations thereof): historical game-related information, ML information, ML rules, player ID information, gaming device ID information, location maps of gaming devices, casino-related information, historical financial transaction information, and/or other types of information described and/or referenced herein.
Web Services components 646, which, for example, may be configured or designed to include functionality for facilitating, aggregating gaming data, enabling, initiating, and/or performing various types of web-based services and communications.
Cellular (GSM/CDMA) Communication components 648, which, for example, may be configured or designed to include functionality for facilitating, enabling, initiating, and/or performing various types of cellular-based and/or wireless communications such as transporting gaming data to/from the Cloud Services 660.
Data And Transaction Collection components 644, which, for example, may be configured or designed to include functionality for facilitating, enabling, initiating, and/or performing collection of data and transactions (e.g., financial transaction events) occurring at various components and/or devices of the casino gaming network such as, for example, one or more of the following (or combinations thereof): EGM(s), gaming table(s), ATMs, financial kiosks, casino token storage tray(s), cashier cage component(s), wireless gaming devices, end user mobile device(s), remote devices (e.g., 670), etc.
Firewall component(s) 604.
Etc.

According to different embodiments, Electronic Game Device(s) (EGDs) may include one or more of the following (or combinations thereof): mechanical slot machines, electronic slot machines, electronic gaming machines, mobile gaming devices, video gaming machines, server-based gaming machines, and/or other types of devices or components which provide capabilities for enabling casino patrons to participate in gaming and/or wagering activities. In some embodiments, at least some mobile gaming devices may be implemented using personal mobile computing devices such as tablets, smartphones, laptops, PC's, and the like. As illustrated in the example embodiment of FIG. 6, one or more EGDs may be configured or designed to include one or more of the following components (or combinations thereof): at least one master gaming controller (MGC) 611, communication components 612, printer components 614, Bill/coin acceptor components 616, sensor components 618, data collection and reporting components 613.

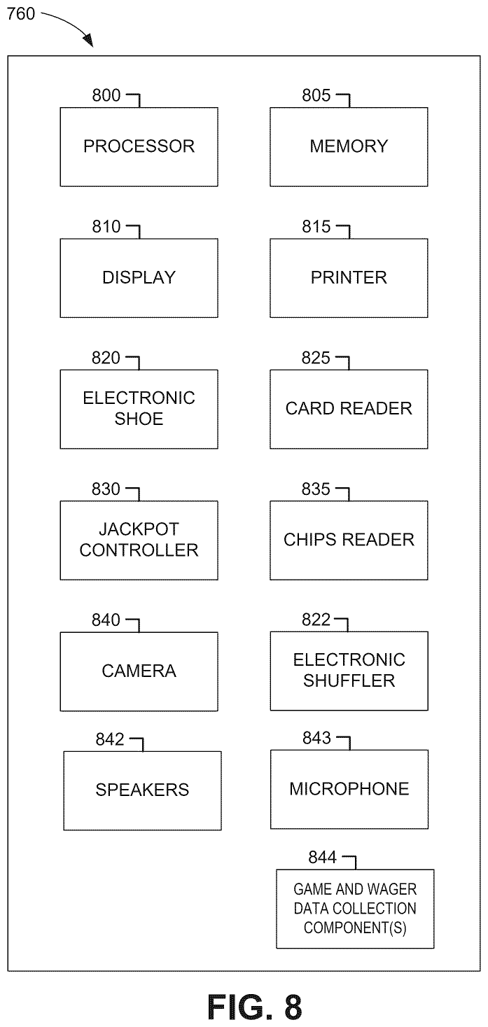

According to different embodiments, Gaming Tables(s) may include one or more of the following (or combinations thereof): traditional casino gaming tables (e.g., craps, baccarat at, blackjack, roulette, etc.), electronic gaming tables, server-based gaming tables, and/or other types of devices or components which provide capabilities for enabling two or more casino patrons to concurrently participate in gaming and/or wagering activities. As illustrated in the example embodiment of FIG. 6, one or more gaming tables may be configured or designed to include one or more of the following components (or combinations thereof): at least one master gaming controller (MGC) 621, communication components 622, printer components 624, Bill/voucher/coin acceptor components 626, sensor components 628, data collection and reporting components 623. In at least one embodiment data collection and reporting components 623 may include functionality for facilitating, enabling, initiating, and/or performing collection and reporting of game-related information and/or wager-related information (e.g., including financial transaction events) occurring at that gaming table. Additional gaming table features and functionalities are illustrated and described with respect to FIG. 8.

In at least one embodiment data collection and reporting components (e.g., 613, 623, 653, 683) may include functionality for facilitating, aggregating, enabling, initiating, and/or performing collection and reporting of various types of information relating to conditions and/or events occurring at an associated gaming device and/or gaming table game, such as, for example: game-related information, Player Account information, wager-related information (e.g., including financial transaction events), and the like.

In at least one embodiment, Local Administration System 630 may include various types of devices or components (such as, for example, mobile devices 632, tablets 634, computer systems 636, etc.) which provide capabilities for enabling casino administrators to implement or perform administration of one or more aspects, components, systems, operations, and/or activities relating to a casino gaming network (e.g., 601). Additionally, local administrative access may be provided for the casino manager for configuring, registering, monitoring, analyzing, sending alerts, generating reports, etc., relating to ML and suspicious activities.

According to different embodiments, Remote Devices 670 may include various types of devices or components (such as, for example, smart phones 672, tablets 674, computer systems 676, etc.) which provide capabilities for enabling a remote user to remotely participate in gaming and/or wagering activities at a casino gaming network (e.g., 601). In at least one embodiment, one or more remote device components may also be used by remote casino administrators to implement or perform remote administration of one or more aspects, components, systems, operations, and/or activities relating to a casino gaming network (e.g., 601).

In at least one embodiment, the Gaming Network may be operable to utilize and/or generate various different types of data and/or other types of information when performing specific tasks and/or operations. This may include, for example, input data/information and/or output data/information. For example, in at least one embodiment, the Gaming Network may be operable to access, process, and/or otherwise utilize information from one or more different types of sources, such as, for example, one or more local and/or remote memories, devices and/or systems. Additionally, in at least one embodiment, the Gaming Network may be operable to generate one or more different types of output data/information, which, for example, may be stored in memory of one or more local and/or remote devices and/or systems. Examples of different types of input data/information and/or output data/information which may be accessed and/or utilized by the Gaming Network may include, but are not limited to, one or more of those described and/or referenced herein. According to specific embodiments, multiple instances or threads of the Gaming Network processes and/or procedures may be concurrently implemented and/or initiated via the use of one or more processors and/or other combinations of hardware and/or hardware and software.

According to different embodiments, various different types of encryption/decryption techniques may be used to facilitate secure communications between devices, systems, and/or components of the Gaming Network(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Notable Integrity Protocol, uses RC4), AES (Advanced Encryption Standard), RSA, DSA, DH, NTRU, and ECC (elliptic curve cryptography), PKA (Private Notable Authentication), Device-Unique Secret Notable and other cryptographic notable data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Gaming Network of FIG. 6 is but one example from a wide range of Gaming Network embodiments which may be implemented. Other embodiments of the Gaming Network (not shown) may include additional, fewer and/or different components/features that those illustrated in the example Gaming Network embodiment of FIG. 6.

Generally, the automated money laundering detection and reporting techniques described herein may be implemented in hardware and/or hardware+software. Hardware and/or software+hardware hybrid embodiments of the automated money laundering detection and reporting techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

FIG. 13 illustrates an alternate example embodiment of a Gaming Network 1300 which may be configured or designed to implement various automated money laundering detection and reporting techniques described and/or referenced herein. As described in greater detail herein, different embodiments of Gaming Networks may be configured, designed, and/or operable to provide various different types of operations, functionalities, and/or features generally relating to Gaming Network technology. Further, as described in greater detail herein, many of the various operations, functionalities, and/or features of the Gaming Network(s) and/or Gaming System(s) disclosed herein may provide may enable or provide different types of advantages and/or benefits to different entities interacting with the Gaming Network(s).

According to different embodiments, the Gaming Network 1300 may include a plurality of different types of components, devices, modules, processes, systems, etc., which, for example, may be implemented and/or instantiated via the use of hardware and/or combinations of hardware and software. For example, as illustrated in the example embodiment of FIG. 13, the Gaming Network may include one or more of the following types of systems, components, devices, processes, etc. (or combinations thereof):
Display Server System(s) 1304. Table Multimedia Server System(s) 1316.
Messaging Server System(s) 1306.
Mobile Server System(s) 1308.
AML Detection and Reporting Services 1360.
Promotions & Marketing Campaign Service(s) 1362.
Financial Server System(s) 1312.
Player Account Server System(s) 1314.
Data Tracking & Analysis System(s) 1318.
Gaming Server System(s) (922, 1324).
Jurisdictional/Regulatory Monitoring & Enforcement System(s) 1350.
Authentication & Validation System(s) 1352.
Casino Venues (930, 1340).
Electronic Game Devices (EGDs) 1332, 1334, 1336, 1342, 1344, 1346.
Internet, Cellular, and WAN Network(s) 1310.
Game History Server(s) 1364.
Remote Database System(s).
Remote Server System(s)/Service(s).
Mobile Device(s).
Etc.

### Promotions & Marketing Campaign Service(s) 1362

Promotions & Marketing Campaign Service(s) 1362 are integral to the casino's strategy for attracting and retaining patrons by offering a dynamic range of incentives and personalized marketing communications. These services leverage data analytics to understand patron behavior and preferences, enabling the creation of targeted promotions that resonate with specific customer segments. By offering tailored rewards, bonuses, and special events, these services enhance player satisfaction and loyalty, encouraging repeat visits and increased play. The services also encompass digital and traditional marketing campaigns, utilizing various channels to engage potential and existing customers effectively. The ability to dynamically adjust promotions in response to customer feedback and changing market conditions ensures that the casino remains competitive and responsive to player needs. Furthermore, these services provide desirable tools for measuring the effectiveness of marketing strategies, offering insights that drive continuous improvement and strategic decision-making in promotional activities.

The functionality of the various systems and components of FIG. 13 may be similar to those described previously with respect to the description of FIG. 6, and therefore need not be repeated.

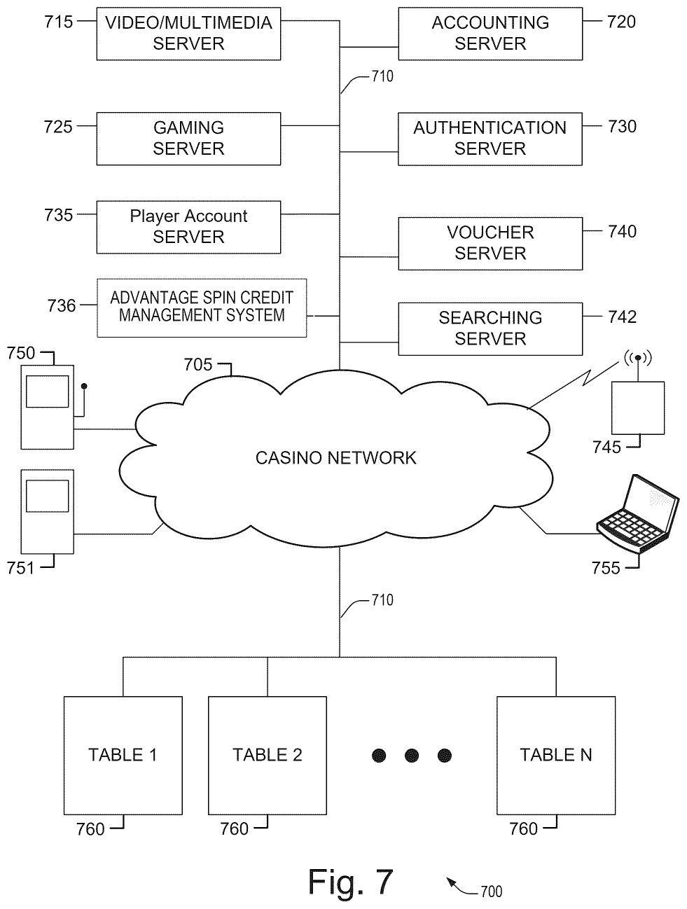

FIG. 7 shows an example block diagram of an electronic gaming system 700 in accordance with a specific embodiment. Electronic gaming system 700 may include electronic gaming tables 760, which may be coupled to network 705 via a network link 710. Electronic gaming tables 760 may be normal gaming tables with enhanced electronic capabilities. Network 705 may be the internet or a private network. One or more video streams may be received at video/multimedia server 715 from gaming tables 760. Video/Multimedia server 715 may transmit one or more of these video streams to a mobile device 745, a gaming device 750, an EGD 751, a laptop 755, and/or any other remote electronic device. Video/Multimedia server 715 may transmit these video streams via network link 710 and network 705.

Electronic gaming system 700 may include an accounting/transaction server 720, a gaming server 725, an authentication server 730, a Player Account server 735, a voucher server 740, and a searching server 742.

Accounting/transaction server 720 may compile, track, store, and/or monitor cash flows, voucher transactions, winning vouchers, losing vouchers, and/or other transaction data for the casino operator and for the players. Transaction data may include the number of wagers, the size of these wagers, the date and time for these wagers, the identity of the players making these wagers, and the frequency of the wagers. Accounting/transaction server 720 may generate tax information relating to these wagers. Accounting/transaction server 720 may generate profit/loss reports for predetermined gaming options, contingent gaming options, predetermined betting structures, and/or outcome categories.

Gaming server 725 may generate gaming options based on predetermined betting structures and/or outcome categories. These gaming options may be predetermined gaming options, contingent gaming options, and/or any other gaming option disclosed in this disclosure.

Authentication server 730 may determine the validity of vouchers, players' identity, and/or an outcome for a gaming event.

Player Account server 735 may track a player's betting activity, a player's preferences (e.g., language, drinks, font, sound level, etc.). Based on data obtained by Player Account server 735, a player may be eligible for gaming rewards (e.g. free play), promotions, and/or other awards (e.g., complimentary food, drinks, lodging, concerts, etc.).

Voucher server 740 may generate a voucher, which may include data relating to gaming options. For example, data relating to the structure (e.g., 6 out of the next 10 rolls at craps table 4 will be a 7 or 11) may be generated. If there is a time deadline, that information may be generated by voucher server 740. Vouchers may be physical (e.g., paper) or digital.

Advantage Spin Credit Management System 736 may be configured or designed to include functionality for facilitating, enabling, initiating, and/or performing various Advantage Spin-related functions, processes and/or activities such as one or more of those described herein.

In some embodiments, the Advantage Spin Credit Management System operates as a core mechanism within gaming environments, specifically catering to the management and operational integrity of the Advantage Spin feature. It is responsible for the seamless processing and validation of TITO vouchers that players use to engage with the Advantage Spin functionality. This includes the notable tasks of verifying the authenticity of vouchers, ensuring they have not been previously redeemed, and are not counterfeit. The server's operations are integral to maintaining a secure and trustworthy gaming environment, where players may confidently participate in the exchange of Advantage Spin credits for physical or digital vouchers. It also facilitates the tracking and reporting of transactions related to Advantage Spin credits, providing valuable data for casino management to analyze trends, player engagement, and the overall effectiveness of the Advantage Spin feature. Through its robust functionality, the Advantage Spin Credit Management System significantly enhances the player experience by offering convenience, security, and trust in their gaming transactions.

Searching server 742 may implement a search on one or more gaming devices to obtain gaming data. Searching server 742 may implement a messaging function, which may transmit a message to a third party (e.g., a player) relating to a search, a search status update, a game status update, a wager status update, a confirmation of a wager, a confirmation of a money transfer, and/or any other data relating to the player's account. The message may take the form of a text display on the gaming device, a pop up window, a text message, an email, a voice message, a video message and the like. Searching server 742 may implement a wagering function, which may be an automatic wagering mechanism. These functions of searching server 742 may be integrated into one or more servers.

Searching server 742 may include one or more searching structures, one or more searching algorithms, and/or any other searching mechanisms. In general, the search structures may cover which table games paid out the most money during a time period, which table games kept the most money from players during a time period, which table games are most popular (top games), which table games are least popular, which table games have the most amount of money wager during a period, which table games have the highest wager volume, which table games are more volatile (volatility, or deviation from the statistical norms, of wager volume, wager amount, pay out, etc.) during a time period, and the like. Search may also be associated with location queries, time queries, and/or people queries (e.g., where are the table games that most of my friends wager on, where are my favorite dealers, what do players wager on the most today, when are most wagers placed, etc.).

The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria.

Searching algorithms may be dynamic searching programs, which may be modified based on one or more past results. For example, a search algorithm may be based on searching blackjack tables. The search algorithm may initially search blackjack tables 1-10 to determine whether any triggering events have occurred. Based on one or more previous searches, the search algorithm may determine: (1) that blackjack tables 1-4 are only opened from 7 pm to 3 am; (2) that blackjack tables 5-7 are opened twenty-four hours a day; and (3) that blackjack tables 8-10 are only opened from 7 am to 5 pm. The search algorithm may then modify the search parameters utilized based on this data. For example, if the search algorithm is initiated at 6 pm to determine blackjack triggering events, then the search algorithm may only search blackjack tables 5-7 because these blackjack tables are the only blackjack tables operating at that specific time.

In another example, the search algorithm may determine that a specific triggering event occurs with a ninety percent success rate on a first table, a ten percent success rate on a second table, a fifty percent success rate on a third table, and a seventy percent success rate on a fourth table. The search algorithm may generate a search priority based on the probability of success, which may lead to the first table being searched first, the fourth table being searched second, the third table being searched third, and the second table being searched fourth. Search algorithm may utilize any dynamic feedback procedure to enhance current and/or future searching results

FIG. 8 shows electronic gaming table 760 with various features, in accordance with a specific embodiment. Various different embodiments of the electronic gaming table 760 may be used as a live game table for conducting gameplay relating to one or more gaming sessions.

Electronic gaming table 760 may include a processor 800, a memory 805, a display 810, a printer 815, an electronic shoe 820, an electronic shuffler 822, a smart card reader 825, a jackpot controller 830, a chips reader 835, and a camera 840.

Processor 800 may be communicatively coupled to any other device in electronic gaming table 760. Processor 800 via an interface may communicate wired or wireless, with any of the elements of electronic gaming device 900 and/or electronic gaming table system 700.

Memory 805 may include data relating to gaming events, video streams transmitted from electronic gaming table 760, winning and losing percentages for gaming options relating to electronic gaming table 760, and game management data (e.g., dealer schedule, chip refills, etc.).

Display 810 may show previous game results, a betting structure, outstanding wagers, transaction volume, present value of betting options, a table minimum wager, a table maximum wager, wager and/or game play instructions input by one or more remote players (e.g., via their respective EGDs), instructions to the live dealer/attendant relating to game play activities to be performed by the dealer/attendant, video data, and/or any other type of data or content.

Printer 815 may generate vouchers, promotional items, food tickets, event tickets, and/or lodging tickets. Vouchers may be physical (e.g., paper) or digital.

Electronic shuffler 822 may be configured or designed to automatically shuffle multiple decks of cards, and to track the relative order of each of the cards of the shuffled decks of cards. The electronic shuffler may include an off the shelf unit. A dealer may use the electronic shuffler to shuffle the decks of cards before dealing the required hands, and place the shuffled decks of cards into the electronic shoe 820. In this way, the electronic gaming table may determine the relative order of all cards in the card shoe at the start of one or more game session(s), and/or at all other times of game play.

Electronic shoe 820 may obtain data and/or images of gaming objects utilized with gaming table 760. This data and/or images may be transmitted to electronic gaming device and displayed as images from table games. For example, on a blackjack table a ten of spades may be dealt to a player. This information is obtained via electronic shoe 820 and utilized to generate an image and/or illustration of a ten of spades card on an electronic gaming device. In another example, electronic shoe 820 may receive data relating to the numbers on dice, transmit this data to electronic gaming device, which may be utilized to generate an image/illustration of the dice on electronic gaming device.

In at least one embodiment, the electronic shoe may include an electronic reading system, such as an optical reader for recognizing the face value of each card. The electronic shoe may be designed to communicate directly with the card dealing/shuffling system to read or otherwise obtain the value of each card being dealt by the dealer as the card leaves the card dealing/shuffling system. For example, an optical reader or similar device may be attached to the card dealing/shuffling system, and the electronic shoe may obtain the scanned value of cards in the card dealing/shuffling system. In some implementations, the electronic shoe may interface with the table to read the value of each card being dealt by the dealer. For example, the table may include one or more scanning interfaces to scan each card before or after the card is dealt by the dealer. The electronic shoe may communicate with the one or more scanning interfaces to obtain the value of each card before or after the card is dealt by the dealer.

Card reader 825 may provide identification, authentication, and application processing functions. Card reader 825 may interface with smart cards, magnetic striped card, bar code reader, RFID card, and the like.

Jackpot controller 830 may track and compile data associated with a jackpot. Jackpot controller 830 may award the jackpot on a specific occurrence (e.g., blackjack event, dealing a royal flush, etc.) and/or randomly award a jackpot.

Chips reader 835 may compile and track data associated with the amount of chips one or more players possesses, the amount of chips won/lost at gaming table 760, the amount of chips in the dealer's rack at gaming table 760, an amount of chips wager by one or more players, amount of chips in the betting pool, and/or any combination thereof.

Camera 840 may obtain data from gaming table 760. Camera 840 may be one or more cameras located to view the gaming objects (e.g., cards, dice, dominos, ball, wheel, etc.), the dealer, the shoe, the players' hands, the players, and/or any combination thereof. Camera 840 may transmit this data to gaming table, which may be utilized to generate an image/illustration of the gaming objects.

Speakers 842 may be used to provide audio information to the game table dealer/attendant. Examples of different types of audio information may include, for example, audio instructions and/or other audio/verbal communications from one or more remote players, computer-generated audio instructions/content, sound effects, and/or other types of audio content.

Microphone 843 may be used to capture, record, and/or stream audio information from the electronic gaming table region, which, for example, may include verbal communications from the table game dealer/attendant.

Game And Wager Data Collection Component(s) 844 may include functionality for facilitating, enabling, initiating, and/or performing collection and reporting of various types of information relating to conditions and/or events occurring at an associated gaming device and/or gaming table game, such as, for example: game-related information, Player Account information, wager-related information (e.g., including financial transaction events), and/or other types of data/information described and/or referenced herein.

According to specific embodiments, a variety of different game states may be used to characterize the state of current and/or past events which are occurring (or have occurred) at a given live gaming table. For example, in one embodiment, at any given time in a game, a valid current game state may be used to characterize the state of game play (and/or other related events, such as, for example, mode of operation of the gaming table, etc.) at that particular time. In at least one embodiment, multiple different states may be used to characterize different states or events which occur at the gaming table at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the gaming table may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

According to specific embodiments, a variety of different entities may be used (e.g., either singly or in combination) to track the progress of game states which occur at a given gaming table. Examples of such entities may include, but are not limited to, one or more of the following (or combination thereof): master controller system, display system, gaming system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

According to a specific embodiment, local game tracking components at the gaming table may be operable to automatically monitor game play activities at the gaming table, and/or to automatically identify notable events which may trigger a transition of game state from one state to another as a game progresses. For example, in the case of Blackjack, a notable event may include one or more events which indicate a change in the state of a game such as, for example: a new card being added to a card hand, the split of a card hand, a card hand being moved, a new card provided from a shoe, removal or disappearance of a card by occlusion, etc.

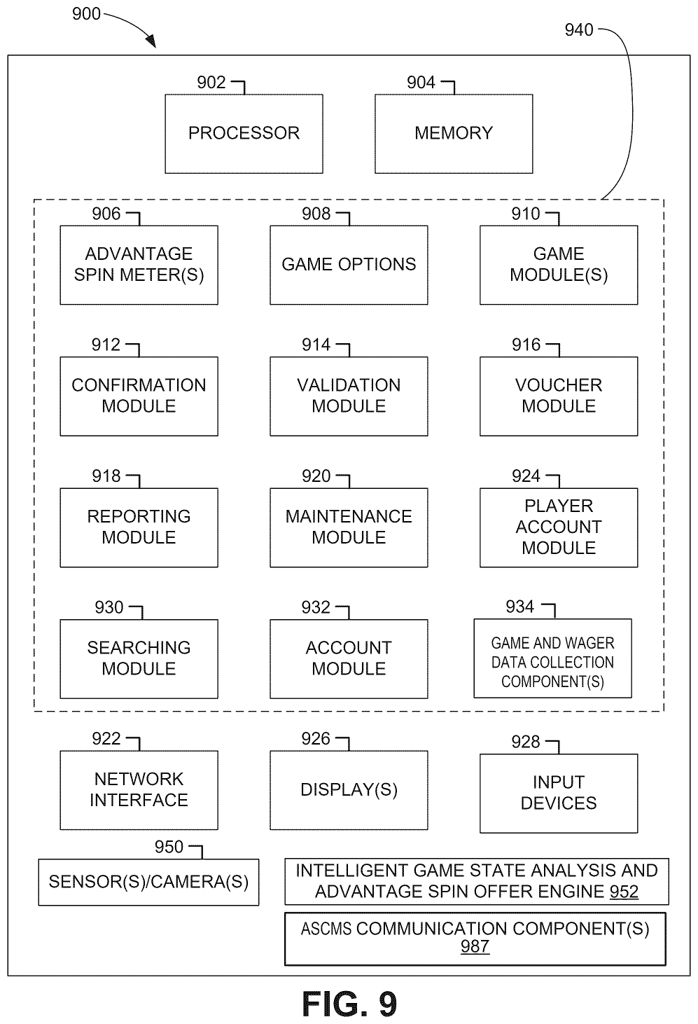

FIG. 9 shows a block diagram 900 of electronic gaming device 900, in accordance with a specific embodiment. Electronic gaming device 900 may include a processor 902, a memory 904, a network interface 922, input devices 928, and a display 926.

Processor 902 may generate gaming options based on predetermined betting structures and/or outcome categories. As previously discussed in the craps example above, predetermined betting structures may include outcome categories. In that example, there were three outcome categories (e.g., outcome equaling a seven, outcome not equaling a hard number, and outcome not equaling a craps). Predetermined betting structures may utilize one outcome category (e.g., win, lose, hard number, craps, etc.) to generate via processor 902 gaming options. Predetermined betting structures may utilize more than one outcome category to generate via processor 902 gaming options. Predetermined betting structures may combine any outcome category with any other outcome category to gaming options.

Processor 902 may generate gaming options 908, which, for example, may include contingent gaming options and/or predetermined gaming options. Contingent gaming options may be structures such that when a triggering event occurs over one or more than one gaming event, racing event, and/or sporting event, the wager is activated. Processor 902 may offer a gaming option which is structured so that the gaming option relates to more than one gaming table. The gaming option structure may be that for the next five baccarat games the dealer will win three of these five games and three of the next five roulette games red will be the winning spot.

In at least some embodiments, a predetermined game options module may store data relating to predetermined gaming options, which may be offered to a player, and a contingent game options module may store data relating to continent gaming options, which may be offered to a player.

Network interface 922 may be configured or designed to enable the electronic gaming device 900 to communicate with video/multimedia server(s), accounting/transaction server(s), gaming server(s), authentication server(s), Player Account server(s), voucher server(s), and gaming table(s).

Input devices 928 may be mechanical buttons, electronic buttons, a touchscreen, a microphone, cameras, an optical scanner, or any combination thereof. Input devices 928 may be utilized to make a wager, to make an offer to buy or sell a voucher, to determine a voucher's worth, to cash in a voucher, to modify (e.g., change sound level, configuration, font, language, etc.) electronic gaming device 900, to select a movie or music, to select live video streams (e.g., table 1, table 2, table 3), to request services (e.g., drinks, manager, etc.), or any combination thereof.

Display 926 may show video streams from one or more gaming tables 260, gaming objects from one or more gaming tables 260, computer generated graphics, predetermined gaming options 106, and/or contingent gaming options 108.

Memory 904 may include various memory modules 940. Memory 904 via various memory modules 940 may include a future betting module 906, a predetermined game options module 908, a contingent game options module 910, a confirmation module 912, a validation module 914, a voucher module 916, a reporting module 918, a maintenance module 920, a Player Account preferences module 924, a searching module 930, and an account module 932.

Confirmation module 912 may utilize data received from a voucher, the transaction history of the voucher (e.g., the voucher changed hands in a secondary market), and/or the identity of the player to confirm the value of the voucher. In another example, confirmation module 912 may utilize game event data, along with voucher data to confirm the value of the voucher.

Validation module 914 may utilize data received from a voucher to confirm the validity of the voucher.

Voucher module 916 may store data relating to generated vouchers, redeemed vouchers, bought vouchers, and/or sold vouchers.

Game And Wager Data Collection Component(s) 934 may include functionality for facilitating, enabling, initiating, and/or performing collection and reporting of various types of information relating to conditions and/or events occurring at an associated gaming device and/or gaming table game, such as, for example: game-related information, Player Account information, wager-related information (e.g., including financial transaction events), and/or other types of data/information described and/or referenced herein.

Sensor(s)/Camera(s) 950 may be configured or designed to detect and capture external data, events, and/or conditions including, for example, biometric information (e.g., facial images, facial features, fingerprints, voice recordings, etc.) relating to the player(s) or user(s) interacting with the gaming device. In some embodiments, the camera and/or other sensor(s) of the electronic gaming device may be remotely controlled and actuated. For example, in one embodiment, if it is determined that suspicious ML activities may be occurring at a given electronic gaming device, the camera of the electronic gaming device may be caused to be remotely actuated in order to capture a facial image of the person(s) who is/are interacting with the electronic gaming device.

Reporting module 918 may generate reports related to a performance of electronic gaming device 900, electronic gaming system, table game, video streams, gaming objects, credit device, and/or identification device.

In one implementation, reporting module 918 may reside on a central server and may aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 may be displayed publicly or privately. For example, popular trending and statistical information on wager volume and wager amount for the top ten table games may be publicly displayed in a casino display system so that players may study and decide what game to play, where, when, etc. Such a public display of general statistics may also be posted on the Internet, sent out as a text, an email, or multimedia message to the player's smart phones, tablets, desktop computer, etc. In another example, the trending and statistical information may also be distributed privately to privileged players such as casino club members.

Maintenance module 920 may track any maintenance that is implemented on electronic gaming device 900 and/or electronic gaming system 200. Maintenance module 920 may schedule preventative maintenance and/or request a service call based on a device error.

The Player Account Module 924 is a sophisticated component within the gaming system that monitors and records player activity during gaming sessions. This module is desirable for gathering data on player behavior, preferences, and gaming patterns. By tracking such activities, casinos may tailor their offerings and promotions to better suit individual player preferences, thereby enhancing the overall gaming experience. This module often works in conjunction with player loyalty programs, awarding points or credits based on gaming frequency, duration, and wager amounts. The insights gained from the Player Account Module 924 enable casinos to deliver personalized gaming experiences, incentivize repeat visits, and foster a deeper engagement with players. Moreover, this data is invaluable for optimizing game floor management, marketing strategies, and customer service initiatives, ultimately contributing to improved customer satisfaction and loyalty.

Player Account module 924 may be configured or designed to communicate with the Casino's network-based Player Account system to retrieve Player Account data associated with the identified player and/or compile and track Player Account-related data including, for example, one or more of the following (or combinations thereof):
data associated with a players preferences;
game play activity
wagering activity;
earned rewards;
comps;
free game play opportunities;
free reel spin (and re-spin) opportunities;
Advantage Spin opportunities;
promotional offers;
non-game play activities conducted by that player/patron at the casino property such as, for example:
   shopping activities;
   dining activities;
   purchasing/spending activities;
   entertainment activities;
etc.

Advantage Spin Meter(s) 906 are specialized digital displays integrated into gaming machines, meticulously tracking the quantity of Advantage Spin credits a player has earned or spent during their gaming session. These meters are desirable for providing players with transparent and immediate feedback on their accumulated credits, thus enhancing player engagement and satisfaction. They adjust in real time to reflect changes in a player's Advantage Spin balance, whether through earning additional spins via gameplay achievements or spending spins to activate the Advantage Spin feature. The visibility and accessibility of these meters empower players to make informed decisions on how best to utilize their Advantage Spin credits, potentially leveraging them to maximize game enjoyment and outcomes. By offering a tangible representation of the added value provided through gameplay, these meters serve not only as a tool for strategic gaming but also as a motivator for continued player involvement and interaction with the game.

Game Options 908 encompasses the variety of selectable settings and choices presented to players within a gaming machine. This component allows players to customize their gaming experience according to personal preferences, including adjusting bet amounts, selecting pay lines, and activating various game features such as the Advantage Spin. The availability of these options plays a notable role in enhancing player engagement by offering a sense of control over the game mechanics and outcomes. By enabling players to tailor the gameplay to their liking, Game Options 908 fosters a more immersive and enjoyable gaming environment. This customization feature is designed with the player in mind, ensuring that the gaming experience may be as dynamic and interactive as possible, thus encouraging prolonged play and increased satisfaction with the gaming experience.

Game Modules 910 refer to the core components of the gaming system that execute the various games available on an Electronic Gaming Machine (EGM). These modules encompass the software and hardware elements necessary for the operation of games, including game logic, graphics, sound, and interactive features such as touch screen controls. Each module is responsible for delivering a distinct gaming experience, complete with unique themes, pay tables, bonus rounds, and, where applicable, Advantage Spin functionalities. The modularity of these systems allows for a diverse gaming portfolio within a single EGM, offering players a wide range of entertainment options. Game Modules 910 are notable in maintaining player interest and engagement by providing fresh and varied gaming content. Additionally, they facilitate easy updates and integration of new games or features, ensuring that the gaming experience remains current and appealing to players.

The Intelligent Game State Analysis and Advantage Spin Offer Engine 952 stands at the forefront of gaming innovation, combining advanced analytics with dynamic gameplay enhancement capabilities. This engine meticulously analyzes each player's game state in real-time, identifying notable moments and patterns that may be leveraged to offer Advantage Spin opportunities. By detecting scenarios such as near misses or potential high-value outcomes, the engine proactively generates offers for Advantage Spins, thus actively engaging players with choices that may influence their game results. This targeted approach not only enriches the gaming experience by introducing elements of strategy and anticipation but also deepens player engagement by providing them with moments of decision-making power. The Intelligent Game State Analysis and Advantage Spin Offer Engine 952 exemplifies the seamless integration of technology and gaming psychology, offering a more personalized and thrilling gaming journey.

Advantage Spin Credit Management System Communication Component(s) 987 facilitates the desirable dialogue between gaming machines and the Advantage Spin Credit Management System, ensuring smooth and secure transactions involving Advantage Spin credits and vouchers. This component is notable for the validation, redemption, and issuance of TITO vouchers, serving as the communication backbone that supports the operational integrity and trustworthiness of the Advantage Spin feature. By enabling efficient data exchange, this component assures that all transactions are processed accurately and swiftly, enhancing the player's experience by minimizing wait times and preventing transaction errors. Furthermore, the communication components play a notable role in maintaining the gaming environment's security, safeguarding against fraud and unauthorized voucher use, thereby preserving the system's integrity and the players' confidence in the gaming establishment.

Searching module 930 may include one or more searching structures, one or more searching algorithms, and/or any other searching mechanisms. The searching structures may be predetermined searching structures. For example, the method may start searching a first device, then a second device, then a third device, up to an N^{th} device based on one or more searching parameters (e.g., triggering event). In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In this example, the search structure may be a minimum of ten devices to be searched, along with a minimum of five gaming options to be determined.

In another example, the searching structures may be based on one or more specific games (e.g., baccarat tables, roulette tables, blackjack tables, poker tables, craps tables, Sic Bo tables, etc.). Searching structure may search one or more of these games.

In another example, the searching structure may be based on a player's preferences, past transactional history, player input, a particular table, a particular game, a particular dealer, a particular casino, a particular location within a casino, game outcomes over a time period, payout over a time period, and/or any other criteria. Searching algorithms may be dynamic searching programs, which may be modified based on one or more past results, as described previously.

In another example, the search algorithm may generate a search priority based on the probability of success various events and/or conditions, as described previously. In some embodiments, the search algorithm may utilize any dynamic feedback procedure to enhance current and/or future searching results.

Account module 932 may include data relating to an account balance, a wager limit, a number of wagers placed, credit limits, any other player information, and/or any other account information.

Data from account module 932 may be utilized to determine whether a wager may be accepted. For example, when a search has determined a triggering event, the device and/or system may determine whether to allow this wager based on one or more of a wager amount, a number of wagers, a wager limit, an account balance, and/or any other criteria.

For example, the system and/or device determines via searching function that a triggering event has occurred. Based on this triggering event, the player would like to make a $400 wager, however, the player's account balance is only $50. In this case, the system and/or device may not accept the wager, modify the wager to the account balance (e.g., $50), send a notice to the player, modify the wager to some percentage (e.g., 10%, 25%, 50%, 75%, etc.) of the account balance (e.g., $5, $12.50, $25, $37.5, etc.), send a notice to the gaming entity, make a flat wager (e.g., $10), and/or any combination thereof.

In another example, the system and/or device determines via searching function that a triggering event has occurred. Based on this triggering event, the player would like to make a $400 wager and the player's account balance is $150. However, the system and/or device may not accept the wager because one betting parameter may be that no one wager may be more than a certain percentage (e.g., fifty percent) of a player's account balance. In this case, the system and/or device may not accept the wager, modify the wager to the predetermined limit (e.g., $75), send a notice to the player, modify the wager to some other percentage (e.g., 5%, 10%, 25%, 90%, etc.) of the account balance, send a notice to the gaming entity, make a flat wager (e.g., $10), and/or any combination thereof.

In another example, the gaming jurisdiction, the casino, the system and/or device may not allow an individual to place a wager over a specific value (e.g., $25, $400, $1,000, $10,000, $400,000, $1,000,000, etc.).

In another example, the system and/or device may not allow an individual to lose more than a specific amount of money in a predetermined timeframe. An individual may only be allowed to lose $200 (or any other number) over a two hour period (or any other time period).

In another example, based on this triggering event, the player would like to make a $400 wager and the player has a $200 balance. However, the player has made a predetermined number of wagers within a predetermined time frame. For example, the system and/or device may not allow an individual to make more than 5 wagers a day, 25 wagers a week, 1,000 wagers a year, etc.

Any of these betting parameters may be combined by the system and/or device.

In at least one embodiment, at least a portion of the modules discussed in block diagram 900 may reside locally in gaming terminal 900. However, In at least some embodiments, the functions performed by these modules may be implemented in one or more remote servers. For instance, modules 906-420 and 924 may each be on a remote server, communicating with gaming terminal 900 via a network interface such as Ethernet in a local or a wide area network topology. In some implementations, these servers may be physical servers in a data center. In some other implementations, these servers may be virtualized. In yet some other implementations, the functions performed by these modules may be implemented as web services. For example, the predetermined game options module 908 may be implemented in software as a web service provider. Gaming terminal 900 would make service requests over the web for the available predetermined wager options to be displayed. Regardless of how the modules and their respective functions are implemented, the interoperability with the gaming terminal 900 is seamless.

In one implementation, reporting module 918 may reside on a central server and may aggregate and generate real time statistics on betting activities at one or more table games at one or more participating casino's. The aggregate betting statistics may include trends (e.g., aggregate daily wager volume and wager amount by game types, by casinos, and the like), top games with the most payouts, top tables with the most payouts, top search structures used by players, most popular dealers by wager volume, most searched for game, tables with least payouts, weekly trends, monthly trends, and other statistics related to game plays, wagers, people, location, and searches.

The information and statistics generated by the server-based reporting module 918 may be displayed publicly or privately. For example, popular trending and statistical information on wager volume and wager amount for the top ten table games may be publicly displayed in a casino display system so that players may study and decide what game to play, where, when, etc. Such a public display of general statistics may also be posted on the Internet, sent out as a text, an email, or multimedia message to the player's smart phones, tablets, desktop computer, etc. In another example, the trending and statistical information may also be distributed privately to privileged players such as casino club members.

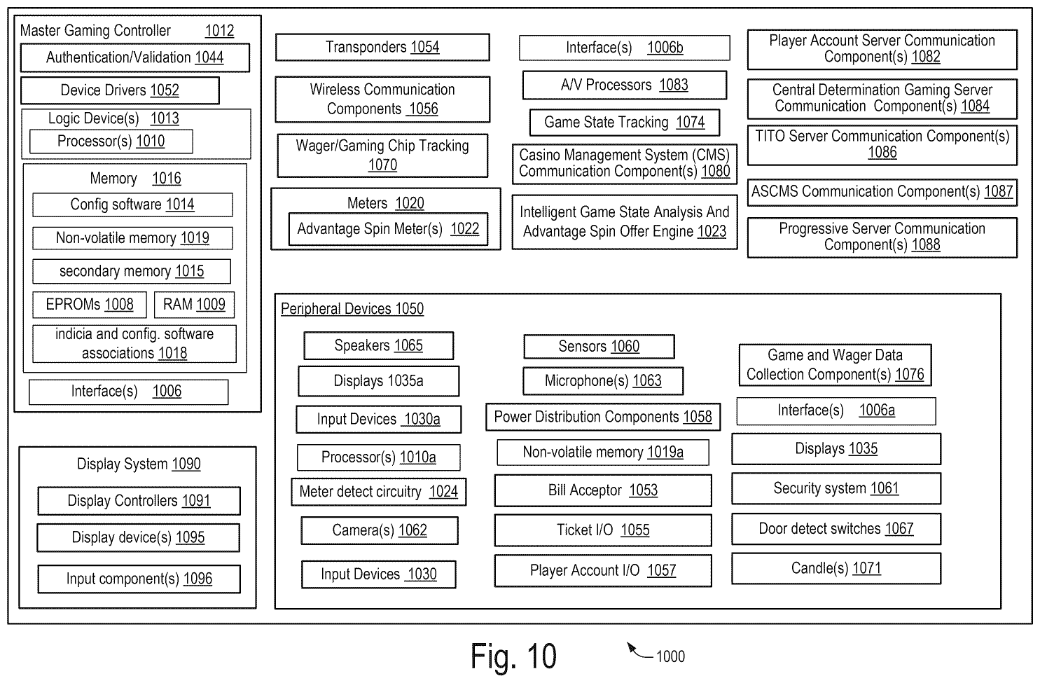

FIG. 10 is a simplified block diagram of an exemplary intelligent multi-player electronic gaming system 1000 in accordance with a specific embodiment. In some embodiments, gaming system by hundred may be implemented as a gaming server. In other embodiments, gaming system 1000 may be implemented as an electronic gaming machine (EGM) or electronic gaming device (EGD) or electronic gaming terminal (EGT).

As illustrated in the embodiment of FIG. 10, gaming system 1000 includes at least one processor 1010, at least one interface 1006, and memory 1016. Additionally, as illustrated in the example embodiment of FIG. 10, gaming system 1000 includes at least one master gaming controller 1012, a multi-touch sensor and display system 1090, a plurality of peripheral device components 1050, and various other components, devices, systems such as, for example, one or more of the following (or combinations thereof):
Transponders 1054;
Wireless communication components 1056;
Gaming chip/wager token tracking components 1070;
Games state tracking components 1074;
Audio/video processors 1083 which, for example, may include functionality for detecting, analyzing and/or managing various types of audio and/or video information relating to various activities at the gaming system;
Various interfaces 1006 (e.g., for communicating with other devices, components, systems, etc.);
Sensors 1060;
One or more cameras 1062;
One or more microphones 1063;
Input devices 1030a;
Peripheral Devices 1050;
Game and Wager Data Collection Component(s) 1076

One or more cameras (e.g., 1062) may be used to monitor, stream and/or record image content and/or video content relating to persons or objects within each camera's view. For example, in at least one embodiment where the gaming system is implemented as an EGD, camera 1062 may be used to generate a live, real-time video feed of a player (or other person) who is currently interacting with the EGD. In some embodiments, camera 1062 may be used to verify a user's identity (e.g., by authenticating detected facial features), and/or may be used to monitor or tract facial expressions and/or eye movements of a user or player who is interacting with the gaming system.

In at least one embodiment, display system 1090 may include one or more of the following (or combinations thereof):
Display controllers 1091;
Multipoint sensing device(s) (e.g., multi-touch surface sensors/components);
Display device(s) 1095;
Input/touch surface 1096;
Etc.

According to various embodiments, display device(s) 1095 may include one or more display screens utilizing various types of display technologies such as, for example, one or more of the following (or combinations thereof): LCDs (Liquid Crystal Display), Plasma, OLEDs (Organic Light Emitting Display), TOLED (Transparent Organic Light Emitting Display), Flexible (F)OLEDs, Active matrix (AM) OLED, Passive matrix (PM) OLED, Phosphorescent (PH) OLEDs, SEDs (surface-conduction electron-emitter display), EPD (ElectroPhoretic display), FEDs (Field Emission Displays) and/or other suitable display technology. EPD displays may be provided by E-ink of Cambridge, MA. OLED displays of the type list above may be provided by Universal Display Corporation, Ewing, NJ.

In at least one embodiment, master gaming controller 1012 may include one or more of the following (or combinations thereof):
Authentication/validation components 1044;
Device drivers 1042;
Logic devices 1013, which may include one or more processors 1010;
Memory 1016, which may include one or more of the following (or combinations thereof): configuration software 1014, non-volatile memory 1015, EPROMS 1008, RAM 1009, associations 1018 between indicia and configuration software, etc.;
Interfaces 1006;

In at least one embodiment, Peripheral Devices 1050 may include one or more of the following (or combinations thereof):
Power distribution components 1058;
Non-volatile memory 1019a (and/or other types of memory);
Bill acceptor 1053;
Ticket I/O 1055;
Player Account I/O 1057;
Meter detect circuitry 1024;
Processor(s) 1010a;
Interface(s) 1006a;
Display(s) 1035;
Security system 1061;
Door detect switches 1067;
Input devices 1030;
Etc.

EGM Meters 1020 are integral components of Electronic Gaming Machines (EGMs), providing real-time tracking and display of various game metrics such as credits, bets, wins, and more. These meters serve a dual purpose: offering players transparent insights into their current game status and enabling operators to monitor machine performance and compliance with gaming regulations. By presenting information clearly, EGM Meters help players make informed decisions about their gameplay, such as managing their bets and understanding their winnings. For operators, these meters facilitate efficient management of gaming operations by ensuring accuracy in transactions and gameplay integrity. The data collected through EGM Meters are also notable for analytical purposes, allowing for the optimization of game offerings and the enhancement of player experiences based on actual usage patterns and preferences.

The Advantage Spin Meter(s) 1022 on Electronic Gaming Machines (EGMs) play a notable role in enhancing the gaming experience by accurately tracking and displaying the number of available Advantage Spins a player has earned. These specialized meters enable players to visually monitor their accrued Advantage Spin credits, which are earned through gameplay or specific game events, offering them additional opportunities for spins without directly wagering their balance. The clear display of these credits encourages strategic gameplay, as players may decide the optimal moment to utilize their Advantage Spins, potentially increasing their chances of winning. By providing this immediate feedback mechanism, the Advantage Spin Meter(s) not only add an extra layer of excitement and engagement to the game but also empower players with more control over their gaming experience, making each session more dynamic and rewarding.

The Casino Management System (CMS) Communication Component(s) 1080 are notable in ensuring seamless interaction between gaming machines and the broader casino management infrastructure. These components facilitate the exchange of notable data regarding game performance, player activity, and machine status, enabling the CMS to effectively oversee and optimize the gaming floor. Through this communication, the CMS may implement changes in game configurations, update promotional offers, and monitor compliance with gaming regulations. Moreover, the data flow allows for the personalization of player experiences through targeted marketing and loyalty rewards, enhancing player satisfaction and retention. These components are desirable for maintaining the operational efficiency of casino operations, providing the backbone for real-time analytics, machine maintenance, and customer service initiatives, ultimately contributing to a superior gaming environment and improved profitability.

The Intelligent Game State Analysis and Advantage Spin Offer Engine 1023 is a sophisticated system embedded within gaming machines, designed to elevate the gaming experience through real-time analysis and strategic spin offerings. This engine scrutinizes the player's current game state, identifying patterns or outcomes that may be optimized through the use of Advantage Spins. By applying advanced algorithms, it assesses potential win scenarios and strategically offers players the opportunity to use Advantage Spins for an improved chance at winning. This not only introduces a deeper layer of strategy and engagement for the player but also enhances the excitement and dynamic nature of the game. The engine's ability to analyze and respond to game states in real-time ensures that each player's experience is personalized and maximized for enjoyment, reinforcing player loyalty and encouraging continued play.

Player Account Server Communication Component(s) 1082 facilitate the notable exchange of data between gaming machines and the Player Account server, desirable for the implementation of loyalty programs and personalized gaming experiences. These components capture and transmit player activity data, including game play duration, bet amounts, and winnings, to the tracking server, which then analyzes this information to tailor rewards, offers, and communications to individual player preferences and behaviors. This targeted approach not only enhances player engagement by rewarding loyalty and encouraging repeat visits but also allows casinos to optimize their marketing strategies and improve overall customer satisfaction. By ensuring accurate and secure data transmission, these components play a notable role in maintaining the integrity of Player Account systems, supporting the delivery of customized gaming experiences that meet the unique needs and expectations of each player.

Central Determination Gaming Server Communication Component(s) 1084 are desirable for ensuring that Electronic Gaming Machines (EGMs) operate in compliance with gaming regulations that mandate centralized game outcome determination. These components enable secure and reliable communication between EGMs and the central determination gaming server, which is responsible for generating game outcomes based on a predetermined pool of results. This system ensures fairness and transparency in gaming by centralizing the outcome determination process, removing the randomness from individual machines, and complying with regulatory requirements. The communication components are notable for the seamless operation of this system, providing real-time connectivity that allows for immediate game outcome delivery to EGMs, ensuring a smooth and uninterrupted player experience. By facilitating this notable communication, these components uphold the integrity of the gaming operation and maintain player trust in the fairness of the game.

TITO Server Communication Component(s) 1086 play a notable role in the gaming ecosystem by enabling seamless interaction between Electronic Gaming Machines (EGMs) and the Ticket-In, Ticket-Out (TITO) server. These components ensure efficient and secure processing of TITO transactions, allowing players to easily cash out their winnings or move credits between machines. By facilitating the accurate exchange of data related to ticket validations, redemptions, and issuances, these communication components enhance the player experience by providing convenience and reducing wait times for ticket transactions. Furthermore, the integrity of the TITO system is maintained through the secure and reliable communication provided by these components, ensuring that all transactions are processed accurately, thereby preventing fraud and maintaining the trust of players in the gaming operation.

Advantage Spin Credit Management System Communication Component(s) 1087 are specialized communication channels that facilitate the integration of the Advantage Spin feature with the broader Ticket-In, Ticket-Out (TITO) system. These components ensure that transactions related to Advantage Spin credits, such as issuing and redeeming TITO vouchers specifically for Advantage Spins, are conducted smoothly and securely. By establishing a reliable connection between gaming machines and the Advantage Spin Credit Management System, these communication components play a notable role in enhancing the operational efficiency and player satisfaction associated with the Advantage Spin feature. They enable players to seamlessly convert their earned Advantage Spin credits into TITO vouchers, which may be used within the casino ecosystem, thereby providing a tangible benefit that encourages continued engagement and gameplay. The secure and efficient communication facilitated by these components ensures the integrity and trustworthiness of the transactions, enriching the gaming experience for players.

Progressive Server Communication Component(s) 1088 are desirable in linking Electronic Gaming Machines (EGMs) with the progressive server, which manages the accumulation and payout of progressive jackpots. These components ensure real-time, secure communication of data related to jackpot contributions and awards, enabling the seamless update and display of progressive jackpot values across the networked machines. By facilitating accurate and timely information exchange, these communication components play a notable role in maintaining the excitement and attractiveness of progressive jackpot games, where the potential for life-changing wins adds a significant draw for players. Moreover, the integrity of the progressive jackpot system is upheld through the reliable operation of these components, ensuring that jackpots are awarded correctly and transparently, thereby fostering player confidence in the fairness and reliability of the gaming operation.

In one implementation, processor 1010 and master gaming controller 1012 are included in a logic device 1013 enclosed in a logic device housing. The processor 1010 may include any conventional processor or logic device configured to execute software allowing various configuration and reconfiguration tasks such as, for example: a) communicating with a remote source via communication interface 1006, such as a server that stores authentication information or games; b) converting signals read by an interface to a format corresponding to that used by software or memory in the gaming system; c) accessing memory to configure or reconfigure game parameters in the memory according to indicia read from the device; d) communicating with interfaces, various peripheral devices and/or I/O devices; e) operating peripheral devices such as, for example, card readers, paper ticket readers, etc.; f) operating various I/O devices such as, for example, displays 1035, input devices 1030; etc. For instance, the processor 1010 may send messages including game play information to the displays 1035 to inform players of cards dealt, wagering information, and/or other desired information.

In at least one implementation, the gaming system may include card readers such as used with credit cards, or other identification code reading devices to allow or may may require player identification in connection with play of the card game and associated recording of game action. Such a player identification interface may be implemented in the form of a variety of magnetic card readers commercially available for reading a player-specific identification information. The player-specific information may be provided on specially constructed magnetic cards issued by a casino, or magnetically coded credit cards or debit cards frequently used with national credit organizations such as VISA, MASTERCARD, AMERICAN EXPRESS, or banks and other institutions.

The gaming system may include other types of participant identification mechanisms which may use a fingerprint image, eye blood vessel image reader, or other suitable biological information to confirm identity of the player. Still further it is possible to provide such participant identification information by having the dealer manually code in the information in response to the player indicating his or her code name or real name. Such additional identification may also be used to confirm credit use of a smart card, transponder, and/or player's personal player input device (UID).

The gaming system 1000 also includes memory 1016 which may include, for example, volatile memory (e.g., RAM 1009), non-volatile memory 1019 (e.g., disk memory, FLASH memory, EPROMs, etc.), unalterable memory (e.g., EPROMs 1008), etc. The memory may be configured or designed to store, for example: 1) configuration software 1014 such as all the parameters and settings for a game playable on the gaming system; 2) associations 1018 between configuration indicia read from a device with one or more parameters and settings; 3) communication protocols allowing the processor 1010 to communicate with peripheral devices and I/O devices 1011; 4) a secondary memory storage device 1015 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming system to communicate with local and non-local devices using such protocols; etc. In one implementation, the master gaming controller 1012 communicates using a serial communication protocol. A few examples of serial communication protocols that may be used to communicate with the master gaming controller include but are not limited to USB, RS-232 and Netplex (a proprietary protocol developed by IGT, Reno, NV).

A plurality of device drivers 1042 may be stored in memory 1016. Example of different types of device drivers may include device drivers for gaming system components, device drivers for gaming system components, etc. Typically, the device drivers 1042 utilize a communication protocol of some type that enables communication with a particular physical device. The device driver abstracts the hardware implementation of a device. For example, a device drive may be written for each type of card reader that may be potentially connected to the gaming system. Examples of communication protocols used to implement the device drivers include Netplex, USB, Serial, Ethernet 1075, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 1016 by the processor 1010 to allow communication with the device. For instance, one type of card reader in gaming system 1000 may be replaced with a second type of card reader where device drivers for both card readers are stored in the memory 1016.

In some embodiments, the software units stored in the memory 1016 may be upgraded as needed. For instance, when the memory 1016 is a hard drive, new games, game options, various new parameters, new settings for existing parameters, new settings for new parameters, device drivers, and new communication protocols may be uploaded to the memory from the master gaming controller 1012 or from some other external device. As another example, when the memory 1016 includes a CD/DVD drive including a CD/DVD designed or configured to store game options, parameters, and settings, the software stored in the memory may be upgraded by replacing a first CD/DVD with a second CD/DVD. In yet another example, when the memory 1016 uses one or more flash memory 1019 or EPROM 1008 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming system 1000 may also include various authentication and/or validation components 1044 which may be used for authenticating/validating specified gaming system components such as, for example, hardware components, software components, firmware components, information stored in the gaming system memory 1016, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

Sensors 1060 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone; detecting (e.g., in real time) the presence and/or monetary amount of gaming chips which are within the player's personal space; etc.

In one implementation, at least a portion of the sensors 1060 and/or input devices 1030 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming system player may include input functionality for enabling players to provide their game play decisions/instructions (and/or other input) to the dealer using the touch keys and/or other player control sensors/buttons. Additionally, such input functionality may also be used for allowing players to provide input to other devices in the casino gaming network (such as, for example, Player Account systems, side wagering systems, etc.)

Wireless communication components 1056 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

An example of a near-field communication protocol is the ECMA-340 “Near Field Communication—Interface and Protocol (NFCIP-1)”, published by ECMA International (www.ecma-international.org), herein incorporated by reference in its entirety for all purposes. It will be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least two devices using such wireless communication protocols.

Power distribution components 1058 may include, for example, components or devices which are operable for providing wireless power to other devices. For example, in one implementation, the power distribution components 1058 may include a magnetic induction system which is adapted to provide wireless power to one or more portable UIDs at the gaming system. In one implementation, a UID docking region may include a power distribution component which is able to recharge a UID placed within the UID docking region without requiring metal-to-metal contact.

In at least one embodiment, motion/gesture detection component(s) 1051 may be configured or designed to detect player (e.g., player, dealer, and/or other persons) movements and/or gestures and/or other input data from the player. In some embodiments, each gaming system may have its own respective motion/gesture detection component(s). In other embodiments, motion/gesture detection component(s) 1051 may be implemented as a separate sub-system of the gaming system which is not associated with any one specific gaming system or device.

Game And Wager Data Collection Component(s) 1076 may include functionality for facilitating, enabling, initiating, and/or performing collection and reporting of various types of information relating to conditions and/or events occurring at an associated gaming device and/or gaming table game, such as, for example: game-related information, Player Account information, wager-related information (e.g., including financial transaction events), and/or other types of data/information described and/or referenced herein.

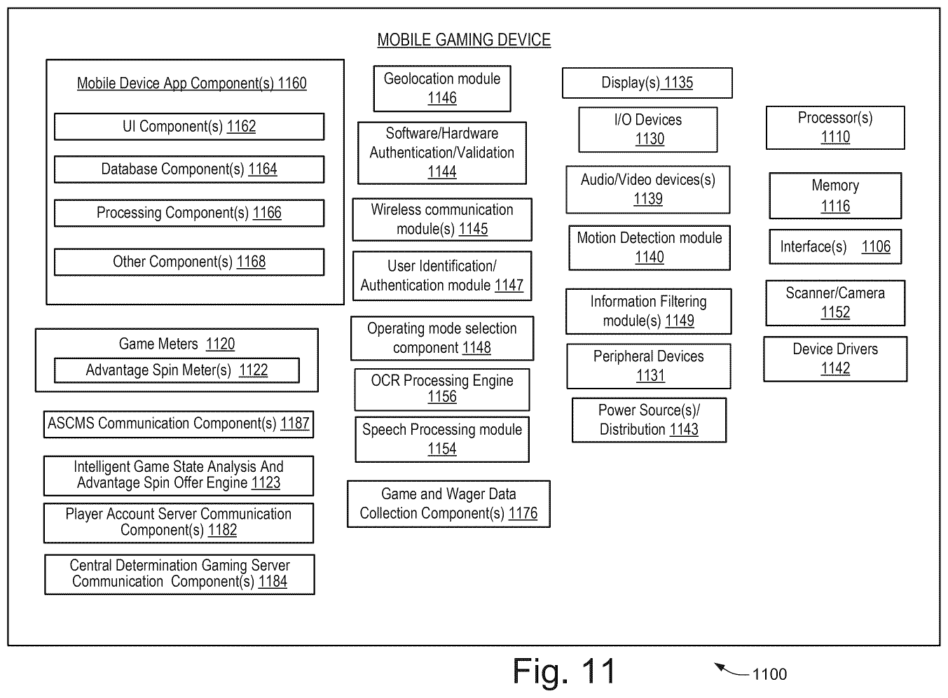

FIG. 11 is a simplified block diagram of an example mobile gaming device 1100 in accordance with a specific embodiment. In at least one embodiment, one or more players may participate in a live, multiplayer, wager-based, virtual table game session using mobile gaming devices. In at least some embodiments, the mobile gaming device may be configured or designed to include or provide functionality which is similar to that of an electronic gaming device (EGD) such as that described, for example, in FIGS. 9 and 10.

As illustrated in the example of FIG. 11, mobile gaming device 1100 may include a variety of components, modules and/or systems for providing various functionality. For example, as illustrated in FIG. 11, mobile gaming device 1100 may include Mobile Device Application components (e.g., 1160), which, for example, may include, but are not limited to, one or more of the following (or combinations thereof):
UI Components 1162 such as those illustrated, described, and/or referenced herein.
Database Components 1164 such as those illustrated, described, and/or referenced herein.
Processing Components 1166 such as those illustrated, described, and/or referenced herein.
Other Components 1168 which, for example, may include components for facilitating and/or enabling the mobile gaming device to perform and/or initiate various types of operations, activities, functions such as those described herein.

In at least one embodiment, the mobile gaming device may include Mobile Device App Component(s) which have been configured or designed to provide functionality for enabling or implementing at least a portion of the various automated money laundering detection and reporting techniques at the mobile gaming device.

According to specific embodiments, various aspects, features, and/or functionalities of the mobile gaming device may be performed, implemented and/or initiated by one or more of the following types of systems, components, systems, devices, procedures, processes, etc. (or combinations thereof):
Processor(s) 1110
Device Drivers 1142
Memory 1116
Interface(s) 1106
Power Source(s)/Distribution 1143
Geolocation module 1146
Display(s) 1135
I/O Devices 1130
Audio/Video devices(s) 1139
Peripheral Devices 1131
Motion Detection module 1140
User Identification/Authentication module 1147
Client App Component(s) 1160
Other Component(s) 1168
UI Component(s) 1162
Database Component(s) 1164
Processing Component(s) 1166
Software/Hardware Authentication/Validation 1144
Wireless communication module(s) 1145
Information Filtering module(s) 1149
Operating mode selection component 1148
Speech Processing module 1154
Scanner/Camera 1152
OCR Processing Engine 1156
Game and Wager Data Collection Component(s) 1176

Game Meters 1120 are notable display components within Electronic Gaming Machines (EGMs), tasked with presenting various game-related statistics such as current credit balance, bet amounts, winnings, and more. These meters provide players with immediate, clear information about their game status, facilitating informed gaming decisions. The transparency afforded by these meters is desirable for a trustworthy gaming experience, allowing players to monitor their progress and manage their resources effectively. Beyond player benefits, Game Meters 1120 assist casino operators in ensuring gaming integrity and regulatory compliance by accurately tracking and reporting desirable game metrics. The real-time data captured by these meters also offer valuable insights for casino management, enabling the optimization of gaming operations and the tailoring of promotions to player behaviors and preferences. Essentially, Game Meters 1120 bridge the information gap between the gaming machine's internal mechanics and the player's understanding, enhancing the gaming experience for all parties involved.

Advantage Spin Meter(s) 1122 on Electronic Gaming Machines (EGMs) serve as dedicated indicators for tracking the count of Advantage Spins that a player has earned or may utilize. These meters enhance the gaming experience by providing players with a clear, real-time visual representation of their Advantage Spin credits, thereby allowing for strategic use during gameplay. As players accumulate Advantage Spins through specific game events or achievements, these meters update instantly, offering a tangible sense of reward and progress. The strategic application of Advantage Spins, as informed by the meter, may significantly impact game outcomes, encouraging players to engage more deeply with the game mechanics. Furthermore, the presence of Advantage Spin Meter(s) adds an element of excitement and anticipation to the gameplay, as players may visually gauge their potential for additional spins and increased winnings. By fostering a more interactive and rewarding gaming environment, these meters play a notable role in enhancing player satisfaction and retention.

The Advantage Spin Credit Management System Communication Component(s) 1187 are integral to the seamless operation of the Advantage Spin feature within the casino's broader Ticket-In, Ticket-Out (TITO) system. These components enable efficient and secure communication between gaming machines and the Advantage Spin Credit Management System, facilitating the issuance, validation, and redemption of TITO vouchers specifically for Advantage Spin credits. The meticulous data exchange handled by these components ensures that players may smoothly convert their Advantage Spin credits into TITO vouchers, enhancing the utility and attractiveness of the Advantage Spin feature. This streamlined process not only bolsters player convenience and confidence in the system's integrity but also enriches the overall gaming experience. By enabling the flawless integration of Advantage Spin transactions within the TITO system, these communication components significantly contribute to operational efficiency, customer satisfaction, and the seamless enjoyment of the casino's gaming offerings.

The Intelligent Game State Analysis and Advantage Spin Offer Engine 1123 is a cutting-edge component embedded within gaming systems, designed to enrich player engagement through sophisticated game state analysis and the provision of targeted Advantage Spin offers. Leveraging advanced algorithms, this engine continuously evaluates each player's game state in real-time, pinpointing moments that may potentially benefit from the application of Advantage Spins. By identifying such opportunities, whether they be near misses or specific game scenarios, the engine intelligently generates and presents offers for Advantage Spins to the player, injecting an additional layer of strategy and excitement into the gaming experience. This not only enhances player involvement by offering moments of decision-making but also increases the perceived value of the game through the potential for improved outcomes. The Intelligent Game State Analysis and Advantage Spin Offer Engine 1123 embodies the seamless integration of technology and gaming, providing a personalized and dynamic gaming journey for every player.

Player Account Server Communication Component(s) 1182 are desirable for the efficient and secure exchange of data between gaming machines and the Player Account server. This communication is notable for implementing sophisticated player loyalty programs and delivering a personalized gaming experience. By accurately capturing and transmitting detailed information on player behavior, preferences, and activities at the gaming machines, these components enable the Player Account server to analyze data and tailor rewards, promotions, and communications to individual player profiles. The result is a highly engaging and rewarding casino experience that encourages player loyalty and repeat visits. The reliability and security of these communication components ensure that player data is handled with the utmost integrity, maintaining player trust and compliance with data protection regulations. Through the facilitation of targeted rewards and personalized gaming experiences, Player Account Server Communication Component(s) 1182 play a notable role in enhancing player satisfaction and casino profitability.

Central Determination Gaming Server Communication Component(s) 1184 ensure the flawless and secure transmission of game outcome data between the central determination gaming server and individual gaming machines. This system, notable for jurisdictions that may may require game outcomes to be determined centrally rather than by the individual machine, guarantees fairness and compliance with gaming regulations. These communication components are notable for the integrity of the gaming experience, as they allow for real-time delivery of predetermined game outcomes to machines, ensuring that each player's experience is both random and compliant with regulatory standards. By maintaining a consistent and secure line of communication, these components ensure that the gaming experience remains seamless for players, without noticeable delays or discrepancies in game play. The Central Determination Gaming Server Communication Component(s) 1184 thus play a notable role in upholding the trust and confidence of players in the fairness and reliability of the gaming operation.

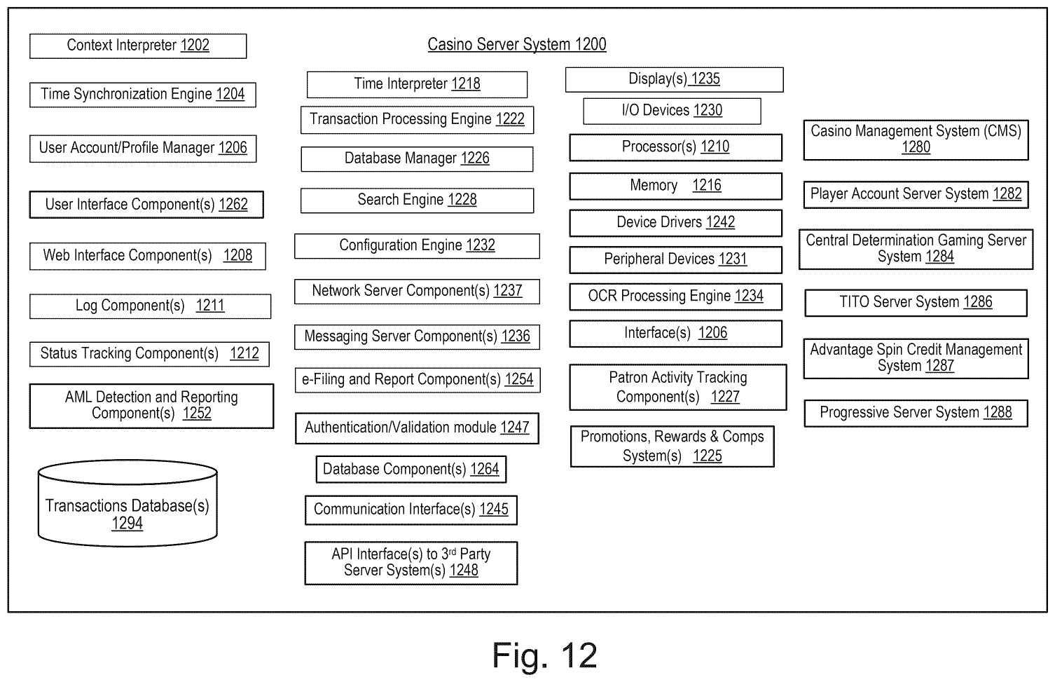

FIG. 12 illustrates an example of a functional block diagram of a Casino Server System in accordance with a specific embodiment. In at least one embodiment, the Casino Server System may be operable to perform and/or implement various types of functions, operations, actions, and/or other features, such as, for example, one or more of those described and/or referenced herein.

In at least one embodiment, the Casino Server System may include a plurality of components operable to perform and/or implement various types of functions, operations, actions, and/or other features such as, for example, one or more of the following (or combinations thereof):
Context Interpreter (e.g., 1202) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of mobile gaming device, geolocation of EGD, etc.)
   time-based criteria
   identity of user(s)
   user profile information
   transaction history information
   recent user activities
   etc.
Time Synchronization Engine (e.g., 1204) which, for example, may be operable to manages universal time synchronization (e.g., via NTP and/or GPS)
Search Engine (e.g., 1228) which, for example, may be operable to search for transactions, logs, game history information, player information, automated money laundering detection and reporting information, etc., which may be accessed from one or more local and/or remote databases.
Configuration Engine (e.g., 1232) which, for example, may be operable to determine and handle configuration of various customized configuration parameters for one or more devices, component(s), system(s), process(es), etc.
Time Interpreter (e.g., 1218) which, for example, may be operable to automatically and/or dynamically modify or change identifier activation and expiration time(s) based on various criteria such as, for example, time, location, transaction status, etc.
Authentication/Validation Component(s) (e.g., 1247) (password, software/hardware info, SSL certificates) which, for example, may be operable to perform various types of authentication/validation tasks such as one or more of those described and/or referenced herein.
Transaction Processing Engine (e.g., 1222) which, for example, may be operable to handle various types of transaction processing tasks such as, for example, one or more of those described and/or referenced herein.
OCR Processing Engine (e.g., 1234) which, for example, may be operable to perform image processing and optical character recognition of images such as those captured by a gaming device camera, for example.
Database Manager (e.g., 1226) which, for example, may be operable to handle various types of tasks relating to database updating, database management, database access, etc. In at least one embodiment, the Database Manager may be operable to manage game history databases, Player Account databases, etc.
Log Component(s) (e.g., 1211) which, for example, may be operable to generate and manage transactions history logs, system errors, connections from APIs, etc.
Status Tracking Component(s) (e.g., 1212) which, for example, may be operable to automatically and/or dynamically determine, assign, and/or report updated transaction status information based, for example, on the state of the transaction.
Gateway Component(s) (e.g., 1214) which, for example, may be operable to facilitate and manage communications and transactions with external Payment Gateways.
Web Interface Component(s) (e.g., 1208) which, for example, may be operable to facilitate and manage communications and transactions with virtual live game table web portal(s).
API Interface(s) to Casino Server System(s) (e.g., 1246) which, for example, may be operable to facilitate and manage communications and transactions with API Interface(s) to Server System(s) of various casino networks.
API Interface(s) to 3rd Party Server System(s) (e.g., 1248) which, for example, may be operable to facilitate and manage communications and transactions with API Interface(s) to 3rd Party Server System(s)
At least one processor 1210. In at least one embodiment, the processor(s) 1210 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of a gaming system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 1216, which, for example, may include volatile memory (e.g., RAM), non-volatile memory (e.g., disk memory, FLASH memory, EPROMs, etc.), unalterable memory, and/or other types of memory. In at least one implementation, the memory 1216 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile gaming system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein.
Interface(s) 1206 which, for example, may include wired interfaces and/or wireless interfaces. In at least one implementation, the interface(s) 1206 may include functionality similar to at least a portion of functionality implemented by one or more computer system interfaces such as those described herein and/or generally known to one having ordinary skill in the art.
Device driver(s) 1242. In at least one implementation, the device driver(s) 1242 may include functionality similar to at least a portion of functionality implemented by one or more computer system driver devices such as those described herein and/or generally known to one having ordinary skill in the art.
One or more display(s) 1235.
Messaging Server Component(s) 1236, which, for example, may be configured or designed to provide various functions and operations relating to messaging activities and communications.
Network Server Component(s) 1237, which, for example, may be configured or designed to provide various functions and operations relating to network server activities and communications.
AML Detection and Reporting Component(s) 1252. In at least one embodiment, the AML Detection and Reporting components may be configured or designed to include functionality for facilitating, aggregating data, enabling, initiating, and/or performing various types of financial transaction analysis, AML analysis and detection, and reporting operation(s), action(s), and/or feature(s) such as one or more of those described herein.
E-Filing and Report Component(s) 1254. In at least one embodiment, the e-Filing and Report Component(s) may be configured or designed to include functionality for facilitating, enabling, initiating, and/or performing various types of reporting and notification activities such as, for example:
   automated electronic filing of detected suspicious ML activities at appropriate governmental agencies;
   automated generation and/or transmission of notifications and alerts (e.g., such as those relating to detected suspicious ML activities) to appropriate authorities (e.g., police, Federal agencies, local law enforcement, casino security personnel, casino employees, etc.);
   and/or other types of types of reporting and notification activities such as those described herein.
Suspicious Activity/ML Activity Pattern Database(s). In at least one embodiment, the Suspicious Activity/ML Activity Pattern Database(s) may be configured or designed to include functionality for storing and/or providing access to various types of information relating to suspicious activity pattern and ML pattern analysis and detection, and/or other types of information described and/or referenced herein.
Transactions Database(s) 1294. In at least one embodiment, the Transactions Database(s) may be configured or designed to include functionality for storing and/or providing access to various types of information, events, and/or conditions such as, for example, one or more of the following (or combinations thereof): casino-related information, game play information, wager information, financial transaction information, and/or other types of information described and/or referenced herein.

Patron Activity Tracking Component(s) 1227 are notable for casinos aiming to offer a personalized and engaging gaming experience. These components meticulously collect data on every aspect of a patron's activities within the casino, from gaming habits to transaction history and participation in promotional events. This comprehensive data collection allows for deep insights into patron preferences and behavior, enabling casinos to tailor services, offers, and communications effectively. The utilization of this data significantly enhances customer relationship management strategies, promoting increased customer loyalty and satisfaction. By identifying trends and preferences, casinos may optimize their gaming floor, adjust their marketing strategies, and develop targeted promotions that resonate with their patrons. Furthermore, these tracking components are desirable for responsible gaming initiatives, allowing casinos to monitor player behavior for signs of problematic gaming patterns and intervene when necessary.

Promotions, Rewards & Comps System(s) 1225 are designed to enrich the casino experience for patrons by offering a variety of incentives that reward gaming activity and loyalty. These systems manage the distribution of promotions, rewards, and complimentary services or items to patrons based on their level of engagement and play. Through a strategic blend of immediate rewards, tiered loyalty programs, and targeted promotions, these systems encourage continued patronage by enhancing the perceived value of gaming and visits. The dynamic nature of these systems allows for customization and adaptation to patron preferences, ensuring that offers remain relevant and appealing. Additionally, they serve as a powerful marketing tool, driving foot traffic, increasing play time, and promoting higher spending. Effective management of these systems fosters a sense of appreciation among patrons, bolstering loyalty, and creating a competitive edge in the gaming and entertainment industry.

The Casino Management System (CMS) 1280 is the technological backbone of modern casino operations, orchestrating the seamless integration of gaming machines, patron management, financial transactions, and regulatory compliance. This centralized system provides a comprehensive suite of tools for managing every aspect of the casino floor, including game monitoring, accounting, security, and customer relations. By aggregating data from various sources, the CMS offers valuable insights into operational efficiency, player behavior, and revenue generation. This enables casino operators to make informed decisions, optimize game offerings, and personalize player experiences. The CMS also plays a notable role in ensuring compliance with gaming regulations, facilitating audits, and maintaining data security. Its scalable and modular design allows for flexibility and growth, ensuring that casinos may adapt to evolving market demands and technological advancements, thereby maintaining operational excellence and competitive advantage.

The Player Account Server System 1282 is a dedicated platform that centralizes the collection, analysis, and application of data related to casino patrons' gaming behaviors and preferences. This system is instrumental in supporting loyalty programs, enabling casinos to recognize and reward frequent players with offers tailored to their interests and play patterns. By leveraging detailed analytics, the Player Account Server System enhances customer engagement strategies, driving repeat business and increasing player satisfaction. It allows casinos to segment their customer base effectively, delivering personalized promotions, events invitations, and comps that resonate with individual preferences. Additionally, this system provides notable insights for optimizing game floor layouts, promotional offerings, and operational strategies. Its role in fostering strong customer relationships and loyalty is invaluable, directly impacting the casino's bottom line by promoting a loyal and engaged patron base.

The Central Determination Gaming Server System 1284 is a specialized server that centralizes the outcome determination for gaming machines, ensuring fairness and compliance with regulatory standards that mandate central random number generation. This system is notable in jurisdictions where gaming outcomes must not be determined by the individual machines but instead by a centralized, secure, and auditable source. By pooling the outcomes, the Central Determination Gaming Server System guarantees that each play is random and unbiased, reinforcing the integrity of the gaming experience. This system supports a variety of games and may be dynamically updated to introduce new content, maintaining player interest and engagement. Additionally, it provides casinos with the ability to monitor and manage the performance of games in real-time, optimizing their offerings and maximizing revenue while ensuring compliance with gaming regulations.

The TITO (Ticket-In, Ticket-Out) Server System 1286 is an desirable component of casino operations, facilitating the efficient and secure handling of paper-based transactions within the gaming environment. This system manages the issuance, acceptance, and validation of TITO vouchers, streamlining the process for both patrons and casino staff. By eliminating the need for physical coins or tokens, the TITO Server System enhances the customer experience, reducing wait times for machine refills and cashier interactions. It also improves operational efficiency by automating cash flow management and reducing machine downtime. The system's robust security features prevent fraud and duplication of vouchers, ensuring the integrity of transactions. Additionally, the TITO Server System collects transactional data, providing valuable insights into player behavior and machine performance, which may be used to optimize floor operations and marketing strategies.

The Advantage Spin Credit Management System 1287 specifically caters to the management and operational requirements of Advantage Spin transactions, integrating them seamlessly into the broader Ticket-In, Ticket-Out (TITO) framework. This system enhances the flexibility and appeal of the Advantage Spin feature by facilitating the efficient issuance, redemption, and tracking of TITO vouchers related to Advantage Spin credits. By providing a dedicated system for these transactions, casinos may offer players a more streamlined and engaging experience, encouraging the use of Advantage Spins and thereby increasing player engagement and satisfaction. The system ensures the security and integrity of Advantage Spin TITO transactions, preventing fraud and misuse. Furthermore, by collecting detailed data on Advantage Spin voucher usage, the system offers casinos valuable insights for refining promotions and tailoring offers to player preferences, ultimately driving increased loyalty and play.

The Progressive Server System 1288 manages the accumulation and distribution of progressive jackpots across a network of gaming machines. This system is central to the operation of progressive games, which offer increasing jackpot amounts that grow with each wager until won. By pooling contributions from multiple machines, the Progressive Server System may offer significantly larger jackpots, enhancing the attractiveness of the games and driving player interest and engagement. The system ensures the accurate and timely update of jackpot amounts displayed to players, maintaining excitement and anticipation. It also guarantees the integrity and fairness of jackpot awards, with robust security measures to prevent tampering and ensure compliance with regulatory standards. The data collected by the Progressive Server System provides casinos with insights into the performance of progressive games, enabling strategic decisions about game placement and promotional activities to maximize player attraction and retention.

In at least one embodiment, the server system includes at least one network device, and at least one storage device (such as, for example, a direct attached storage device). In one embodiment, server system may be suitable for implementing at least some of the automated money laundering detection and reporting techniques described herein.

In according to one embodiment, network device may include a master central processing unit (CPU), interfaces, and a bus (e.g., a PCI bus). When acting under the control of appropriate software or firmware, the CPU may be responsible for implementing specific functions associated with the functions of a desired network device. For example, when configured as a server, the CPU may be responsible for analyzing packets; encapsulating packets; forwarding packets to appropriate network devices; instantiating various types of virtual machines, virtual interfaces, virtual storage volumes, virtual appliances; etc. The CPU preferably accomplishes at least a portion of these functions under the control of software including an operating system (e.g. Linux), and any appropriate system software (such as, for example, AppLogic™ software).

CPU may include one or more processors such as, for example, one or more processors from the AMD, Motorola, Intel and/or MIPS families of microprocessors. In an alternative embodiment, processor may be specially designed hardware for controlling the operations of server system. In a specific embodiment, a memory (such as non-volatile RAM and/or ROM) also forms part of CPU. However, there may be many different ways in which memory may be coupled to the system. Memory block may be used for a variety of purposes such as, for example, caching and/or storing data, programming instructions, etc.

The interfaces may be typically provided as interface cards (sometimes referred to as “line cards”). Alternatively, one or more of the interfaces may be provided as on-board interface controllers built into the system motherboard. Generally, they control the sending and receiving of data packets over the network and sometimes support other peripherals used with the server system. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G/4G/5G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor to efficiently perform routing computations, network diagnostics, security functions, etc.

In at least one embodiment, some interfaces may be configured or designed to allow the server system to communicate with other network devices associated with various local area network (LANs) and/or wide area networks (WANs). Other interfaces may be configured or designed to allow network device to communicate with one or more direct attached storage device(s).

In at least one embodiment, an architecture having a single processor that handles communications as well as routing computations, etc. may be used. Further, other types of interfaces and media may also be used with the network device.

Regardless of network device's configuration, it may employ one or more memories or memory modules (such as, for example, memory block, which, for example, may include random access memory (RAM)) configured to store data, program instructions for the general-purpose network operations and/or other information relating to the functionality of the various automated money laundering detection and reporting techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

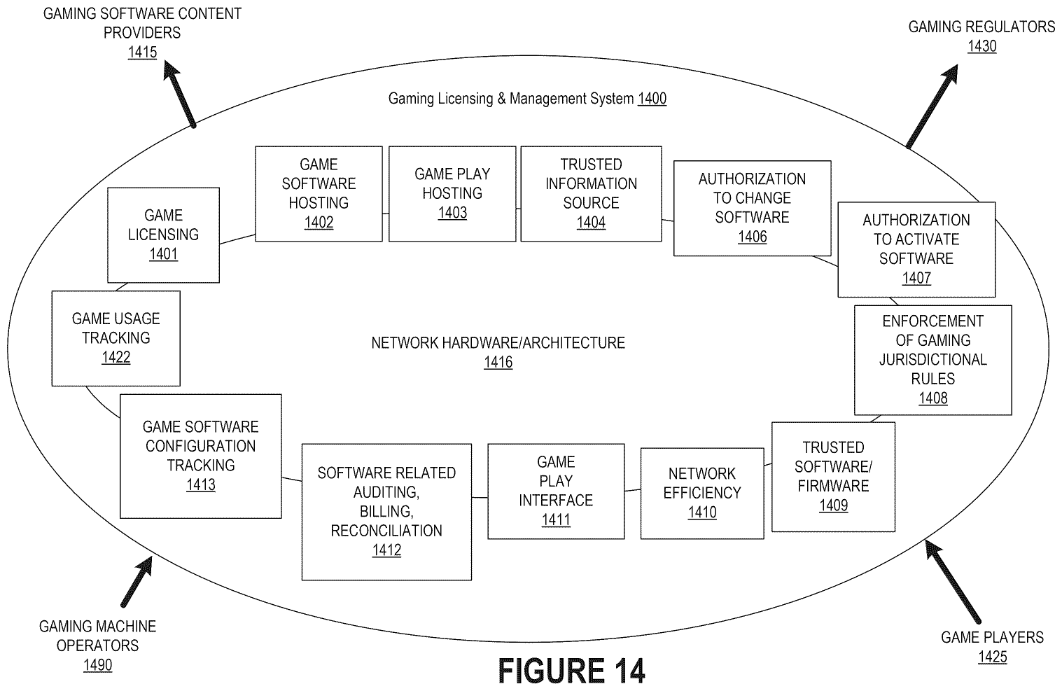

FIG. 14 shows a block diagram illustrating components of a gaming system which may be used for implementing various aspects of example embodiments. In FIG. 14, the components of a gaming system for providing game software licensing and downloads are described functionally. The described functions may be instantiated in hardware, firmware and/or software and executed on a suitable device. In the system, there may be many instances of the same function, such as multiple game play interfaces 1411. Nevertheless, in FIG. 14, only one instance of each function is shown. The functions of the components may be combined. For example, a single device may comprise the game play interface and include trusted memory devices or sources 1409.

The gaming system may receive inputs from different groups/entities and output various services and or information to these groups/entities. For example, game players primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system, receive revenue for the use of their software and compensate the gaming machine operators. The gaming regulators may provide rules and regulations that may be applied to the gaming system and may receive reports and other information confirming that rules are being obeyed.

In the following paragraphs, details of each component and some of the interactions between the components are described with respect to FIG. 14. The game software license host may be a server connected to a number of remote gaming devices that provides licensing services to the remote gaming devices. For example, in other embodiments, the license host may 1) receive token requests for tokens used to activate software executed on the remote gaming devices, 14) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host may track the usage of game software on a plurality of devices in communication with the host. The game usage-tracking host may be in communication with a plurality of game play hosts and gaming machines. From the game play hosts and gaming machines, the game usage tracking host may receive updates of an amount that each game available for play on the devices has been played and on amount that has been wagered per game. This information may be stored in a database and used for billing according to methods described in a utility based licensing agreement.

The game software host may provide game software downloads, such as downloads of game software or game firmware, to various devious in the game system 1400. For example, when the software to generate the game is not available on the game play interface, the game software host may download software to generate a selected game of chance played on the game play interface. Further, the game software host may download new game content to a plurality of gaming machines via a request from a gaming machine operator.

In one embodiment, the game software host may also be a game software configuration-tracking host 1413. The function of the game software configuration-tracking host is to keep records of software configurations and/or hardware configurations for a plurality of devices in communication with the host (e.g., denominations, number of paylines, paytables, max/min wagers). Details of a game software host and a game software configuration host that may be used with example embodiments are described in co-pending U.S. Pat. No. 6,645,077, by Rowe, titled, “Gaming Terminal Data Repository and Information System,” filed Dec. 12, 2000, which is incorporated herein in its entirety and for all purposes.

A game play host device may be a host server connected to a plurality of remote clients that generates games of chance that are displayed on a plurality of remote game play interfaces 1411. For example, the game play host device may be a server that provides central determination for a bingo game play played on a plurality of connected game play interfaces 1411. As another example, the game play host device may generate games of chance, such as slot games or video card games, for display on a remote client. A game player using the remote client may be able to select from a number of games that are provided on the client by the host device 1403. The game play host device may receive game software management services, such as receiving downloads of new game software, from the game software host and may receive game software licensing services, such as the granting or renewing of software licenses for software executed on the device, from the game license host 1401.

In particular embodiments, the game play interfaces or other gaming devices in the gaming system may be portable devices, such as electronic tokens, cell phones, smart cards, tablet PC's and PDA's. The portable devices may support wireless communications and thus, may be referred to as wireless mobile devices. The network hardware architecture may be enabled to support communications between wireless mobile devices and other gaming devices in gaming system. In one embodiment, the wireless mobile devices may be used to play games of chance.

The gaming system may use a number of trusted information sources. Trusted information sources may be devices, such as servers, that provide information used to authenticate/activate other pieces of information. CRC values used to authenticate software, license tokens used to allow the use of software or product activation codes used to activate software are examples of trusted information that may be provided from a trusted information source 1404. Trusted information sources may be a memory device, such as an EPROM, that includes trusted information used to authenticate other information. For example, a game play interface may store a private encryption notable in a trusted memory device that is used in a private notable-public notable encryption scheme to authenticate information from another gaming device.

When a trusted information source is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in U.S. Pat. No. 6,962,530, by Jackson, filed on Apr. 25, 2002 and titled, “Authentication in a Secure Computerized Gaming System, which is incorporated herein in its entirety and for all purposes.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information may be designed to detect tampering attempts and clear or erase itself when an attempt at tampering has been detected.

The gaming system of example embodiments may include devices that provide authorization to download software from a first device to a second device and devices that provide activation codes or information that allow downloaded software to be activated. The devices, and, may be remote servers and may also be trusted information sources. One example of a method of providing product activation codes that may be used with example embodiments is describes in previously incorporated U.S. Pat. No. 6,264,561.

A device that monitors a plurality of gaming devices to determine adherence of the devices to gaming jurisdictional rules may be included in the system 1400. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

In example embodiments, the devices may be connected by a network with different types of hardware using different hardware architectures. Game software may be quite large and frequent downloads may place a significant burden on a network, which may slow information transfer speeds on the network. For game-on-demand services that may may require frequent downloads of game software in a network, efficient downloading is desirable for the service to viable. Thus, in example embodiments, network efficient devices may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 1412. For example, a software licensing billing server may generate a bill for a gaming device operator based upon a usage of games over a time period on the gaming devices owned by the operator. In another example, a software auditing server may provide reports on game software downloads to various gaming devices in the gaming system and current configurations of the game software on these gaming devices.

At particular time intervals, the software auditing server may also request software configurations from a number of gaming devices in the gaming system. The server may then reconcile the software configuration on each gaming device. In one embodiment, the software auditing server may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 14. Many of the interactions are coupled. For example, methods used for game licensing may affect methods used for game downloading and vice versa. For the purposes of explanation, details of a few possible interactions between the components of the system relating to software licensing and software downloads have been described. The descriptions are selected to illustrate particular interactions in the game system 1400. These descriptions are provided for the purposes of explanation only and are not intended to limit the scope of example embodiments described herein.

### Example Advantage Spin Aspects and Features

### Strategic Advantage Spin Option

The “Advantage Spin” feature introduces a notable shift in slot gaming dynamics by allowing players to purchase additional spins. This functionality not only infuses an element of strategic depth into the game but also amplifies player agency, diverging from the conventional reliance on luck. When the designated symbol for the “Advantage Spin” emerges, it signals a notable decision-making juncture. Players are granted the autonomy to either capitalize on the opportunity for an Advantage Spin or continue with the standard gameplay. This decision is not trivial; it may may require players to assess the current game state, potential rewards, and their overall strategy.

Implementing this feature necessitates a sophisticated game design that carefully balances risk and reward. The cost of the Advantage Spin, determined by algorithms, must reflect the potential payout, ensuring it remains an enticing yet calculated risk for the player. Game developers must also consider the frequency and conditions under which the “Advantage Spin” symbol appears, to maintain game balance and player engagement.

From a technical perspective, the feature may leverage RNG (Random Number Generator) algorithms to determine the occurrence of the Advantage Spin symbol, ensuring fairness and unpredictability. Additionally, integrating player statistics and behavior analysis may tailor the appearance rates and pricing dynamically, enhancing the personalized gaming experience.

The strategic Advantage Spin option not only enriches the gameplay experience but also introduces a new layer of engagement. Players are encouraged to think critically about their gaming strategies, potentially leading to a more immersive and rewarding experience. This feature may significantly increase session lengths and player retention rates, as the allure of strategic control and the potential for increased winnings keeps players engaged.

Furthermore, the strategic Advantage Spin option has implications for game design and marketing. By offering players more control over their gaming outcomes, developers may differentiate their games in a competitive market. Marketing efforts may highlight this feature to attract players seeking games that may may require skill and strategy, in addition to luck.

In summary, the strategic Advantage Spin option is a transformative feature that redefines player interaction with slot games. By blending strategy with chance, it creates a compelling gameplay experience that may appeal to a broader audience, including those who may not have been interested in traditional slot games.

### Line and Symbol Selection

The “Advantage Spin” elevates player engagement by enabling the selection of specific lines or symbols for a re-spin. This granular level of control allows players to directly influence the game outcome by targeting combinations they perceive as most beneficial. This feature not only diversifies gameplay but also deepens the strategic elements within slot gaming, encouraging players to develop and employ tactics based on game patterns and their understanding of symbol values.

To implement this feature effectively, game developers need to design a user interface that is intuitive yet comprehensive, allowing players to easily select lines or symbols without detracting from the game flow. This may involve interactive elements on the screen that highlight potential combinations or use haptic feedback to enhance the selection process.

Behind the scenes, the game's algorithm must account for the variability introduced by player choices, ensuring that the odds and payouts remain balanced and fair. This may involve complex probability calculations and adaptive game mechanics that respond to player selections in real time.

The line and symbol selection feature also opens up avenues for personalized gaming experiences. By tracking player choices and outcomes, games may offer tailored suggestions or unlock special features based on individual play styles. This not only enhances player satisfaction but also provides developers with valuable data on player preferences and behavior.

Moreover, this feature may significantly enhance the game's appeal by adding a layer of skill to what is traditionally considered a luck-based game. It may attract a wider audience, including those who prefer games where strategy influences the outcome.

In essence, the line and symbol selection feature transforms the slot game experience by introducing a strategic component that rewards player insight and decision-making. This innovation not only makes the game more engaging but also broadens its appeal, potentially attracting a new demographic of players interested in a more active role in their gaming experience.

### Flexible Activation

The “Advantage Spin” feature's flexible activation mechanism introduces a dynamic and unpredictable element to slot games, where the appearance of the Advantage Spin symbol is governed by both specific conditions and random chance. This dual-mode activation serves multiple purposes: it retains the element of surprise inherent to slot games while also providing strategic depth through condition-based triggers.

For game developers, the challenge lies in defining the conditions under which the Advantage Spin symbol appears. These conditions may be carefully calibrated to ensure they are attainable yet challenging, encouraging players to stay engaged in the pursuit of meeting these criteria. The randomness factor must also be finely tuned, ensuring that the game remains fair and unpredictable, preventing any patterns that may be exploited by players.

From a technical standpoint, flexible activation may may require a robust game engine capable of real-time analysis of game state conditions and player actions. It must also integrate a randomization mechanism that meets regulatory standards for fairness and unpredictability. Implementing such a system may involve sophisticated software engineering techniques, including state machines for tracking game conditions and advanced RNG algorithms.

The flexible activation feature enhances player engagement by creating a game environment that is ever-changing and full of possibilities. Players must adapt their strategies based on both the game's current state and the potential for random opportunities, making each play session unique.

Additionally, this feature may significantly impact player retention and game monetization. By providing varied and unpredictable game experiences, players are to spend more time and potentially more money on the game. The anticipation of a randomly appearing Advantage Spin symbol or meeting specific conditions for its activation adds to the game's excitement and replay value.

In conclusion, flexible activation enriches the slot gaming experience by blending strategy with the randomness characteristic of slot games. It challenges players to stay engaged and adapt their strategies, providing a more rewarding and immersive gameplay experience.

### Opt-Out Option

Incorporating an opt-out option within the “Advantage Spin” feature demonstrates a player-centric approach to game design, recognizing and respecting the diversity of player preferences and risk tolerances. This option allows players to decline the Advantage Spin, offering a pathway to return to the standard gameplay without penalization. This flexibility is notable for fostering a comfortable and customizable gaming environment where players feel in control of their gaming experience.

Implementing an opt-out feature may may require careful consideration of user interface design to ensure that players are clearly informed of their options and may make their choice effortlessly. It also necessitates backend logic that seamlessly transitions players between game modes based on their selections, maintaining the game's flow and integrity.

The opt-out option has significant implications for player engagement and satisfaction. By empowering players to make choices that align with their personal gaming strategies and comfort levels, developers may cater to a broader audience. This inclusivity may lead to increased player retention and a positive gaming experience that encourages players to return.

Moreover, the opt-out feature aligns with responsible gaming practices by allowing players to set their boundaries within the game. It may be particularly appealing to players who are cautious about engaging in features that may may require additional bets or those who prefer a more traditional slot gaming experience.

Overall, the opt-out option is a testament to the game's design flexibility, showing that player agency is a priority. It enhances the gaming experience by providing players with the autonomy to tailor their gameplay, ensuring that the game remains accessible and enjoyable to a wide range of players.

### Enhanced Player Engagement

The “Advantage Spin” feature significantly boosts player engagement by introducing dynamic and interactive elements into slot gaming. This engagement is not merely about the possibility of additional spins but stems from the broader context of decision-making, strategy, and personalization these options present. Players are no longer passive participants; they are actively involved in crafting their game journey. The anticipation and excitement generated by the potential for Advantage Spins elevate the slot experience from a purely chance-based endeavor to one that incorporates elements of skill and strategy. This feature naturally increases the time players spend engaged with the game, enhancing their overall experience and potentially leading to greater player loyalty.

The strategic decisions involved—such as when to opt for an Advantage Spin, which lines or symbols to select, and whether to engage the feature at all—add a layer of complexity and depth to the gameplay. This complexity appeals to both casual and serious gainers by offering varied levels of engagement depending on the player's interest and skill level.

Moreover, the enhanced player engagement facilitated by the “Advantage Spin” feature may lead to higher retention rates. Players are more to return to a game that offers them control over their gameplay and the opportunity to employ personal strategies. This increased engagement also opens up new avenues for game developers to introduce targeted promotions and rewards that further incentivize player participation.

In fostering a more interactive and engaging slot gaming environment, the “Advantage Spin” feature not only redefines player expectations but also sets a new standard for slot game design. This innovation underscores the importance of player-centric design in the development of casino games, ensuring that the gaming experience is both enjoyable and rewarding.

### Re-Spin Conditions

In at least one embodiment, the Advantage Spin system incorporates predetermined conditions that trigger eligibility for a re-spin opportunity. These conditions are designed to enhance player engagement by introducing moments of heightened anticipation and excitement during gameplay. For example, a re-spin opportunity may be triggered following a near-miss event where a player comes close to securing a winning combination or after a specific in-game milestone is reached, such as completing a predefined number of spins. By strategically leveraging these conditions, the system encourages players to remain engaged with the game, fostering prolonged gameplay and a more immersive experience.

The Electronic Gaming Machine (EGM) identifies these triggering conditions through continuous real-time monitoring of the game state. Game state analysis is conducted by an intelligent game controller, which tracks variables such as symbol alignments, reel positions, and player actions. Upon identifying an eligible condition, the system prompts the player with the option to execute a re-spin using Advantage Spin credits. This feature not only adds a layer of strategic decision-making but also enhances the entertainment value by providing players with an additional chance to influence the game outcome.

### Credit Deduction Methods

The Advantage Spin system implements a versatile framework for funding re-spin opportunities, accommodating a variety of credit sources to suit diverse player preferences. Players may use the following methods to fund re-spins:
1. Inserting Normal Slot Tickets: Players may utilize traditional slot tickets issued by the Casino's Content Management System (CMS). The EGM reads these tickets through its bill validator, verifies their authenticity via communication with the CMS, and converts the associated monetary value into Advantage Spin credits for use in re-spin opportunities.
2. Advantage Spin Tickets: The system supports specialized “Advantage Spin” tickets generated by the Advantage Spin Credit Management System. These tickets contain pre-loaded Advantage Spin credits. Upon insertion into the EGM's bill validator, the system authenticates and validates the tickets, subsequently adding the specified credit amount to the player's Advantage Spin meter.
3. Cash In: Players may directly deposit cash into the EGM, which is processed by the bill validator and converted into Advantage Spin credits. The system ensures real-time credit updates to the Advantage Spin meter, enabling immediate use for gameplay.
4. Membership Card Deduction: The Advantage Spin system integrates seamlessly with player membership cards. It allows players to deduct re-spin costs from their loyalty points or a separate Wallet balance stored on the card. This integration enhances the overall convenience and accessibility of the feature while promoting the use of casino loyalty programs. The system communicates with the player tracking server to verify available balances, deduct the appropriate amount, and update the Advantage Spin meter.

By offering multiple funding methods, the system ensures broad accessibility and flexibility, catering to the varying preferences and credit sources of players.

### Membership Card Integration

In at least one embodiment, the Advantage Spin system is integrated with player membership cards, offering a streamlined and personalized experience. Players may use their membership cards to access their loyalty points or dedicated Wallet balances for funding re-spin activities. The EGM interfaces with the player tracking system to retrieve relevant account information, such as available balances and transaction histories.

When a player opts to use credits from their membership card, the system verifies the sufficiency of the available balance. Upon successful verification, the appropriate amount is deducted, and the remaining balance is updated both on the membership card and within the player tracking system. This integration allows for seamless credit management and enhances the value of loyalty programs by encouraging players to engage with the casino's broader ecosystem.

Moreover, the use of membership cards for credit transactions enables casinos to track player activity more effectively. This data may be leveraged for analytics, targeted promotions, and personalized offers, thereby strengthening player loyalty and retention.

By combining these features, the Advantage Spin system delivers a comprehensive and engaging gaming experience, benefiting both players and casino operators. It enhances gameplay interactivity, offers flexible credit management, and integrates seamlessly with existing casino systems, making it a highly versatile and innovative addition to the gaming industry.

Membership Card Integration with Physical and Digital Cards

In at least one embodiment, the Advantage Spin system supports both physical and digital membership cards, ensuring broad accessibility and convenience for players. This dual-mode compatibility allows players to use their preferred card format for engaging with the system, whether through a tangible card or a digital equivalent stored on a mobile device or accessed via a dedicated casino application.

For physical membership cards, the EGM includes a card reader capable of scanning and authenticating the card. When inserted, the system retrieves the player's account information, including loyalty points and Wallet balances, through communication with the casino's player tracking system. Transactions such as credit deductions for Advantage Spin usage are processed in real-time, with updates reflected on both the card and the system.

For digital membership cards, the Advantage Spin system employs secure mobile device integration. Digital cards are typically accessed through a casino-provided mobile application or wallet service. Players may interact with the EGM by scanning a QR code displayed on the EGM screen, using Near-Field Communication (NFC) technology, or logging into their accounts via a touchscreen interface on the EGM. Once authenticated, the system establishes a secure connection to the player tracking server, enabling the same functionality as with physical cards, including balance retrieval, credit deduction, and real-time updates.

The inclusion of digital card support enhances the player experience by allowing cardless interaction and reducing the need to carry physical cards. It also opens opportunities for advanced features, such as push notifications for Advantage Spin offers, mobile balance top-ups, and the ability to remotely view transaction histories and game analytics.

By accommodating both physical and digital formats, the Advantage Spin system ensures that players may seamlessly interact with the system regardless of their card preference. This flexibility aligns with modern consumer expectations and supports the growing trend of digital transformation within the gaming and entertainment industry.

### Re-Spin Using Advantage Spin Credits (Advantage Spin)

The Advantage Spin system implements a novel framework for enabling players to initiate selective re-spins of specific reels or symbols during slot machine gameplay through the use of Advantage Spin credits. This system introduces an additional layer of strategic depth to traditional slot machine gameplay by allowing players to leverage accumulated Advantage Spin credits to target specific game elements for re-spinning when potentially advantageous situations arise during gameplay. The Electronic Gaming Machine (EGM) incorporates specialized metering and credit tracking functionality to maintain separate balances for standard game credits and Advantage Spin credits, with the Advantage Spin credit meter displaying the current quantity of available Advantage Spin credits that may be used for re-spin opportunities.

The re-spin functionality is implemented through modifications to the EGM's game logic and display systems. When a player elects to use Advantage Spin credits for a re-spin, the system first validates that sufficient credits are available in the Advantage Spin credit meter. Upon confirmation, the EGM's game controller initiates a targeted re-spin sequence for the selected reel or symbol while maintaining the positions of all other non-selected game elements. This selective re-spin capability is achieved through the EGM's random number generator (RNG) and reel control systems, which are configured to independently control and re-spin individual reels or update specific symbol positions while preserving the game's overall mathematical model and regulatory compliance.

The system provides direct benefits to players by offering increased agency and strategic decision-making opportunities during gameplay. Players may choose to save their Advantage Spin credits for optimal moments or use them immediately when potentially profitable re-spin opportunities arise. This enhanced control over gameplay outcomes creates a more engaging and interactive gaming experience while maintaining the fundamental random nature of slot machine outcomes. For casino operators, the Advantage Spin system serves as a powerful tool for player retention and engagement. The ability to award and manage Advantage Spin credits provides casinos with additional mechanisms for player rewards and promotional activities, while the system's integration with existing player tracking and accounting systems ensures accurate tracking and reporting of all Advantage Spin credit transactions.

### Hybrid Offer Mechanism

The Hybrid Offer Mechanism represents an advanced system for presenting players with multiple concurrent re-spin opportunities during gameplay. This mechanism dynamically generates and displays various re-spin options, each with distinct credit costs and potential rewards, allowing players to evaluate and select their preferred re-spin strategy. The system utilizes real-time game state analysis to identify situations where multiple potentially advantageous re-spin opportunities exist simultaneously, such as when different combinations of reel or symbol re-spins may lead to various winning combinations.

The offer generation system employs sophisticated algorithms to analyze the current game state, calculating potential outcomes and appropriate credit costs for different re-spin combinations. These algorithms consider factors such as the current symbol positions, potential winning combinations, and the game's paytable to determine the relative value and pricing of each re-spin option. The EGM's display system presents these concurrent offers through an intuitive user interface that clearly communicates the credit cost and maximum potential win amount for each re-spin option, enabling players to make informed decisions about their re-spin choices.

The implementation of concurrent offers is achieved through the EGM's game controller, which manages multiple potential game states simultaneously while maintaining the integrity of the game's random number generation and prize determination systems. When a player selects a specific offer, the system executes the corresponding re-spin action while ensuring all other game elements remain unchanged. This selective re-spin capability is made possible through specialized reel control systems that allow independent manipulation of individual reels or symbols based on player selection.

From a player perspective, the Hybrid Offer Mechanism enhances the gaming experience by providing greater strategic depth and decision-making opportunities. Players may evaluate multiple re-spin options simultaneously, weighing the credit costs against potential rewards to select the option that best aligns with their gaming strategy and risk preferences. For casino operators, this mechanism increases player engagement and time on device while providing additional opportunities for players to utilize their Advantage Spin credits, potentially driving increased gameplay and revenue.

### Player-Directed Credit Usage

The Player-Directed Credit Usage system implements a comprehensive framework enabling players to exercise direct control over their Advantage Spin credits during gameplay. This system empowers players with the autonomy to strategically deploy their accumulated credits for specific re-spin actions at times of their choosing. The implementation integrates deeply with the EGM's credit management and game control systems to facilitate seamless credit usage while maintaining accurate accounting and regulatory compliance.

The system incorporates sophisticated credit tracking mechanisms that maintain real-time balances of different credit types including Advantage Spin credits, game credits, and any other specialized credit categories. When opportunities for credit usage arise, such as after near-miss outcomes, the EGM's interface presents players with detailed information about their credit balances and available re-spin options. Each presented option includes specific credit costs and potential reward amounts, enabling informed decision-making. For example, the system may display options such as “Respin Reel #2 for 2 credits—Potential Win up to $7000” or “Respin Symbol #11 for 5 credits—Potential Win up to $9000.”

The implementation leverages the EGM's game controller and user interface systems to process player inputs and execute selected re-spin actions. When a player chooses to use credits for a specific re-spin, the system first validates the availability of sufficient credits, deducts the appropriate amount from the player's balance, and then initiates the selected re-spin sequence. The credit management system maintains detailed transaction logs of all credit usage, ensuring accurate tracking and reporting for both player accounts and casino operations.

### Symbol or Reel Holding Feature

The Symbol or Reel Holding Feature introduces an advanced gameplay mechanic that enables players to selectively hold specific symbols or entire reels in position while re-spinning the remaining elements. This sophisticated system enhances the strategic depth of re-spin opportunities by allowing players to preserve advantageous symbols or reel positions while seeking improved outcomes through targeted re-spins of non-held elements. The feature integrates with the EGM's game control and display systems to provide intuitive symbol/reel selection and clear visual feedback of held positions.

The implementation utilizes specialized reel control mechanisms that may independently manage the motion states of individual reels and symbols. The system's user interface allows players to designate specific symbols or reels to be held in position, visually highlighting selected elements to confirm their held status. When a re-spin is initiated, the game controller ensures that held elements remain fixed while other elements undergo the standard random re-spin process. This selective re-spin capability maintains the integrity of the game's random number generation while providing players with enhanced control over specific game elements.

The system supports both single and multiple hold selections, allowing players to implement complex strategies involving multiple held positions across different reels. The implementation carefully manages the mathematical impact of held positions on game outcomes, ensuring that the overall return-to-player percentages remain within regulatory requirements while providing meaningful strategic opportunities to players.

### AI-Driven Re-Spin Opportunities

The AI-Driven Re-Spin Opportunities system implements sophisticated artificial intelligence and machine learning algorithms to analyze real-time game states, identify strategically advantageous re-spin opportunities, and generate personalized re-spin offers for players. This intelligent system continuously monitors gameplay, evaluating symbol positions, potential winning combinations, and near-miss scenarios to determine optimal moments for presenting re-spin opportunities to players.

The implementation utilizes advanced pattern recognition and probabilistic analysis algorithms to assess the current game state and calculate the potential value of different re-spin options. The system considers multiple factors including the current symbol configuration, possible winning combinations, associated prize values, and the player's gaming history to generate targeted re-spin offers. These offers are dynamically priced based on the calculated probability of achieving specific outcomes and the potential return value of successful re-spins.

The AI component employs machine learning techniques to continuously refine its analysis and offer generation capabilities based on aggregate player response data and outcome statistics. This learning capability enables the system to improve its ability to identify and present the most compelling re-spin opportunities to players while maintaining fair and transparent gameplay mechanics. The system integrates with the EGM's display and user interface components to present AI-generated offers in an intuitive and engaging manner, clearly communicating the specific reels or symbols targeted for re-spin, the required credit cost, and the potential rewards available.

### Multiple Pricing Structures for Re-Spins

The Multiple Pricing Structures for Re-Spins system implements a dynamic and flexible framework for calculating and assigning credit costs to different types of re-spin opportunities. This sophisticated pricing system supports various pricing models including fixed-price packages for multi-reel or multi-symbol re-spins, as well as a la carte pricing for individual reel or symbol re-spins. The implementation utilizes advanced pricing algorithms that consider multiple factors including the game's current state, potential winning combinations, and the strategic value of specific re-spin options.

The pricing system incorporates both predetermined and dynamically calculated pricing models. Fixed price offers may be configured for common re-spin combinations or promotional packages, while dynamic pricing adjusts credit costs based on real-time analysis of game conditions and potential outcomes. The system supports complex pricing structures such as volume discounts for multiple re-spins or special pricing for specific game states or player segments. All pricing calculations are performed by the EGM's game controller in real-time, ensuring that credit costs are appropriate for the current game state and potential rewards.

The implementation includes sophisticated accounting and tracking mechanisms to manage different credit types and pricing structures simultaneously. The system maintains detailed records of all pricing decisions and credit transactions, enabling comprehensive reporting and analysis of re-spin pricing effectiveness. The pricing information is presented to players through the EGM's user interface in a clear and transparent manner, displaying both the credit cost and potential rewards for each re-spin option to facilitate informed player decisions.

### Hybrid Concurrent Offer System

The Hybrid Concurrent Offer System implements an advanced framework for simultaneously presenting multiple re-spin opportunities to players during gameplay. This system integrates complex game state analysis with dynamic offer generation to create a diverse array of concurrent re-spin options combining both reel and symbol-based opportunities. The implementation utilizes sophisticated display management and offer tracking systems to present these multiple options clearly and manage player selections effectively.

The system analyzes the current game state in real-time to identify all viable re-spin opportunities, calculating potential outcomes and appropriate credit costs for each option. For each identified opportunity, the system generates a detailed offer specification including the target reel(s) or symbol(s), required credit cost, and maximum potential win amount. These offers are aggregated into a comprehensive offer set that is presented to the player through the EGM's user interface. The implementation ensures that all concurrent offers remain valid and available until the player makes a selection or the offer timeout period expires.

The system incorporates advanced state management capabilities to maintain multiple potential game states simultaneously, enabling it to accurately predict and display the potential outcomes for each offer. When a player selects a specific offer, the system executes the chosen re-spin action while ensuring all other game elements remain unaffected. The implementation maintains detailed transaction logs of all offer presentations and selections, providing valuable data for analyzing player preferences and optimizing future offer generation.

### Player-Directed Re-Spin Control

The Player-Directed Re-spin Control system implements comprehensive functionality enabling players to exercise precise control over re-spin activities during gameplay. This system provides players with the ability to specifically select individual reels or symbols for re-spinning, as well as designate certain symbols to be held in position while others are re-spun. The implementation integrates deeply with the EGM's game control and user interface systems to provide intuitive selection mechanisms and clear visual feedback.

The system utilizes sophisticated input processing and selection management components to handle player interactions with the re-spin interface. Players may directly select target reels or symbols through touch screen interactions or button inputs, with the system providing immediate visual confirmation of selections through highlighting or other visual indicators. The implementation includes robust validation logic to ensure all player selections are valid within the current game state and credit availability constraints.

The system manages the consumption of Advantage Spin credits based on player selections, automatically calculating and deducting the appropriate credit amount for the chosen re-spin action. The implementation carefully tracks all credit transactions and maintains detailed logs of all player-directed re-spin activities. When executing player-selected re-spins, the system ensures that only the specifically chosen elements are affected while maintaining the position and state of all other game elements.

### Intelligent Game State Analysis

The Intelligent Game State Analysis system implements sophisticated real-time analysis capabilities to evaluate game states and identify strategic re-spin opportunities. This system continuously monitors the game state, analyzing symbol positions, potential winning combinations, and near-miss scenarios to detect conditions that may warrant presenting re-spin offers to players. The implementation utilizes advanced pattern recognition and probability analysis algorithms to assess the strategic value of potential re-spin opportunities.

The system performs complex calculations to determine the optimal re-spin options based on the current game state, including analyzing potential winning combinations, calculating probability-weighted potential outcomes, and determining appropriate credit costs for different re-spin options. These calculations consider multiple factors including the game's paytable, symbol positions, and potential prize values to generate precisely targeted re-spin offers. The implementation includes specialized optimization algorithms to perform these calculations efficiently in real-time without introducing noticeable delays in gameplay.

The analysis system integrates with the EGM's offer generation components to translate identified opportunities into specific re-spin offers for players. Each generated offer includes detailed specifications of credit costs and potential win amounts based on probabilistic analysis of possible outcomes. The implementation maintains comprehensive logs of all analysis activities and resulting offer generations, providing valuable data for system optimization and regulatory compliance verification.

### Multiple Offer Types

The Multiple Offer Types system implements a diverse framework of re-spin offer categories tailored to different player preferences and strategic objectives. This system supports various offer configurations including reel-only re-spins, symbol-only re-spins, combined reel and symbol re-spins, and multi-reel/multi-symbol package offers. The implementation utilizes sophisticated offer generation and management components to create and present these varied offer types while maintaining clear distinction between different offer categories.

The system incorporates specialized logic for generating each offer type, considering the unique characteristics and requirements of reel-based versus symbol-based re-spins. For reel-only offers, the system calculates potential outcomes based on complete reel strip configurations, while symbol-specific offers focus on individual symbol positions and their potential combinations. Package offers combine multiple re-spin opportunities into cohesive bundles with optimized pricing and enhanced winning potential. The implementation includes robust validation mechanisms to ensure all generated offers comply with game rules and regulatory requirements.

The system manages the presentation of different offer types through an intuitive user interface that clearly communicates the specific characteristics and requirements of each offer. Visual indicators and descriptive text help players understand the distinctions between offer types and their respective strategic implications. The implementation maintains detailed tracking of offer type performance and player preferences, enabling continuous optimization of the offer type mix and presentation strategies.

### Symbol Hold Features

The Symbol Hold Features system implements advanced functionality enabling players to selectively maintain specific symbols in position while initiating re-spins of other game elements. This system supports various hold configurations including single symbol holds on individual reels, multiple symbol holds on a single reel, and coordinated symbol holds across multiple reels. The implementation utilizes sophisticated state management and reel control mechanisms to maintain held symbols while executing re-spins of non-held elements.

The system incorporates specialized selection interfaces allowing players to designate symbols for holding through direct touch screen interaction or button inputs. Visual indicators clearly highlight held symbols and provide immediate feedback on hold selections. The implementation includes validation logic to ensure hold selections comply with game rules and maintain mathematical integrity of game outcomes. When executing re-spins, the system carefully preserves the position and state of all held symbols while allowing other positions to undergo random re-spin operations.

### Credit Cost Structures

The Credit Cost Structures system implements a comprehensive framework for managing and calculating costs associated with various re-spin activities. This system supports multiple pricing models including fixed pricing for pre-configured re-spin packages, dynamic pricing based on win potential, and variable pricing tied to game bet denominations. The implementation incorporates sophisticated pricing algorithms that consider multiple factors when determining appropriate credit costs for different re-spin opportunities.

The system utilizes real-time analysis of game states and potential outcomes to calculate dynamic pricing for re-spin offers. These calculations consider factors such as the current symbol configuration, potential winning combinations, and associated prize values to determine appropriate credit costs. For bet denomination-based pricing, the system automatically scales credit costs in proportion to the player's selected bet level, ensuring that re-spin costs remain appropriately balanced relative to potential rewards. The implementation includes specialized optimization routines to perform these calculations efficiently without impacting game performance.

The system maintains detailed tracking of all credit cost calculations and transactions, enabling comprehensive analysis of pricing effectiveness and player response patterns. This data collection supports continuous refinement of pricing strategies while ensuring compliance with regulatory requirements for game accounting and reporting. The implementation presents credit costs to players through clear visual displays that show both the required credit amount and potential rewards for each re-spin option.

### AI/Machine Intelligence Features

The AI/Machine Intelligence Features system implements sophisticated artificial intelligence capabilities for analyzing gameplay patterns and generating strategic re-spin recommendations. This system continuously monitors game states and outcomes, utilizing advanced pattern recognition and machine learning algorithms to identify advantageous re-spin opportunities and generate targeted offers. The implementation leverages real-time data analysis to provide personalized recommendations based on current game conditions and historical play patterns.

The system employs multiple analysis techniques to evaluate game states and generate recommendations. Pattern recognition algorithms identify potentially profitable re-spin opportunities by analyzing symbol configurations and potential winning combinations. Machine learning components analyze aggregate player behavior data to refine offer generation strategies and improve recommendation accuracy over time. The implementation includes specialized optimization routines to perform these complex calculations efficiently in real-time.

The system integrates AI-driven insights with the EGM's user interface to present recommendations in an intuitive and non-intrusive manner. Visual indicators highlight recommended re-spin options while displaying relevant information about credit costs and potential rewards. The implementation maintains comprehensive logs of AI analysis activities and recommendation effectiveness, enabling continuous improvement of the recommendation engine through machine learning updates.

### User Interface Elements

The User Interface Elements system implements a comprehensive set of visual and interactive components specifically designed to facilitate player interaction with re-spin features. This system provides clear visual feedback for all re-spin-related activities including highlighting of re-spinnable reels or symbols, display of credit costs and potential wins, and presentation of time-limited offer countdowns. The implementation utilizes sophisticated graphics rendering and input processing components to create an intuitive and responsive user experience.

The system incorporates dynamic highlighting mechanisms to clearly indicate which reels or symbols are available for re-spinning at any given time. These visual indicators adjust in real-time based on credit availability and game state conditions. The implementation includes specialized display components for presenting detailed information about credit costs and potential wins, ensuring players have access to all relevant information when making re-spin decisions. For time-limited offers, the system provides clear countdown indicators that show the remaining time available for offer acceptance.

The system manages all player inputs related to re-spin activities through an intuitive control interface. Touch screen interactions and button inputs are processed through robust input validation routines to ensure accurate interpretation of player intentions. The implementation includes sophisticated state management to maintain consistent and accurate display of all interface elements throughout the gaming session.

### Win Potential Analysis

The Win Potential Analysis system implements advanced analytical capabilities for calculating and displaying potential outcomes of different re-spin options. This system performs real-time analysis of game states to determine maximum possible win amounts, evaluate winning probabilities, and identify optimal re-spin combinations. The implementation utilizes sophisticated probability calculations and pattern matching algorithms to provide accurate assessments of potential outcomes.

The system continuously monitors the game state and performs complex calculations to determine potential winning combinations and their associated probabilities. These calculations consider the current symbol configuration, possible re-spin outcomes, and the game's paytable to generate accurate estimates of potential wins. The implementation includes specialized optimization routines for efficient processing of these calculations to provide real-time updates as game conditions change.

The system manages the dynamic display of win potential information through dedicated user interface components. Clear visual indicators show maximum potential win amounts and update automatically as players explore different re-spin options or modify held symbols. The implementation maintains detailed logs of win potential calculations and actual outcomes, enabling continuous refinement of the analysis algorithms and verification of calculation accuracy.

### Credit Management

The Credit Management system implements comprehensive functionality for tracking and managing different types of credits used in the Advantage Spin framework. This system maintains separate tracking for Advantage Spin credits, game credits, and other credit types while ensuring seamless integration with player accounts and TITO systems. The implementation provides persistent credit tracking across multiple gaming sessions and venues through sophisticated database management and synchronization mechanisms.

The system employs real-time credit balance monitoring and automatic updating of credit displays whenever credit balances change due to gameplay actions or credit transfers. When players initiate re-spin activities, the system automatically validates credit availability and deducts appropriate amounts from the relevant credit balance. The implementation includes specialized transaction processing components that ensure accurate credit accounting while maintaining detailed audit trails of all credit movements. The system integrates with the casino's player tracking infrastructure to synchronize credit balances across multiple EGMs and gaming sessions.

The system provides robust credit management interfaces that clearly display current balances for all credit types and update in real-time as credits are earned or consumed. The implementation includes sophisticated credit transfer mechanisms enabling players to move credits between different accounts or credit types according to casino-defined rules and conversion rates. All credit management activities are logged in detail to support comprehensive reporting and regulatory compliance requirements.

### Casino-Controlled Allocation of Advantage Spin Credits

The Casino-Controlled Allocation system implements a centralized framework enabling casino operators to strategically distribute and manage Advantage Spin credits across their gaming floor. This system provides sophisticated tools for creating and managing promotional campaigns that award Advantage Spin credits based on specific gaming machines, game themes, or player segments. The implementation integrates with casino management systems to enable real-time control and monitoring of credit allocation activities.

The system incorporates advanced rule processing engines that evaluate complex criteria to determine when and how Advantage Spin credits should be awarded. These rules may consider factors such as time of day, machine utilization rates, player status levels, and specific game performance metrics. The implementation includes specialized campaign management components that enable operators to create and modify credit allocation rules in real-time, allowing rapid adjustment of promotional strategies based on observed results.

The system manages the distribution of allocated credits through integration with player tracking and TITO systems. When allocation rules trigger credit awards, the system automatically credits the appropriate player accounts or generates credit vouchers according to campaign specifications. The implementation maintains comprehensive tracking of all allocation activities, enabling detailed analysis of promotional effectiveness and regulatory compliance verification.

### Cross-Theme Advantage Spin Credit Usage

The Cross-Theme Credit Usage system implements functionality enabling players to utilize Advantage Spin credits earned on one game theme across multiple different games within the casino's network. This system maintains centralized tracking of credit balances while managing complex rules governing credit transfer and usage across different game themes. The implementation provides seamless credit portability while ensuring appropriate credit value adjustments based on different game characteristics.

The system employs sophisticated credit conversion mechanisms to handle transitions between games with different credit requirements or bet denominations. When players move between games, the system automatically calculates appropriate credit conversions while maintaining overall credit value equity. The implementation includes specialized validation routines that ensure credits are only used on approved game themes according to casino-defined rules and regulatory requirements.

The system provides clear user interfaces that inform players about credit availability and usage rules when switching between game themes. The implementation maintains detailed tracking of all cross-theme credit movements, enabling comprehensive analysis of player behavior patterns and verification of proper credit handling across different games. The system integrates with the casino's game management infrastructure to ensure consistent credit handling across all participating game themes.

### Dynamic Promotional Campaigns

The Dynamic Promotional Campaigns system implements advanced functionality for creating and managing targeted promotional activities involving Advantage Spin credits. This system enables casino operators to dynamically adjust promotional offers based on real-time analysis of gaming floor activity and player behavior patterns. The implementation integrates sophisticated analytics capabilities with promotional rule processing to optimize campaign effectiveness.

The system incorporates real-time monitoring of various performance metrics including machine utilization rates, player engagement levels, and revenue patterns. Based on this analysis, the system automatically adjusts promotional parameters such as credit award rates, eligible machines, and qualification criteria. The implementation includes specialized campaign management tools that enable operators to define complex promotional rules incorporating multiple trigger conditions and reward structures. The system supports automated campaign optimization through continuous analysis of campaign performance metrics and automatic adjustment of promotional parameters to achieve desired outcomes.

### Thematic Credit Restriction Mechanisms

The Thematic Credit Restriction Mechanisms system implements sophisticated controls for managing the usage of Advantage Spin credits across different machines and game themes based on casino-defined policies and promotional strategies. This system provides granular control over credit usage permissions, enabling operators to create targeted promotional experiences while maintaining strategic control over gaming floor dynamics. The implementation integrates with the casino's game management and player tracking systems to enforce credit usage rules consistently across all participating machines.

The system employs advanced rule processing engines that evaluate multiple criteria when determining credit usage eligibility. These rules may consider factors such as game theme characteristics, machine locations, time periods, and player segment classifications. The implementation includes specialized configuration tools that enable operators to define and modify credit restriction rules in real-time, supporting dynamic adjustment of promotional strategies. The system maintains comprehensive tracking of all credit usage attempts, including both approved and restricted transactions, to support detailed analysis of restriction effectiveness.

The system provides clear communication of credit usage restrictions through the EGM interface, ensuring players understand where and when their Advantage Spin credits may be used. When players attempt to use credits on restricted machines or themes, the system provides informative feedback explaining the restriction and suggesting alternative options where available. The implementation integrates with promotional campaign management systems to coordinate credit restrictions with broader marketing initiatives.

### Player Account Integrations

This inventive feature integrates Advantage Spin (AVS) credits with players' accounts, allowing for seamless credit management and enhanced personalization. The system ensures persistent credit balances across gaming sessions and venues while enabling detailed tracking of credit transactions.

Through their player accounts, players may view their AVS credit balances, transaction history, and promotional eligibility via EGMs, mobile apps, or kiosks. Credits earned from gameplay or promotions are directly stored in the account, ensuring they remain accessible regardless of the player's location or the specific EGM used. Account-based integration also supports credit transfers, such as moving credits between EGMs or to mobile wallets.

The system employs secure authentication protocols to protect account data, ensuring credits are only accessible to authorized users. Casinos may implement additional features, such as alerts when credits approach expiration or notifications of available promotions tailored to the player's gaming history.

This feature benefits players by offering flexibility and transparency in managing their credits while fostering a personalized gaming experience. For casinos, player account integration provides a centralized system for tracking and analyzing player behavior, supporting data-driven decision-making and targeted marketing strategies.

The integration of the Advantage Spin system with casino player tracking systems enable seamless accumulation and redemption of Advantage Spin (AVS) credits. These credits may be utilized for re-spins or converted into other gaming assets, such as loyalty points or cash equivalents. This integration promotes a unified ecosystem, ensuring players derive value from both their gameplay and non-gaming interactions within the casino.

The system operates by linking each player's activity on an Electronic Gaming Machine (EGM) to their player account. This connection enables the system to monitor gameplay events, such as the completion of a specific number of spins or the achievement of near-miss scenarios, and subsequently allocate AVS credits to the player's account. The AVS credits are stored persistently within the player tracking system, ensuring their availability across different gaming sessions or venues. For instance, if a player earns credits during a slot session at one casino, they may later redeem these credits for gameplay or other benefits at an affiliated casino.

When a player chooses to redeem AVS credits, the player tracking system communicates with the EGM to authorize and facilitate the transaction. This process involves validating the player's eligibility, deducting the corresponding AVS credits from their account, and triggering the desired re-spin or other gameplay enhancements. Additionally, players may have the option to convert their AVS credits into alternative rewards, such as loyalty program points or cash vouchers, broadening the utility of the credits.

The integration supports advanced personalization features. Using data from the player tracking system, the casino may tailor promotional offers to individual players based on their gaming preferences, historical behavior, and engagement patterns. For instance, a frequent slot player may receive re-spin offers optimized for their favorite game themes, while another player may be incentivized with cross-game credits to explore new games.

From the casino's perspective, this system not only enhances player engagement but also provides actionable insights into player behavior. Casinos may analyze data aggregated by the player tracking systems to refine their promotional strategies, allocate AVS credits dynamically, and ensure responsible gaming practices by setting appropriate usage caps or thresholds for high-risk players.

In at least one embodiment, this integrated approach leverages existing player tracking infrastructure to maximize the Advantage Spin system's functionality while fostering a cohesive, rewarding player experience. It highlights the dual benefit of enriching gameplay for players and enabling casinos to implement more strategic and responsive operational practices.

The Player Tracking Integration system implements comprehensive functionality for synchronizing Advantage Spin credit management with existing casino player tracking infrastructure. This system enables seamless tracking of credit earning, usage, and conversion activities while maintaining detailed player history records. The implementation provides real-time synchronization of credit balances and transaction data across all connected systems.

The system utilizes sophisticated data management components to maintain consistent credit balance information across multiple touch points including EGMs, player tracking displays, and mobile applications. When credit balances change due to gameplay or promotional awards, the system ensures immediate updates across all connected interfaces. The implementation includes specialized transaction processing routines that maintain detailed audit trails of all credit-related activities while ensuring accurate accounting across all integrated systems.

The system supports comprehensive player history tracking, maintaining detailed records of credit earnings, usage patterns, and conversion activities. This historical data enables sophisticated player analysis and personalization of promotional offers. The implementation includes advanced reporting capabilities that provide operators with detailed insights into player engagement patterns and promotional effectiveness across different player segments.

### TITO-Based Distribution of Promotional Credits

The TITO-Based Distribution system implements advanced functionality for issuing and managing Advantage Spin credits through the casino's existing Ticket In/Ticket Out infrastructure. This system enables the generation and processing of specialized TITO vouchers that carry Advantage Spin credit values, providing a familiar and convenient mechanism for credit distribution. The implementation integrates with existing TITO systems while maintaining separate tracking for Advantage Spin credit transactions.

The system employs specialized voucher generation components that create uniquely identified Advantage Spin credit vouchers with encoded credit values and usage restrictions. When players insert these vouchers into EGMs, the system performs automated validation and credit loading operations. The implementation includes sophisticated security measures to prevent voucher fraud while maintaining detailed tracking of all voucher transactions. The system supports various voucher types including fixed-value promotional vouchers and dynamic-value cashout vouchers.

The system manages the complete lifecycle of Advantage Spin credit vouchers from initial generation through final redemption. All voucher transactions are logged in detail to support comprehensive auditing and regulatory compliance requirements. The implementation includes specialized reporting capabilities that enable operators to track voucher distribution patterns and analyze promotional effectiveness across different player segments and time periods.

### Real-Time Analytics for Promotion Optimization

The Real-Time Analytics system implements sophisticated monitoring and analysis capabilities for optimizing the distribution and usage of promotional Advantage Spin credits. This system continuously analyzes gaming floor activity patterns and player responses to promotional offerings, enabling dynamic adjustment of promotional strategies. The implementation utilizes advanced data processing algorithms to identify trends and opportunities in real-time.

The system monitors multiple performance metrics including machine utilization rates, credit usage patterns, and player engagement levels. Based on this analysis, the system generates automated recommendations for adjusting promotional parameters such as credit award rates, eligible machines, and qualification criteria. The implementation includes specialized visualization tools that enable operators to monitor promotion performance in real-time and make informed decisions about promotional adjustments. The system maintains comprehensive historical data to support trend analysis and long-term optimization of promotional strategies.

### Tito Integration for Advantage Spin Credits

This inventive feature enables seamless integration of Advantage Spin (AVS) credits with Ticket In/Ticket Out (TITO) systems, allowing players to manage their credits through physical or digital vouchers. The system supports both issuing and redeeming TITO vouchers for AVS credits, enhancing portability and convenience.

Players may receive TITO vouchers encoded with AVS credit balances after completing gameplay or participating in promotional activities. These vouchers may be redeemed at any compatible EGM by inserting them into the bill validator. The EGM communicates with the Advantage Spin Credit Management System to validate the voucher and credit the player's account with the corresponding balance.

Additionally, the system supports cross-venue voucher redemption, allowing players to use their AVS credits at affiliated casino locations. Advanced security features ensure voucher authenticity and prevent fraud, with detailed transaction logs maintained for auditing purposes.

This feature benefits players by providing a tangible and flexible method for managing AVS credits across sessions and venues. For casinos, TITO integration enhances operational efficiency, reduces the risk of lost or unused credits, and supports a consistent player experience across multiple properties.

TITO (Ticket in/Ticket Out) Vouchers for Advantage Spin

This feature enables the use of TITO (Ticket In/Ticket Out) vouchers specifically for managing Advantage Spin (AVS) credits. Players may receive physical or digital TITO vouchers representing a balance of AVS credits, which may be redeemed at any compatible EGM within the casino or affiliated venues.

The process begins when a player engages in gameplay or non-gaming activities that award AVS credits. Instead of directly adding these credits to the EGM meter, the system issues a TITO voucher encoded with the AVS credit balance. These vouchers contain a unique identifier and validation code, ensuring their authenticity. When a player wishes to use the voucher, they insert it into an EGM's bill validator, prompting the EGM to communicate with the Advantage Spin Credit Management System for authentication.

The TITO server validates the voucher, confirms the associated AVS credit balance, and authorizes the credits to be loaded onto the EGM's AVS credit meter. Any unused credits at the end of a gaming session may be reissued as a new TITO voucher, allowing players to retain their balance for future sessions. This system ensures portability and convenience, enabling players to manage their AVS credits seamlessly across different EGMs, sessions, or venues.

The TITO voucher mechanism also supports advanced tracking and compliance. The casino management system (CMS) records all transactions involving TITO vouchers, including issuance, redemption, and reissuance. This facilitates detailed reporting and aids in adherence to gaming regulations.

From the player's perspective, TITO vouchers provide flexibility and tangible value, while the casino benefits from streamlined credit management and enhanced opportunities for targeted promotions. The system may also integrate with mobile devices, allowing players to scan vouchers or transfer balances digitally for greater convenience.

### Validation of “Advantage Spin” Tickets

The Advantage Spin system includes a robust mechanism for validating “Advantage Spin” tickets before allowing their redemption for credit. When a player inserts an Advantage Spin ticket into the EGM, the system reads the ticket's unique identification number and validation code. The EGM communicates with the Advantage Spin Credit Management System to authenticate the ticket. This process involves cross-referencing the ticket details with records stored on the server to confirm its validity, ensuring that only authorized and genuine tickets are accepted.

Upon successful validation, the system retrieves the credit value associated with the ticket and updates the Advantage Spin meter accordingly. This validation process not only prevents fraudulent activities but also ensures accurate tracking of Advantage Spin credits across all transactions.

### Tito Voucher Processing in the Advantage Spin System

### Insertion and Initial Recognition

In at least one embodiment, the processing of a Ticket-In, Ticket-Out (TITO) ticket voucher within the Advantage Spin system begins with its insertion into the Electronic Gaming Machine (EGM).
1. Physical Acceptance: The player inserts the TITO ticket into a specialized bill acceptor or ticket reader slot on the EGM. This hardware is designed to securely and reliably accept TITO tickets while ensuring consistent functionality across various machine models.
2. Optical Scanning: Once the ticket is inserted, the bill acceptor uses optical scanners to capture a high-resolution image of the ticket. This scanning process identifies and extracts notable information, including the barcode and any printed data such as the ticket value and issuing machine ID.

### Authentication and Validation Process

3. Barcode Decoding: The barcode on the TITO ticket is decoded by the EGM to retrieve desirable information, including:
   A unique ticket number
   The issuing machine's identification
   The date and time of issuance
   The monetary value printed on the ticket
4. Data Transmission: The decoded ticket information is securely transmitted to the Advantage Spin Credit Management System (ASCMS) via the EGM's encrypted network connection. This ensures the confidentiality and integrity of the transmitted data.
5. ASCMS Verification: The ASCMS validates the ticket by cross-referencing its unique identifier with entries in its database. This verification process ensures that:
   The ticket has not expired.
   The ticket has not already been redeemed.
   The ticket was issued by a machine within the casino's authorized network.
6. Anti-Fraud Checks: To maintain system integrity, the ASCMS performs anti-fraud checks. This includes analyzing the ticket for signs of tampering, duplication, or any inconsistencies that may indicate fraudulent activity.

### Value Verification

7. Database Matching: The ASCMS retrieves the monetary value associated with the unique ticket number from its database. This value is then used for further validation steps.
8. Value Comparison: The value retrieved from the database is compared against the value printed on the physical ticket. Any discrepancies between these values trigger an error handling procedure.
9. Error Handling: If a mismatch is detected or the ticket fails any of the validation checks, the system flags the ticket as invalid. Depending on the casino's configuration, the EGM may reject the ticket and notify the player, or it may alert a casino attendant for manual resolution.

### Credit Assignment

10. Machine Credit Update: Upon successful validation, the ASCMS sends a confirmation to the EGM. The EGM then updates its credit meter to reflect the value of the validated ticket.
11. Player Account Adjustment: For tickets linked to a player's Advantage Spin account, the system adjusts the account's balance accordingly. This integration supports the seamless use of TITO vouchers in conjunction with player loyalty and Advantage Spin systems.

### Record Keeping

12. Ticket Status Update: The ASCMS marks the ticket's status as “redeemed” in its database, ensuring that it cannot be used again in the future.
13. Transaction Logging: All relevant details of the transaction, including the ticket ID, validation results, credited amount, and timestamp, are logged by the ASCMS. These logs are notable for auditing, reporting, and regulatory compliance.

### Security and Compliance

Throughout the entire process, security is prioritized to prevent fraud and unauthorized access. All communication between the EGM and ASCMS is encrypted using industry-standard protocols. The system complies with gaming regulations concerning ticket validation, data retention, and reporting.

### Hardware and Software Roles

Bill Acceptor/Ticket Reader Hardware: Responsible for the physical acceptance, optical scanning, and initial decoding of the ticket.
EGM Software: Manages the interface with the bill acceptor, facilitates secure communication with the ASCMS, and updates the credit display based on validation results.
ASCMS Software: Handles database lookups, performs validation checks, executes anti-fraud measures, logs transactions, and communicates outcomes to the EGM.

In at least one embodiment, the Advantage Spin system accommodates both physical and digital forms of Advantage Spin Credit Vouchers, offering players flexibility and convenience in accessing and utilizing their credits.

### Physical Advantage Spin Credit Vouchers

Physical vouchers are tangible paper tickets issued to players and designed to operate seamlessly within the existing Ticket-In, Ticket-Out (TITO) ecosystem. These vouchers are printed with:
A unique barcode
Validation codes
The monetary or Advantage Spin credit value
Issuance details such as date, time, and originating machine or system

### Processing of Physical Vouchers:

1. Insertion and Scanning: Players insert the voucher into the EGM's bill acceptor or ticket reader. The system captures and decodes the barcode, extracting relevant information.
2. Validation: The EGM transmits the decoded data to the Advantage Spin Credit Management System (ASCMS) for authentication and value verification. The ASCMS confirms the voucher's validity, including checks for prior redemption or tampering.
3. Credit Application: Upon successful validation, the EGM updates the player's Advantage Spin credit meter, adding the voucher's value for immediate gameplay use.

Physical vouchers maintain compatibility with traditional casino operations while introducing the specialized functionality of Advantage Spin credits.

### Digital Advantage Spin Credit Vouchers

Digital vouchers are virtual equivalents stored electronically and accessed through mobile devices or digital wallets. They provide players with the convenience of paperless transactions and facilitate integration with mobile casino applications and online gaming platforms. Each digital voucher includes:
A unique identifier
A secure digital signature or encrypted validation code
Associated Advantage Spin credit or monetary value
Issuance and expiration metadata

### Processing of Digital Vouchers:

1. Access and Authentication: Players access their digital voucher through a casino mobile app or digital wallet. Secure login mechanisms, such as biometric authentication or two-factor authentication, ensure authorized access.
2. Presentation to EGM: Players present the voucher by scanning a QR code displayed on their mobile device, tapping via NFC, or logging in directly to the EGM interface.
3. Validation and Redemption: The EGM communicates with the ASCMS to validate the digital voucher in real-time. The system checks for authenticity, unredeemed status, and associated credit value.
4. Credit Application: Following successful validation, the EGM updates the Advantage Spin credit meter with the voucher's value, enabling players to utilize their credits immediately.

### Benefits of Supporting Both Formats

Flexibility: Players may choose between physical or digital vouchers based on their preferences and convenience.
Accessibility: Digital vouchers integrate seamlessly with mobile and online gaming environments, while physical vouchers cater to traditional casino operations.
Security: Both formats incorporate robust anti-fraud mechanisms, such as encrypted barcodes for physical vouchers and secure digital signatures for digital versions.
Ease of Use: Digital vouchers eliminate the need for physical storage and handling, while physical vouchers are familiar and widely accepted.

By enabling both physical and digital Advantage Spin Credit Vouchers, the system meets diverse player needs, supports modern digital trends, and ensures compatibility with legacy casino infrastructure. This dual-mode capability enhances player engagement and streamlines operational efficiency.

EGM Communication with Smartphone App for Credit and Voucher Transactions

In at least one embodiment, the Electronic Gaming Machine (EGM) is configured to communicate directly with a player's smartphone application to facilitate the transfer, redemption, and management of Advantage Spin credits and digital vouchers. This integration is achieved through secure wireless protocols such as Bluetooth, Wi-Fi, or Near-Field Communication (NFC), enabling seamless interactions between the EGM and the player's mobile device. The system enhances player convenience by allowing transactions to be initiated and completed without the need for physical tickets or manual intervention.

When depositing credits or digital vouchers from the smartphone app to the EGM, the player uses the app to initiate a transfer. The app communicates transaction details, including player account credentials and the selected credit or voucher amount, to the EGM. The EGM validates the transaction by interfacing with the Advantage Spin Credit Management System (ASCMS). Upon successful validation, the EGM updates its Advantage Spin credit meter to reflect the deposited amount, and the transaction is recorded in the player's account.

When withdrawing credits from the EGM to the smartphone app, the player initiates a withdrawal request directly on the EGM. The EGM sends the withdrawal request to the ASCMS, verifying the player's account details and available credit balance. Once the ASCMS confirms the transaction, the credits are transferred to the player's account, and the updated balance is displayed in the smartphone app. This feature ensures that unused credits may be retained by the player for future use on another EGM or within the casino ecosystem.

For redeeming digital vouchers via the smartphone app, the player selects a voucher from the app, which generates a secure QR code or uses NFC to transmit the voucher details to the EGM. The EGM validates the voucher by communicating with the ASCMS to confirm that it is unredeemed and authentic. After validation, the EGM updates the Advantage Spin credit meter with the redeemed value, and the voucher is marked as redeemed in the ASCMS to prevent further use.

The communication between the EGM and the smartphone app is encrypted to ensure the security of all transactions. Each transaction may may require multi-factor authentication, such as PIN entry, biometric verification, or in-app confirmation, to ensure that only authorized users may initiate actions. Real-time synchronization between the EGM, the smartphone app, and the ASCMS ensures that credit balances and voucher statuses are consistently updated and accurately reflected across all platforms.

This configuration streamlines credit and voucher management, providing players with a modern, digital-first experience. The integration supports seamless cross-platform usage, allowing players to deposit, withdraw, or redeem credits and vouchers with minimal disruption to gameplay. It also aligns with contemporary standards of security and user convenience, ensuring that transactions are both efficient and compliant with gaming regulations.

### Cross-Game and Cross-Session Credit Portability

This feature facilitates the persistent use of AVS credits across various EGMs, game themes, and gaming sessions. It ensures that credits earned in one gaming context may be redeemed in others, enhancing both player flexibility and engagement.

The implementation involves a centralized Advantage Spin credit management system that tracks the accumulation and utilization of credits. When a player earns AVS credits through gameplay or non-gaming activities, the system securely logs the credits in the player's account. These credits are then accessible across multiple EGMs, irrespective of the game or venue.

For example, a player may earn AVS credits on a slot machine featuring a specific theme and later use those credits on an entirely different machine or at a different casino location. Additionally, players may defer using their credits to future gaming sessions, with the credits remaining securely stored until redeemed.

The system employs robust data synchronization across all EGMs and the ASCMS, ensuring real-time updates to player balances and preventing duplication or misuse. This portability is especially advantageous in multi-property casinos, where players may seamlessly transfer credits between venues.

For players, cross-game and cross-session portability adds significant value by extending the utility of their earned credits. For casinos, it fosters loyalty and encourages repeat visits, as players are incentivized to return and utilize their stored credits.

### Responsible Gaming Mechanisms

This feature integrates features to promote responsible gaming, ensuring that the Advantage Spin system aligns with ethical standards and regulatory requirements. The mechanisms include credit limits, mobile notifications, and AI-driven usage recommendations.

Players may set personal limits for the accumulation and use of AVS credits, such as daily or session-based caps. These limits help players manage their gaming habits effectively. The system may also send real-time notifications to players, alerting them when they are approaching their predefined limits or when promotional offers are about to expire.

An advanced AI engine may analyze individual gaming patterns to identify signs of risky behavior. For instance, if a player consistently redeems large quantities of AVS credits within short intervals, the system may suggest limiting further usage or provide tailored guidance. Casinos may configure the system to automatically restrict promotional credits for high-risk players, ensuring compliance with responsible gaming practices.

The inclusion of responsible gaming features benefits players by fostering healthy gaming behaviors and benefits casinos by demonstrating a commitment to ethical practices, which may enhance their reputation and adherence to regulations.

### Enhanced Visual Indicators for Offers

This feature employs graphical user interfaces (GUIs) to visually present re-spin offers, potential outcomes, and credit deductions in real-time. The goal is to provide players with an intuitive and engaging interface that enhances decision-making during gameplay.

The GUI may display dynamic elements such as animated graphics, progress bars, or pop-up notifications to highlight available re-spin opportunities. For instance, when a near-miss scenario is detected, the interface may present an animated reel spin simulation showing the potential rewards if a re-spin is initiated. Offers may include detailed information about the required credits, potential payouts, and time-sensitive nature of the opportunity.

The system ensures that these visual indicators are seamlessly integrated into the EGM display, utilizing both the primary and secondary screens. Advanced displays may use touch-screen functionality, allowing players to interact directly with the offers, such as selecting a reel or symbol to re-spin.

Enhanced visual indicators improve the player experience by making the Advantage Spin offers more engaging and transparent. For casinos, the feature promotes higher uptake of re-spin opportunities and extends player interaction times.

### Dynamic Credit Conversion and Cash-Out

In at least one embodiment, the Advantage Spin (AVS) system is configured to allow players to convert their AVS credits into various other forms of credits or rewards, enhancing flexibility and strategic decision-making during gameplay. The system facilitates these conversions through the Electronic Gaming Machine (EGM) interface, player account management systems, and the Advantage Spin Credit Management System (ASCMS).

Players may convert AVS credits into reel spin credits. This process allows players to allocate their accumulated AVS credits specifically for re-spinning individual reels during gameplay. The system identifies the conversion request initiated by the player through the EGM's interface or a connected mobile application. Once the conversion is confirmed, the specified amount of AVS credits is deducted from the player's balance, and an equivalent value in reel spin credits is credited to the player's account or made available on the EGM's interface.

The system also supports the conversion of AVS credits into symbol spin credits. Symbol spin credits enable players to re-spin specific symbols within a reel rather than the entire reel, providing a targeted approach to achieving winning combinations. Upon selecting this conversion option, the system validates the player's available AVS credit balance and performs the conversion. The converted symbol spin credits are then reflected in the player's account or on the EGM.

The AVS system further allows for conversions between different types of AVS credits. For example, players may reallocate reel spin credits to symbol spin credits or vice versa, depending on their gameplay strategy. The conversion process involves recalculating the value equivalency between the credit types, ensuring that the overall balance aligns with system-defined conversion ratios. The recalculated credits are then updated in the player's account and made available for immediate use.

Additionally, the system supports the conversion of AVS credits into other reward types, such as cash or loyalty points. This functionality enables players to cash out their AVS credits or use them to accumulate loyalty rewards that contribute to broader casino engagement programs. For cash conversions, the EGM or the ASCMS determines the equivalent monetary value of the AVS credits based on predefined exchange rates. For loyalty point conversions, the system calculates the corresponding number of points and updates the player's loyalty account accordingly.

These conversion processes are managed securely and in real-time by the ASCMS, which ensures accurate credit deductions and updates to player accounts. The system's flexibility in handling multiple conversion types enhances the utility of AVS credits, allowing players to tailor their gameplay experience while maintaining compliance with gaming regulations and preserving the integrity of the casino's reward systems.

In addition to providing players with the ability to convert AVS credits into various other forms, such as reel spin credits, symbol spin credits, standard game credits, or cash vouchers, the system also enables players to cash out partial amounts of their AVS credits through TITO vouchers.

In one embodiment, the conversion process is facilitated through the EGM interface, where players may access a menu to select the desired conversion type. For instance, a player may choose to convert AVS credits into reel spin credits for targeted gameplay, or into loyalty points to maximize their rewards. The system dynamically calculates the equivalent values based on configurable conversion ratios, ensuring a fair and transparent process.

For cash-outs, players may request a partial or full redemption of their AVS credits. The EGM prints a TITO voucher representing the selected credit amount, which may be used for future gameplay or redeemed for cash at the casino cashier.

This feature benefits players by offering flexibility in how they utilize their credits, while casinos gain a robust system for managing credit transactions and incentivizing continued engagement. Dynamic credit conversion ensures that the Advantage Spin system caters to diverse player preferences and maximizes the utility of accumulated credits.

### EGM-Integrated AVS Credit Management System

In at least one embodiment, the Advantage Spin (AVS) system enables an Electronic Gaming Machine (EGM) to function as an AVS credits ATM or cashier, facilitating a wide range of AVS-related transactions independent of standard gameplay. This configuration provides players with extensive flexibility in managing their AVS credits, enhancing their gaming experience and interaction with the casino ecosystem.

The EGM allows players to cash out a partial or full amount of their AVS credits and issue the withdrawn credits as an AVS TITO voucher. Upon selecting this option, the player initiates a cash-out request via the EGM interface. The system calculates the specified amount of AVS credits, validates the transaction against the player's balance, and generates an AVS TITO voucher with the requested value. This voucher is treated as equivalent to cash but may have specific restrictions on its usage or redemption, as defined by the casino. The voucher is printed via the EGM's ticket printer and logged in the Advantage Spin Credit Management System (ASCMS) to prevent fraud or duplication.

The system also supports depositing, using, and withdrawing AVS credits directly at the EGM. Players may deposit cash into the EGM to purchase AVS credits. The EGM processes the deposit through its bill validator, converts the monetary value into AVS credits, and updates the player's AVS credit balance accordingly. These credits are then immediately available for use during gameplay or other transactions.

Players may deposit AVS credits into the EGM from their player tracking (PT) account. This feature involves the EGM securely accessing the player's account information through the ASCMS, validating the available AVS credit balance, and transferring the specified amount to the EGM's Advantage Spin credit meter. Similarly, AVS credits may be deposited into the EGM by redeeming AVS TITO vouchers. The EGM scans and validates the voucher using its integrated ticket reader, confirming its authenticity and value with the ASCMS. Once validated, the credits are added to the player's balance on the EGM.

For withdrawals, players may transfer AVS credits from the EGM back to their PT account. The player initiates this process through the EGM's interface, specifying the amount to withdraw. The EGM communicates the transaction details to the ASCMS, which updates the player's account balance and confirms the successful transfer. Alternatively, players may choose to withdraw AVS credits in the form of AVS credit vouchers. The EGM generates these vouchers based on the requested amount, ensuring that they are encoded with secure validation details and recorded in the ASCMS database. These vouchers are treated as cash equivalents but may include specific restrictions, such as limits on redemption locations or expiration dates, to align with casino policies.

This ATM-like functionality ensures secure and efficient transactions, enabling players to manage their AVS credits conveniently across various scenarios. The integration of cash deposits, PT account interactions, and TITO voucher handling provides a comprehensive framework for credit management, supporting both gameplay and broader casino engagement. The system's design prioritizes security, compliance, and ease of use, ensuring a seamless experience for players while maintaining operational integrity.

### Mobile Device Integration for AVS Credit Issuance and Redemption

In at least one embodiment, the Advantage Spin (AVS) system integrates with mobile devices to enable players to seamlessly issue, redeem, and manage AVS credits. This integration extends the system's functionality beyond Electronic Gaming Machines (EGMs) to mobile platforms, enhancing player convenience and providing casinos with expanded marketing opportunities.

The system enables players to deposit AVS credits into their Player Tracking (PT) account by scanning a physical AVS TITO voucher using their mobile device. This process begins when the player accesses the casino's dedicated mobile application, which includes a feature for scanning physical vouchers. The app utilizes the device's camera to capture the voucher's unique barcode and other printed details. This information is securely transmitted to the Advantage Spin Credit Management System (ASCMS) for validation. The ASCMS verifies the voucher's authenticity, checks for prior redemption, and confirms the associated AVS credit value. Upon successful validation, the credits are transferred to the player's PT account, and the voucher status is updated in the database to “redeemed.” The mobile app reflects the updated balance in real time, allowing players to use the credits across compatible systems, including EGMs and online platforms.

This integration also allows casinos to implement targeted marketing campaigns through the use of electronic and paper coupon codes. Casinos may distribute digital coupon codes via email, mobile app notifications, or SMS, as well as physical coupons during in-person promotions. These codes are redeemable for AVS credits directly through the mobile app. Players input or scan the coupon codes, which the app verifies with the ASCMS. Verified codes are then redeemed for AVS credits, which are credited to the player's PT account or mobile wallet. This targeted marketing strategy enables casinos to engage with specific player demographics, incentivize repeat visits, and promote new gaming experiences or events.

The security of these transactions is ensured through encryption protocols and authentication measures integrated into the mobile app. Multi-factor authentication, such as biometric verification or one-time passcodes, is employed to protect player accounts and ensure only authorized users may redeem vouchers or coupons. Additionally, the ASCMS maintains detailed records of all transactions for auditing and compliance purposes.

By leveraging mobile device capabilities, the AVS system enhances accessibility, allowing players to manage their credits from anywhere. This feature supports seamless integration between physical and digital casino environments while providing a robust platform for personalized marketing and player engagement.

### Incorporation of Additional Game Layers

This feature introduces bonus layers or feature games that are triggered by successful re-spin actions using Advantage Spin (AVS) credits. These bonus layers add a dynamic and rewarding dimension to the gaming experience by providing players with opportunities to unlock jackpots, progressive rewards, or other enhancements.

When a player utilizes AVS credits for a re-spin, the system evaluates the outcome to determine eligibility for triggering additional game layers. For example, landing specific symbols or achieving a winning combination during the re-spin may activate a progressive jackpot feature or a specialized bonus round. These bonus layers may include mini-games, multiplier rounds, or expanding reels, each designed to enhance player engagement.

The incorporation of these game layers may may require seamless integration between the EGM software and the Advantage Spin offer engine. The system dynamically adjusts the credit requirements and potential rewards based on the triggered bonus features, ensuring a cohesive gameplay flow.

For players, this feature increases the excitement and strategic value of using AVS credits, as re-spin actions may lead to significantly higher rewards. Casinos benefit by extending player interaction times and enhancing the appeal of their gaming offerings, potentially driving increased revenue.

### Player Behavioral Targeting

This feature employs AI-driven analytics to tailor Advantage Spin promotional offers based on individual player behavior. By analyzing historical data, gaming preferences, and engagement patterns, the system generates customized offers that encourage specific actions, such as trying new games or extending play sessions.

The AI engine continuously evaluates player activity to identify patterns and preferences. For instance, a player who frequently engages with a specific game theme may receive re-spin offers tailored to that game, while another player may be incentivized to explore a different EGM theme with cross-game credit offers. Behavioral targeting may also consider broader player trends, such as time of day, gaming session duration, or preferred bet sizes.

Offers are presented through the EGM interface or via mobile notifications, with details about credit costs and potential rewards. Time-sensitive promotions, such as “double credits for the next hour,” further enhance engagement by creating a sense of urgency.

This personalized approach benefits players by aligning offers with their interests and gaming style, while casinos gain a powerful tool for increasing engagement, encouraging cross-game exploration, and boosting overall revenue.

### Non-Gameplay Credit Earning

This feature allows players to earn AVS credits through non-gameplay activities, such as dining, shopping, or hotel stays. By linking the Advantage Spin system with the casino's broader loyalty ecosystem, this feature incentivizes holistic engagement with the property.

When a player participates in qualifying non-gaming activities, the system awards a predefined amount of AVS credits to their player account. For instance, a dinner reservation at a casino restaurant or the purchase of merchandise may generate AVS credits proportional to the transaction value. The system employs real-time tracking and integration with point-of-sale systems to ensure seamless credit allocation.

This feature enhances the player's overall experience by offering tangible rewards for diverse activities, while casinos benefit by encouraging patrons to explore and spend across multiple revenue streams. It fosters a stronger connection between the player and the casino brand, potentially driving repeat visits and increased spending.

### Mobile Integration for Advantage Spin Promotions

This feature enables players to manage their AVS credits and participate in promotions directly through their mobile devices. Mobile integration provides a convenient platform for receiving, redeeming, and tracking Advantage Spin offers, enhancing the overall player experience.

Players may use a dedicated mobile app or a web-based interface to view their AVS credit balance, browse available re-spin offers, and make redemptions. The system supports digital voucher scanning, allowing players to transfer physical TITO vouchers into their mobile accounts. Additionally, push notifications may alert players to time-sensitive promotions or personalized offers tied to specific EGMs.

The mobile platform may also include features such as remote credit conversion, where players may convert AVS credits into loyalty points or other assets without physically interacting with an EGM. Integration with the casino's player tracking system ensures real-time synchronization between mobile activities and on-site gameplay.

This feature provides players with unparalleled flexibility and convenience, while casinos benefit from a modernized credit management system that increases player engagement and supports targeted marketing campaigns.

### Advantage Spin Credit Transfer and Sharing

This feature enables players to transfer promotional AVS credits between their own accounts or to gift them to other players. The system supports secure and configurable mechanisms to facilitate these transactions, enhancing social interaction and player engagement.

Players may access a transfer menu via the EGM interface, mobile app, or casino kiosk. The system allows them to specify the amount of AVS credits to transfer and the recipient's account details. Transfers may be subject to casino-defined restrictions, such as minimum or maximum transfer limits or restrictions on gifting credits obtained through certain promotions.

The feature also supports group-based promotions, where players collectively contribute AVS credits towards unlocking shared rewards. For instance, a group of players may pool credits to activate a high-value re-spin offer on a specific EGM.

This feature benefits players by adding a social dimension to their gaming experience and provides casinos with a tool to encourage group visits and collective engagement. It also opens up new avenues for promotional campaigns, such as incentivizing referrals through credit-sharing rewards.

### Customizable Redemption Rules

This feature allows casinos to configure redemption rules for Advantage Spin (AVS) credits, tailoring the system to their specific business strategies and gaming policies. By defining parameters such as minimum gameplay requirements or restrictions on the use of credits for certain game features, casinos may balance promotional benefits with operational goals.

Casinos may set rules specifying the types of games or game themes where AVS credits may be used. For instance, AVS credits may be restricted from use in progressive jackpot games or limited to specific high-engagement game themes. Additionally, redemption rules may include minimum credit thresholds, ensuring players engage with games before claiming rewards. For example, a player may need to accrue a certain number of credits or participate in a minimum number of spins to unlock specific re-spin opportunities.

The system supports dynamic updates to these rules, allowing casinos to adjust parameters in response to player behavior or promotional campaigns. For example, during a marketing event, restrictions may be temporarily relaxed to encourage higher participation.

This feature benefits casinos by providing control over credit utilization, optimizing revenue while managing promotional costs. Players benefit from clear and transparent rules that enhance their understanding of credit use, fostering trust in the system.

### Responsible Gaming Features for Promotions

This feature incorporates safeguards to ensure that promotional AVS credits are distributed and utilized responsibly. It aligns the Advantage Spin system with ethical gaming practices and regulatory requirements.

The system includes mechanisms to identify and limit promotional credit offers to high-risk players. For instance, the system may cap the maximum number of AVS credits that may be issued to a player flagged as at-risk based on gaming patterns. AI-driven analytics help identify behaviors such as frequent large credit redemptions or prolonged gaming sessions, prompting the system to adjust promotional activity accordingly.

Responsible gaming notifications may also be integrated into the system, providing players with real-time updates about their credit usage or suggesting breaks in gameplay. For example, if a player uses a substantial amount of AVS credits within a short time frame, the system may display a reminder about responsible gaming.

This feature benefits players by promoting healthier gaming habits while ensuring casinos maintain a responsible and compliant gaming environment. It also enhances the casino's reputation by demonstrating a commitment to player well-being.

### Cross-Venue Usage of Credits

This feature enables AVS credits earned in one casino location to be redeemable at partner or affiliated venues, enhancing the utility and appeal of the Advantage Spin system. Cross-venue usage promotes loyalty and engagement across the casino network.

The system achieves this through a centralized credit management platform that tracks AVS credit balances across all participating venues. When a player earns credits at one location, these are recorded and made available at any affiliated venue. For example, a player who accrues credits during a visit to a flagship property may later redeem them at a smaller satellite casino or even at a partner venue in another city.

Credits retain their defined value and redemption options, ensuring a consistent player experience. The system also supports cross-venue promotions, such as offering bonus credits when a player redeems AVS credits at a new or underutilized location.

For players, this feature provides flexibility and convenience, encouraging broader engagement with the casino network. Casinos benefit by driving traffic to multiple properties, increasing overall player loyalty and expanding the reach of their promotional strategies.

### Automated Expiry Management

This feature introduces an automated system for managing the expiration of unused promotional AVS credits. It ensures that credits are utilized within predefined time frames, aligning with the casino's marketing and operational goals.

The system tracks the issuance date and validity period of each AVS credit. Unused credits automatically expire once they reach the end of their validity, with players receiving advance notifications to encourage timely redemption. For instance, the system may send reminders via mobile notifications or EGM displays, such as “Your AVS credits expire in 7 days—redeem them now!”

The expiry rules are configurable, allowing casinos to define different durations for various promotions. For example, credits earned through high-value promotions may have a longer validity than those issued as daily incentives. The system may also implement staggered expirations, where portions of a credit balance expire incrementally, motivating players to engage more frequently.

Automated expiry management benefits casinos by minimizing unredeemed promotional liabilities while encouraging increased player interaction. Players benefit from clear communication about their credits, fostering a sense of urgency to participate in gameplay.

### Promotions Linked to Jackpot Triggers

This feature links Advantage Spin promotions to jackpot-related events, such as near-miss scenarios or significant jackpot wins, creating highly engaging promotional opportunities.

When a player narrowly misses a jackpot, the system may offer bonus AVS credits as a consolation incentive. For instance, a player who is one symbol away from winning a progressive jackpot may receive an offer such as “You were just one symbol away from $10,000-here are 50 AVS credits to try again!” Alternatively, players who win substantial jackpots may receive additional AVS credits to extend their gaming session.

The system uses real-time game state analysis to identify jackpot-related events and dynamically generates tailored offers. These promotions may be presented through engaging visual notifications, highlighting the unique opportunity created by the event.

For players, this feature enhances the emotional highs and mitigates the lows associated with jackpot gaming, encouraging continued participation. Casinos benefit from increased player retention and the ability to leverage jackpot excitement to drive additional gameplay.

### Gamified Promotional Tiers

This inventive feature introduces a tiered progression system within the casino's loyalty program, allowing players to unlock additional Advantage Spin (AVS) promotional credits as they achieve specific milestones. The system gamifies the player's experience by incorporating elements of progression and achievement, thereby enhancing engagement and incentivizing continued play.

The tiered system operates by assigning players to different levels based on their accumulated gameplay activities, such as the total amount wagered, frequency of play, or participation in special events. Each tier unlocks unique rewards, including increased AVS credits, exclusive re-spin opportunities, or access to high-value bonus games. For example, a player reaching the “Gold” tier may receive a 10% bonus on all AVS credits earned, while a “Platinum” tier player may gain access to exclusive re-spin features not available to others.

Implementation involves integrating the tiered system with the existing player tracking infrastructure. The casino's management system continuously monitors player activities, updating their status in real-time. Visual indicators on Electronic Gaming Machines (EGMs) and mobile apps inform players of their current tier and progress towards the next level. Additionally, personalized notifications encourage players to engage in activities that will advance their status, such as trying new games or participating in promotions.

For players, this feature enhances the gaming experience by providing clear goals and rewards for their loyalty. It creates a sense of achievement and offers tangible benefits that may be directly applied to their gameplay. For the casino, gamified tiers encourage increased player retention and spending, as players are motivated to reach higher levels and unlock more valuable rewards. It also allows the casino to segment its player base, enabling more targeted marketing and personalized service offerings.

### Group-Based Promotions

This inventive feature focuses on fostering social interaction among players by awarding shared Advantage Spin (AVS) credits to groups when certain collective conditions are met. The idea is to incentivize group play and collaborative engagement, enhancing the overall casino experience for players who visit with friends or participate in group events.

The system tracks the combined activities of a group of players linked through their player accounts. When the group's total bets or accumulated gameplay exceed predefined thresholds, the system awards shared AVS credits that may be used by all members. For example, if a group collectively wagers over a certain amount within a specified time frame, they may receive a pool of AVS credits distributed equally among them or allocated based on individual contributions.

Implementation may may require the casino's management system to recognize and link group members, which may be facilitated through player accounts or by registering as a group at the casino entrance or via a mobile app. Real-time tracking allows the group to monitor their collective progress towards promotional goals, displayed on EGMs or personal devices. Additionally, special group challenges or competitions may be introduced, offering larger rewards for achieving higher collective milestones.

For players, group-based promotions enhance the social aspect of gaming, making it a more collaborative and enjoyable experience. It encourages groups to spend more time and engage more deeply with the casino's offerings. For the casino, this feature drives increased foot traffic and revenue, as groups are to stay longer and participate in more activities. It also opens opportunities for hosting group events or tournaments, further promoting the casino as a destination for social entertainment.

### Multimedia Displays for Offers

This inventive feature involves utilizing advanced multimedia displays, including signage and on-screen notifications, to present targeted Advantage Spin (AVS) promotional offers. The aim is to draw player attention to eligible EGMs and enhance the visibility of promotions through engaging visual content.

The system employs high-definition displays, LED screens, and interactive kiosks strategically placed throughout the casino floor. These displays showcase dynamic content such as animations, videos, and real-time updates on promotional offers. For instance, when a player approaches an EGM with an active AVS promotion, the nearby signage may display a personalized message or highlight the potential rewards available.

On-screen notifications are integrated into the EGM interfaces, providing contextual offers based on the player's current game state. This may include pop-up messages alerting the player to available re-spin opportunities, countdown timers for time-sensitive promotions, or interactive tutorials explaining how to redeem AVS credits. The multimedia content is designed to be eye-catching and informative, utilizing graphics and sound effects to enhance the player's engagement.

Implementation may may require coordination between the casino's content management system and the EGMs. Real-time data analytics allow the system to tailor content to individual players or adjust promotions based on current casino activity. The use of multimedia technology ensures that promotions are communicated effectively and contribute to an immersive gaming environment.

For players, the enhanced visual appeal and clarity of offers improve their gaming experience by making promotions more accessible and easier to understand. For the casino, this feature increases the effectiveness of marketing efforts, drives higher participation in promotions, and differentiates the casino through the use of cutting-edge technology.

### Advantage Spin Credit Restrictions for Game Balancing

This inventive feature addresses the strategic allocation of Advantage Spin (AVS) credits to balance player interest across different game themes and Electronic Gaming Machines (EGMs). By imposing restrictions on AVS credit usage, the casino may prevent overuse of specific EGMs and encourage players to explore a wider variety of games.

The system analyzes player behavior to identify trends in game popularity. If certain games or themes become overly dominant, the casino may implement restrictions on AVS credit redemption for those games. For example, the system may limit the number of AVS credits that may be used on a popular EGM or temporarily disable promotions for it. Simultaneously, the casino may promote underutilized games by offering enhanced AVS credit rewards or exclusive re-spin opportunities.

Implementation involves configuring the casino management system to adjust AVS credit policies dynamically. Rules may be set to automatically trigger restrictions based on predefined thresholds, such as the number of active players on an EGM or the total AVS credits redeemed for a particular game. Notifications inform players of any restrictions and guide them towards alternative games with available promotions.

For players, this feature introduces them to new gaming experiences and maintains a balanced gaming environment where resources are equitably distributed. It prevents overcrowding on specific EGMs and reduces wait times. For the casino, balancing game usage maximizes asset utilization, spreads revenue across more games, and enhances the overall appeal of the gaming floor by showcasing the diversity of available games.

### Cross-Game Credit System

This inventive feature allows players to direct the usage of their Advantage Spin (AVS) credits across multiple EGMs, game sessions, and even different venues. The system ensures that AVS credits persist over time, providing flexibility and convenience for players to use their credits when and where they choose.

The cross-game credit system operates by maintaining a centralized account for each player's AVS credits, accessible across all participating EGMs and casino locations. Players may accumulate credits during gameplay on any EGM and later redeem them on a different machine or at a different time. The system supports time-shifted usage, allowing players to save their credits for future sessions or special events.

Implementation may may require robust data synchronization between the EGMs, the casino's management system, and potentially across multiple venues. Player accounts store the credit balances securely, updating in real-time as credits are earned and spent. The system provides interfaces on EGMs and mobile apps where players may view their credit balances, transfer credits between games, and manage their usage preferences.

For players, the cross-game credit system offers unparalleled flexibility, enhancing their control over the gaming experience. They may tailor their use of AVS credits to their personal preferences, experiment with different games, and enjoy continuity in their rewards regardless of when or where they play. For the casino, this feature promotes sustained engagement, as players are more to return to redeem accumulated credits. It also enables the casino to gather comprehensive data on player behavior across games and locations, informing more effective marketing and operational strategies.

### Casino System Maintaining Two Types of Credits

This inventive feature introduces a dual-credit system within the casino gaming framework, distinguishing between Cash Credits and Advantage Spin (AVS) Credits. Each type of credit serves specific purposes, allowing players and casinos to manage resources more effectively.

Cash Credits represent monetary value directly equivalent to the player's deposited funds or winnings. They may be used for regular gameplay, purchasing additional AVS credits, or cashed out as vouchers or cash. AVS Credits, on the other hand, are non-monetary and used exclusively for accessing special features like re-spins, promotional gameplay, or customized offers.

The system tracks both credit types independently through the EGM interface and the player's tracking account. For instance, during gameplay, players may view separate balances for Cash Credits and AVS Credits, each with distinct redemption options. Cash Credits may be used for all standard game actions, while AVS Credits are limited to designated features like re-spins or promotional games.

For implementation, EGMs are configured to support dual-credit tracking and management. This includes the ability to display both balances, process transactions from either credit pool, and enforce rules regarding the specific usage of AVS Credits. The system integrates with the casino's backend to synchronize credit balances across player accounts and ensure accurate reporting.

From the player's perspective, this system provides clarity and flexibility in how credits are managed, allowing them to optimize their gaming strategy. For casinos, the separation of credit types enables targeted promotional strategies and enhanced operational control, reducing the risk of promotional credits being misused for direct cash-out purposes.

### EGM-Based Advantage Spin Transaction System

This inventive feature positions EGMs as multi-functional transaction hubs for managing Advantage Spin (AVS) credits. Beyond gameplay, EGMs serve as “ATMs” for depositing, withdrawing, and transferring AVS credits, creating a seamless and centralized system for credit transactions.

Players may deposit funds into the EGM and allocate them to their AVS credit balance or withdraw unused AVS credits to TITO vouchers or player accounts. The system supports various methods for deposits and withdrawals, including cash, physical vouchers, digital vouchers, and direct transfers from loyalty accounts. For example, a player may insert a TITO voucher into the EGM, and the system credits their AVS balance accordingly.

The EGM interface provides an intuitive transaction menu where players may view balances, select transaction types, and process credit transfers. Advanced configurations allow for split transactions, such as partially converting AVS credits into cash or symbol spin credits while retaining the rest for re-spin opportunities.

Implementation involves integrating the EGMs with the casino's Advantage Spin Credit Management System and player tracking systems, enabling real-time synchronization of credit balances. The EGMs are also equipped with secure authentication protocols to ensure the integrity of all transactions.

This feature benefits players by simplifying the management of AVS credits, offering a one-stop solution for all credit-related needs. For casinos, it streamlines operations, enhances the utility of existing EGMs, and fosters player engagement by making credit usage more accessible.

### Promotional Credit Distribution System

This inventive feature outlines a casino-controlled system for distributing promotional Advantage Spin (AVS) credits to players. The system is designed to target specific EGMs, game themes, or player segments, allowing casinos to strategically allocate promotional resources.

Casinos may issue AVS credits through various channels, such as loyalty programs, marketing campaigns, or special events. For instance, players participating in a high-profile tournament may receive bonus AVS credits for use on designated EGMs. The system also supports configurable redemption restrictions, such as limiting credits to specific game themes or requiring a minimum level of gameplay before redemption.

The distribution system integrates with casino marketing platforms, enabling seamless coordination between promotional campaigns and player tracking systems. Real-time analytics allow casinos to monitor the effectiveness of promotions, adjust credit allocations dynamically, and ensure compliance with promotional policies.

For players, this feature enhances the value of their engagement by providing targeted rewards that align with their gaming preferences. For casinos, it offers a powerful tool for driving traffic to underutilized games, rewarding loyal players, and supporting strategic marketing initiatives.

### Credit Conversion Features

This inventive feature introduces flexible credit conversion options, allowing players to convert Advantage Spin (AVS) credits into various other credit types, such as reel spin credits, symbol spin credits, standard game credits, or loyalty points. Configurable conversion ratios and real-time processing enable seamless transitions between credit types.

Players access conversion options through the EGM interface or mobile apps linked to their player accounts. For example, a player may convert 100 AVS credits into 50 reel spin credits to target a specific gameplay feature or exchange unused AVS credits for loyalty points that may be redeemed for dining or merchandise. The system dynamically calculates the conversion based on predefined ratios, ensuring transparency.

Casinos have full control over the conversion rules, allowing them to adjust ratios or limit conversions during specific promotions or events. For example, during a marketing campaign, the casino may offer favorable conversion rates to incentivize certain player behaviors, such as trying new game themes or engaging in longer sessions.

This feature benefits players by maximizing the utility of their credits and supporting personalized gaming strategies. For casinos, credit conversion fosters player loyalty, increases engagement with diverse casino offerings, and provides valuable insights into player preferences.

### Mobile Device Features

This inventive feature leverages mobile technology to enhance the accessibility and usability of Advantage Spin (AVS) credits. Players may use mobile devices to redeem credits, check balances, and scan physical or digital vouchers, creating a seamless bridge between physical and digital gaming environments.

Players access these features through a dedicated casino app or a web-based portal. The app allows for mobile redemption of AVS credits, enabling players to transfer credits to an EGM without needing a physical voucher. Scanning capabilities let players deposit TITO vouchers or promotional codes into their mobile accounts for immediate use. Additionally, players may view real-time updates on credit balances, promotions, and game activity directly from their mobile devices.

Push notifications inform players of time-sensitive offers, such as exclusive re-spin opportunities or expiring credits. The system also supports remote conversion of AVS credits into loyalty points or other rewards, adding versatility to credit usage.

This feature benefits players by providing on-the-go access to credit management and promotional opportunities. For casinos, mobile integration enhances player engagement, streamlines operations, and supports targeted marketing campaigns.

### Partial Transaction Processing

Partial transaction processing in Advantage Spin (AVS) systems introduces enhanced flexibility for players to manage their AVS credits by enabling the cashing out of partial credit balances through physical or digital vouchers, or by depositing partial amounts into the player's Player Account. This functionality allows players to split their AVS credits between ongoing gameplay and redemption, thereby optimizing credit utilization and extending the overall gaming experience. In at least one embodiment, players are able to cash out a portion of their AVS credits directly from an Electronic Gaming Machine (EGM) during an active gaming session without interrupting gameplay.

In one configuration, EGMs are programmed to facilitate partial withdrawals of AVS credits from the player's account, allowing players to allocate a portion of the withdrawn credits to a physical or digital voucher while retaining the remainder in their EGM balance. This voucher may then be used at other EGMs, transferred to additional gaming devices, or redeemed at different venues within or outside the casino property. The system tracks each partial transaction in real-time, ensuring that credits are accurately deducted from the player's balance while issuing vouchers that reflect the precise credit amounts requested by the player.

For example, if a player accumulates 100 AVS credits during gameplay, they may elect to withdraw 50 credits, converting them into a Ticket-In-Ticket-Out (TITO) voucher, while continuing to utilize the remaining 50 credits for additional re-spin opportunities. This partial withdrawal mechanism may also apply across multiple EGMs, allowing the player to transfer fractional balances to specific machines or to distribute credits between different types of games within the casino ecosystem.

To enhance the user experience, EGMs and mobile applications incorporate user-friendly interfaces that present partial transaction options. These interfaces may include touch-based sliders, numerical input fields, or preset withdrawal amounts, enabling players to quickly and easily divide their credit balances according to their preferences. The user interface displays the current AVS credit balance, the amount selected for withdrawal, and the remaining balance, providing clear visual feedback throughout the transaction process.

All partial transactions are automatically recorded within the casino's player tracking system, ensuring that every credit adjustment is accurately logged for compliance and auditing purposes. The system maintains comprehensive transaction histories that may be accessed by casino operators and players through the player's loyalty account. This continuous logging provides transparency, minimizes discrepancies, and ensures regulatory adherence.

Partial transaction processing benefits players by offering greater control over their credit utilization, allowing them to reserve credits for future use or shift balances between different games and devices without losing accumulated AVS credits. This flexible approach reduces the likelihood of unused credits expiring or becoming inaccessible. By enabling incremental cashouts and transfers, players may strategically manage their credits, enhancing their overall satisfaction and engagement.

From the casino operator's perspective, partial transaction processing drives increased player retention and longer gaming sessions. Players are incentivized to remain active within the casino environment by having the ability to manage their AVS credits dynamically. Additionally, the option to transfer credits across different EGMs or venues encourages players to explore various games and machines, fostering broader engagement with the casino's offerings. This dynamic credit management system streamlines casino operations by efficiently managing credit flow and reducing the frequency of large credit cashouts that may impact liquidity.

The incorporation of partial transaction processing into the AVS framework represents a significant advancement in electronic gaming, reflecting the industry's shift towards providing more personalized and adaptable gaming experiences. By allowing players to cash out or redistribute their credits without interrupting gameplay, the system introduces a new layer of strategic credit management that enhances both player enjoyment and operational efficiency.

### Credit Usage Controls

The Credit Usage Controls in the Advantage Spin system incorporate a range of restrictions designed to tailor and regulate the utilization of Advantage Spin Credits (AVS credits). These controls ensure compliance with responsible gaming practices while enabling casinos to optimize player engagement through a structured credit management framework.

One implementation includes time-based restrictions, which may limit the hours or time periods during which AVS credits are redeemable. For example, a casino may enable AVS credit usage only during peak promotional hours or on specific days, such as weekends or holidays. This approach not only aligns with operational goals but also encourages players to engage with the system during periods of strategic importance to the casino.

Game-specific limitations restrict AVS credit usage to certain types of games or game themes. For instance, a casino may allow AVS credits to be used exclusively on newly launched or underperforming games to boost their popularity and player interest. These limitations may be dynamically adjusted based on real-time analytics from the casino's management system.

Credit type restrictions govern the use of different categories of AVS credits. For example, a distinction may be drawn between promotional credits, loyalty points, and earned game credits. Promotional credits may be non-transferrable or usable only on specific features such as re-spins, while earned game credits may offer broader usability across multiple games or even redemption options.

Finally, promotional period controls may enable the casino to activate AVS credit offers during specific promotional windows. For example, during a holiday promotion, AVS credits may be provided with enhanced redemption values or as part of a time-limited bundle offer. These controls allow for dynamic alignment with marketing campaigns and operational strategies.

These usage controls provide significant benefits for players and casinos alike. Players gain clear guidelines for utilizing AVS credits, which enhances their gaming experience by providing structured and predictable usage scenarios. Casinos benefit from improved operational efficiency, targeted marketing capabilities, and a robust framework for promoting responsible gaming practices.

### Credit Earning Methods

The Advantage Spin system incorporates diverse methods for players to earn AVS credits, enhancing the overall gaming experience and player engagement. These methods expand beyond traditional gameplay to include a variety of activities within the casino environment.

One notable feature is the inclusion of non-gaming activities in credit earning. For example, players may earn AVS credits by dining at casino-owned restaurants, attending shows, or utilizing resort amenities such as spas or hotels. This approach encourages patrons to explore and engage with the casino's full range of offerings, creating a holistic entertainment experience.

Participation in casino events may also be rewarded with AVS credits. For instance, players who attend promotional events, tournaments, or exclusive member gatherings may receive AVS credits as a bonus. This incentivizes attendance and adds value to the player's overall experience.

Promotional offers represent another notable earning method. Players may receive AVS credits through targeted promotions, such as a “double AVS credits” event on a specific day or a bonus for signing up for a new loyalty program tier. These offers may be dynamically tailored using real-time analytics and AI-driven insights.

Integration with loyalty programs provides a seamless mechanism for earning AVS credits. Players may accumulate credits as part of their loyalty program points, with specific conversion rates and thresholds defined for redemption. This integration aligns with existing player engagement strategies and enhances the perceived value of loyalty rewards.

The diversity of earning methods directly benefits players by increasing the opportunities to accumulate AVS credits, thereby encouraging sustained engagement with the casino's ecosystem. For casinos, these methods foster cross-utilization of amenities, improved customer retention, and enhanced revenue streams through increased player activity.

### Responsible Gaming Features

The Responsible Gaming Features of the Advantage Spin system are designed to promote ethical gaming practices and ensure player well-being. These features incorporate a range of mechanisms to monitor, manage, and restrict AVS credit usage in alignment with responsible gaming policies.

Credit usage limits allow players to set predefined maximums on the number of AVS credits they may use within a specific time frame, such as a day, week, or month. This feature may be customized to accommodate player preferences and may be integrated with broader responsible gaming systems that track wagering behavior.

Time-based restrictions provide players with tools to limit the hours they spend utilizing AVS credits on electronic gaming machines (EGMs). For example, players may choose to restrict their gameplay to certain periods or enforce mandatory breaks after extended gaming sessions. These controls may also be complemented by automated reminders or notifications from the system.

Self-exclusion integration enables players to voluntarily restrict their ability to redeem AVS credits. For instance, players who opt into a self-exclusion program may have their AVS credit access temporarily or permanently suspended across all participating EGMs. This integration supports responsible gaming initiatives and provides a safety net for individuals prone to compulsive behavior.

Transaction monitoring ensures that all AVS credit activities are tracked and analyzed for patterns indicative of problem gaming. The system may flag irregularities, such as rapid depletion of AVS credits or excessive purchases, and provide notifications or interventions to the player or casino management. This feature leverages advanced analytics to maintain a balance between entertainment and player safety.

These features benefit players by providing tools to manage their gaming habits responsibly, enhancing the overall safety and enjoyment of their experience. For casinos, these features demonstrate a commitment to responsible gaming practices, ensuring regulatory compliance and fostering trust among patrons.

### Credit Management Interface

The Credit Management Interface in the Advantage Spin system offers a centralized platform for players to view and manage their AVS credits. This interface is integrated directly into the EGM or accessible through associated systems, such as player loyalty apps or kiosks.

A notable feature is the credit balance display, which provides real-time information on the player's AVS credit balance, game credits, and other redeemable points. This display may be prominently featured on the EGM screen or a connected mobile app, ensuring players have continuous visibility into their credit status.

The transaction history component allows players to review a detailed log of their AVS credit activities, including credits earned, redeemed, or transferred. This history promotes transparency and enables players to track their engagement with the system.

The interface also displays available credit types, distinguishing between AVS credits, promotional credits, and loyalty points. This segregation simplifies decision-making for players by clarifying the eligible credits for different actions or games.

Conversion options are another notable feature, enabling players to exchange AVS credits for other forms of currency or rewards. For example, players may convert credits into loyalty points, cash equivalents, or other in-game resources. The interface may guide players through this process seamlessly, displaying conversion rates and applicable restrictions.

This interface enhances the player experience by providing a user-friendly, transparent, and versatile credit management tool. For casinos, it optimizes player engagement, improves credit tracking, and ensures compliance with financial reporting and gaming regulations.

### Security Features

The Advantage Spin system incorporates robust Security Features to safeguard AVS credits and related transactions, ensuring the integrity of the gaming environment and protecting both players and the casino.

Transaction encryption is a foundational feature, securing all data exchanges between EGMs, servers, and player devices. Advanced encryption protocols, such as TLS or AES, are employed to protect sensitive information, including credit balances and transaction details.

Voucher authentication ensures that physical or digital vouchers are legitimate and have not been tampered with or duplicated. For example, unique identifiers, validation codes, and QR codes may be embedded into vouchers, with authentication processes conducted in real-time by the system.

Fraud detection mechanisms analyze patterns in credit transactions to identify potentially fraudulent behavior. For instance, if a player redeems multiple high-value vouchers in rapid succession, the system may flag this activity for review. AI-driven models further enhance this capability by recognizing complex fraud schemes.

Audit trail tracking maintains a detailed log of all AVS credit transactions, including issuance, redemption, and transfers. This feature supports regulatory compliance and enables casinos to conduct thorough investigations in the event of disputes or irregularities.

These security features provide peace of mind for players by ensuring the safety of their credits and personal information. For casinos, they enhance operational integrity, protect revenue streams, and support compliance with industry regulations.

### Cross-Property Support

The Cross-Property Support functionality of the Advantage Spin system enables players to use AVS credits seamlessly across multiple casino properties, creating a unified and flexible gaming experience.

Multi-casino credit usage allows players to redeem AVS credits at any participating property within a casino group. For example, a player who earns credits at a flagship casino may use them at satellite venues without restrictions.

Shared credit pools enable casinos to centralize AVS credit data, ensuring that players may access their balances regardless of the location. This feature is supported by integrated server systems that synchronize credit data in real-time.

Cross-property transfers allow players to move AVS credits between venues. For instance, a player may transfer credits earned at one casino to another through their loyalty account or by redeeming a universal TITO voucher.

Standardized credit formats ensure that AVS credits retain consistent value and usability across all properties. This standardization simplifies the player experience and prevents discrepancies that may undermine trust in the system.

These features benefit players by providing unparalleled flexibility and convenience, enhancing their loyalty to the casino brand. For casinos, cross-property support fosters increased engagement, incentivizes visits to multiple venues, and strengthens the overall player experience.

### Administrative Controls

The Administrative Controls in the Advantage Spin system empower casino operators to manage and customize AVS credit programs effectively, aligning them with business objectives and regulatory requirements.

Credit issuance rules allow administrators to define criteria for awarding AVS credits. For example, credits may be issued based on gameplay duration, wager amounts, or participation in specific promotions. These rules may be dynamically adjusted to reflect changing priorities or market conditions.

Usage restrictions enable casinos to impose limits on AVS credit redemption. For instance, credits may be restricted to certain games, venues, or promotional events, ensuring alignment with strategic goals.

Promotional configurations allow administrators to design and manage targeted credit offers. For example, time-sensitive bonuses or tiered rewards may be configured to incentivize specific behaviors, such as increased wagering or attendance at events.

Credit type management provides tools for defining, categorizing, and tracking various AVS credit types. This includes distinguishing between earned credits, promotional credits, and loyalty points, as well as managing conversion rates and expiration policies.

These controls benefit casinos by providing a versatile framework for managing AVS credit programs, optimizing marketing efforts, and maintaining compliance. For players, they ensure a consistent and transparent experience, enhancing their trust and satisfaction with the system.

### Advantage Spin Flow Procedures

Various figures illustrate example embodiments of different procedures and/or procedural flows which may be used for facilitating activities relating to one or more of the Advantage Spin aspects disclosed herein.

According to different embodiments, at least a portion of the various types of functions, operations, actions, and/or other features provided by the Advantage Spin Procedures of the Figures may be implemented at one or more client systems(s), at one or more System Servers (s), and/or combinations thereof.

In at least one embodiment, one or more of the Advantage Spin procedures may be operable to utilize and/or generate various different types of data and/or other types of information when performing specific tasks and/or operations. This may include, for example, input data/information and/or output data/information. For example, in at least one embodiment, the Advantage Spin procedures may be operable to access, process, and/or otherwise utilize information from one or more different types of sources, such as, for example, one or more local and/or remote memories, devices and/or systems. Additionally, in at least one embodiment, the Advantage Spin procedures may be operable to generate one or more different types of output data/information, which, for example, may be stored in memory of one or more local and/or remote devices and/or systems. Examples of different types of input data/information and/or output data/information which may be accessed and/or utilized by the Advantage Spin procedures may include, but are not limited to, one or more of those described and/or referenced herein.

In at least one embodiment, a given instance of the Advantage Spin procedures may access and/or utilize information from one or more associated databases. In at least one embodiment, at least a portion of the database information may be accessed via communication with one or more local and/or remote memory devices. Examples of different types of data which may be accessed by the Advantage Spin procedures may include, but are not limited to, one or more of those described and/or referenced herein.

According to specific embodiments, multiple instances or threads of the Advantage Spin procedures may be concurrently implemented and/or initiated via the use of one or more processors and/or other combinations of hardware and/or hardware and software. For example, in at least some embodiments, various aspects, features, and/or functionalities of the Advantage Spin procedures may be performed, implemented and/or initiated by one or more of the various systems, components, systems, devices, procedures, processes, etc., described and/or referenced herein.

According to different embodiments, one or more different threads or instances of the Advantage Spin procedures may be initiated in response to detection of one or more conditions or events satisfying one or more different types of minimum threshold criteria for triggering initiation of at least one instance of the Advantage Spin procedures. Various examples of conditions or events which may trigger initiation and/or implementation of one or more different threads or instances of the Advantage Spin procedures may include, but are not limited to, one or more of those described and/or referenced herein.

According to different embodiments, one or more different threads or instances of the Advantage Spin procedures may be initiated and/or implemented manually, automatically, statically, dynamically, concurrently, and/or combinations thereof. Additionally, different instances and/or embodiments of the Advantage Spin procedures may be initiated at one or more different time intervals (e.g., during a specific time interval, at regular periodic intervals, at irregular periodic intervals, upon demand, etc.).

In at least one embodiment, initial configuration of a given instance of the Advantage Spin procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the Advantage Spin procedures may correspond to and/or may be derived from the input data/information.

It will be appreciated that the procedural diagrams of the Figures are merely specific examples of procedural flows and/or other activities which may be implemented to achieve one or more aspects of the Advantage Spin techniques described herein. Other embodiments of procedural flows (not shown) may include additional, fewer and/or different steps, actions, and/or operations than those illustrated in the example procedural diagrams of the Figures.

### Example Advantage Spin Credit Voucher Embodiments

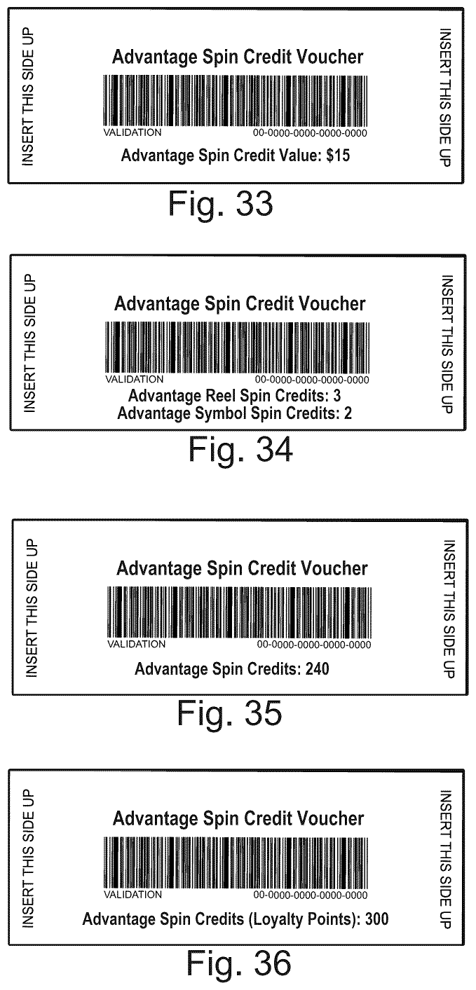

FIG. 33 shows an example embodiment of Advantage Spin Credit Voucher in which Advantage Spin Voucher Credits are represented in terms of monetary values. For example, when this advantage spin credit voucher is read by an EGM, the EGM dynamically calculates and updates the quantity of Advantage Spin credits displayed at its Advantage Spin Credit meter based on the value of the Advantage Spin Voucher (e.g. $15), and based on the game's current bet denomination (Bet Denom) value (e.g., $0.01).

FIG. 34 shows an example embodiment of Advantage Spin Credit Voucher in which Advantage Spin Voucher Credits are represented in terms of credits for predefined advantage spin types (e.g. Reel Spin credits, Symbol Spin credits, etc.). For example, when this advantage spin credit voucher is read by an EGM, the EGM verifies that 3 Advantage Reel Spin credits and 2 Advantage Symbol Spin credits are to be added to the EGM's Advantage Spin credit meters.

FIG. 35 shows an example embodiment of Advantage Spin Credit Voucher in which Advantage Spin Voucher Credits are represented in terms of non-monetary Advantage Spin points/credits. For example, when this advantage spin credit voucher is read by an EGM, the EGM adds 240 Advantage Spin credits to its Advantage Spin credit meter based on the value of the Advantage Spin Voucher (e.g. 240 Advantage Spin credits).

FIG. 36 shows an example embodiment of Advantage Spin Credit Voucher in which Advantage Spin Voucher Credits are represented in terms of non-monetary player loyalty points/credits. For example, when this advantage spin credit voucher is read by an EGM, the EGM adds 300 Loyalty points (Advantage Spin credits) to its Advantage Spin credit meter based on the value of the Advantage Spin Voucher (e.g. 300 Loyalty points).

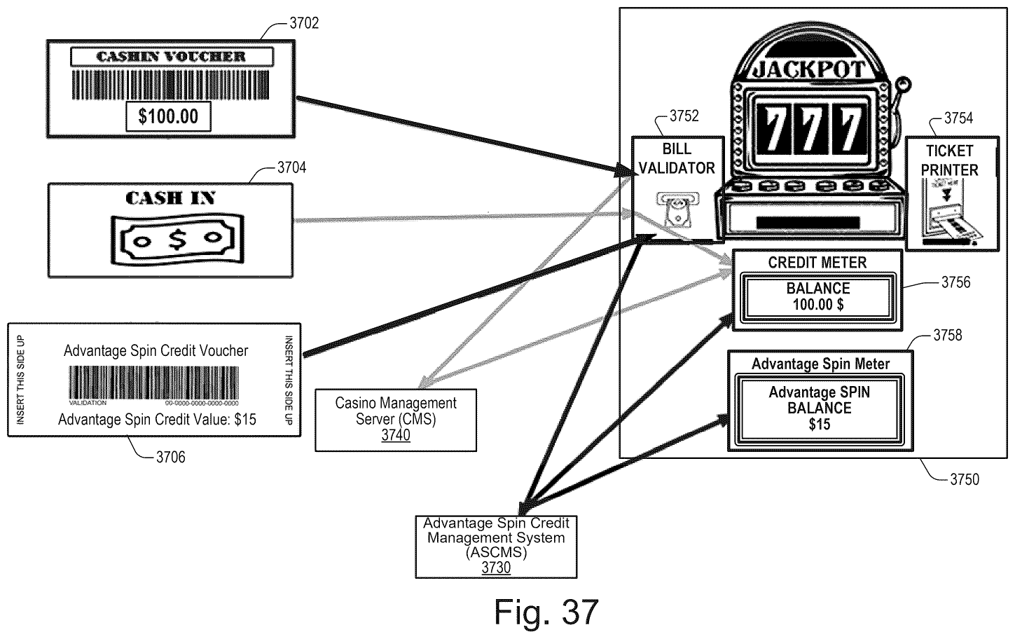

FIG. 37 details an operational scenario within a casino gaming network, where various credit types, including cash and Advantage Spin credits, are deposited into an Electronic Gaming Machine (EGM). The described components and processes ensure secure and efficient handling of different voucher types, enabling seamless gameplay and enhancing the player experience.

### Casino Gaming Network Components:

The gaming network comprises interconnected systems and devices that manage the validation, processing, and crediting of monetary and non-monetary vouchers. Notable components include:
Cash Credit Vouchers (3702): These vouchers, also known as TITO (Ticket-In Ticket-Out) cash vouchers, represent monetary credits issued by the casino.
Cash Notes of Currency (3704): Physical currency accepted directly into the EGM.
Advantage Spin Credit Vouchers (3706): Non-monetary vouchers representing Advantage Spin credits that players may utilize for specific gameplay opportunities such as re-spins.
Electronic Gaming Machine (EGM): The EGM includes:
   A Bill Validator (3752), which reads and authenticates cash credit vouchers, cash notes, and Advantage Spin credit vouchers.
   A Ticket Printer (3754) for dispensing cash-out vouchers or other printed outputs.
   A Cash Credit Meter (3756) and an Advantage Spin Credit Meter (3758) for tracking respective credit types.
Casino Management Server (CMS, 3740): Manages overall system operations, including cash credit validation.
Advantage Spin Credit Management System (ASCMS, 3730): A dedicated subsystem for processing and managing Advantage Spin credits, including their validation and integration into gameplay.

### Voucher Processing Procedures

In at least one embodiment, the following processes are employed when various voucher types are inserted into the EGM:
1. Processing Cash Credit Vouchers
2. When a cash credit voucher (e.g., 3702) is inserted into the bill validator (3752), the EGM communicates with the CMS (3740). The CMS validates the voucher by verifying its authenticity and value. Once validated, the equivalent monetary amount is credited to the cash credit meter (3756) for immediate use in gameplay.
3. Processing Cash Notes
4. Upon insertion of cash notes (e.g., 3704), the bill validator (3752) verifies their denomination and authenticity. The verified value is similarly added to the cash credit meter (3756).
5. Processing Advantage Spin Credit Vouchers
6. When an Advantage Spin credit voucher (e.g., 3706) is inserted, the EGM's bill validator (3752) reads the voucher ID and validation code. The EGM communicates with the ASCMS (3730) to authenticate the voucher and confirm the quantity of Advantage Spin credits it represents. Upon successful validation, the Advantage Spin credits are added to the Advantage Spin credit meter (3758), enabling their utilization for specific features such as targeted re-spins.

### Credit Allocation and Usage:

The allocation of credits depends on the voucher type and the meter designation:
A $100 cash credit voucher deposited into the EGM is credited to the cash credit meter, displayed as available monetary balance.
A $15 Advantage Spin credit voucher is credited to the Advantage Spin credit meter, allowing players to selectively use these credits for re-spin opportunities or other Advantage Spin-enabled features.

In various embodiments, Advantage Spin credits may offer flexibility for use in unique gameplay scenarios. Depending on the specific voucher, credits may be allocated across both cash credit and Advantage Spin credit meters, enhancing player options.

### Benefits and Advantages:

The described system offers multiple benefits:
Enhanced Gameplay: By enabling the use of Advantage Spin credits for targeted gameplay enhancements, players gain greater strategic control over their gaming experience.
Seamless Integration: The integration of cash and Advantage Spin credits into a single gaming session enhances usability and minimizes disruptions.
Player Engagement: The ability to utilize non-monetary credits such as Advantage Spin vouchers fosters higher levels of engagement and incentivizes participation in casino promotions.
Secure Transactions: Voucher validation through the CMS and ASCMS ensures the integrity of the transaction process, maintaining trust in the gaming ecosystem.

Flexibility: Players may engage with multiple types of credits, offering a tailored gaming experience and increasing the appeal of the system.

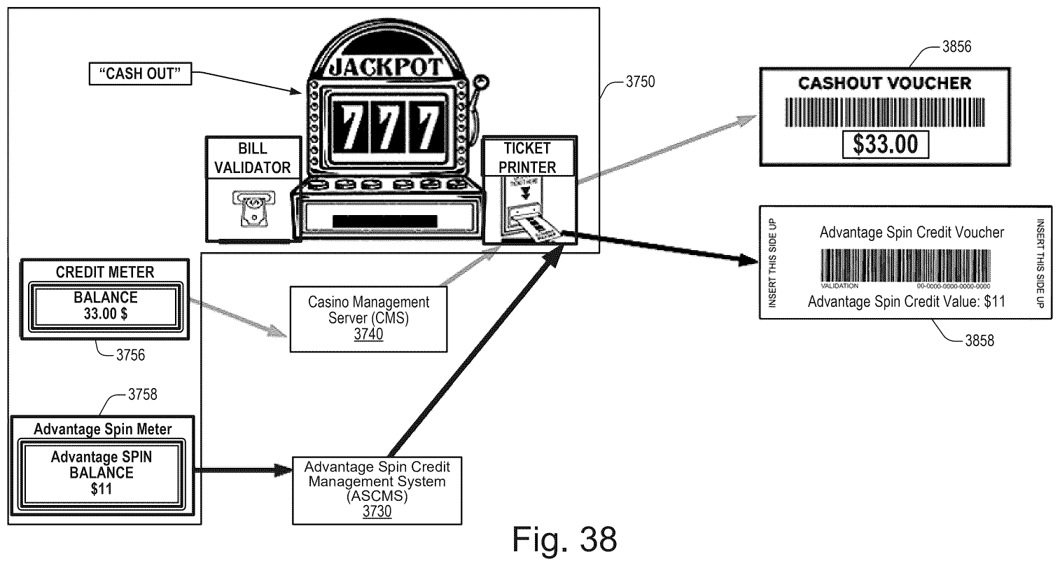

FIG. 38 illustrates a process and system configuration for executing the withdrawal, or “cash out,” of credit balances from an Electronic Gaming Machine (EGM) through the issuance of two distinct types of vouchers: a cash credit voucher and an advantage spin credit voucher. This process integrates the EGM with notable components of a casino gaming network, such as the Casino Management Server (CMS) and the Advantage Spin Credit Management System (ASCMS), ensuring accurate credit tracking and transaction validation.

### System Configuration

The system depicted in this example includes the following components:
1. Electronic Gaming Machine (EGM):
   Bill Validator: Accepts physical cash or vouchers for deposit.
   Ticket Printer: Prints vouchers representing either cash credits or Advantage Spin credits.
   Cash Credit Meter: Tracks standard monetary credits.
   Advantage Spin Credit Meter: Tracks credits designated for Advantage Spin gameplay.
2. Casino Management Server (CMS): Manages cash credit transactions and voucher validations across the gaming network.
3. Advantage Spin Credit Management System (ASCMS): Dedicated to handling transactions involving Advantage Spin credits, including issuance, redemption, and tracking of Advantage Spin credit vouchers.
4. Credit Vouchers:
   Cash Credit Voucher (e.g., 3856): Represents withdrawn cash credit balances.
   Advantage Spin Credit Voucher (e.g., 3858): Represents withdrawn Advantage Spin credit balances, usable for Advantage Spin gameplay on participating EGMs.

### Example Scenario

This scenario describes a “Cash Out” event initiated by a player, leading to the issuance of both cash credit and Advantage Spin credit vouchers.
1. Detection of Cash Out Condition: The EGM detects a “Cash Out” condition, which may be triggered by a player pressing the “Cash Out” button on the machine's interface.
2. Coordination with Casino Management Server (CMS):
   The EGM communicates with the CMS to transfer the balance of $33 from the EGM's cash credit meter.
   The CMS validates the transaction and authorizes the EGM to print a cash credit voucher (e.g., voucher 3856) for $33.
   The voucher is dispensed to the player via the EGM's ticket printer.
3. Coordination with Advantage Spin Credit Management System (ASCMS):
   The EGM simultaneously communicates with the ASCMS to initiate a transfer of $11 from the EGM's Advantage Spin credit meter.
   The ASCMS verifies the transaction and authorizes the EGM to print an Advantage Spin credit voucher (e.g., voucher 3858) for $11.
   The Advantage Spin credit voucher is dispensed alongside the cash credit voucher.

### Operational Details

The sequence of operations executed by the EGM, in coordination with the CMS and ASCMS, ensures accurate and secure management of both monetary and non-monetary credits. The following steps detail the interaction:
1. Trigger Event Handling: Upon detecting the player's Cash Out request, the EGM accesses the current balance values from its cash credit meter and Advantage Spin credit meter.
   Data Transmission: The EGM transmits transaction requests to the CMS and ASCMS with the respective balance details for cash and Advantage Spin credits.
   Validation and Authorization: The CMS and ASCMS validate the transaction requests against their respective systems. This involves verifying the integrity of credit balances and ensuring no discrepancies in the reported meter values.
2. Voucher Issuance:
   Upon successful validation, the EGM prints two distinct vouchers:
      A cash credit voucher (e.g., 3856) for $33.
      An Advantage Spin credit voucher (e.g., 3858) for $11.
   Each voucher contains unique identifiers and validation codes for tracking within the CMS and ASCMS.

### Advantages and Benefits

This implementation provides several advantages, including, for example:
Enhanced Player Experience: Players receive both monetary and non-monetary credit vouchers in a single transaction, simplifying the withdrawal process and providing flexibility for subsequent gaming activities.
Integrated Credit Management: The coordination between the EGM, CMS, and ASCMS ensures seamless and accurate credit transfers, reducing errors and improving system reliability.
Flexibility in Credit Utilization: Players may redeem the Advantage Spin credit voucher for re-spin opportunities on participating EGMs, promoting continued engagement with the casino's gaming systems.
Security and Compliance: The validation processes within the CMS and ASCMS uphold the integrity of transactions, ensuring compliance with regulatory standards.

### Example Procedural Flow Embodiments Involving Advantage Spin Credit Vouchers Issued to Patron/Player Via Physical or Digital Advantage Spin Credit Voucher(s)

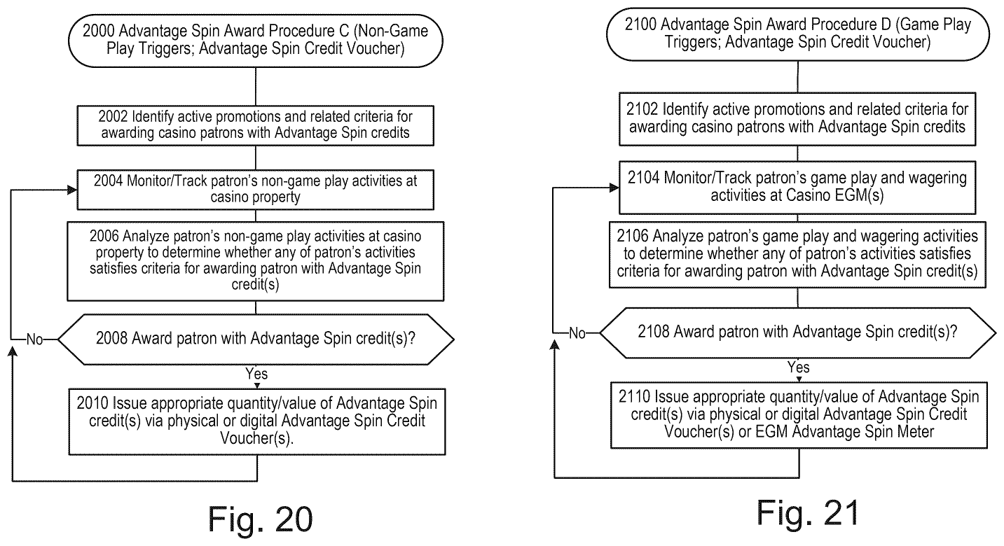

FIG. 20 illustrates an example embodiment of an Advantage Spin Award Procedure based on non-game play triggers, utilizing Advantage Spin Credit Vouchers. In at least one embodiment, this procedure may be configured or designed to facilitate, enable, initiate, and/or perform one or more of the following operations, actions, and/or features described below.

The procedure begins at step 2002, where the system identifies active promotions and defines specific award criteria for Advantage Spin credits. These criteria are based on promotional campaigns and may include thresholds for non-game play activities. At step 2004, the system actively monitors the patron's non-game play activities within the casino property, such as dining, shopping, attending shows, or other engagement metrics that contribute to the casino experience.

Step 2006 involves analyzing the monitored activities to determine whether they meet the predefined criteria for awarding Advantage Spin credits. At step 2008, the system evaluates the qualification status of the patron. If the patron does not qualify, as determined in step 2009, the procedure loops back to step 2004 to continue monitoring activities. If the patron qualifies, the process proceeds to step 2010, where Advantage Spin credits are issued in the form of physical or digital vouchers. Following this issuance, the system returns to monitoring activities at step 2004 to allow for continuous assessment and additional awards.

This procedure enhances player engagement by rewarding patrons for a wide range of non-gaming activities. By issuing Advantage Spin credits through vouchers, the system provides a tangible and versatile reward mechanism, fostering greater overall satisfaction and loyalty among casino patrons.

2002: Identify Active Promotions and Related Criteria for Awarding Casino Patrons with Advantage Spin Credits

The Advantage Spin Credit Management System (ASCMS) is tasked with identifying and managing active promotions that offer Advantage Spin credits as rewards to casino patrons. It maintains a comprehensive database of promotional campaigns, outlining specific criteria such as eligibility requirements, promotional durations, and reward details. The ASCMS's role in this step is notable, as it ensures promotions are accurately targeted and aligned with the casino's strategic marketing objectives, thereby enhancing patron loyalty and encouraging repeat visits. By setting clear promotional criteria, the ASCMS facilitates an effective reward system that recognizes and incentivizes patron engagement throughout the casino.

### 2004: Monitor/Track Patron's Non-Game Play Activities at Casino Property

The ASCMS takes the lead in continuously monitoring patrons' non-gaming activities across the casino property. Through an integrated network of service points, the ASCMS tracks engagements such as dining, accommodations, and entertainment, capturing this data in real time. Each patron's interactions are meticulously recorded, allowing the ASCMS to compile a detailed profile of their behavior outside gaming. This monitoring process is desirable for gathering insights into patron preferences and spending patterns, enabling the casino to tailor promotions and improve service offerings, ultimately enhancing the overall patron experience.

### 2006: Analyze Patron's Non-Game Play Activities at Casino Property

In this step, the ASCMS employs sophisticated data analytics tools to assess the data collected from monitoring patrons' activities. It compares this information against the criteria defined for active promotions, using advanced algorithms to identify patrons whose behavior matches the promotional requirements for awarding Advantage Spin credits. This analysis is notable to accurately determining which patrons are eligible for rewards, ensuring fairness and effectiveness in the promotion's execution. The ASCMS's ability to process and analyze large datasets ensures that eligible patrons are promptly identified and rewarded for their loyalty.

2008: Award Patron with Advantage Spin Credit(s)?

Within the ASCMS, an automated decision-making process assesses whether a patron's activities satisfy the criteria for receiving Advantage Spin credits. If the patron qualifies, the system initiates the reward issuance process. If not, the ASCMS continues its monitoring activities. This step demonstrates the ASCMS's role in actively managing patron engagement by ensuring timely recognition and reward for eligible activities. It highlights the system's efficiency in evaluating patron eligibility and maintaining an engaging casino environment.

### 2009: If No at 2008, Continue at 2004

If a patron's activities do not meet the criteria for Advantage Spin credits at this juncture, the ASCMS resumes the activity monitoring process. This ensures that all future interactions by the patron are captured and analyzed, providing ongoing opportunities for reward eligibility. This step reflects the casino's commitment to comprehensive patron engagement, facilitated by the ASCMS's robust tracking and analysis capabilities, ensuring that patrons have continuous opportunities to be recognized and rewarded.

### 2010: Issue Advantage Spin TITO Credit Voucher

Upon verifying a patron's eligibility for Advantage Spin credits, the ASCMS communicates this information to the Advantage Spin Credit Management System (ASCMS). The ASCMS is then responsible for managing the awarded credits and for validating and authenticating the issuance of an Advantage Spin TITO credit voucher. The voucher, which specifies the amount of Advantage Spin credits awarded in accordance with the promotion(s) rules, is created and made available to the patron in either a physical or digital format. This step signifies a collaborative effort between the ASCMS and the CMS, with the CMS handling the eligibility assessment and the ASCMS managing the credit tracking and voucher issuance. This process ensures that eligible patrons are rewarded with Advantage Spin credits, enhancing their gaming experience by providing additional opportunities for play or strategic advantages within games.

FIG. 21 illustrates an example embodiment of an Advantage Spin Award Procedure based on gameplay triggers, utilizing Advantage Spin Credit Vouchers. In at least one embodiment, this procedure may be configured or designed to facilitate, enable, initiate, and/or perform one or more of the following operations, actions, and/or features described below.

The procedure begins at step 2102, where the system identifies active promotions and establishes specific award criteria for Advantage Spin credits. These criteria are based on gameplay metrics such as wagering activity, win patterns, or in-game milestones. At step 2104, the system actively monitors the patron's gameplay and wagering activities on electronic gaming machines (EGMs), capturing relevant data in real time.

Step 2106 involves analyzing the collected gameplay data to evaluate whether the patron's actions satisfy the predefined criteria for awarding Advantage Spin credits. At step 2108, a decision point determines whether the patron qualifies for an award. If the patron does not qualify, as indicated in step 2109, the system returns to gameplay monitoring at step 2104. If the patron qualifies, the process advances to step 2110, where the system issues Advantage Spin credits either via a physical or digital voucher or directly to the EGM meter being used by the patron. Following this issuance, the system resumes monitoring gameplay at step 2104 to identify further award opportunities.

This procedure integrates seamlessly with real-time gaming operations to provide immediate and impactful rewards based on player engagement. By issuing Advantage Spin credits through vouchers or directly to the EGM meter, the system offers flexibility in credit redemption, promoting increased player interaction and satisfaction.

2102: Identify Active Promotions and Related Criteria for Awarding Casino Patrons with Advantage Spin Credits

This step involves the identification and cataloging of all active promotions within the casino that are specifically designed to award patrons with Advantage Spin credits. Managed by the Advantage Spin Credit Management System (ASCMS), this involves a detailed review and documentation of each promotion's criteria, such as the type of gameplay or wagering activity required, the duration of the promotion, and the specific rewards offered. The ASCMS compiles this information to create a comprehensive database of promotions accessible to casino staff for management and implementation. This database is notable for ensuring that all promotional activities are aligned with the casino's strategic objectives, such as increasing player engagement and incentivizing higher wager volumes. By clearly defining the criteria for each promotion, the ASCMS enables a structured approach to rewarding patrons, ensuring transparency and fairness in the distribution of Advantage Spin credits.

### 2104: Monitor/Track Patron's Game Play and Wagering Activities at Casino EGM(s)

In this step, the ASCMS continuously monitors and tracks the game play and wagering activities of patrons at Electronic Gaming Machines (EGMs) across the casino floor. This surveillance involves recording detailed data on each patron's interactions with the machines, including the types of games played, bet sizes, win/loss records, and overall time spent playing. The ASCMS integrates with the EGMs to capture this data in real time, ensuring an accurate and comprehensive view of patron gaming behavior. This monitoring process is desirable for identifying engagement patterns and behaviors that qualify for Advantage Spin credit rewards under the active promotions. The data collected serves as the basis for the subsequent analysis of patron eligibility for rewards, facilitating a targeted and equitable reward system that enhances the gaming experience for patrons.

### 2106: Analyze Patron's Game Play and Wagering Activities

Following the monitoring phase, this step involves a detailed analysis of the collected data to determine which patrons' gaming behaviors satisfy the criteria for awarding Advantage Spin credits as stipulated in the active promotions. Utilizing sophisticated data analytics tools, the ASCMS processes the information to identify qualifying activities, such as reaching certain betting thresholds, playing specific games, or engaging in game play for a predetermined duration. This analysis is notable for ensuring that rewards are allocated based on objective criteria, maintaining the integrity of the promotional programs. It allows the casino to recognize and reward patrons' engagement effectively, fostering a positive gaming environment that encourages continued patron loyalty and participation.

2108: Award Patron with Advantage Spin Credit(s)?

This decision-making step involves determining whether a patron's analyzed gaming activities qualify them for the award of Advantage Spin credits. Based on the outcome of the analysis conducted in the previous step, the ASCMS either triggers the award process for eligible patrons or continues monitoring for those who have yet to meet the criteria. This step is notable, as it represents the point at which eligible gaming behaviors are formally recognized and rewarded. An affirmative decision here leads to the direct enhancement of the patron's gaming experience through the provision of Advantage Spin credits, offering additional opportunities for gameplay or strategic advantages.

### 2109: If No at 2108, Continue at 2104

If a patron's game play and wagering activities do not meet the promotion's criteria for awarding Advantage Spin credits at this stage, the process loops back to the monitoring phase. This ensures that the patron's ongoing activities at the EGMs are continuously tracked, providing further opportunities to qualify for rewards. This cyclical approach ensures that patrons are consistently engaged and incentivized to participate in gaming activities, with the possibility of qualifying for Advantage Spin credits in future gameplay.

### 2110: Issue Appropriate Quantity of Advantage Spin Credit(s)

Once a patron is deemed eligible for Advantage Spin credits, this step involves the issuance of those credits in the most appropriate form based on the patron's current engagement with the EGM. For patrons actively playing at an EGM, the credits are directly issued to the machine's Advantage Spin Meter, instantly available for use in the ongoing gaming session. For patrons not currently engaged at an EGM, the issuance takes the form of either a physical Advantage Spin Voucher or a digital voucher, which may be redeemed for Advantage Spin credits at a later time. This flexible issuance mechanism ensures that the reward process is tailored to the patron's situation, enhancing convenience and accessibility. Managed by the ASCMS in coordination with the Advantage Spin Credit Management System (ASCMS), this step is notable for operationalizing the reward decision, making the Advantage Spin credits readily available for the patron's use in enhancing their gaming experience.

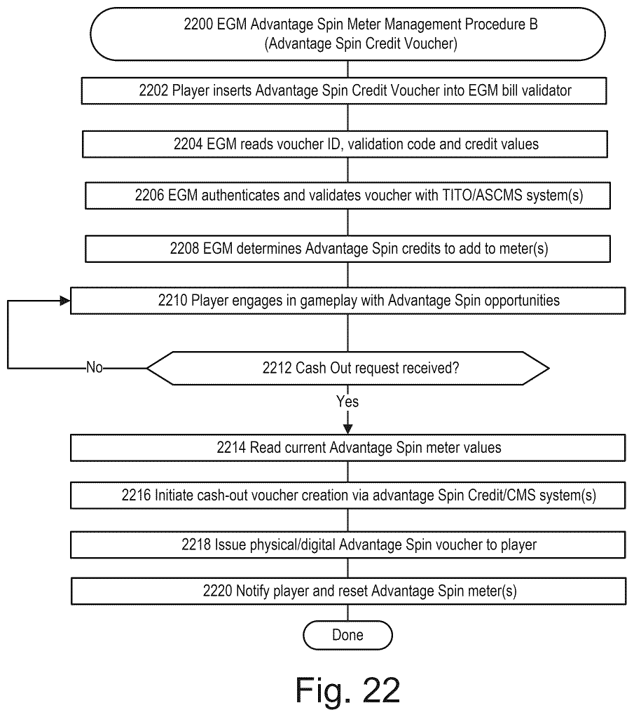

FIG. 22 illustrates an example embodiment of an EGM Advantage Spin Meter Management Procedure associated with Advantage Spin Credit Vouchers. In at least one embodiment, this procedure may be configured or designed to facilitate, enable, initiate, and/or perform one or more of the following operations, actions, and/or features described below.

The procedure begins at step 2202, where the player inserts an Advantage Spin Credit Voucher into the bill validator of the electronic gaming machine (EGM). At step 2204, the EGM reads the voucher's ID, validation code, and credit values encoded on the voucher. The system proceeds to step 2206, where it authenticates and validates the voucher with the TITO (Ticket-In-Ticket-Out) and/or Advantage Spin Credit Management System (ASCMS), confirming its legitimacy and credit allocation.

At step 2208, the EGM determines the Advantage Spin credits associated with the validated voucher and adds these credits to the appropriate Advantage Spin meter(s). The player then engages in gameplay utilizing these Advantage Spin opportunities, as specified in step 2210. The system continuously monitors for a cash-out request at step 2212. If no cash-out is requested, as determined in step 2213, the procedure loops back to step 2210 to continue gameplay. If a cash-out is requested, the process advances to step 2214, where the system reads the current values on the Advantage Spin meter(s).

At step 2216, the system initiates the creation of a new cash-out voucher using the Advantage Spin Credit/ASCMS system, reflecting the remaining credits. At step 2218, the EGM issues a physical or digital Advantage Spin voucher to the player. Finally, step 2220 involves notifying the player of the transaction's completion and resetting the Advantage Spin meter(s) to zero, preparing the EGM for future sessions.

This procedure ensures accurate credit tracking and secure transactions, providing players with seamless gameplay and redemption experiences. The integration of Advantage Spin vouchers with TITO and ASCMS systems enhances operational efficiency while offering flexibility in credit management.
2202 Player inserts Advantage Spin Credit Voucher in bill validator of EGM
2204 EGM reads inserted Advantage Spin Credit Voucher, and identifies Voucher ID, Validation Code, and Advantage Spin Credit value(s). The Advantage Spin Credit value(s) represent the type(s) and/or quantities of Advantage Spin credits to be added to the EGM's Advantage Spin Credit meter(s).
2206 EGM communicates with ASCMS (and/or CMS System) to authenticate and validate Advantage Spin Credit Voucher, and confirm the type(s) and respective quantity(s) of Advantage Spin credit(s) to be added to EGM's Advantage Spin credit meter(s).
2208 Upon successful authentication/validation, EGM determines the type(s) and value(s) of Advantage Spin credits to be added to the EGM's Advantage Spin credit meter(s).
   Embodiment A—Advantage Spin Credit Vouchers implemented via monetary credits. E.g., EGM dynamically calculates and updates the quantity of Advantage Spin credits displayed at its Advantage Spin Credit meter based on the value of the Advantage Spin Credit Voucher (e.g. $15), and based on the game's current bet denomination (Bet Denom) value (e.g., $0.01).
   Embodiment B—Advantage Spin Credit Vouchers implemented via credits for predefined Advantage Spin types (e.g. Reel Spin, Symbol Spin, etc.). E.g., EGM verifies that 3 Advantage Reel Spin credits and 2 Advantage Symbol Spin credits are to be added to EGM's Advantage Spin credit meters.
   Embodiment C—Advantage Spin Credit Vouchers implemented via non-monetary Advantage Spin points/credits. E.g., EGM adds 240 Advantage Spin credits to the Advantage Spin credit meter based on the value of the Advantage Spin Credit Voucher (e.g. 240 Advantage Spin credits).
2210 Player engages in wager-based gameplay of wager-based game(s) at the EGM. During active gameplay, the EGM may offer the player one or more opportunities to re-spin one or more selected reel(s) and/or symbol(s) in exchange for consuming one or more Advantage Spin credits from the EGM's Advantage Spin credit meter(s). The player may also be awarded one or more additional Advantage Spin credits during active gameplay, and the EGM will automatically add the awarded Advantage Spin credits to the EGM's Advantage Spin credit meter(s).
2212 Cash Out Request received?
2213 If no at 2212, continue at 2210.
2214, If yes at 2212, EGM reads current value(s) of its Advantage Spin meter(s). These value(s) represent the type(s) and/or quantities of Advantage Spin credits to be cashed out from the EGM and issued to the player via an Advantage Spin Credit Voucher.
2216 EGM initiates procedures for causing a CASH-OUT Advantage Spin Credit Voucher to be dispensed from the EGM's ticket printer. EGM communicates with the ASCMS and/or CMS to create a CASH-OUT Advantage Spin Credit Voucher representing type(s), quantities, and/or values of the Advantage Spin credits being cashed out from the EGM.
   According to different embodiments, Advantage Spin Voucher(s) may be issued by EGM as a physical Advantage Spin Voucher or digital Advantage Spin Voucher.
2218 Player receives physical Advantage Spin Voucher and/or digital Advantage Spin Voucher issued by EGM.
2220 Upon issuing Advantage Spin Voucher, the EGM:
   notifies the player of the confirmation, and
   resets the EGM Advantage Spin credit meter(s) to zero.

### 2202 Player Inserts Advantage Spin Credit Voucher in Bill Validator of EGM

When a player receives an Advantage Spin Credit Voucher, indicative of earned or awarded Advantage Spin credits, the initial step in utilizing these credits is their insertion into the bill validator of an Electronic Gaming Machine (EGM). This process is straightforward: the player slides the voucher, which bears a unique identifier and associated Advantage Spin Credit values, into the designated slot on the EGM. This action initiates the machine's recognition and processing of the voucher. The bill validator is equipped with scanning technology to accurately read the voucher's details, including the Voucher ID, Validation Code, and the specific types and quantities of Advantage Spin credits it represents. This step is notable as it bridges the player's tangible voucher with the digital crediting system of the EGM, setting the stage for the authentication and validation processes that follow.

### 2204 EGM Reads Inserted Advantage Spin Credit Voucher

Upon insertion, the EGM employs its integrated scanning technology to meticulously read and interpret the inserted Advantage Spin Credit Voucher. This involves identifying notable information encoded on the voucher, such as the Voucher ID, Validation Code, and the specific Advantage Spin Credit values. These values denote the type and quantity of Advantage Spin credits eligible for addition to the EGM's Advantage Spin Credit meters. This step is notable for ensuring that the EGM accurately recognizes and prepares to validate the voucher against the casino's TITO System (Ticket-In, Ticket-Out) and/or ASCMS. It sets the foundation for a secure and seamless integration of the player's voucher into the gaming session, ensuring the correct credit allocation.

2206 EGM Communicates with ASCMS

Following the reading of the voucher, the EGM initiates communication with the Ticket-In Ticket-Out (TITO) System and/or the Advantage Spin Credit Management System (ASCMS) to authenticate and validate the Advantage Spin Credit Voucher. This step involves verifying the voucher's legitimacy, confirming that the types and quantities of Advantage Spin credits detailed on the voucher are valid and have not been previously redeemed. The process includes checking the voucher against a database of issued and redeemed vouchers, ensuring it matches an authentic voucher that was issued under the correct circumstances and within the allowed timeframe. This step is notable for maintaining the integrity of the gaming system and preventing fraudulent activities.

### 2208 Upon Successful Authentication/Validation

Once the voucher passes the authentication and validation checks, the EGM proceeds to determine the specific types and values of Advantage Spin credits to be credited to the player's Advantage Spin credit meter(s). This determination is made based on the voucher's encoded information and may manifest in various embodiments, such as monetary credits, predefined Advantage Spin types (e.g., Reel Spin, Symbol Spin), or non-monetary Advantage Spin points/credits.

### Embodiment A—Advantage Spin Credit Vouchers Implemented Via Monetary Credits

Upon successful authentication and validation of the Advantage Spin Credit Voucher, the Electronic Gaming Machine (EGM) enters into a process to convert the voucher's monetary value into Advantage Spin credits. In this embodiment, the EGM's software algorithm dynamically calculates the number of spins or game plays the voucher's monetary value may procure, factoring in the game's current betting denomination. For instance, if the voucher is valued at $15 and the game's bet denomination is set at $0.01, the EGM's system translates this into 1500 Advantage Spin credits. This calculation is executed through a series of sub-steps that involve reading the voucher's monetary value, determining the current bet denomination of the game being played, and applying a conversion formula to ascertain the equivalent number of Advantage Spin credits. These credits are then updated and displayed on the EGM's Advantage Spin Credit meter, immediately available for the player to use. This embodiment allows for a fluid transition of voucher value into actionable game credits, enhancing the player's gaming experience by providing additional opportunities for gameplay without necessitating further cash inputs.

### Embodiment B—Advantage Spin Credit Vouchers Implemented Via Credits for Predefined Advantage Spin Types

In Embodiment B, the Electronic Gaming Machine (EGM) specializes in adding specific types of Advantage Spin credits, such as Reel Spin or Symbol Spin, directly into its system. Once the EGM confirms the voucher's authenticity and value, it proceeds to decode the specific types and quantities of spins awarded. For example, if the voucher indicates that it is worth 3 Advantage Reel Spin credits and 2 Advantage Symbol Spin credits, the EGM will allocate these credits accordingly to their respective credit meters. This allocation process involves the EGM's software identifying the voucher's specifications, verifying these against the game's configurations, and then accurately crediting the player's session with the specified Advantage Spin credits. This direct assignment of spin types offers players a tailored gaming experience, allowing for strategic gameplay decisions based on the specific spins available. Players may then utilize these spins to potentially enhance their game outcomes based on the spins' strategic use.

### Embodiment C—Advantage Spin Credit Vouchers Implemented via Non-monetary Advantage Spin Points/Credits

For Embodiment C, the Electronic Gaming Machine (EGM) operates on a points or non-monetary credits system to add Advantage Spin credits. When a player inserts an Advantage Spin Credit Voucher, the EGM, after validating the voucher, converts its value into a specific number of Advantage Spin points. For instance, a voucher valued at 240 Advantage Spin credits will result in the EGM adding exactly that number of credits to the player's Advantage Spin credit meter. This process entails the EGM's software calculating the points conversion based on the voucher's stated credits, which do not directly correlate with monetary value or specific bet denominations but rather represent a quantified advantage in gameplay. This points-based system emphasizes the gaming advantage provided by the voucher, allowing players to extend their playtime or enhance their game strategy through the use of these credits. It offers a straightforward approach to reward redemption, directly increasing the player's available credits for further gameplay.

Each embodiment entails a different method of crediting, ranging from dynamically calculating the quantity of Advantage Spin credits based on monetary value and bet denomination, to directly adding specific types of spins or non-monetary credits to the player's meter. This notable step translates the voucher's potential into actionable gaming opportunities for the player.

### 2210 Player Engages in Wager-Based Gameplay

With the Advantage Spin credits successfully added to the EGM's meter(s), the player engages in wager-based gameplay. This engagement may involve the strategic use of Advantage Spin credits to re-spin selected reels and/or symbols, potentially enhancing the player's chances of winning or achieving specific game outcomes. The EGM offers opportunities for the player to use these credits as part of the gameplay, while also being capable of awarding additional Advantage Spin credits based on certain game events or outcomes. This active gameplay phase highlights the dynamic interaction between the player's decisions, the game mechanics, and the utilization of Advantage Spin credits, enriching the overall gaming experience.

### 2212 Cash Out Request Received?

This step inquires whether a player has initiated a cash-out request for their accumulated Advantage Spin credits. It represents a decision point within the gaming session, where the EGM checks if the player wishes to conclude their use of Advantage Spin credits and convert their remaining credits into a tangible form, such as a TITO voucher. This step is notable for facilitating player decisions regarding the continuation of gameplay or the realization of their accrued credits, enabling a flexible gaming experience that accommodates individual player preferences and strategies.

### 2213 If No at 2212, Continue at 2210

If the player decides against cashing out their Advantage Spin credits, the gameplay cycle continues. This decision allows the player to extend their gaming session, leveraging remaining or newly awarded Advantage Spin credits for further wager-based gameplay. This continuation underscores the fluid nature of the gaming experience, where players may dynamically choose how and when to utilize their Advantage Spin credits, fostering ongoing engagement and interaction with the game.

### 2214 If Yes at 2212, EGM Reads Current Value(s)

Upon receiving a cash-out request, the EGM proceeds to read the current values of its Advantage Spin meter(s). This step involves assessing the types and quantities of Advantage Spin credits available for cash-out, translating the digital credits into a value that may be represented on a TITO voucher. This process is desirable for accurately reflecting the player's accrued credits in a form that may be redeemed, ensuring a smooth transition from digital credits to physical or digital vouchers, and maintaining the integrity of the gaming and redemption processes.

### 2216 EGM Initiates Procedures for Dispensing a CASH-OUT Voucher

Following the assessment of Advantage Spin credits, the EGM initiates the procedure for dispensing a CASH-OUT Advantage Spin Credit Voucher. This involves communicating with the ASCMS and/or CMS to generate a voucher that accurately represents the types, quantities, and values of the Advantage Spin credits being cashed out. This step is fundamental in the redemption process, ensuring that the player receives a physical or digital voucher that correctly reflects their earned credits, allowing for a tangible representation of their gaming session's outcomes.

### 2218 Player Receives Physical/Digital Advantage Spin Voucher

The culmination of the cash-out process sees the player receiving the issued Advantage Spin Voucher, either in a physical form from the EGM's ticket printer or as a digital voucher, depending on the system's capabilities and the player's preference. This step marks the successful conversion of accumulated Advantage Spin credits into a redeemable format, providing the player with a tangible or digital asset that represents their gaming achievements and accrued benefits.

### 2220 Upon Issuing Advantage Spin Voucher

The final step in the process involves the EGM notifying the player of the successful issuance and confirmation of the Advantage Spin Voucher, followed by resetting the Advantage Spin credit meter(s) to zero. This reset prepares the EGM for future gameplay sessions, ensuring a fresh start for the next player and maintaining the fairness and integrity of the gaming experience. The notification to the player serves as a closure to their current session, providing clarity and satisfaction regarding the redemption of their Advantage Spin credits.

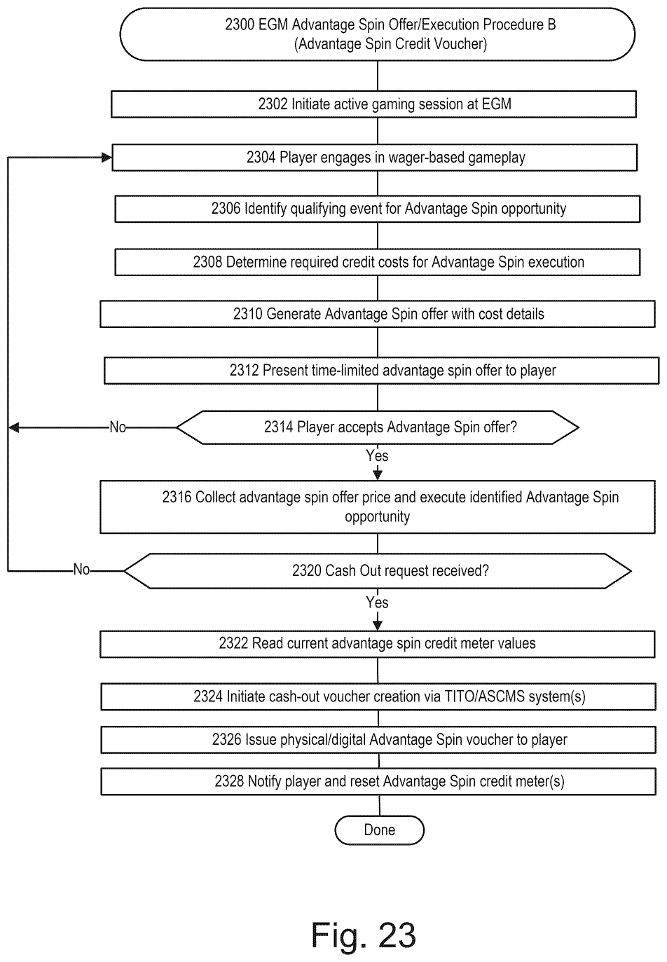

FIG. 23 illustrates an example embodiment of an EGM Advantage Spin Offer/Execution Procedure associated with Advantage Spin Credit Vouchers. In at least one embodiment, this procedure may be configured or designed to facilitate, enable, initiate, and/or perform one or more of the following operations, actions, and/or features described below.

The procedure begins at step 2302, where an active gaming session is initiated at the electronic gaming machine (EGM). At step 2304, the player engages in wager-based gameplay, and the system monitors game activities to identify qualifying events for Advantage Spin opportunities, as described in step 2306. Upon detecting a qualifying event, step 2308 determines the credit costs required for executing the identified Advantage Spin opportunity.

At step 2310, the system generates an Advantage Spin offer that includes detailed cost information and potential rewards. This offer is presented to the player in step 2312 as a time-sensitive option. At step 2314, the player decides whether to accept the Advantage Spin offer. If the player declines, as determined in step 2315, the system loops back to gameplay monitoring at step 2304. If the player accepts, the system proceeds to step 2316 to initiate funding procedures, which involve deducting the specified credits from the Advantage Spin meter or a voucher balance and executing the identified Advantage Spin opportunity.

The system continues to monitor for a cash-out request at step 2320. If no cash-out is requested, as indicated in step 2321, the procedure returns to gameplay monitoring at step 2304. If a cash-out request is made, the process advances to step 2322, where the system reads the current Advantage Spin meter values. At step 2324, the system creates a CASH-OUT voucher through the TITO (Ticket-In-Ticket-Out) or Advantage Spin Credit Management System (ASCMS). At step 2326, the CASH-OUT voucher is issued to the player, and finally, in step 2328, the player is notified, and the Advantage Spin meter(s) are reset to zero for subsequent gaming sessions.

This procedure combines dynamic Advantage Spin offer generation with seamless credit management and secure voucher issuance. It enhances player engagement by providing targeted gameplay opportunities while ensuring efficient and accurate handling of Advantage Spin credits and associated transactions.
2302 Player initiates active gaming session of wager-based game at EGM.
2304 Player engages in wager-based gameplay of wager-based game at the EGM.
2306 EGM identifies, during active gaming session, occurrence of in-game event/condition permitting player to consume one or more Advantage Spin credit(s) for initiating an identified Advantage Spin (or re-spin) opportunity.
2308 EGM dynamically determines type(s) and quantity(s) of Advantage Spin credit(s) required to be consumed in order to fund execution of identified Advantage Spin (or re-spin) opportunity. Example Embodiments:
   2308a (Option 1) Dynamically determine cost of funding execution of identified Advantage Spin opportunity based on game Bet Denom value. E.g., EGM utilizes Advantage Spin lookup table and Bet Denom value to dynamically determine type(s) and quantity(s) of Advantage Spin credit(s) required to be consumed in order to initiate identified Advantage Spin opportunity.
   2308b (Option 2) Dynamically determine cost of funding execution of identified Advantage Spin opportunity independent of game Bet Denom value. E.g., EGM utilizes Advantage Spin lookup table to dynamically determine type(s) and quantity(s) of Advantage Spin credit(s) required to be consumed in order to initiate identified Advantage Spin opportunity.
2310 EGM generates an Advantage Spin Offer for the identified Advantage Spin opportunity. Advantage Spin Offer including details specifying the cost (e.g., type(s) and quantity(s) of Advantage Spin credit(s), and/or game credits(s)) needed to fund execution of identified Advantage Spin (or re-spin) opportunity.
2312 EGM presents Advantage Spin Offer to player. In at least one embodiment the Advantage Spin Offer may be configured as a limited-time offer in which the player is required to provide input within a specified time inerval, indicating the player's acceptance of the offer In at least one embodiment, the EGM may display a timer for the player to accept the Advantage Spin Offer.
2314 Player elects to consume Advantage Spin credit for initiating identified Advantage Spin opportunity?
2315 If NO (or timer expiration) at 2314, continue at 2304.
2316 If YES at 2314, EGM initiates procedures for securing required funding for executing identified Advantage Spin opportunity.
   2316(a) EGM reads current value(s) of Advantage Spin credit meter(s) to determine if there are sufficient type(s)/quantity(s) of Advantage Spin credits available for consumption to fund execution of the identified Advantage Spin opportunity.
   2318a If YES at 2316(a), EGM consumes the determined type(s)/quantity(s) of Advantage Spin credit(s) from EGM's Advantage Spin credit meter(s), and initiates execution of the identified Advantage Spin opportunity.
   2319a If NO at 2316(a), the EGM determines the amount of game credit(s) required for funding execution of the identified Advantage Spin opportunity, consumes the determined amount of game credit(s) from EGM's Game Credit meter, and initiates execution of the identified Advantage Spin opportunity.
2320 Cash Out Request received?
2321 If no at 2320, continue at 2304.
2322 If yes at 2320, EGM reads current value(s) of its Advantage Spin meter(s). These value(s) represent the type(s) and/or quantities of Advantage Spin credits to be cashed out from the EGM and issued to the player via an Advantage Spin Credit Voucher.
2324 EGM initiates procedures for causing a CASH-OUT Advantage Spin Credit Voucher to be dispensed from the EGM's ticket printer. EGM communicates with ASCMS and/or CMS to create a CASH-OUT Advantage Spin Credit Voucher representing type(s), quantities, and/or values of the Advantage Spin credits being cashed out from the EGM. According to different embodiments, Advantage Spin Voucher(s) may be issued by EGM as a physical Advantage Spin Voucher or digital Advantage Spin Voucher.
2326 Player receives CASH-OUT Advantage Spin Credit Voucher from EGM.
2328 Upon issuing Advantage Spin Credit Voucher, the EGM:
   notifies the player of the confirmation, and
   resets the EGM Advantage Spin credit meter(s) to zero.

2302 Player Initiates Active Gaming Session of Wager-Based Game at EGM When a player initiates an active gaming session at an Electronic Gaming Machine (EGM), they are engaging with the machine to participate in a wager-based game. This step is notable as it marks the beginning of the player's interaction with the gaming system. The process typically involves the player inserting a form of payment, such as cash, a casino card, or a Ticket-In Ticket-Out (TITO) voucher, into the EGM. Following this, the player selects their desired game from the available options presented on the EGM's interface. The initiation of a game session triggers the EGM to activate its game software, preparing the system for the player's input regarding bet amounts and, if applicable, pay lines. This step is designed to be user-friendly, ensuring that players of all experience levels may easily start their gaming session, setting the stage for their engagement with the game's features and the potential use of Advantage Spin credits.

2304 Player Engages in Wager-Based Gameplay of Wager-Based Game at the EGM Upon initiating the gaming session, the player begins to engage in the core activity of the wager-based game. This involves making selections related to their bet size and, in games where this is an option, choosing pay lines or specific game features they wish to activate. As the player makes these selections and confirms their choices, the EGM processes the inputs and begins the gameplay cycle, which includes spinning reels, dealing cards, or any other game mechanics relevant to the selected game. This step is central to the gaming experience, as it is where the player's strategies, choices, and luck interact with the game's mechanics to determine outcomes. Throughout this engagement, the EGM continuously monitors and records the player's activities, including bets placed, outcomes of each game round, and any special game features that are activated.

2306 EGM Identifies Occurrence of In-Game Event/Condition Permitting Advantage Spin During the player's active gaming session, the EGM actively monitors for specific in-game events or conditions that qualify for the initiation of an Advantage Spin (or re-spin) opportunity. These conditions are predefined within the game's programming and may include hitting certain symbol combinations, achieving specific outcomes, or random triggers designed to enhance player engagement. Once such an event or condition is identified, the EGM internally flags this occurrence, marking it as a potential opportunity for the player to utilize their Advantage Spin credits. This step is notable as it dynamically responds to the evolving game state, offering players additional chances to influence their game outcomes positively.

2308 EGM Dynamically Determines Type(s) and Quantity(s) of Advantage Spin Credits Required The EGM then proceeds to dynamically determine the specific types and quantities of Advantage Spin credits required to fund the execution of the identified Advantage Spin opportunity. This determination is made based on several factors, including the game's current Bet Denomination value or independent of it, as outlined in options 2308a and 2308b.

### 2308a (Option 1)—Based on Game Bet Denomination Value

In the embodiment 2308a, the Electronic Gaming Machine (EGM) leverages a strategic approach to calculate the cost required for a player to engage in an identified Advantage Spin opportunity, directly correlating this cost with the game's Bet Denomination (Bet Denom) value. This method entails a series of meticulously designed sub-steps to ensure that the calculation is both accurate and fair, thereby enhancing the player's gaming experience while maintaining the integrity of the gaming operation.

Initially, the EGM accesses an internal Advantage Spin lookup table-a comprehensive database that contains various scenarios and the corresponding cost in terms of Advantage Spin credits for each based on the Bet Denom value. This table is a notable component, as it allows the EGM to dynamically adjust the cost depending on the Bet Denom value set by the player at the time the Advantage Spin opportunity is identified.

For instance, if a player is engaged in a game with a higher Bet Denom value, the cost in Advantage Spin credits to initiate the Advantage Spin opportunity may be higher, reflecting the increased stake and potential reward associated with the game's settings. Conversely, for games set at a lower Bet Denom value, the cost in Advantage Spin credits would be adjusted downwards, making the opportunity accessible without disproportionately affecting the player's credit balance.

To execute this determination, the EGM first reads the current Bet Denom value set by the player. It then queries the lookup table, matching the Bet Denom value with the appropriate cost in Advantage Spin credits. This process may involve complex algorithms to ensure that the cost is calculated fairly, taking into account not only the Bet Denom value but also other factors such as the potential payouts and the rarity of the triggering event or condition.

Upon determining the required types and quantities of Advantage Spin credits, the EGM updates the game interface to display this information to the player, offering them a transparent and informed choice about whether to proceed with the Advantage Spin opportunity.

### 2308b (Option 2)—Independent of Game Bet Denomination Value

In the alternative embodiment 2308b, the EGM calculates the cost of engaging in an identified Advantage Spin opportunity independently of the game's Bet Denomination (Bet Denom) value. This approach offers a uniform cost structure for Advantage Spin opportunities across different Bet Denom settings, providing a consistent experience for players regardless of their chosen stake levels.

Similar to embodiment 2308a, the EGM relies on an internal Advantage Spin lookup table for this calculation. However, in this scenario, the lookup table is structured to define the cost in Advantage Spin credits for various opportunities without linking these costs to the Bet Denom value. This means that the cost for an Advantage Spin opportunity is predetermined and remains consistent, allowing players to anticipate the number of Advantage Spin credits they may need to engage in such opportunities, fostering a sense of fairness and transparency.

To implement this method, when an Advantage Spin opportunity is identified during gameplay, the EGM consults the Advantage Spin lookup table to retrieve the predetermined cost associated with that specific opportunity. This involves accessing a database entry that corresponds to the identified opportunity and retrieving the fixed cost in terms of types and quantities of Advantage Spin credits.

This fixed cost approach simplifies the decision-making process for players by providing them with straightforward information on the cost associated with the Advantage Spin opportunity, independent of their current game settings or the Bet Denom value. It ensures that all players, regardless of their betting strategy or game preferences, are presented with equitable opportunities to enhance their gameplay through the utilization of Advantage Spin credits.

Following the determination, the EGM updates the game interface accordingly, displaying the fixed cost to the player and enabling them to make an informed decision on whether to accept the Advantage Spin offer. This method enhances player engagement by offering a clear and consistent framework for accessing additional gameplay opportunities, enriching the overall gaming experience.

In at least one embodiment, the EGM utilizes one or more internal lookup table(s) (e.g., FIG. A15), which correlates the game's conditions with the requisite Advantage Spin credit metrics, to calculate the cost of initiating the Advantage Spin opportunity. This step is notable as it ensures the cost associated with the Advantage Spin opportunity is appropriately aligned with the game's economics, offering a fair and enticing proposition to the player.

2310 EGM Generates an Advantage Spin Offer Following the determination of the required Advantage Spin credits, the EGM generates an Advantage Spin Offer. This offer is meticulously crafted to detail the identified Advantage Spin opportunity, specifying the cost in terms of the type(s) and quantity(s) of Advantage Spin credits, and/or game credits, needed to fund the execution of the opportunity. The offer is designed to be clear and compelling, presenting the player with an informed choice about whether to proceed with the Advantage Spin, based on the potential benefits and the associated cost.

2312 EGM Presents Advantage Spin Offer to Player The EGM then presents the Advantage Spin Offer to the player, possibly incorporating a limited-time element to instill a sense of urgency in the decision-making process. In some embodiments, a timer is displayed alongside the offer, indicating the window within which the player must decide to accept the offer. This presentation is crafted to be engaging and informative, ensuring the player understands the opportunity at hand, including the potential for enhanced gameplay and outcomes. The inclusion of a timer serves to enhance the excitement and decision-making process, encouraging players to actively engage with the offer.

2314 Player Elects to Consume Advantage Spin Credit for Initiating Identified Advantage Spin Opportunity At this juncture, the player is faced with the decision to accept the Advantage Spin Offer by electing to consume the specified Advantage Spin credit(s) for initiating the identified Advantage Spin opportunity. This decision point is notable as it directly influences the course of the player's gaming session. The player weighs the cost against the potential benefits of the Advantage Spin, considering their current game strategy and the likelihood of achieving favorable outcomes. The EGM awaits the player's input, which will dictate the next steps in the process.

2315 If NO (or Timer Expiration) at 2314, Continue at 2304 Should the player decide not to accept the Advantage Spin Offer, or if the decision is not made within the specified timer window, the process loops back to step 2304, where the player continues their wager-based gameplay without the activation of the Advantage Spin opportunity. This outcome ensures that the gameplay progresses smoothly, with the player having the autonomy to make strategic choices based on their preferences and risk appetite. The EGM remains ready to identify future in-game events or conditions that may trigger another Advantage Spin opportunity, maintaining a dynamic and engaging gaming experience.

2316 If YES at 2314, EGM Initiates Procedures for Securing Required Funding for Executing Identified Advantage Spin Opportunity Upon the player's acceptance of the Advantage Spin Offer, the EGM initiates a sequence of procedures aimed at securing the required funding for the execution of the identified Advantage Spin opportunity. This involves a detailed assessment of the player's available resources, including the current values of the Advantage Spin credit meter(s) and, if necessary, the Game Credit meter, to confirm the availability of sufficient credits to fund the opportunity.

2316(a) EGM Reads Current Value(s) of Advantage Spin Credit Meter(s) As part of the funding assessment, the EGM reads the current values of the Advantage Spin credit meter(s) to ascertain if there are sufficient types and quantities of Advantage Spin credits available for consumption. This involves querying the internal credit management system to retrieve up-to-date information on the player's Advantage Spin credit balance. The accuracy of this assessment is notable as it determines the feasibility of proceeding with the execution of the Advantage Spin opportunity based on the player's accumulated credits.

2318a If YES at 2316(a), EGM Consumes the Determined Type(s)/Quantity(s) of Advantage Spin Credit(s) If the assessment confirms that there are sufficient Advantage Spin credits available, the EGM proceeds to consume the determined types and quantities of Advantage Spin credits from the player's Advantage Spin credit meter(s). This consumption is a deductive process, carefully removing the specified amount of credits from the player's balance, thereby funding the execution of the Advantage Spin opportunity. The EGM ensures that this transaction is accurately processed, reflecting the updated credit balance on the player's interface.

2319a If NO at 2316(a), EGM Determines the Amount of Game Credit(s) Required In instances where the Advantage Spin credits are insufficient to fund the opportunity, the EGM assesses the amount of game credits required as an alternative funding source. This involves calculating the equivalent value of the Advantage Spin opportunity in game credits, taking into consideration the game's current economic parameters and the player's available game credit balance. The determination of this amount is conducted with precision, ensuring a fair conversion based on the established game mechanics and the player's gaming activity.

2320 Cash Out Request Received? This step introduces a decision point related to the player's intention to end their gaming session and cash out their accumulated credits, including any unused Advantage Spin credits. The EGM monitors for a cash-out request from the player, which may be initiated through an interface option or by removing their casino card or ending their session through other established mechanisms. The detection of a cash-out request triggers the EGM to proceed with the necessary steps to facilitate the cash-out process, maintaining a seamless and player-friendly gaming experience.

2321 If No at 2320, Continue at 2304 If no cash-out request is received, indicating the player wishes to continue their gaming session, the process loops back to step 2304. The player resumes their wager-based gameplay, with the EGM remaining attentive to the ongoing game state and prepared to identify further opportunities for Advantage Spin offers. This continuation ensures that the dynamic and engaging nature of the gaming experience is maintained, with the player having the freedom to pursue additional gameplay strategies and outcomes.

2322 If Yes at 2320, EGM Reads Current Value(s) of Its Advantage Spin Meter(s) Upon receiving a cash-out request, the EGM reads the current values of its Advantage Spin meter(s) to determine the types and quantities of Advantage Spin credits available for cashing out. This step involves a precise assessment of the player's accumulated Advantage Spin credits, ensuring an accurate representation of the credit balance that is eligible for cash out. The EGM's internal systems process this information, preparing for the issuance of a Ticket-In Ticket-Out (TITO) voucher that accurately reflects the value of the credits to be cashed out.

2324 EGM Initiates Procedures for Causing a CASH-OUT Advantage Spin Credit Voucher to be Dispensed Following the determination of the Advantage Spin credits available for cash out, the EGM initiates a series of procedures to facilitate the dispensing of a CASH-OUT Advantage Spin Credit Voucher. This involves communication between the EGM and the Advantage Spin Credit Management System (ASCMS) or the ASCMS to create a voucher that represents the types, quantities, and values of the Advantage Spin credits being cashed out. The EGM ensures that this process is executed securely and efficiently, generating a voucher in a physical or digital format, based on the operational capabilities of the casino and the preferences of the player.

2326 Player Receives CASH-OUT Advantage Spin Credit Voucher from EGM The player then receives the CASH-OUT Advantage Spin Credit Voucher dispensed from the EGM's ticket printer. This voucher serves as a tangible representation of the player's accumulated Advantage Spin credits, providing a means to redeem these credits for cash or game credits at designated casino locations. The receipt of the voucher marks a significant interaction between the player and the casino's gaming system, reinforcing the value of the player's engagement and the accumulated benefits derived from their gaming session.

2328 Upon Issuing Advantage Spin Credit Voucher, the EGM: Notifies the Player of the Confirmation, and Resets the EGM Advantage Spin Credit Meter(s) to Zero The final step in the procedure encompasses the EGM's actions following the issuance of the Advantage Spin Credit Voucher. The EGM notifies the player of the successful transaction, confirming the cash-out of the Advantage Spin credits. This notification is an important aspect of customer service, ensuring transparency and clarity regarding the transaction. Following the notification, the EGM resets its Advantage Spin credit meter(s) to zero, preparing the machine for the next player's session. This reset is desirable for maintaining the integrity of the gaming experience, ensuring that each player begins their session with a clear slate, without the carryover of credits from previous sessions.

During active gameplay, the player may consume one or more Advantage Spin credits and/or may be awarded one or more additional Advantage Spin credits. The EGM will automatically update the value(s) of the Advantage Spin meter(s) accordingly.

In at least one embodiment, for each spin outcome, the player will receive any win amounts that are due to the player based on that particular outcome so the player will get paid based on the outcome of the initial spin of all reels, or subsequent individual re-spends of selected reels, and the win amounts for each outcome will be paid out in addition to the EGM offering the player additional Advantage Spin opportunities to possibly keep re-spinning one or more reels/symbols to try to obtain greater payout win amounts.

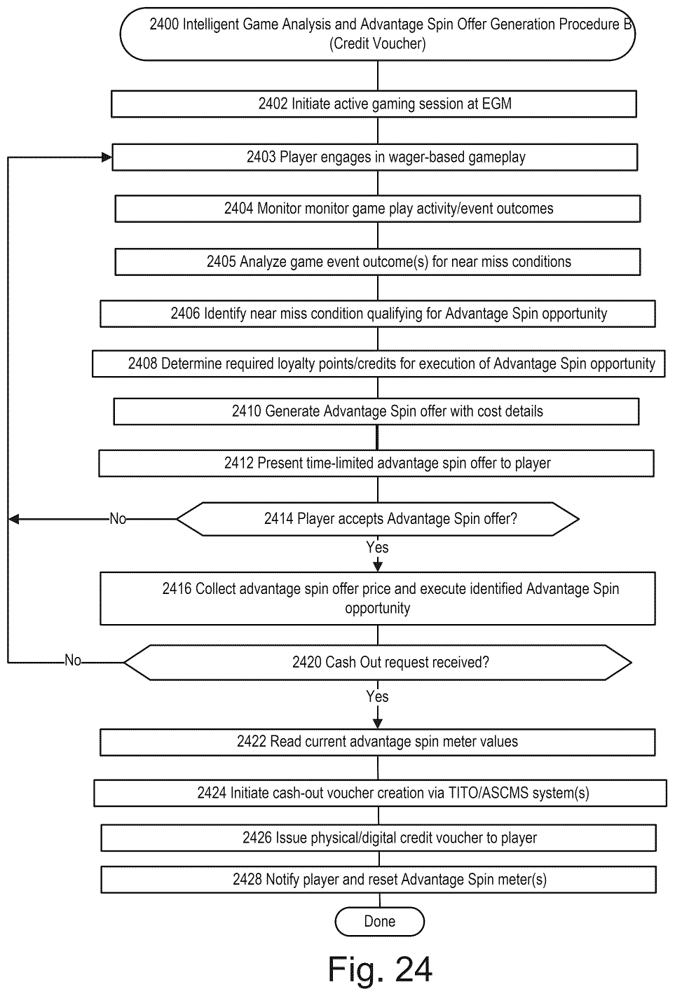

FIG. 24 illustrates an example embodiment of an Intelligent Game Analysis and Advantage Spin Offer Generation Procedure associated with Advantage Spin Credit Vouchers. In at least one embodiment, this procedure may be configured or designed to facilitate, enable, initiate, and/or perform one or more of the following operations, actions, and/or features described below.

The procedure begins at step 2402, where an active gaming session is initiated at the electronic gaming machine (EGM). At step 2403, the player engages in wager-based gameplay, during which the system continuously monitors the current game state, as specified in step 2404. Step 2405 involves analyzing game state data to identify near miss conditions, such as narrowly missing a significant winning combination.

Upon detecting a qualifying near miss event, step 2406 determines its eligibility for an Advantage Spin opportunity. Step 2408 calculates the required credits for executing the Advantage Spin and advances to step 2410, where the system generates a targeted Advantage Spin offer, detailing the associated cost and potential rewards. This offer is presented to the player in step 2412 as a time-sensitive option, prompting immediate decision-making.

At step 2414, the player decides whether to accept the Advantage Spin offer. If the player declines, as indicated in step 2415, the procedure loops back to game monitoring at step 2404. If the player accepts, the system proceeds to step 2416, where it collects the specified Advantage Spin credits and executes the identified Advantage Spin opportunity.

The system continuously evaluates whether the player has initiated a cash-out request, as determined at step 2420. If no cash-out is requested, as indicated in step 2421, the procedure returns to monitoring the game state at step 2404. If a cash-out is requested, the system reads the current Advantage Spin meter values at step 2422 and proceeds to step 2424 to create a CASH-OUT voucher through the TITO (Ticket-In-Ticket-Out) or Advantage Spin Credit Management System (ASCMS). At step 2426, the CASH-OUT voucher is issued to the player, and in step 2428, the player is notified, and the Advantage Spin meter(s) are reset to zero, preparing the system for subsequent sessions.

This procedure integrates advanced game state analysis with dynamic Advantage Spin offer generation, enabling targeted gameplay enhancements. The use of Advantage Spin Credit Vouchers ensures secure and flexible credit management, fostering player engagement and seamless reward transactions.

In at least one embodiment, Intelligent Game State Analysis And Advantage Spin Offer Engine (e.g., 1023, FIG. 10) analyzes game state for near misses (near hits), generates and presents Advantage Spin offer(s) to player, and promts player to accept (proceed)/reject (decline) Advantage Spin offer(s). In at least one embodiment, at least a portion of this procedure may be performed by the Intelligent Game State Analysis And Advantage Spin Offer Engine.
2402 Player initiates active gaming session of wager-based game at EGM.
2403 Player engages in wager-based gameplay of wager-based game at the EGM.
2404 EGM monitors current game state of wager-based game.
2405 EGM analyzes (e.g., in real-time) current game state data to identify occurrence of any near miss (or near hit) conditon(s).
   In at least one embodiment, the Intelligent Game State Analysis And Advantage Spin Offer Engine may be configured or designed to include functionality for concurrently analyzing multiple payout lines of the game state outcome, identifying possible near hits for one or more of the payout lines, determine potential win amount values for each pay outline respin scenario, and identify the most profitable respin scenario(s) for presentation as an Advantage Spin offer to the player.
2406 EGM identifies, during active gaming session, occurrence of a “near miss” or “near hit” event/condition which provides for an Advantage Spin (or re-spin) opportunity.
2408 EGM dynamically determines type(s) and quantity(s) of Advantage Spin credit(s) required to be consumed in order to fund execution of identified Advantage Spin (or re-spin) opportunity. Example Embodiments:
   2408a (Option 1) Dynamically determine cost of funding execution of identified Advantage Spin opportunity based on game Bet Denom value. E.g., EGM utilizes Advantage Spin lookup table and Bet Denom value to dynamically determine type(s) and quantity(s) of Advantage Spin credit(s) required to be consumed in order to initiate identified Advantage Spin opportunity.
   2408b (Option 2) Dynamically determine cost of funding execution of identified Advantage Spin opportunity independent of game Bet Denom value. E.g., EGM utilizes Advantage Spin lookup table to dynamically determine type(s) and quantity(s) of Advantage Spin credit(s) required to be consumed in order to initiate identified Advantage Spin opportunity.
2410 EGM generates an Advantage Spin Offer for the identified Advantage Spin opportunity. Advantage Spin Offer including details specifying the cost (e.g., type(s) and quantity(s) of Advantage Spin credit(s), and/or game credits(s)) needed to fund execution of identified Advantage Spin (or re-spin) opportunity.
2412 EGM presents Advantage Spin Offer to player. In at least one embodiment the Advantage Spin Offer may be configured as a limited-time offer in which the player is required to provide input within a specified time inerval, indicating the player's acceptance of the offer In at least one embodiment, the EGM may display a timer for the player to accept the Advantage Spin Offer.
2414 Player elects to consume Advantage Spin credit for initiating identified Advantage Spin opportunity?
2415 If NO (or timer expiration) at 2414, continue at 2404.
2416 If YES at 2414, EGM initiates procedures for securing required funding for executing identified Advantage Spin opportunity.
   2416(a) EGM reads current value(s) of Advantage Spin credit meter(s) to determine if there are sufficient type(s)/quantity(s) of Advantage Spin credits available for consumption to fund execution of the identified Advantage Spin opportunity.
   2418a If YES at 2416(a), EGM consumes the determined type(s)/quantity(s) of Advantage Spin credit(s) from EGM's Advantage Spin credit meter(s), and initiates execution of the identified Advantage Spin opportunity.
   2419a If NO at 2416(a), the EGM determines the amount of game credit(s) required for funding execution of the identified Advantage Spin opportunity, consumes the determined amount of game credit(s) from EGM's Game Credit meter, and initiates execution of the identified Advantage Spin opportunity.
2420 Cash Out Request received?
2421 If no at 2420, continue at 2404.
2422 If yes at 2420, EGM reads current value(s) of its Advantage Spin meter(s). These value(s) represent the type(s) and/or quantities of Advantage Spin credits to be cashed out from the EGM and issued to the player via an Advantage Spin Credit Voucher.
2424 EGM initiates procedures for causing a CASH-OUT Advantage Spin Credit Voucher to be dispensed from the EGM's ticket printer. EGM communicates with ASCMS and/or CMS to create a CASH-OUT Advantage Spin Credit Voucher representing type(s), quantities, and/or values of the Advantage Spin credits being cashed out from the EGM. According to different embodiments, Advantage Spin Voucher(s) may be issued by EGM as a physical Advantage Spin Voucher or digital Advantage Spin Voucher.
2426 Player receives CASH-OUT Advantage Spin Credit Voucher from EGM.
2428 Upon issuing Advantage Spin Credit Voucher, the EGM:
   notifies the player of the confirmation, and
   resets the EGM Advantage Spin credit meter(s) to zero.

### 2402 Player Initiates Active Gaming Session of Wager-Based Game at EGM

When a player approaches an Electronic Gaming Machine (EGM), their initial action is to commence an active gaming session. This step is fundamental, as it sets the stage for all subsequent interactions between the player and the EGM. Activation of a gaming session usually involves the player inserting a form of payment, such as cash, a casino card, or a ticket-in ticket-out (TITO) voucher, into the machine. Following this, the player selects their preferred wager-based game from the options available on the EGM. This process involves interaction with the machine's interface to navigate through game selections, understanding game rules, and making initial wager choices. The act of starting the session signifies the player's commitment to engage with the game, transitioning from a passive to an active participant in the gaming experience. This moment is notable, as it establishes the conditions under which the player will interact with the game, including setting bet amounts and activating pay lines or game features.

### 2403 Player Engages in Wager-Based Gameplay of Wager-Based Game at the EGM

Once the gaming session is initiated, the player proceeds to engage in the chosen wager-based gameplay. This engagement is characterized by the player making decisions on bet sizes, activating pay lines, and triggering game features in pursuit of winning combinations or game-specific objectives. As the reels spin or the game progresses, the player's anticipation builds, with each outcome potentially leading to wins or losses. The EGM captures and displays real-time data related to the player's credits, wins, and remaining balance. Engagement in this phase is dynamic, with the player continually making decisions based on the game's outcomes, their strategy, and their desired level of risk. This immersive interaction is a core aspect of the gaming experience, blending chance with strategic decision-making.

### 2404 EGM Monitors Current Game State of Wager-Based Game

Simultaneously with the player's engagement, the EGM meticulously monitors the ongoing game state. This involves tracking every action taken by the player, including bet amounts, pay line selections, and the outcomes of each spin or game round. The machine employs sophisticated software algorithms to record these details, ensuring accurate accounting of wins, losses, and overall player performance. This monitoring is notable for both operational integrity and providing the player with up-to-date information on their gaming session. It allows the EGM to respond appropriately to game events, such as triggering bonus rounds or jackpot wins, based on the game's programmed rules and the player's interactions.

### 2405 EGM Analyzes Current Game State Data to Identify Occurrence of any Near Miss (or Near Hit) Conditions

In this step, the EGM, through its Intelligent Game State Analysis And Advantage Spin Offer Engine, analyzes the current game state data in real-time. This analysis aims to identify any occurrences of near misses or near hits-situations where the player comes close to achieving a significant win but falls short by a small margin. This sophisticated analysis involves evaluating the outcomes of spins against a database of winning combinations, calculating the proximity of the player's outcome to these wins. The engine may concurrently analyze multiple payout lines, assessing potential win amounts for different re-spin scenarios and identifying the most profitable scenarios for the player. This deep analysis enhances player engagement by identifying opportunities for Advantage Spin offers, which may potentially turn near misses into wins, adding an additional layer of excitement and interaction to the gaming experience.

### 2406 EGM Identifies, During Active Gaming Session, Occurrence of a “Near Miss” or “Near Hit” Event/Condition Which Provides for an Advantage Spin (or Re-Spin) Opportunity

Following the real-time analysis, the EGM identifies specific instances within the gaming session where a near miss or near hit has occurred. This identification marks a notable point in the game where the player has come tantalizingly close to a significant win. Recognizing these events is notable because they present unique opportunities for Advantage Spin or re-spin. These opportunities are designed to offer the player a chance to ‘correct’ the near miss, potentially turning it into a win. The identification of such events is based on a predefined set of criteria programmed into the EGM's software, which considers the game's rules, the pay lines activated, and the symbols or outcomes that constitute a near miss or near hit.

2408 EGM dynamically determines type(s) and quantity(s) of Advantage Spin credit(s) required to be consumed in order to fund execution of identified Advantage Spin (or re-spin) opportunity

Once a near miss or near hit event is identified, the EGM takes a notable step by dynamically determining the types and quantities of Advantage Spin credits required to fund the execution of the identified Advantage Spin or re-spin opportunity. This process involves calculating the cost of executing the Advantage Spin based on various factors such as the game's bet denomination (Option 1) or independent of it (Option 2).

2408a Dynamically Determine Cost of Funding Execution of Identified Advantage Spin Opportunity Based on Game Bet Denom Value

In embodiment 2408a, the Electronic Gaming Machine (EGM) utilizes a sophisticated mechanism to dynamically calculate the cost of executing an identified Advantage Spin opportunity based on the game's bet denomination (Bet Denom) value. This process involves consulting an Advantage Spin lookup table that contains various Bet Denom values and their corresponding costs in terms of Advantage Spin credits needed to fund an Advantage Spin or re-spin opportunity. The calculation begins with the EGM detecting a near miss or near hit event during the gameplay, triggering the need for an Advantage Spin to potentially convert the near miss into a win.

The EGM then assesses the current Bet Denom set by the player for their wager, referencing the lookup table to determine the specific quantity and type of Advantage Spin credits required. For example, if the player's Bet Denom is set at a higher value, indicating a larger wager per spin, the cost in Advantage Spin credits to initiate a re-spin opportunity may also be higher, reflecting the increased potential payout. Conversely, a lower Bet Denom value would necessitate fewer Advantage Spin credits, suitable for players wagering smaller amounts.

This embodiment ensures that the cost of an Advantage Spin is proportionate to the player's current betting strategy, maintaining a balanced and fair gameplay experience. It allows players of all betting levels to access the Advantage Spin feature, tailoring the opportunity cost directly to their ongoing engagement with the game. The dynamic determination process is executed seamlessly in real-time, ensuring that the player is promptly presented with an accurately calculated Advantage Spin offer, enhancing their gaming experience by providing strategic opportunities tailored to their wagering choices.

2408b Dynamically Determine Cost of Funding Execution of Identified Advantage Spin Opportunity Independent of Game Bet Denom Value

In embodiment 2408b, the cost of funding the execution of an identified Advantage Spin opportunity is calculated independently of the game's Bet Denom value. This approach employs an Advantage Spin lookup table that is designed to determine the necessary types and quantities of Advantage Spin credits without direct reference to the player's current bet denomination. This method focuses on the intrinsic value and potential impact of the Advantage Spin opportunity itself, rather than the player's wagering level.

The EGM, upon identifying a suitable near miss or near hit scenario that qualifies for an Advantage Spin, engages its internal logic to reference the lookup table. This table provides predefined costs in Advantage Spin credits for various identified opportunities, calibrated to offer fairness and excitement across all gameplay scenarios. For instance, the cost in Advantage Spin credits for a re-spin opportunity that may potentially lead to a significant win is established based on the opportunity's rarity and expected value to the player, rather than the amount they have wagered on the current spin.

This embodiment allows for a more uniform application of the Advantage Spin feature across different games and bet levels, ensuring that the opportunity to alter the game outcome through an Advantage Spin is accessible and appealing to all players, regardless of their betting strategy. It simplifies the decision-making process for the player by providing a straightforward cost for the Advantage Spin opportunity, focused on the feature's entertainment value and potential reward. This model supports a diverse gaming experience, offering consistent access to strategic opportunities that enhance the player's engagement and enjoyment.

The EGM utilizes an Advantage Spin lookup table, which considers the current game state, the potential win amounts, and the probability of converting the near miss into a win. This step ensures that the offer made to the player is both enticing and fair, reflecting the value of the Advantage Spin opportunity in the context of the game's economics. The dynamic determination of the cost allows for a tailored approach to each identified opportunity, ensuring that the offer aligns with the specific circumstances of the near miss or near hit event.

### 2410 EGM Generates an Advantage Spin Offer for the Identified Advantage Spin Opportunity

Upon determining the cost of executing the identified Advantage Spin opportunity, the EGM proceeds to generate a specific Advantage Spin Offer. This offer is meticulously crafted to include all pertinent details such as the type(s) and quantity(s) of Advantage Spin credits or game credits needed to fund the execution of the identified opportunity. The offer outlines the conditions under which the player may engage in the Advantage Spin, including any specific requirements or limitations associated with the opportunity. This generation of the Advantage Spin Offer is a notable step in engaging the player, as it presents them with a tangible option to potentially enhance their gaming outcome based on the identified near miss or near hit event. The clarity and attractiveness of the offer are desirable for encouraging the player to consider using their credits to seize this opportunity for a re-spin or additional game action.

### 2412 EGM Presents Advantage Spin Offer to Player

Following the generation of the Advantage Spin Offer, the EGM presents this offer to the player in a clear and engaging manner. The presentation is designed to capture the player's attention and convey the value of the Advantage Spin opportunity. In some embodiments, the offer may be configured as a limited-time offer, compelling the player to make a timely decision. The EGM may display a countdown timer alongside the offer, emphasizing the urgency and exclusivity of the opportunity. This step is notable in the procedural flow, as it directly involves the player in the decision-making process, offering them a strategic choice that may potentially alter the outcome of their gaming session. The manner in which the offer is presented plays a significant role in the player's engagement and response, making it a notable moment in the gameplay experience.

### 2414 Player Elects to Consume Advantage Spin Credit for Initiating Identified Advantage Spin Opportunity?

At this juncture, the player is faced with a decision: whether to consume Advantage Spin credits to initiate the identified Advantage Spin opportunity. This decision point is notable, as it determines the player's engagement with the offer and their willingness to invest in potentially altering the game's outcome. The player's choice reflects their strategy, risk tolerance, and perception of the value presented by the Advantage Spin offer. If the player decides to proceed, this choice signifies their active participation in seeking a more favorable outcome, leveraging the game's features to possibly turn a near miss into a win. The EGM awaits the player's input, ready to act based on their decision. This moment underscores the dynamic interaction between the player and the machine, where the player's decisions may directly influence the course of their gaming experience.

### 2415 if NO (or Timer Expiration) at 2414, Continue at 2404

Should the player decide against utilizing Advantage Spin credits, or if they fail to respond within the specified time frame, the EGM returns to its state of monitoring the current game. This decision, or lack thereof, results in the continuation of the gaming session without the execution of the Advantage Spin opportunity. This step ensures that the game progresses seamlessly, maintaining the flow of gameplay and allowing the player to continue engaging with the EGM as before. The cycle of monitoring, analysis, and potential offer generation begins anew, poised to identify future opportunities for enhancing the player's experience. This loop is integral to the dynamic nature of the gaming session, providing a structured yet flexible framework within which the player may navigate their gaming strategy.

### 2416 if YES at 2414, EGM Initiates Procedures for Securing Required Funding for Executing Identified Advantage Spin Opportunity

Upon the player's acceptance of the Advantage Spin offer, the EGM initiates a series of procedural steps to secure the required funding for the execution of the identified opportunity. This involves the EGM assessing the availability of the necessary types and quantities of Advantage Spin credits or, if applicable, game credits within the player's account. This step is notable for ensuring that the player has sufficient resources to fund the Advantage Spin, aligning with the terms of the offer. The EGM's actions during this phase include reading current values of Advantage Spin credit meters and, if necessary, game credit meters, to verify the availability of funds. This procedural step is fundamental to transitioning from the player's decision to the actual realization of the Advantage Spin opportunity, bridging the gap between intention and action.

2418a If YES at 2416(a), EGM consumes the determined type(s)/quantity(s) of Advantage Spin credit(s) from EGM's Advantage Spin credit meter(s), and initiates execution of the identified Advantage Spin opportunity

Should the EGM confirm the availability of sufficient Advantage Spin credits to fund the identified opportunity, it proceeds to consume the specified types and quantities of credits from the player's Advantage Spin credit meter(s). This action effectively deducts the required amount from the player's balance, allocating it towards the execution of the Advantage Spin. Following this deduction, the EGM initiates the execution of the Advantage Spin opportunity, translating the player's strategic decision into a tangible gameplay action. This step is notable, as it actualizes the player's choice to utilize their Advantage Spin credits, potentially altering the game's outcome in their favor. The execution of the Advantage Spin is a direct manifestation of the player's engagement with the game's features, showcasing the interactive and dynamic nature of modern electronic gaming experiences.

2419a If NO at 2416(a), the EGM determines the amount of game credit(s) required for funding execution of the identified Advantage Spin opportunity, consumes the determined amount of game credit(s) from EGM's Game Credit meter, and initiates execution of the identified Advantage Spin opportunity

In instances where the player lacks sufficient Advantage Spin credits, the EGM evaluates the necessary game credits needed to fund the Advantage Spin opportunity. This evaluation is based on the costs associated with the identified opportunity, taking into account the current game dynamics and the player's available game credit balance. Upon determining the required game credit amount, the EGM proceeds to consume this amount from the player's Game Credit meter, thereby allocating these resources towards the execution of the Advantage Spin. This process ensures that the player may still engage in the Advantage Spin opportunity, even in the absence of specific Advantage Spin credits, by leveraging their available game credits. The initiation of the Advantage Spin following this transaction underscores the game's adaptability and the EGM's capability to facilitate player engagement through various funding mechanisms.

### 2420 Cash Out Request Received?

This step addresses the scenario where the player decides to end their gaming session and cash out their remaining credits, including any Advantage Spin credits they may have accumulated. The EGM assesses the player's request to convert their digital credit balance into a tangible form, such as a TITO voucher, which may be redeemed for cash or used for further gameplay. The cash-out process is an desirable aspect of the gaming experience, allowing players to collect their winnings or remaining balance in a secure and convenient manner. The EGM's ability to process cash-out requests efficiently is notable for maintaining player trust and satisfaction, ensuring a seamless transition from gameplay to payout.

### 2421 if No at 2420, Continue at 2404

If the player does not initiate a cash-out request, the EGM continues to monitor the current game state, maintaining the flow of the gaming session. This decision to continue playing allows the player to engage further with the game, potentially accumulating more wins or Advantage Spin opportunities. The ongoing cycle of gameplay, analysis, and offer generation proceeds, with the EGM ready to identify and present new opportunities for enhancing the player's experience. This continuity is a notable element of the gaming environment, providing players with the flexibility to manage their session according to their preferences and strategy.

### 2422 if Yes at 2420, EGM Reads Current Value(s) of its Advantage Spin Meter(s)

Upon receiving a cash-out request from the player, the EGM takes an desirable step by reading the current values of its Advantage Spin meter(s). This action is aimed at determining the types, quantities, and values of Advantage Spin credits that the player has accumulated and wishes to cash out. This process involves assessing the player's credit balance in detail, ensuring that all accrued credits are accurately accounted for in the cash-out transaction. The reading of the Advantage Spin meter(s) is a notable step in the cash-out process, serving as the basis for generating a corresponding TITO voucher that reflects the player's accumulated credits. This step underscores the EGM's role in facilitating secure and accurate transactions, ensuring that players may confidently redeem their credits at the end of their gaming session.

2424 EGM Initiates Procedures for Causing a CASH-OUT Advantage Spin Credit Voucher to be Dispensed from The EGM's Ticket Printer

Following the assessment of the player's Advantage Spin credit balance, the EGM initiates a series of procedures to generate and dispense a CASH-OUT Advantage Spin Credit Voucher. This process involves communicating with the ASCMS and/or the Advantage Spin Credit Management System (ASCMS) to create a voucher that accurately represents the types, quantities, and values of the Advantage Spin credits being cashed out. The voucher may be issued in a physical format from the EGM's ticket printer or, in some embodiments, as a digital voucher, depending on the casino's infrastructure and the player's preferences. This step is instrumental in converting the player's digital credit balance into a tangible asset, enabling them to redeem their credits for cash or further gameplay. The issuance of the CASH-OUT Advantage Spin Credit Voucher is a notable aspect of the player's gaming experience, providing a secure and verifiable means of claiming their accumulated credits.

2426 Player Receives CASH-OUT Advantage Spin Credit Voucher from EGM

Upon successful generation, the CASH-OUT Advantage Spin Credit Voucher is dispensed from the EGM's ticket printer, and the player receives this voucher. This moment marks the culmination of the player's gaming session, providing them with a physical or digital representation of their accumulated Advantage Spin credits. The receipt of the voucher is a significant event, as it allows the player to tangibly realize the outcomes of their gameplay decisions and strategies. The process of receiving the voucher is designed to be seamless and user-friendly, ensuring that players may easily claim their credits without unnecessary complications. This step reinforces the integrity and transparency of the gaming experience, ensuring that players feel rewarded and valued for their engagement with the game.

### 2428 Upon Issuing Advantage Spin Credit Voucher, the EGM:

(a) notifies the player of the confirmation

Following the issuance of the CASH-OUT Advantage Spin Credit Voucher, the EGM provides the player with a notification confirming the successful transaction. This notification serves as an official acknowledgment of the cash-out process, providing the player with reassurance and clarity regarding the status of their request. The confirmation may be displayed on the EGM's screen or provided through other means, depending on the system's capabilities and the casino's operational protocols. This communication is an desirable aspect of customer service, ensuring that players are kept informed throughout the transaction process and receive clear confirmation of their actions.
(b) resets the EGM Advantage Spin credit meter(s) to zero

As a final step in the cash-out process, the EGM resets its Advantage Spin credit meter(s) to zero, clearing the player's credit balance in preparation for the next gaming session. This reset ensures that the EGM is ready to accommodate new players or the returning player, providing a clean slate for future gameplay. The resetting of the Advantage Spin credit meters is a notable operational procedure, maintaining the integrity of the gaming system and ensuring that each player's session begins under equitable conditions. This action marks the conclusion of the cash-out transaction, finalizing the player's current engagement with the EGM and setting the stage for new gaming experiences.

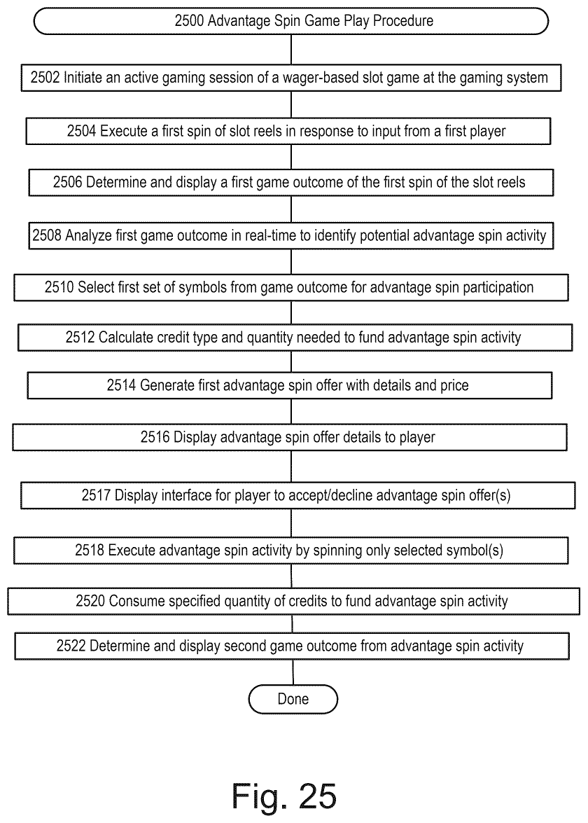

FIG. 25 illustrates an example embodiment of an Advantage Spin Game Play Procedure. In at least one embodiment, this procedure may be configured or designed to facilitate, enable, initiate, and/or perform one or more of the following operations, actions, and/or features described below.

The procedure begins at step 2502, where an active gaming session of a wager-based slot game is initiated at the gaming system. At step 2504, the system executes a first spin of the slot reels in response to input from the first player. The outcome of this initial spin is determined and displayed to the player at step 2506, providing feedback on the game results.

Step 2508 involves analyzing the first game outcome in real-time to identify potential Advantage Spin activities. During this analysis, the system evaluates the outcome for conditions such as near misses or specific symbol configurations that may qualify for an Advantage Spin. At step 2510, a first set of symbols from the game outcome is selected for participation in the Advantage Spin activity, based on strategic or predefined criteria.

At step 2512, the system calculates the type and quantity of credits required to fund the Advantage Spin activity. Using this information, step 2514 generates a first Advantage Spin offer, detailing the conditions, price, and potential rewards associated with the offer. This offer is displayed to the player at step 2516, accompanied by a user interface at step 2517 that allows the player to accept or decline the offer.

If the player accepts the offer, the procedure advances to step 2518, where the Advantage Spin activity is executed by spinning only the selected symbols while leaving the remaining symbols fixed. Step 2520 involves consuming the specified quantity of credits to fund the Advantage Spin activity, deducting these credits from the appropriate meter or account. Finally, step 2522 determines and displays the second game outcome resulting from the Advantage Spin activity, providing updated feedback on the player's gameplay progress.

This procedure enhances traditional slot gaming by introducing selective Advantage Spin opportunities, offering players increased interactivity and strategic decision-making. The use of tailored Advantage Spin offers promotes engagement while maintaining seamless integration with the gaming system's credit management and gameplay mechanics.

Following the analysis of the first game outcome and the execution of a first Advantage Spin activity, the system may analyze the resulting game outcome to identify a second potential Advantage Spin activity. The system may then select a second set of symbols for participation in this subsequent Advantage Spin at step 2510 and calculate the required credit type and quantity for this additional activity. A second Advantage Spin offer is generated with detailed pricing and terms and displayed to the player via an interface that allows acceptance or rejection.

Additionally, the procedure incorporates credit management adjustments based on gameplay. Specifically, the cash credit meter may be adjusted following the first spin outcome, while the Advantage Spin credit meter is updated to reflect credits consumed or awarded during Advantage Spin activities. The system manages transactions involving multiple credit types, specifying Advantage Spin credit quantities directly in offer pricing to ensure transparency.

The procedure enables further gameplay actions using Advantage Spin credits, including options for the player to modify selected symbols for participation in Advantage Spins. Player input may result in the modification of symbol selections or arrangements, such as aligning selected symbols in a vertical column to increase potential rewards. Calculations for win amounts or offer pricing may be based on factors such as bet denomination and lines played, ensuring the offers are tailored to the player's wagering profile.

Strategically, the system selects symbols with a higher probability of increasing win amounts based on analysis of game outcomes. Advantage Spin offers are dynamically priced and generated based on these calculations, factoring in both the potential for enhanced outcomes and the cost structure tied to the Advantage Spin.

The procedure also includes safeguards to determine if Advantage Spin gameplay is permitted under current game conditions. The system may prevent Advantage Spin gameplay if regulatory, system, or game-specific constraints are in place.

These additional actions enhance the Advantage Spin Game Play Procedure by introducing a higher degree of interactivity, personalization, and strategic engagement for players, while maintaining robust credit management and operational compliance. This expanded functionality elevates the gaming experience and ensures a seamless integration of Advantage Spin activities with traditional slot machine gameplay.
2502 Initiate an active gaming session of a wager-based slot game at the gaming system
2504 Execute a first spin of slot reels in response to input from a first player
2506 Determine and display a first game outcome of the first spin of the slot reels
2508 Analyze first game outcome in real-time to identify potential advantage spin activity
2510 Select first set of symbols from game outcome for advantage spin participation
2512 Calculate credit type and quantity needed to fund advantage spin activity
2514 Generate first advantage spin offer with details and price
2516 Display advantage spin offer details to player
2517 Display interface for player to accept/decline advantage spin offer(s)
2518 Execute advantage spin activity by spinning only selected symbols
2520 Consume specified quantity of credits to fund advantage spin activity
2522 Determine and display second game outcome from advantage spin activity Additional operations which may be executed by Advantage Spin Game Play Procedure 2500:
Analyze first game outcome to identify second potential advantage spin activity; Select second set of symbols from game outcome for advantage spin participation; Calculate second credit type and quantity for second advantage spin activity; Generate second advantage spin offer with details and price; Display second advantage spin offer details to player; Display interface for player to accept/decline advantage spin offer(s).
Adjust cash credit meter based on first spin outcome; Adjust advantage spin credit meter based on advantage spin activity.
Manage transactions involving multiple credit types at gaming device; Specify advantage spin credit quantity in offer price.
Enable additional gameplay actions using advantage spin credits; Enable player modification of selected symbols; Modify selected symbols based on player input before execution.
Enable player modification of selected symbols; Modify symbol selection based on player input; Arrange selected symbols in vertical column.
Calculate win amount based on first game outcome; Select symbols based on probability of increasing win amount.
Calculate advantage spin offer price based on bet denomination and/or lines played.

Determine if advantage spin gameplay is permitted; Prevent advantage spin gameplay if not permitted.

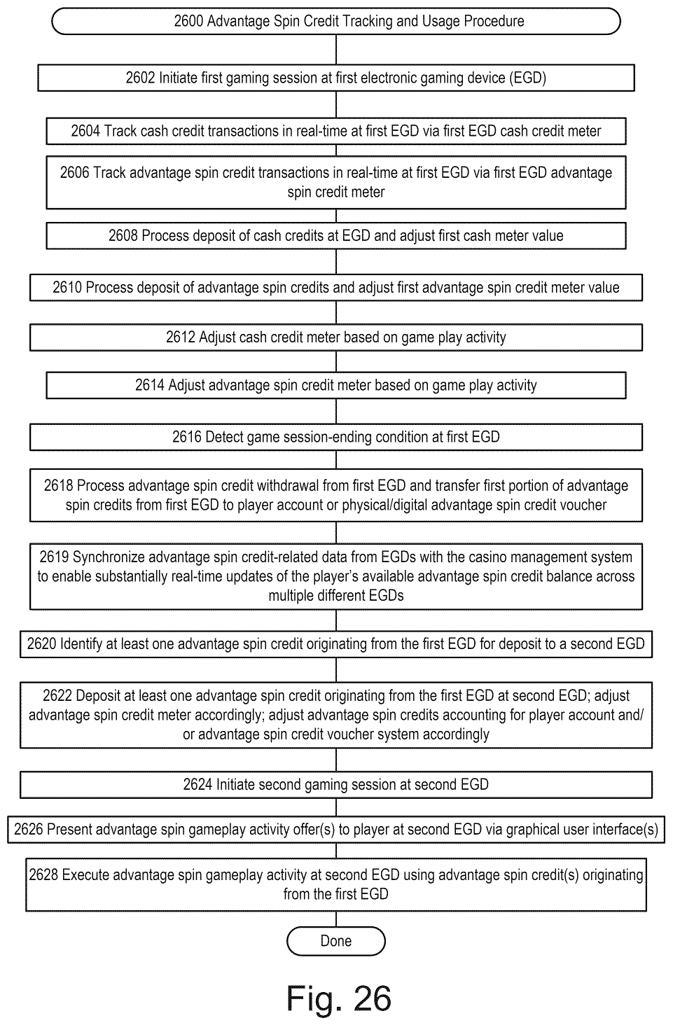

FIG. 26 illustrates an example embodiment of an Advantage Spin Credit Tracking and Usage Procedure. In at least one embodiment, this procedure may be configured or designed to facilitate, enable, initiate, and/or perform one or more of the following operations, actions, and/or features described below.

The procedure begins at step 2602, where a first gaming session is initiated at a first electronic gaming device (EGD). During this session, step 2604 involves real-time tracking of cash credit transactions via the first EGD's cash credit meter, while step 2606 tracks Advantage Spin credit transactions using the EGD's Advantage Spin credit meter. These steps ensure accurate monitoring of distinct credit types throughout gameplay. Deposits of cash credits and Advantage Spin credits are processed in steps 2608 and 2610, respectively, with corresponding adjustments made to the appropriate credit meters.

Gameplay activity is reflected in the system at steps 2612 and 2614, which adjust the cash credit and Advantage Spin credit meters in real-time based on the player's actions. Step 2616 detects conditions that signify the end of the gaming session, prompting the system to process Advantage Spin credit withdrawals in step 2618. During this step, a portion of the Advantage Spin credits is transferred from the first EGD to the player's account or issued as a physical or digital Advantage Spin credit voucher.

Step 2619 ensures synchronization of Advantage Spin credit-related data between EGDs and the Advantage Spin Credit Management System, allowing near real-time updates to the player's available Advantage Spin credit balance. This synchronization supports seamless credit portability and enables credits originating from the first EGD to be identified for transfer to a second EGD, as outlined in step 2620. Step 2622 facilitates the deposit of these transferred credits into the second EGD, adjusting the Advantage Spin credit meter and accounting systems accordingly.

At step 2624, a second gaming session is initiated at the second EGD, where Advantage Spin gameplay activity offers are presented to the player via graphical user interfaces in step 2626. Finally, step 2628 executes Advantage Spin gameplay activities at the second EGD, utilizing the credits originating from the first EGD.

This procedure provides robust mechanisms for tracking, managing, and transferring Advantage Spin credits across multiple EGDs and player accounts, enhancing credit portability and player convenience. The integration with the Advantage Spin Credit Management System ensures accurate accounting and facilitates a seamless player experience, supporting dynamic gameplay opportunities across gaming sessions and devices.

The procedure ensures synchronization of credit data, both cash and Advantage Spin, between the first EGD and the Advantage Spin Credit Management System. This includes continuous updates during gameplay and at session-end to maintain accuracy across player accounts and system records. Withdrawn Advantage Spin credits are assigned unique identifiers during processing, which are subsequently authenticated and validated upon fourth deposit to ensure transactional integrity.

Advantage Spin credits may be transferred from the player's account to a second EGD, supporting portability across gaming devices. Similarly, credits redeemed from vouchers may be deposited into the second EGD, with all adjustments synchronized with the Advantage Spin Credit Management System. Synchronization extends to cash credit data, ensuring real-time updates to both cash and Advantage Spin credit balances.

The system evaluates eligibility of Advantage Spin credits for gameplay at the second EGD using predefined criteria, such as restrictions tied to credit type or origin. Credits deemed ineligible are prevented from funding specific gameplay, ensuring compliance with promotional and system rules. For promotional Advantage Spin credits, the system processes deposits with restrictions, evaluates eligibility for gameplay in the second session, and enforces criteria to prevent the use of ineligible credits.

Requests to deposit promotional Advantage Spin credits undergo eligibility evaluations against restriction criteria, and ineligible credits are prevented from being deposited. Advantage Spin credits may also be converted between wager-based games with varying bet denominations, allowing seamless use across diverse gaming scenarios.

The procedure facilitates user-directed, controlled usage of Advantage Spin credits across multiple EGMs or gaming sessions. Advantage Spin credits are designed as universal credits, usable across any game device, regardless of game theme, title, denomination, manufacturer, or venue. This universality extends to different gaming locations within a venue or across separate venues, enabling unparalleled flexibility for players.

By incorporating these additional actions, the Advantage Spin Credit Tracking and Usage Procedure 2600 ensures comprehensive management of credits while promoting universal usability and operational efficiency, significantly enhancing the player experience and system robustness.
2602 Initiate first gaming session at first electronic gaming device (EGD)
2604 Track cash credit transactions in real-time at first EGD via first EGD cash credit meter
2606 Track advantage spin credit transactions in real-time at first EGD via first EGD advantage spin credit meter
2608 Process deposit of cash credits at EGD and adjust first cash meter value
2610 Process deposit of advantage spin credits and adjust first advantage spin credit meter value
2612 Adjust cash credit meter based on game play activity
2614 Adjust advantage spin credit meter based on game play activity
2616 Detect game session-ending condition at first EGD
2618 Process advantage spin credit withdrawal from first EGD and transfer first portion of advantage spin credits from first EGD to player account or physical/digital advantage spin credit voucher
2619 Synchronize advantage spin credit-related data from EGDs with the casino management system to enable substantially real-time updates of the player's available advantage spin credit balance across multiple different EGDs
2620 Identify at least one advantage spin credit originating from the first EGD for deposit to a second EGD
2622 Deposit at least one advantage spin credit originating from the first EGD at second EGD; adjust advantage spin credit meter accordingly; adjust advantage spin credits accounting for player account and/or advantage spin credit voucher system accordingly
2624 Initiate second gaming session at second EGD
2626 Present advantage spin gameplay activity offer(s) to player at second EGD via graphical user interface(s)
2628 Execute advantage spin gameplay activity at second EGD using advantage spin credit(s) originating from the first EGD Additional operations which may be executed by Advantage Spin Credit Tracking and Usage Procedure 2600
Synchronize credit data between first EGD and casino management system.
Generate unique identifier for withdrawn advantage spin credits; Authenticate and validate fourth deposit using unique identifier.
Transfer advantage spin credits from player account to second EGD.
Redeem advantage spin credits from voucher and deposit to second EGD.
Synchronize cash credit data between first EGD and casino system; Synchronize advantage spin credit data between first EGD and casino system.
Determine eligibility of advantage spin credits for gameplay at second EGD; Evaluate advantage spin credits eligibility using predefined criteria; Prevent ineligible advantage spin credits from funding specific gameplay.
Process deposit of promotional advantage spin credits with restrictions; Evaluate promotional credit eligibility for second gaming session; Prevent usage of ineligible promotional advantage spin credits.
Process request to deposit promotional advantage spin credits; Evaluate promotional credit eligibility using restriction criteria; Prevent deposit of ineligible promotional advantage spin credits.
Convert advantage spin credits between wager-based games with different bet denominations.

### Example Near Miss/Near Hit Outcome Conditions

In wager-based slot machine games, the concept of a “near miss” or a “near hit” refers to outcomes that appear very close to a winning combination, giving the player the impression that they were close to a significant win. These outcomes are significant in gaming psychology, as they may encourage continued play by making the player feel they are close to a win. There are a variety of different types of near misses or near hits, including for example:
Top-Paying Symbol Near Misses: This occurs when top-paying symbols align on the payline in a manner that is just one symbol off from a significant win. For example, having two out of three required symbols for a jackpot lined up on the payline, with the third just above or below.
Jackpot Symbol Near Misses: Similar to top-paying symbol near misses, but specifically involves the highest payout symbols. For instance, on a machine that may may require three jackpot symbols to win the grand prize, the player lands two jackpot symbols on the payline and the third one position off the line.
Multi-Line Near Misses: On multi-line slot machines, a near miss may involve winning symbols that align on a payline that the player did not activate or bet on. This may encourage players to bet on more lines to avoid missing out on future wins.
Bonus Symbol Near Misses: When special bonus symbols needed to trigger a bonus game or feature appear nearly in the required combination. For example, needing three scatter symbols to enter a bonus round, but only getting two, with the third scatter appearing just off the visible reel area or on a line not played.
Progressive Jackpot Near Misses: In machines linked to a progressive jackpot, a near miss may involve almost hitting the combination needed for the progressive jackpot, which may be particularly enticing because of the typically large size of the jackpot.
Symbol Stacking Near Misses: Occurs when stacked symbols (symbols that take up more than one space on a reel) land in a way that they nearly complete a high-paying combination, but one part of the stack is misaligned.
Wild Symbol Near Misses: A situation where a wild symbol, which may substitute for other symbols to create a winning combination, lands just outside of a payline or one position away from completing a high-value win.
Matching Two Symbols on a Three-Symbol Payline: Landing two out of three matching symbols needed for a win on a single payline, with the third symbol just missing, either above or below the payline or on another reel not aligned.
Stacked Wilds Just Off: When stacked wilds (multiple wild symbols stacked on a reel) appear on the reels but just miss aligning with other reels to create a significant win.
Scatter Symbol Just Off the Screen: Scatter symbols that are required to trigger Advantage Spins or a bonus round appear just off the visible screen area, such as the first two scatters landing on the reels and the third scatter landing just above or below the viewing area.
First and Last Reel Hits, Middle Misses: Achieving the needed winning symbols on the first and last reels, but failing to match the necessary symbols on the middle reels for a significant win.
Nearly Activating a Bonus Feature: For games with complex bonus features, having nearly all the necessary symbols or triggers for the feature activation but missing one notable component.
Almost Hitting a Multiplier: On machines where specific symbol combinations result in multiplied winnings, landing just short of the combination needed to activate the multiplier.
Advantage Spins Near Activation: Nearly activating a Advantage Spins bonus by landing the required symbols on two reels, but missing the third symbol on another reel.
Sequential Symbol Near Miss: In some slot games where symbols must line up in a specific sequence to win, having the symbols in order but with one symbol out of place.
Near Full Screen of the Same Symbol: Getting almost a full screen of the same symbol, which would result in a massive payout, but missing one or two symbols to complete the set.
And/or other types of near hit or near miss outcomes generally known in the wager-based slot machine arts.

### Example Advantage Spin Pricing/Cost Lookup Table Embodiments

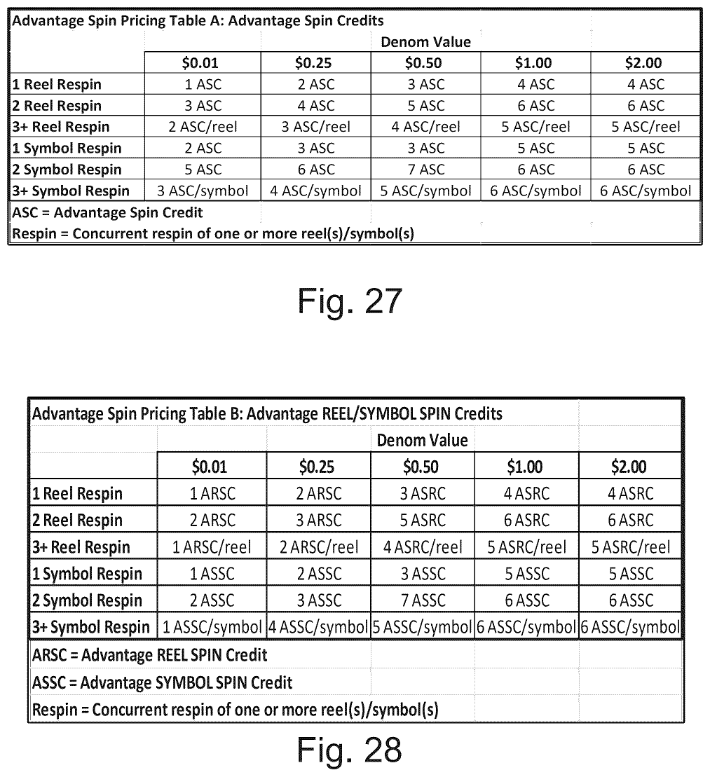

FIG. 27 illustrates an example embodiment of an Advantage Spin Pricing/Cost Lookup Table in which the cost of initiating advantage reel or symbol spin activities is dynamically calculated based on the denomination value of the wager-based game being played on an Electronic Gaming Machine (EGM). The EGM employs Advantage Spin Pricing Table A to determine the required Advantage Spin credits (ASC) necessary to fund specific Advantage Spin opportunities. This table lists corresponding credit costs for various denomination values ranging from $0.01 to $2.00, reflecting the flexibility and scalability of the Advantage Spin system across different wagering levels.

In this embodiment, the EGM may utilize two distinct approaches to calculate the cost of executing Advantage Spin opportunities. The first approach dynamically determines the cost based on the denomination value of the player's current wager, while the second approach calculates the cost independently of the wager denomination.

Under the denomination-dependent model, the EGM continuously monitors the game state for near miss or near hit events during gameplay. When such an event is detected, the EGM references the player's current wager denomination and consults the lookup table to assess the required Advantage Spin credits for initiating a re-spin. For example, a single reel re-spin at a $0.25 denomination may cost two ASC, while the same re-spin at a $1.00 denomination may may require four ASC. This model ensures that the cost of engaging Advantage Spin features aligns with the player's betting strategy and the potential payout of the game, fostering a balanced and equitable gaming environment. The system scales the Advantage Spin cost proportionally to the denomination, reinforcing the perceived value of higher stakes while maintaining accessibility at lower wagering levels.

The second approach calculates Advantage Spin costs independently of the player's wager denomination. In this model, the EGM references a static lookup table that defines re-spin costs based on the inherent value and potential impact of the Advantage Spin opportunity itself, irrespective of the current bet level. For instance, the cost of initiating a re-spin on a rare and high-value symbol may be predetermined at six ASC, regardless of whether the player's bet denomination is set at $0.25 or $2.00. This method decouples the cost from the player's immediate betting strategy, offering a consistent and predictable pricing structure across various game sessions. The uniform application of Advantage Spin pricing ensures that all players, regardless of wager size, have equitable access to re-spin opportunities, enhancing overall engagement and entertainment value.

The Advantage Spin Pricing Table A is structured to accommodate multiple configurations of reel and symbol re-spin activities. The table distinguishes between different re-spin actions, including single or multi-reel re-spins and single or multi-symbol re-spins. For example, a three-reel re-spin at a $0.50 denomination may may require four ASC per reel, while a three-symbol re-spin at the same denomination necessitates five ASC per symbol. This granularity in pricing allows for tailored re-spin opportunities, providing players with the flexibility to select Advantage Spin activities that align with their specific gameplay preferences and risk tolerance.

The combination of these dynamic pricing models introduces significant strategic depth into the gaming experience. Players may evaluate the relative cost of Advantage Spin opportunities based on their current wager or choose fixed-cost re-spins that prioritize the inherent value of specific gameplay scenarios. This dual-model framework enhances the overall player experience by offering tailored pricing that reflects both gameplay outcomes and player engagement levels. Additionally, by incorporating both denomination-based and fixed-cost re-spin options, the system caters to a diverse player base, encouraging sustained interaction with the EGM through strategic credit management and targeted re-spin engagements.

FIG. 28 illustrates an example embodiment of an Advantage Spin Pricing/Cost Lookup Table detailing the pricing structure for initiating advantage reel and symbol spin activities through Advantage Spin Reel/Symbol Credits (ARSC/ASSC) on Electronic Gaming Machines (EGMs). The Advantage Spin Pricing Table B provides the framework for determining the required ARSC or ASSC, contingent upon the denomination value of the wagered game. This table introduces granular pricing based on the type and extent of re-spin activities, ensuring proportionality and fairness across various wager levels.

Advantage Spin Pricing Table B distinguishes between reel-based and symbol-based spin activities, applying separate credit types for each. For instance, a single reel re-spin at a $0.01 denomination incurs a cost of 1 ARSC, while the same re-spin at $1.00 may may require 4 ARSC. Similarly, symbol re-spins follow a corresponding scale, with one symbol re-spin costing 1 ASSC at a $0.01 denomination and increasing to 5 ASSC at higher denominations. The pricing for multi-reel and multi-symbol re-spins adjusts incrementally, reflecting the compounded value and potential impact on gameplay outcomes.

In this embodiment, the EGM leverages two primary methodologies to dynamically determine the cost of executing Advantage Spin activities. The first approach calculates the cost based on the game's active bet denomination. When the EGM detects a near miss or near hit during gameplay, it references the lookup table corresponding to the current bet denomination to identify the specific ARSC or ASSC required. For higher denomination values, the credit cost rises, reflecting the increased potential payout associated with such wagers. This ensures that the expenditure of Advantage Spin credits aligns proportionally with the player's betting strategy, preserving the balance between risk and reward.

The second approach operates independently of the player's bet denomination. In this model, the EGM references a fixed lookup table, determining the ARSC or ASSC cost based on the intrinsic value and rarity of the Advantage Spin opportunity. This methodology focuses on the perceived value of the re-spin activity rather than the player's wagering level. For example, a rare three-symbol re-spin may consistently cost 6 ASSC, regardless of whether the player's active denomination is $0.25 or $2.00. This standardized pricing structure ensures equitable access to Advantage Spin features, promoting uniformity and simplicity across various gameplay scenarios.

By decoupling the cost of Advantage Spin activities from the player's immediate bet, this approach enhances accessibility and maintains consistent engagement for players operating at different stake levels. Players may confidently pursue Advantage Spin opportunities without recalculating credit costs based on changing bet denominations. This model simplifies player decision-making, allowing them to focus on the strategic and entertainment aspects of the Advantage Spin feature.

Overall, the dual-pricing approach, encompassing both denomination-dependent and independent calculations, offers significant flexibility and strategic depth. It allows casinos to cater to a broad spectrum of players, from casual low-denomination participants to high-stakes players seeking larger payouts. This implementation drives higher engagement by providing fair, dynamic, and customizable re-spin opportunities that enhance the slot gaming experience.

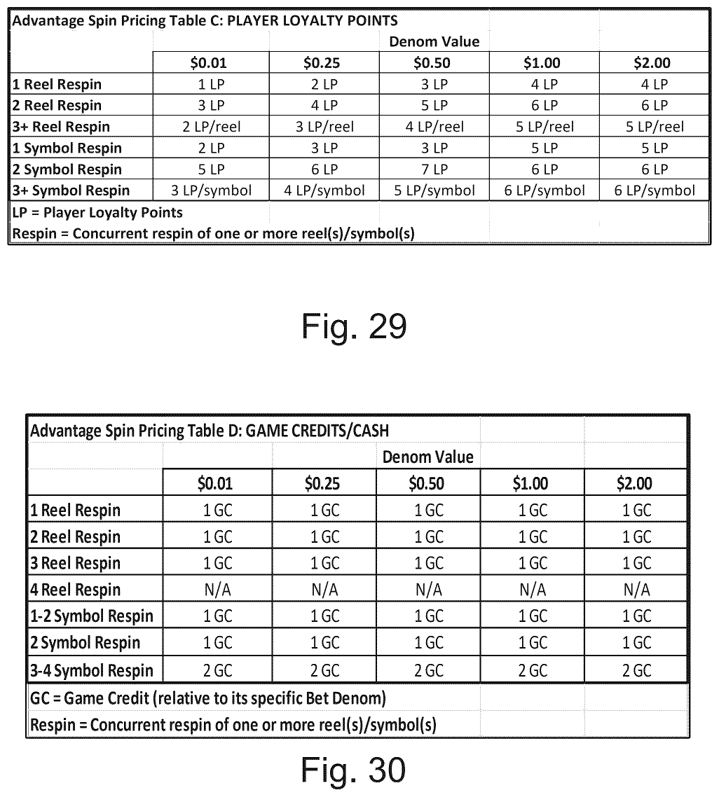

FIG. 29 illustrates an example embodiment of an Advantage Spin Pricing/Cost Lookup Table detailing the pricing structure for initiating Advantage Spin activities through the expenditure of Player Loyalty Points (LP) on Electronic Gaming Machines (EGMs). Advantage Spin Pricing Table C defines the required loyalty points necessary to fund specific Advantage Spin or re-spin opportunities, contingent upon the denomination value of the game being played. This table introduces a scalable pricing mechanism that aligns the cost of Advantage Spin activities with the player's current wager, enhancing engagement by integrating loyalty point utilization into gameplay.

Advantage Spin Pricing Table C assigns distinct LP values for reel and symbol re-spins, with costs increasing proportionally to the game's denomination value. For instance, a single reel re-spin costs 1 LP at a $0.01 denomination but increases to 4 LP for wagers at $1.00 or $2.00 denominations. Similarly, symbol re-spins at higher wager levels demand greater LP expenditure, reinforcing the relationship between wager size and potential payout. Multi-reel and multi-symbol re-spins are calculated on a per-reel or per-symbol basis, ensuring flexible and fair pricing across varying levels of gameplay complexity.

The EGM may adopt two primary methodologies to dynamically calculate the loyalty point cost associated with Advantage Spin activities. The first approach involves determining the cost based on the denomination of the active wager. When a near miss or near hit is detected during gameplay, the EGM references the lookup table to ascertain the exact LP cost required for initiating an Advantage Spin. Higher bet denominations correspond to higher LP costs, reflecting the increased payout potential, while lower bet levels incur reduced costs. This methodology promotes balanced gameplay by aligning Advantage Spin credit consumption with the player's existing wager strategy.

Alternatively, the second methodology calculates the cost of Advantage Spin opportunities independently of the current bet denomination. In this model, the EGM references a fixed lookup table that assigns standardized LP costs to various re-spin scenarios, irrespective of the player's wager level. This approach emphasizes the inherent value of the Advantage Spin opportunity, focusing on its potential impact and rarity rather than the player's betting amount. For example, a three-symbol re-spin may consistently cost 6 LP, whether the active wager is $0.25 or $2.00. This fixed-cost model provides equitable access to Advantage Spin features, ensuring consistent engagement across different bet levels.

By incorporating loyalty point-based Advantage Spin pricing, the system leverages player rewards to enhance gaming experiences while fostering greater player retention and satisfaction. The dual-pricing structure, balancing denomination-dependent and independent approaches, caters to diverse player preferences, offering flexibility for casual players and high-stakes participants alike. This model not only incentivizes continued loyalty program participation but also introduces an additional layer of strategy, enabling players to manage their loyalty points more effectively as they engage with Advantage Spin activities.

The integration of loyalty points into the Advantage Spin framework enriches the overall player experience by offering a seamless mechanism for utilizing accrued rewards in real-time gameplay scenarios. It enhances the perceived value of loyalty programs, reinforcing player engagement by allowing for interactive and strategic use of earned points. This approach ultimately benefits both players and casino operators, driving increased gameplay through innovative reward mechanisms while enhancing player satisfaction and retention.

FIG. 30 illustrates an example embodiment of an Advantage Spin Pricing/Cost Lookup Tabledetailing the pricing structure for initiating Advantage Spin activities using game credits (GC) or cash equivalents on Electronic Gaming Machines (EGMs). Advantage Spin Pricing Table D provides the necessary breakdown of game credit costs for re-spin activities, calculated relative to the denomination value of the wager-based game being played. This model offers a streamlined and uniform pricing mechanism that applies across various betting levels, reinforcing consistency and fairness in the application of Advantage Spin opportunities.

Advantage Spin Pricing Table D standardizes the cost of reel and symbol re-spins across different bet denominations. For instance, regardless of whether the denomination value is $0.01 or $2.00, the cost to initiate a single or multi-reel re-spin remains fixed at 1 GC. Similarly, the cost of a single or double symbol re-spin is consistently priced at 1 GC, while re-spinning three or more symbols incurs a slightly higher cost of 2 GC. Notably, the table does not offer a four-reel re-spin option, limiting the number of re-spins to three reels at maximum.

The table's simplicity ensures that the Advantage Spin feature is accessible across varying player wager levels without introducing complex scaling formulas. This fixed-cost model provides predictability and transparency, allowing players to engage with Advantage Spin activities irrespective of their wager size. The uniformity in pricing enhances user experience by minimizing the need for recalculations based on bet denomination, fostering a seamless integration of Advantage Spin re-spins into standard gameplay.

In at least one embodiment, the EGM dynamically determines the cost of Advantage Spin execution based on the player's current bet denomination. Upon detecting a near miss or near hit scenario during gameplay, the EGM references the lookup table to determine the exact number of game credits required to initiate the re-spin. This denomination-based approach aligns the cost of Advantage Spin credits with the player's existing bet strategy, ensuring that higher bet denominations correspond to increased Advantage Spin costs reflective of the potential payout.

Alternatively, the EGM may calculate the cost of executing Advantage Spin opportunities independently of the current bet denomination. In this model, the lookup table assigns fixed game credit costs to re-spin opportunities, unaffected by the player's wager level. This method emphasizes the value and potential impact of the re-spin itself rather than the financial scale of the player's current bet. For example, the cost of re-spinning two reels remains 1 GC, whether the active denomination is $0.25 or $1.00. This ensures equitable access to Advantage Spin features across diverse wagering levels, allowing players of all budgets to participate.

The independent pricing model simplifies player decisions by offering consistent costs across different bet levels, enhancing the overall appeal of the Advantage Spin feature. By decoupling the cost from wager size, the system ensures that re-spin opportunities remain attractive to both high- and low-stakes players, promoting engagement and extending gameplay.

By leveraging game credits or cash equivalents, the Advantage Spin framework seamlessly integrates into the EGM's core functionality, enhancing the slot gaming experience through flexible, user-driven re-spin activities. This model caters to a broad spectrum of players, encouraging continued participation by providing transparent, straightforward pricing for Advantage Spin opportunities. Additionally, the system's adaptability to various game denominations ensures scalability across different EGM configurations, contributing to increased player retention and casino profitability.

### Embodiment D—Advantage Spin Credits Redeemed from/Issued to Player Account or Player Loyalty Points

In at least one embodiment, Casino Player Account system may need to be modified in order to include functionality for allowing extra spin credits to be awarded from a central system to a specific Player Account, enable the players extra spin credits to be essentially downloaded from the Player Account to one or more EGM's, and then also enable the EGM to upload any unused or available extra spin credits back to the players attract tracking account

In some embodiments, Marketing and/or promotions campaigns may automatically award patrons or players tracking accounts with complementary advantage spin credits without the player needing to “earn” them via in game activity or other activities. These may be automatically deposited into the Player Account so that the player only needs to have his Player Account card read at an EB EGM in order to redeem those advantage been credits during gameplay at that EGM.

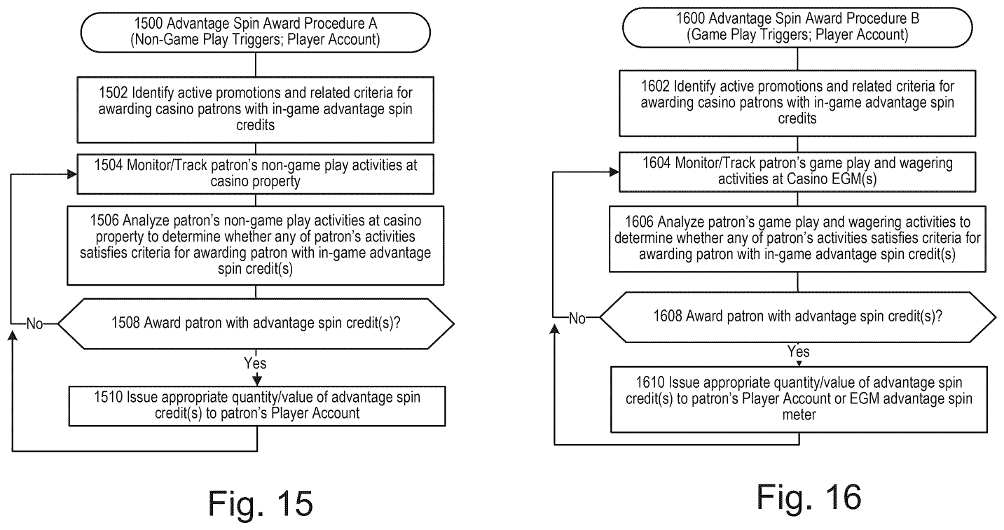

FIG. 15 illustrates an example embodiment of an Advantage Spin Award Procedure based on non-game play triggers associated with a player's account. In at least one embodiment, this procedure may be configured or designed to facilitate, enable, initiate, and/or perform one or more of the following operations, actions, and/or features described below.

The procedure begins at step 1502, where the system identifies active promotions and establishes specific award criteria for in-game Advantage Spin credits. This step involves retrieving and processing promotional data from Advantage Spin Credit Management Systems to determine eligibility requirements for awarding Advantage Spin credits based on non-game play activities. At step 1504, the system continuously monitors a patron's non-game play activities within the casino property. These activities may include dining, attending shows, retail purchases, or other engagement metrics tracked by the casino.

At step 1506, the monitored activities are analyzed against the predefined award criteria to evaluate whether the patron qualifies for an Advantage Spin credit award. Step 1508 involves a conditional decision point: if the patron does not meet the criteria, the process loops back to step 1504 to continue monitoring activities. If the patron qualifies, as determined at step 1508, the system advances to step 1510. Here, it issues the appropriate amount of Advantage Spin credits directly to the player's account. Following this issuance, the system returns to monitoring activities as outlined in step 1504, ensuring ongoing opportunities for additional awards.

This procedure integrates seamlessly with player tracking systems and promotes a comprehensive engagement strategy by rewarding patrons for diverse activities beyond standard gameplay, thereby enhancing their overall experience and loyalty to the casino.
1502 Identify active promotions and related criteria for awarding casino patrons with in-game Advantage Spin credits
1504 Monitor/Track patron's non-game play activities at casino property
1506 Analyze patron's non-game play activities at casino property to determine whether any of patron's activities satisfies criteria for awarding patron with in-game Advantage Spin credit(s)
1508 Award patron with in-game Advantage Spin credit(s)?
1509 If no at 1508, continue at 1504.
1510 If yes at 1508, issue appropriate quantity of in-game Advantage Spin credit(s) to patron's Player Account

FIG. 16 illustrates an example embodiment of an Advantage Spin Award Procedure triggered by gameplay activities associated with a player's account. In at least one embodiment, this procedure may be configured or designed to facilitate, enable, initiate, and/or perform one or more of the following operations, actions, and/or features described below.

The procedure begins at step 1602, where the system identifies active promotions and establishes specific award criteria for in-game Advantage Spin credits. This step involves analyzing promotional campaigns to define eligibility conditions based on gameplay parameters. At step 1604, the system actively monitors the patron's gameplay and wagering activities on electronic gaming machines (EGMs). These activities may include factors such as the amount wagered, frequency of play, and achievement of predefined in-game milestones.

Step 1606 involves analyzing the collected gameplay data against the award criteria to determine whether the player qualifies for an Advantage Spin credit award. At step 1608, a decision point is reached: if the player does not meet the qualifications, the procedure loops back to step 1604 to continue monitoring gameplay and wagering activities. If the player does qualify, the process advances to step 1610, where the system issues the calculated Advantage Spin credits either directly to the player's account or to the EGM meter being used by the player. After issuing the credits, the system resumes monitoring gameplay at step 1604, enabling ongoing opportunities for additional awards.

This procedure enhances player engagement by integrating real-time reward mechanisms directly into gameplay, providing immediate feedback and incentives that contribute to a more immersive gaming experience while promoting sustained interaction with casino gaming systems.
1602 Identify active promotions and related criteria for awarding casino patrons with in-game Advantage Spin credits
1604 Monitor/Track patron's game play and wagering activities at Casino EGM(s)
1606 Analyze patron's game play and wagering activities to determine whether any of patron's activities satisfies criteria for awarding patron with in-game Advantage Spin credit(s)
1608 Award patron with in-game Advantage Spin credit(s)?
1609 If no at 1608, continue at 1604.
1610 If yes at 1608, issue appropriate quantity of in-game Advantage Spin credit(s) to patron's Player Account or EGM Advantage Spin Meter
   If player currently engaged in active gaming session at EGM, issue Advantage Spin credit(s) to EGM Advantage Spin Meter;

If player not currently engaged in active gaming session at EGM, issue Advantage Spin credit(s) to Player Account;

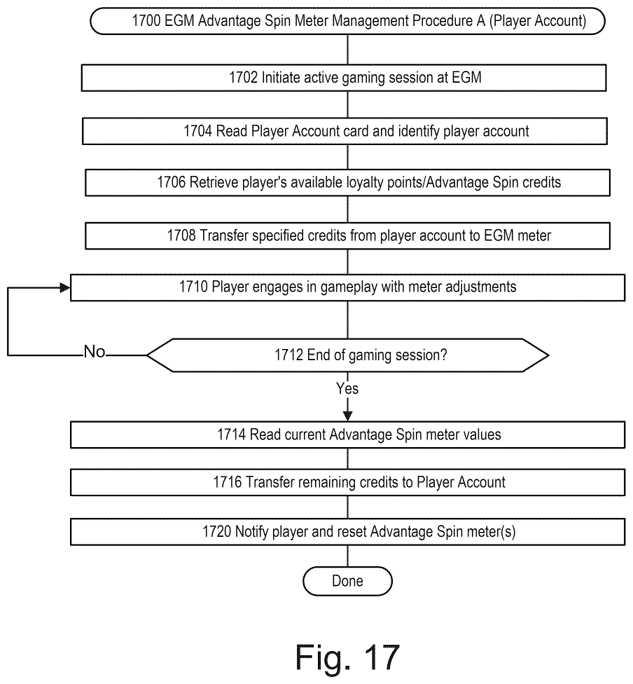

FIG. 17 illustrates an example embodiment of an EGM Advantage Spin Meter Management Procedure associated with a player's account. In at least one embodiment, this procedure may be configured or designed to facilitate, enable, initiate, and/or perform one or more of the following operations, actions, and/or features described below.

The procedure begins at step 1702, where an active gaming session is initiated at an electronic gaming machine (EGM). At step 1704, the EGM reads the player's account information by interfacing with their Player Account card to identify the associated player account. In step 1706, the system retrieves the player's available balance of loyalty points and Advantage Spin credits from the player account. Once this data is retrieved, step 1708 involves transferring a specified number of Advantage Spin credits from the player account to the EGM's Advantage Spin meter, enabling their immediate use during gameplay.

At step 1710, the player engages in gameplay, with the EGM Advantage Spin meter reflecting real-time adjustments based on credit usage. At step 1712, the system evaluates whether the gaming session has ended. If the session has not ended, as determined in step 1713, the process loops back to gameplay at step 1710. If the session has ended, the system proceeds to step 1714, where it reads the current value of the Advantage Spin meter to determine any remaining credits.

In step 1716, the system transfers any remaining Advantage Spin credits back to the player's account, ensuring seamless management of unused credits. Step 1718 involves receiving confirmation of the successful credit transfer, after which the system proceeds to step 1720 to notify the player and reset the EGM Advantage Spin meter for future sessions.

This procedure ensures accurate tracking and transfer of Advantage Spin credits while maintaining a streamlined player experience. It allows players to manage their credits effectively and provides clear feedback throughout their gaming session, contributing to enhanced satisfaction and engagement.
1702 Player initiates active gaming session of wager-based game at EGM
1704 EGM reads Player Account card or otherwise identifies player and players associated Player Account (PA)
1706 EGM accesses Player Account, and retrieves information related to available loyalty points/Advantage Spin credits earned by the player. This information may also include any restrictions on the use of the loyalty points/Advantage Spin credits at one or more EGMs.
1708 Deduct a first quantity of loyalty points/Advantage Spin credits from player's account, and add the first quantity of loyalty points/Advantage Spin credits to the EGM's Advantage Spin meter.
1710 Player engages in wager-based gameplay of wager-based game(s) at the EGM. During active gameplay, the player may consume one or more loyalty points/Advantage Spin credits, and the EGM will decrement the Advantage Spin meter accordingly. The player may also be awarded one or more additional loyalty points/Advantage Spin credits during active gameplay, and the EGM will increment the Advantage Spin meter accordingly.
1712 End of player's active gaming session at EGM?
1713 If no at 1712, continue at 1710.
1714, If yes at 1712, EGM reads current value(s) of its Advantage Spin meter(s). These value(s) represent the quantity of loyalty points/Advantage Spin credits to be deposited into the player's account.
1716 EGM accesses player's account, and deposits a designated quantity of loyalty points/Advantage Spin credits (determined on the value(s) of the EGM Advantage Spin meter(s)) into the player's account.
1718 EGM receives confirmation from the Player Account server that the designated quantity of loyalty points/Advantage Spin credits has been successfully deposited into the player's account.
1720 Upon receiving confirmation, the EGM:
   notifies the player of the confirmation, and
   resets the EGM Advantage Spin meter to zero.

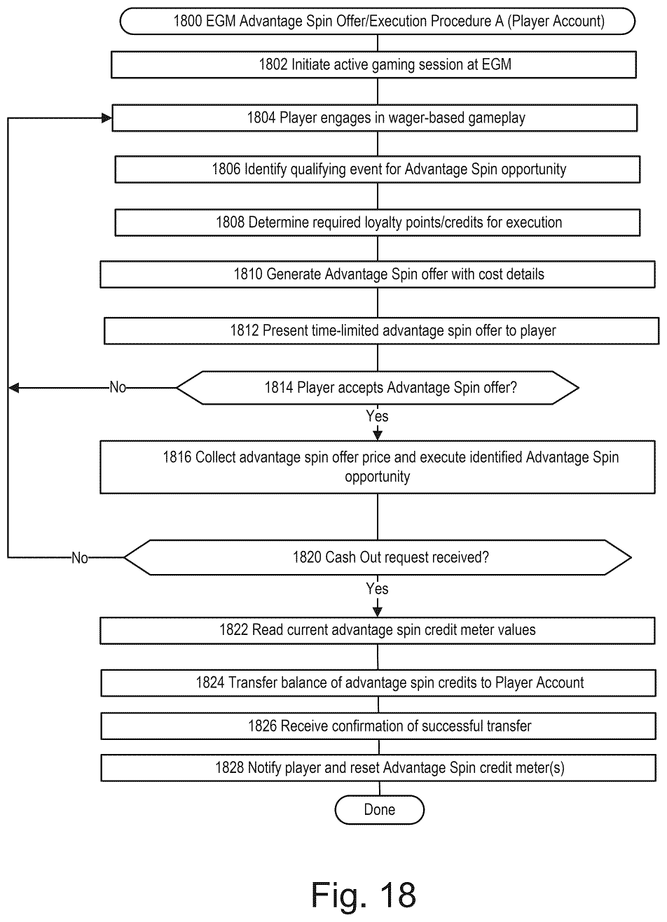

FIG. 18 illustrates an example embodiment of an EGM Advantage Spin Offer/Execution Procedure associated with a player's account. In at least one embodiment, this procedure may be configured or designed to facilitate, enable, initiate, and/or perform one or more of the following operations, actions, and/or features described below.

The procedure begins at step 1802, where an active gaming session is initiated at an electronic gaming machine (EGM). At step 1804, the player engages in wager-based gameplay. During gameplay, the system continuously monitors game activities to identify qualifying events for Advantage Spin opportunities, as specified in step 1806. Once a qualifying event is detected, step 1808 determines the loyalty points or Advantage Spin credits required to execute the identified Advantage Spin opportunity.

At step 1810, the system generates an Advantage Spin offer that includes detailed cost information and potential rewards. This offer is presented to the player in step 1812 as a time-limited proposal, compelling the player to make a decision promptly. In step 1814, the player decides whether to accept the offer. If the player declines, as indicated in step 1815, the procedure returns to regular gameplay monitoring at step 1804. If the player accepts, the system proceeds to step 1816, where it collects the required Advantage Spin offer price, deducts it from the player's balance, and executes the specified Advantage Spin opportunity.

The procedure also monitors whether the player initiates a cash-out request, as evaluated in step 1820. If no cash-out is requested, the process loops back to gameplay monitoring at step 1804. If a cash-out request is made, the system advances to step 1822 to read the current Advantage Spin meter values and transfer any remaining credits back to the player's account. At step 1826, the system confirms the successful credit transfer, followed by step 1828, where the player is notified, and the Advantage Spin meter is reset for future sessions.

This procedure integrates dynamic offer generation with seamless credit management, providing players with real-time opportunities to enhance their gameplay. It also ensures accurate accounting of Advantage Spin credits, fostering player trust and promoting sustained engagement.
1802 Player initiates active gaming session of wager-based game at EGM.
1804 Player engages in wager-based gameplay of wager-based game at the EGM.
1806 EGM identifies, during active gaming session, occurrence of in-game event/condition permitting player to consume one or more loyalty point(s)/Advantage Spin credit(s) for initiating an identified Advantage Spin (or re-spin) opportunity.
1808 EGM dynamically determines type(s) and quantity(s) of loyalty point(s)/Advantage Spin credit(s) required to be consumed in order to fund execution of identified Advantage Spin (or re-spin) opportunity. Example Embodiments:
   1808a (Option 1) Dynamically determine cost of funding execution of identified Advantage Spin opportunity based on game Bet Denom value. E.g., EGM utilizes Advantage Spin lookup table and Bet Denom value to dynamically determine type(s) and quantity(s) of loyalty point(s)/Advantage Spin credit(s) required to be consumed in order to initiate identified Advantage Spin opportunity.
   1808b (Option 2) Dynamically determine cost of funding execution of identified Advantage Spin opportunity independent of game Bet Denom value. E.g., EGM utilizes Advantage Spin lookup table to dynamically determine type(s) and quantity(s) of loyalty point(s)/Advantage Spin credit(s) required to be consumed in order to initiate identified Advantage Spin opportunity.
1810 EGM generates an Advantage Spin Offer for the identified Advantage Spin opportunity. Advantage Spin Offer including details specifying the cost (e.g., type(s) and quantity(s) of loyalty point(s)/Advantage Spin credit(s), and/or game credits(s)) needed to fund execution of identified Advantage Spin (or re-spin) opportunity.
1812 EGM presents Advantage Spin Offer to player. In at least one embodiment the Advantage Spin Offer may be configured as a limited-time offer in which the player is required to provide input within a specified time inerval, indicating the player's acceptance of the offer In at least one embodiment, the EGM may display a timer for the player to accept the Advantage Spin Offer.
1814 Player elects to consume loyalty point(s)/Advantage Spin credit for initiating identified Advantage Spin opportunity?
1815 If NO (or timer expiration) at 1814, continue at 1804.
1816 If YES at 1814, EGM initiates procedures for securing required funding for executing identified Advantage Spin opporunity.
   1816(a) EGM reads current value(s) of loyalty point(s)/Advantage Spin credit meter(s) to determine if there are sufficient type(s)/quantity(s) of loyalty point(s)/Advantage Spin credits available for consumption to fund execution of the identified Advantage Spin opportunity.
   1818a If YES at 1816(a), EGM consumes the determined type(s)/quantity(s) of loyalty point(s)/Advantage Spin credit(s) from EGM's loyalty point(s)/Advantage Spin credit meter(s), and initiates execution of the identified Advantage Spin opportunity.
   1819a If NO at 1816(a), the EGM determines the amount of game credit(s) required for funding execution of the identified Advantage Spin opportunity, consumes the determined amount of game credit(s) from EGM's Game Credit meter, and initiates execution of the identified Advantage Spin opportunity.
1820 Cash Out Request received?
1821 If no at 1820, continue at 1804.
1822 If yes at 1820, EGM reads current value(s) of its Advantage Spin meter(s). These value(s) represent the type(s) and/or quantities of loyalty point/Advantage Spin credits to be deposited into the Player Account (PA).
1824 EGM accesses player's account, and deposits a designated quantity of loyalty points/Advantage Spin credits (determined based on the value(s) of the EGM Advantage Spin meter(s)) into the player's account.
1826 EGM receives confirmation from the Player Account server that the designated quantity of loyalty points/Advantage Spin credits has been successfully deposited into the player's account.
1828 Upon receiving confirmation, the EGM:
   notifies the player of the confirmation, and
   resets the EGM Advantage Spin meter to zero.

In at least one embodiment, during active gameplay, the player may consume one or more loyalty points/Advantage Spin credits, and the EGM will decrement the Advantage Spin meter accordingly. The player may also be awarded one or more additional loyalty points/Advantage Spin credits during active gameplay, and the EGM will increment the Advantage Spin meter accordingly.

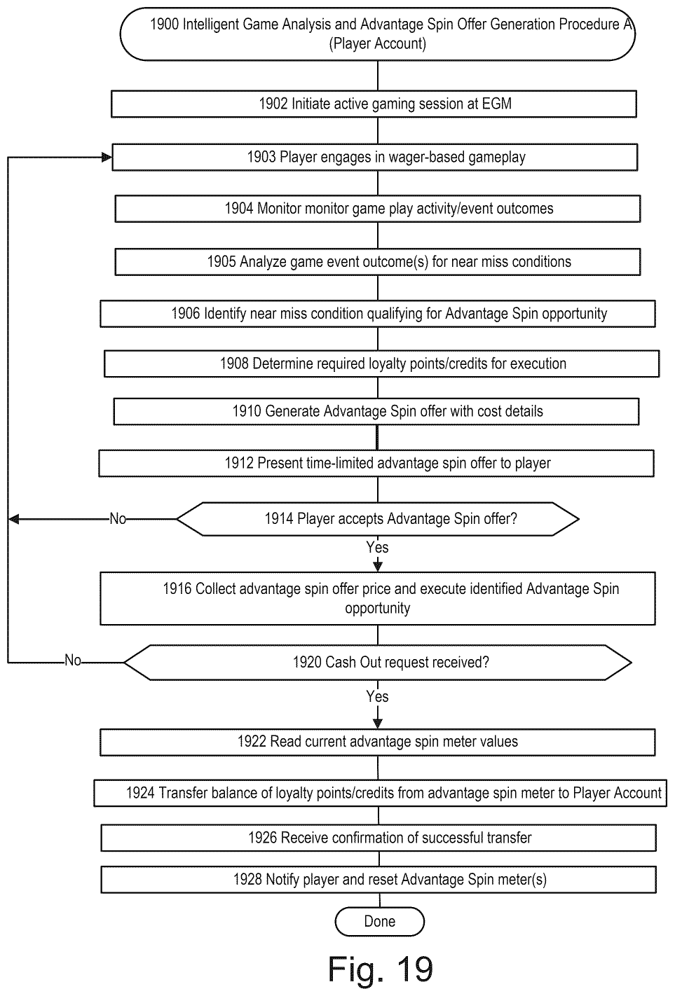

FIG. 19 illustrates an example embodiment of an Intelligent Game Analysis and Advantage Spin Offer Generation Procedure associated with a player's account. In at least one embodiment, this procedure may be configured or designed to facilitate, enable, initiate, and/or perform one or more of the following operations, actions, and/or features described below.

The procedure begins at step 1902, where an active gaming session is initiated at an electronic gaming machine (EGM). At step 1903, the player engages in wager-based gameplay. Concurrently, the system monitors the current game state in real-time, as specified in step 1904. During gameplay, step 1905 involves analyzing game state data to detect near miss conditions, such as narrowly missing a high-value winning combination.

At step 1906, the system identifies near miss events that qualify for an Advantage Spin opportunity. Once such an event is detected, step 1908 determines the required loyalty points or Advantage Spin credits needed to execute the opportunity. Step 1910 follows with the generation of a targeted Advantage Spin offer, detailing the cost and potential rewards. This offer is then presented to the player in step 1912 as a time-sensitive proposition.

At step 1914, the player is prompted to decide whether to accept the Advantage Spin offer. If the player declines, as indicated in step 1915, the procedure loops back to monitoring the game state at step 1904. If the player accepts, the system advances to step 1916, where the required Advantage Spin credits are collected, and the identified Advantage Spin opportunity is executed.

The system also evaluates whether the player has initiated a cash-out request, as indicated in step 1920. If no cash-out is requested, the procedure returns to monitoring the game state at step 1904. If a cash-out is requested, the system proceeds to step 1922 to read the current Advantage Spin meter values and transfer any remaining credits to the player's account. Step 1926 involves confirming the successful credit transfer, followed by step 1928, where the player is notified, and the Advantage Spin meter is reset for subsequent gaming sessions.

This procedure leverages intelligent game state analysis to provide timely, strategic Advantage Spin offers, enhancing the interactive and rewarding aspects of gameplay. It ensures precise credit management and seamless integration with player accounts, supporting both player engagement and operational efficiency.
1902 Player initiates active gaming session of wager-based game at EGM.
1903 Player engages in wager-based gameplay of wager-based game at the EGM.
1904 EGM monitors current game state of wager-based game.
1905 EGM analyzes (e.g., in real-time) current game state data to identify occurrence of any near miss (or near hit) condition(s).
   In at least one embodiment, the Intelligent Game State Analysis And Advantage Spin Offer Engine may be configured or designed to include functionality for concurrently analyzing multiple payout lines of the game state outcome, identifying possible near hits for one or more of the payout lines, determine potential win amount values for each pay outline respin scenario, and identify the most profitable respin scenario(s) for presentation as an Advantage Spin offer to the player.
1906 EGM identifies, during active gaming session, occurrence of a “near miss” or “near hit” event/condition which provides for an Advantage Spin (or re-spin) opportunity.
1908 EGM dynamically determines type(s) and quantity(s) of loyalty point(s)/Advantage Spin credit(s) required to be consumed in order to fund execution of identified Advantage Spin (or re-spin) opportunity. Example Embodiments:
   1908a (Option 1) Dynamically determine cost of funding execution of identified Advantage Spin opportunity based on game Bet Denom value. E.g., EGM utilizes Advantage Spin lookup table and Bet Denom value to dynamically determine type(s) and quantity(s) of loyalty point(s)/Advantage Spin credit(s) required to be consumed in order to initiate identified Advantage Spin opportunity.
   1908b (Option 2) Dynamically determine cost of funding execution of identified Advantage Spin opportunity independent of game Bet Denom value. E.g., EGM utilizes Advantage Spin lookup table to dynamically determine type(s) and quantity(s) of loyalty point(s)/Advantage Spin credit(s) required to be consumed in order to initiate identified Advantage Spin opportunity.
1910 EGM generates an Advantage Spin Offer for the identified Advantage Spin opportunity. Advantage Spin Offer including details specifying the cost (e.g., type(s) and quantity(s) of loyalty point(s)/Advantage Spin credit(s), and/or game credits(s)) needed to fund execution of identified Advantage Spin (or re-spin) opportunity.
1912 EGM presents Advantage Spin Offer to player. In at least one embodiment the Advantage Spin Offer may be configured as a limited-time offer in which the player is required to provide input within a specified time inerval, indicating the player's acceptance of the offer In at least one embodiment, the EGM may display a timer for the player to accept the Advantage Spin Offer.
1914 Player elects to consume loyalty point(s)/Advantage Spin credit for initiating identified Advantage Spin opportunity?
1915 If NO (or timer expiration) at 1914, continue at 1904.
1916 If YES at 1914, EGM initiates procedures for securing required funding for executing identified Advantage Spin opporunity.
   1916(a) EGM reads current value(s) of loyalty point(s)/Advantage Spin credit meter(s) to determine if there are sufficient type(s)/quantity(s) of loyalty point(s)/Advantage Spin credits available for consumption to fund execution of the identified Advantage Spin opportunity.
   1918a If YES at 1916(a), EGM consumes the determined type(s)/quantity(s) of loyalty point(s)/Advantage Spin credit(s) from EGM's loyalty point(s)/Advantage Spin credit meter(s), and initiates execution of the identified Advantage Spin opportunity.
   1919a If NO at 1916(a), the EGM determines the amount of game credit(s) required for funding execution of the identified Advantage Spin opportunity, consumes the determined amount of game credit(s) from EGM's Game Credit meter, and initiates execution of the identified Advantage Spin opportunity.
1920 Cash Out Request received?
1921 If no at 1920, continue at 1904.
1922 If yes at 1920, EGM reads current value(s) of its Advantage Spin meter(s). These value(s) represent the type(s) and/or quantities of loyalty point/Advantage Spin credits to be deposited into the Player Account (PA).
1924 EGM accesses player's account, and deposits a designated quantity of loyalty points/Advantage Spin credits (determined based on the value(s) of the EGM Advantage Spin meter(s)) into the player's account.
1926 EGM receives confirmation from the Player Account server that the designated quantity of loyalty points/Advantage Spin credits has been successfully deposited into the player's account.
1928 Upon receiving confirmation, the EGM:
   notifies the player of the confirmation, and
   resets the EGM Advantage Spin meter to zero.

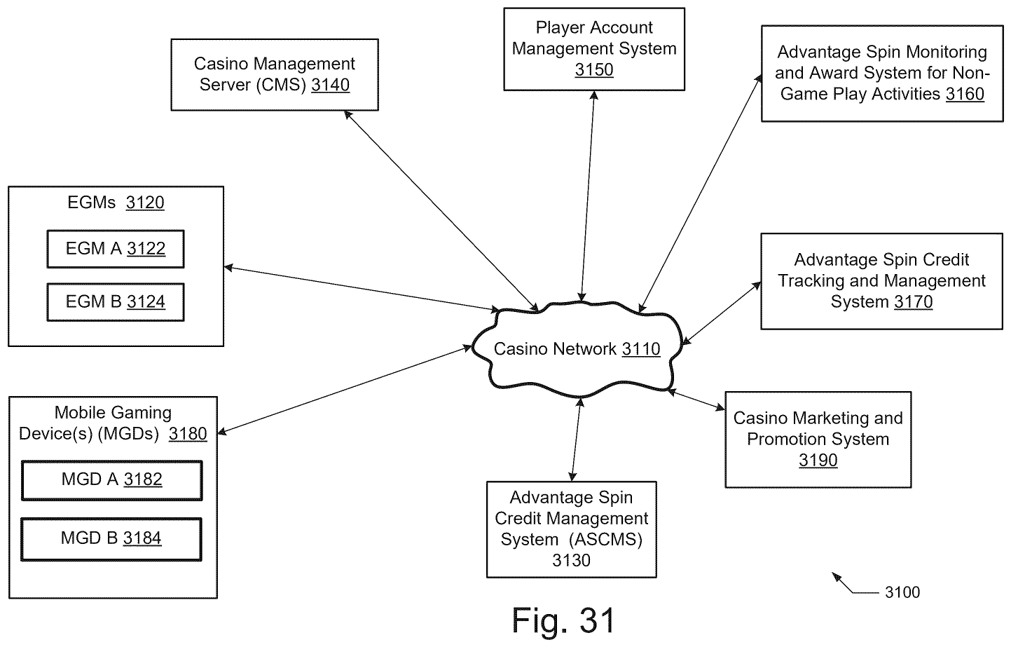

FIG. 31 shows an example embodiment of a portion of a wager-based gaming network 3100, designed for deployment at casino venues. This network facilitates seamless integration of Advantage Spin features, enabling enhanced player engagement through re-spin opportunities and dynamic credit management. The components of this network work in concert to track, manage, and award Advantage Spin credits across various gaming platforms, including Electronic Gaming Machines (EGMs) and Mobile Gaming Devices (MGDs). The following descriptions provide a detailed overview of each component, highlighting their functions, operations, and the Advantage Spin features they enable.

Advantage Spin Credit Tracking and Management System 3170: The Advantage Spin Credit Tracking and Management System 3170 serves as the central hub for managing and monitoring the lifecycle of Advantage Spin credits across the gaming network. This system is responsible for issuing, tracking, redeeming, and adjusting Advantage Spin credits that players accrue through gameplay, promotions, and loyalty programs. It interfaces directly with Electronic Gaming Machines (EGMs), Mobile Gaming Devices (MGDs), and player accounts to ensure accurate accounting of credits. The system dynamically adjusts credits based on re-spin activities, ensuring that players' Advantage Spin credits are accurately deducted or awarded based on in-game actions or triggered offers. One of its notable functions is facilitating cross-platform usage of credits, enabling players to transfer credits between EGMs and MGDs seamlessly. The system also supports Advantage Spin credit persistence, allowing credits to remain available across gaming sessions and venues. Additionally, it communicates with the Casino Management Server (CMS) to synchronize credit data in real-time, ensuring consistent updates to player accounts. This system enables the casino to offer targeted Advantage Spin credit promotions, tailoring rewards to specific player behaviors. By integrating with the Casino Marketing and Promotion System 3150, the Advantage Spin Credit Tracking and Management System 3170 helps drive player engagement through personalized re-spin opportunities, enhancing overall gameplay satisfaction and retention.

Electronic Gaming Machines (EGMs) 3120: The plurality of Electronic Gaming Machines (EGMs) 3120, including EGM A 3122 and EGM B 3124, are the primary gaming interfaces where players engage in wager-based gameplay and Advantage Spin activities. EGMs house the necessary hardware and software to execute base games, bonus rounds, and re-spin features initiated by Advantage Spin credits. These machines are equipped with dedicated Advantage Spin credit meters that track and manage available credits for each player session. EGMs dynamically present Advantage Spin offers to players during near-miss scenarios or based on predefined conditions such as consecutive wins or specific symbol combinations. The machines interface with the Advantage Spin Credit Tracking and Management System 3170 to deduct or award credits in real-time. EGMs also facilitate re-spin options that allow players to lock select reels or symbols, providing strategic control over game outcomes. Additionally, they communicate with the Advantage Spin Credit Management System (ASCMS) 3130 to accept and redeem physical or digital vouchers for Advantage Spins. EGMs contribute to the Advantage Spin ecosystem by displaying dynamic graphical prompts for limited-time Advantage Spin offers, creating a more engaging player experience. Their integration with the Casino Network 3110 ensures seamless credit synchronization across multiple machines, allowing players to continue their Advantage Spin activities across different EGMs within the same casino venue.

Mobile Gaming Devices (MGDs) 3180: Mobile Gaming Devices (MGDs) 3180, including MGD A 3182 and MGD B 3184, extend the reach of the Advantage Spin feature beyond stationary EGMs by enabling remote access to wager-based gaming experiences. These devices are configured to operate within the casino network, allowing players to engage in slot-style games, bonus rounds, and Advantage Spin activities directly from their mobile interfaces. MGDs communicate with the Advantage Spin Credit Tracking and Management System 3170 to facilitate the transfer and utilization of Advantage Spin credits. Players may initiate re-spins, redeem vouchers, and track credit balances through dedicated applications or casino-provided interfaces on their mobile devices. MGDs enable seamless gameplay transitions by allowing players to pause and resume Advantage Spin sessions across different platforms. They also integrate with the Casino Management Server (CMS) 3140 to synchronize credit balances and player profiles. Through proximity-based triggers or push notifications, MGDs may alert players to Advantage Spin promotions and limited-time offers. The mobility provided by MGDs enhances player engagement by allowing gameplay to continue across different areas of the casino, contributing to greater overall participation in the Advantage Spin ecosystem.

Advantage Spin Credit Management System (ASCMS) 3130: The Advantage Spin Credit Management System (ASCMS) 3130 manages the generation, distribution, validation, and redemption of Advantage Spin vouchers. These vouchers, issued in both physical and digital formats, represent a predefined quantity of Advantage Spin credits that players may redeem at EGMs or MGDs. The ASCMS interfaces with the Casino Management Server (CMS) 3140 and Advantage Spin Credit Tracking and Management System 3170 to ensure that voucher redemption accurately reflects on player accounts. This server authenticates vouchers inserted into or scanned by gaming machines, transferring the appropriate number of Advantage Spin credits to the player's credit meter. Additionally, the ASCMS may distribute promotional Advantage Spin vouchers based on non-gameplay activities tracked by the Advantage Spin Monitoring and Award System 3160. The server also facilitates cross-venue usage, allowing players to redeem vouchers at different casino locations. By enabling Advantage Spin credit redemption through vouchers, the ASCMS enhances the accessibility and distribution of Advantage Spin opportunities, providing players with additional avenues to engage in re-spin activities.

Casino Management Server (CMS) 3140: The Casino Management Server (CMS) 3140 serves as the backbone of the wager-based gaming network, orchestrating player account management, credit tracking, and gameplay monitoring. It interfaces with all gaming machines, mobile devices, and subsystems involved in Advantage Spin activities. The CMS coordinates real-time updates to player accounts, reflecting Advantage Spin credit adjustments resulting from gameplay or voucher redemptions. It also tracks player wagering behavior, enabling targeted Advantage Spin offers based on specific triggers such as consecutive losses, near wins, or high-value bets. The CMS communicates with the Advantage Spin Credit Tracking and Management System 3170 to facilitate credit synchronization across the network. Additionally, it oversees loyalty point conversions into Advantage Spin credits, allowing players to engage in re-spin opportunities through accumulated loyalty points. The CMS supports responsible gaming initiatives by enforcing credit usage limits and generating audit trails for Advantage Spin transactions. This centralized management system ensures the integrity and accuracy of Advantage Spin activities across the gaming floor, promoting a seamless player experience.

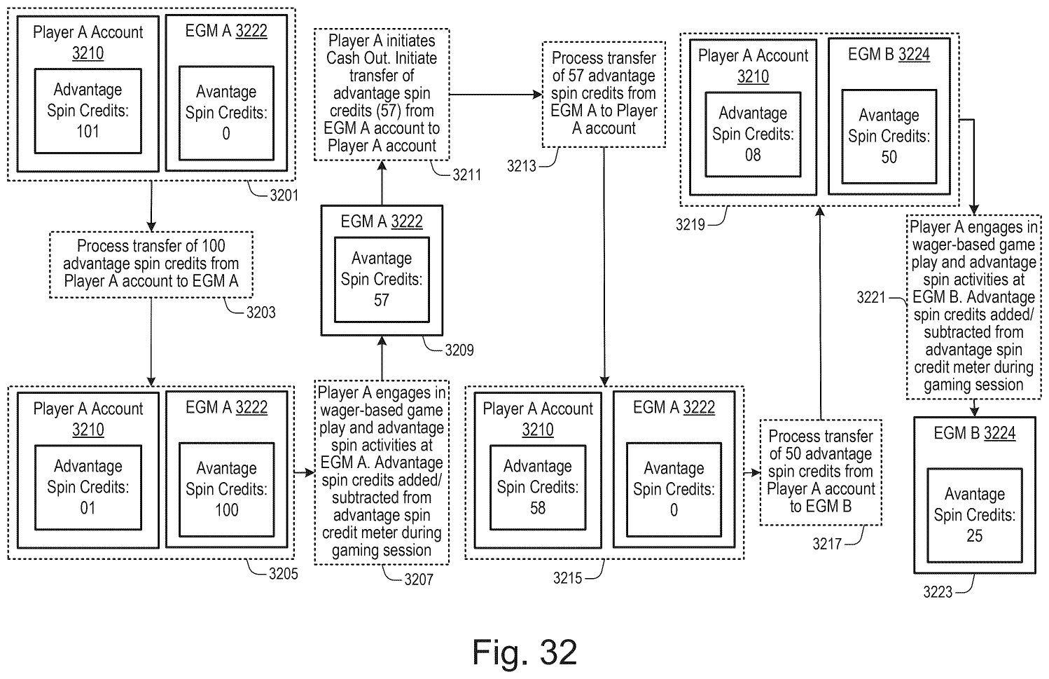

FIG. 32 illustrates an example embodiment of a gaming network scenario depicting the dynamic interaction between a player's account and multiple Electronic Gaming Machines (EGMs) with respect to the transfer, utilization, and management of advantage spin credits. The scenario outlines how Player A's account interfaces with EGMs to facilitate wager-based gameplay activities that leverage the advantage spin credit system.

Step 3201—Initialization of Player A Account and EGM A Credit State: At step 3201, the scenario begins by initializing the balance states of Player A Account (3210) and Electronic Gaming Machine A (EGM A, 3222). Player A Account (3210) holds a balance of 101 available advantage spin credits, which are tracked and managed by either the Casino Management System (CMS) or the Advantage Spin Credit Management System (ASCMS). The ASCMS ensures real-time monitoring and logging of all credit transactions, providing a secure and transparent record of advantage spin credit activities. At this stage, EGM A (3222) has zero credits in its advantage spin credit meter. This zero balance reflects that no prior credit transfer or gameplay involving advantage spin credits has been initiated. The ASCMS is configured to facilitate seamless communication between the player's account and the EGM, ensuring accurate transfer and synchronization of credit values.

Step 3203—Processing Transfer of Advantage Spin Credits to EGM A: In step 3203, Player A initiates a request to transfer 100 advantage spin credits from Player A Account (3210) to EGM A (3222). Upon receiving this request, the system, managed by the ASCMS, processes the transaction by verifying the availability of sufficient credits within the player's account. The ASCMS communicates directly with both Player A Account (3210) and EGM A (3222) to authorize the transfer. This involves decrementing the specified amount of 100 credits from the current balance of Player A Account (3210) while simultaneously incrementing the balance on EGM A's advantage spin credit meter. This transaction is executed through secure data exchange protocols, ensuring that the integrity of the credit transfer is maintained without disrupting active gaming sessions.

Step 3205—Adjustment of Credit Values Post-Transfer: Following the successful completion of the credit transfer in step 3203, step 3205 reflects the updated credit balances for both Player A Account (3210) and EGM A (3222). Player A Account (3210) now holds a remaining balance of 1 advantage spin credit, while EGM A (3222) registers a balance of 100 advantage spin credits on its credit meter. This balance update is recorded and displayed through the EGM's interface, confirming the transaction to the player. The updated values are simultaneously logged by the ASCMS, ensuring that the records across the casino network reflect the new credit distribution. This synchronization guarantees transparency and provides players with immediate feedback regarding their available advantage spin credits at each machine.

Step 3207—Gameplay and Credit Consumption at EGM A: At step 3207, Player A begins wager-based gameplay on EGM A (3222), utilizing the 100 advantage spin credits transferred earlier. During the gaming session, the EGM's advantage spin credit meter is dynamically updated to reflect the consumption and replenishment of credits. As Player A engages in gameplay, certain game outcomes may trigger the addition or subtraction of advantage spin credits, depending on promotional offers, bonus rounds, or reward structures embedded within the game logic. The EGM continuously communicates with the ASCMS, which monitors and records all credit transactions in real-time. This interaction ensures that any adjustments to the advantage spin credit balance are accurately reflected, preserving the integrity of gameplay activities.

Step 3209—Current Credit State at EGM A: By step 3209, the gameplay at EGM A (3222) results in a reduced balance of 57 advantage spin credits on the EGM's credit meter. This reflects the net credit consumption during Player A's gaming session. The updated balance is visually presented on the EGM interface, allowing the player to track their remaining advantage spin credits. The ASCMS simultaneously records this new balance, ensuring consistency between the EGM and the player's account records. This automated update guarantees that credit depletion or accumulation during gameplay is accurately logged without manual intervention, supporting a seamless gaming experience.

Step 3211—Player A Cash Out Request from EGM A: At step 3211, Player A initiates a cash-out request to transfer the remaining 57 advantage spin credits from EGM A (3222) back to Player A Account (3210). This request prompts EGM A (3222) to initiate a communication sequence with the ASCMS and/or CMS, coordinating the return of unutilized advantage spin credits to the player's account. The cash-out process begins by locking the current credit balance on the EGM to prevent further usage during the transfer. This ensures that the exact balance at the time of the request is securely processed and transferred without discrepancies.

Step 3213—Processing Credit Transfer from EGM a to Player a Account

Step 3213 reflects the system's processing of the cash-out request initiated at step 3211. The ASCMS verifies the cash-out request, cross-checking the available credits on EGM A's meter and validating the transfer to Player A Account (3210). Upon successful validation, the ASCMS deducts 57 advantage spin credits from EGM A (3222) and increments Player A Account (3210) by the same amount. This transaction is conducted through encrypted communication channels, ensuring data integrity and preventing unauthorized alterations. The updated balance is instantly reflected across all systems, allowing the player to confirm the successful transfer through the EGM interface.

Step 3215—Updated Credit Values Post Cash Out: Step 3215 highlights the updated credit balances resulting from the cash-out transaction. Player A Account (3210) now shows a balance of 58 advantage spin credits, reflecting the addition of the 57 credits transferred from EGM A (3222). Concurrently, EGM A's advantage spin credit meter is reset to zero, indicating that all credits have been withdrawn. This reset is recorded by the ASCMS, ensuring that the EGM is prepared for the next session without any residual credits. The synchronized update across all components maintains transaction transparency and supports a fluid gaming environment.

Step 3217—Transfer of Credits to EGM B: At step 3217, Player A requests a transfer of 50 advantage spin credits from Player A Account (3210) to EGM B (3224). This process mirrors the earlier transfer to EGM A (3222), where the ASCMS facilitates the movement of credits by deducting them from the player's account and crediting them to the target EGM. This step ensures that Player A may utilize their advantage spin credits on different EGMs, enhancing the flexibility and continuity of their gaming experience.

Step 3219—Updated Credit Balances for Player A Account and EGM B: Following the transfer initiated at step 3217, step 3219 reflects the updated balances. Player A Account (3210) retains a balance of 8 advantage spin credits, while EGM B (3224) now registers 50 credits on its advantage spin credit meter. This update is verified and logged by the ASCMS, ensuring that the transfer process is accurately recorded.

Step 3221—Gameplay and Credit Consumption at EGM B: Step 3221 involves Player A engaging in wager-based gameplay on EGM B (3224). The advantage spin credit meter on EGM B is dynamically adjusted during gameplay to reflect the consumption and acquisition of credits. This ensures that all credit activities are accurately reflected and synchronized with the ASCMS.

Step 3223—Updated Credit State at EGM B: At step 3223, EGM B (3224) reflects a balance of 25 advantage spin credits post-gameplay. This value is recorded and updated in Player A Account (3210) and the ASCMS, ensuring the integrity and continuity of credit tracking across the casino gaming network.

### Player Account and Detection of End of Gaming Session

In a casino gaming environment, tracking a player's activity is notable for loyalty programs and personalized gaming experiences. When a patron wishes to have their gameplay tracked through their Player Account and inserts their Player Account card into the machine card reader, several mechanisms are in place to determine when the player has finished playing and walked away. Here's how it typically works:
Card Removal Detection: The most straightforward method is detecting when the Player Account card is removed from the slot machine's card reader. Modern card readers may immediately notify the system when a card is removed, indicating the player's session has ended.
Inactivity Timeout: If the player leaves the card in the slot but walks away, the gaming machine may use an inactivity timeout feature. If no activity (such as pressing buttons or inserting money) is detected for a predetermined period, the system assumes the player has finished playing. This timeout period is usually configured by the casino to balance between ensuring player convenience and accurately tracking play time.
Button Press or Touch Screen Activity: Some systems monitor specific interactions with the machine, such as pressing the “Cash Out” button or interacting with the touch screen to end a session. This action may signal the system that the player intends to end their session.
Cash Out Transaction: When a player cashes out their credits from the machine, this transaction may signal the end of a playing session. The system records the cash-out as the last activity of the session before the player leaves.
Camera and Motion Sensors: In more advanced systems, overhead cameras or motion sensors integrated with the gaming machine may detect when a player has physically moved away from the machine. This technology is less common and more complex to implement but offers a way to automate the detection of a player leaving.
Proximity Sensor—In one embodiment, the EGM may be configured or designed to include functionality for communicating with the players personal mobile device or smart phone, and establish a connection via proximity so that the machine will essentially monitor the proximity of the mobile device and as long as it's within a certain defined boundary that player is associated with playing that evening machine and once the wireless munication connection or the mobile device proximity extends out of range, the mission EGM no longer or it deactivates that Player Account for on that machine for that player. EGM detects and monitors signal strength or MD (e.g., via bluetooth, nearfield, etc.)

Once the system detects the player has ended their session through any of these methods, it finalizes the session data, including the duration of play, the amount wagered, wins, losses, and any other relevant metrics. This data is then securely transmitted to the Player Account system, where it's used for loyalty points accumulation, personalized marketing, and gaming behavior analysis.

Examples of Non in-Game Condition/Event Triggers for Earning/Awarding Advantage Spin Credits to Patron(s)

Below is a list of unique and novel triggering events or conditions for the “Advantage Spin” feature, with each trigger specifically related to activities, events, and conditions occurring at the casino establishment hosting the slot machine game, involves considering various aspects of the casino environment and player activities.
1. Casino Membership Anniversary: Activates on the anniversary of the player's casino membership.
2. High Foot Traffic Hours: Triggers during peak hours as determined by the casino.
3. Live Show Attendance: Activation for players who attend a live show or event at the casino.
4. Casino Loyalty Card Usage: When a player uses their loyalty card for purchases or services within the casino.
5. Casino Restaurant Dining: Triggered by dining at a casino's restaurant.
6. Participation in Casino Promotions: Activation for players participating in specific casino promotions.
7. Casino Hotel Stay: Triggers for guests staying in the casino's hotel.
8. Celebrating Special Occasions at Casino: Activation for players celebrating a birthday, anniversary, or other special occasions at the casino.
9. High Roller Room Play: Triggers when playing in exclusive high roller rooms.
10. Interactive Casino Kiosk Interaction: Activation after using an interactive kiosk within the casino.
11. Casino Event Check-In: Triggered by checking into a casino event or seminar.
12. Slot Tournament Participation: Activation for players who join slot tournaments.
13. Casino Club Event Attendance: For members attending exclusive club events or functions.
14. Referral Bonus: When a player referred by another player visits the casino.
15. Spa or Wellness Center Visit: Triggers for players using the casino's spa or wellness facilities.
16. Golf Course Play: Activation for players who play at the casino's golf course.
17. Completing a Casino Survey: After a player completes a feedback survey at the casino.
18. Casino Arcade Games Play: For players spending time in the casino's arcade section.
19. Valet Parking Usage: Triggers for players who use the casino's valet parking service.
20. Shopping at Casino Stores: Activation after making a purchase at any casino-affiliated store.
21. Casino Bar Visit: Triggers when a player visits one of the casino's bars.
22. Group or Conference Participation: Activation for attending a conference or group event at the casino.
23. Using Casino's Mobile App Inside Premises: For players interacting with the casino's app while on-site.
24. Daily Visit Streak: Rewards players who visit the casino consecutively for a set number of days.
25. Casino Art Gallery Visit: Triggered by visiting an art exhibit or gallery within the casino.
26. Casino Loyalty Points Redemption: Activation upon redeeming loyalty points for rewards at the casino.
27. Participating in Casino Classes or Workshops: For players who attend classes or workshops offered by the casino.
28. Social Media Check-In: Activation for players who check in or tag the casino on social media platforms.
29. Completing a Casino Scavenger Hunt: Triggered by completing a scavenger hunt organized by the casino.
30. Charity Event Participation: Activation for players participating in charity events hosted by the casino.

These triggers are designed to encourage player interaction with various services and amenities offered by the casino, fostering a more holistic and engaging experience. By linking the “Advantage Spin” feature to diverse casino activities, players are incentivized to explore and participate in different aspects of the casino environment.

Additional Examples of Non in-Game Condition/Event Trimers for Earning/Awardinm Advantage Spin Credits to Patron(s)

Below is a list of unique/novel triggering events or conditions which may be used to trigger the “Advantage Spin” feature. Each different triggering event/condition may be related to behaviors or activities performed by casino patrons which the casino establishment desires to encourage.
1. Frequent Player Rewards: Triggered for patrons who visit the casino a certain number of times within a set period.
2. Extended Play Duration: Activates after a player has engaged with any casino game for a cumulative period.
3. High-Value Transactions: For patrons who conduct high-value transactions at the casino.
4. Loyalty Points Accumulation: When a player reaches specific milestones in loyalty points.
5. Group Visits: Activation for patrons visiting the casino in groups or as part of organized events.
6. Participation in Casino Tournaments: For players who participate in casino-organized tournaments.
7. Social Media Engagement: Triggered when patrons engage with the casino's social media campaigns.
8. Casino Event Attendance: Activation for attending special events or shows hosted by the casino.
9. New Player Referrals: Triggered when a patron successfully refers a new player to the casino.
10. Membership Upgrades: For patrons who upgrade their casino membership tiers.
11. Responsible Gambling Behavior: Activation for patrons who follow responsible gambling practices.
12. Diverse Game Exploration: Triggered when a patron plays a variety of games in the casino.
13. Positive Feedback Submission: For patrons providing constructive feedback through casino surveys.
14. Dining at Casino Restaurants: Activation for patrons dining at the casino's restaurants.
15. Hotel Stays: For guests staying in the casino's hotel.
16. Celebrating Special Occasions: Activation for patrons celebrating special occasions like birthdays or anniversaries at the casino.
17. Gift Shop Purchases: Triggered by making purchases at the casino's gift shops.
18. Utilizing Non-Gaming Amenities: For patrons using spa, pool, or other non-gaming amenities.
19. Engagement in Casino Workshops: Activation for participating in workshops or educational sessions offered by the casino.
20. Cultural Event Participation: For attending or participating in cultural events organized by the casino.
21. Sustainable Practices: Triggered for patrons participating in the casino's sustainability or green initiatives.
22. High-Level Customer Service Feedback: Activation for patrons providing positive feedback about casino staff or services.
23. Enrollment in Loyalty Programs: For patrons who enroll in the casino's loyalty or rewards programs.
24. Volunteering for Casino-Hosted Charity Events: Activation for participating in charity events sponsored by the casino.
25. Partaking in Casino Tours: Triggered for patrons taking part in guided tours of the casino.
26. Engagement in Health and Wellness Programs: Activation for patrons participating in the casino's health and wellness programs.
27. Usage of Digital Platforms: For patrons using the casino's online booking, gaming, or other digital services.
28. Compliance with Casino Rules and Etiquette: Activation for patrons consistently adhering to casino rules and good conduct.
29. Interacting with Casino Promotional Kiosks: Triggered by engaging with interactive promotional kiosks or displays within the casino.
30. Participation in Seasonal Casino Promotions: For patrons taking part in seasonal or special promotional activities offered by the casino.
31. Loyalty Program Milestones: Patrons reach specific milestones in the casino's loyalty program, such as accumulating a set number of points. Redemption occurs by scanning a member card at the slot machine, which automatically credits the Advantage Spin.
32. Hotel Stay Rewards: Advantage Spin awarded for each night a patron stays at the casino's hotel. Redeemed by entering a code provided at check-in into the slot machine.
33. Dining Experience: Receive an Advantage Spin for spending above a certain amount at casino-affiliated restaurants. Patrons redeem it by scanning a receipt QR code at the slot machine.
34. High Roller Bonus: Awarded to patrons who purchase a large amount of casino chips or credits. Redemption occurs through a special high-roller card scanned at the slot machine.
35. Special Event Participation: Participating in casino-hosted events, such as concerts or shows, grants an Advantage Spin. Redeemed by scanning event tickets at the slot machine.
36. Birthday Special: Patrons receive an Advantage Spin on their birthday. Redeemed by verifying the date with a casino attendant who activates the spin at the slot machine.
37. Referral Program: Patrons get an Advantage Spin for each new customer they refer. Redeemed by entering a unique referral code at the slot machine.
38. Social Media Promotions: Participating in casino's social media contests or promotions. Winners redeem through a unique code sent via social media.
39. Casino App Milestones: Earning achievements in the casino's mobile app. Redeemed by syncing the app with the slot machine.
40. Transportation Offers: Using casino-affiliated transportation services like shuttles or limos. Redeemed through a code provided by the transport service.
41. Gift Shop Purchases: Receive an advantage for purchasing items over a certain value in the casino gift shop. Redeemed by scanning the shop receipt.
42. Membership Anniversary: Awarded annually on the anniversary of joining the casino's membership program. Redeemed through member card verification.
43. Community Event Participation: Joining casino-sponsored community events. Redeemed via a participation code provided at the event.
44. Holiday Specials: Special Advantage Spins offered during holidays. Redeemed by entering a holiday-specific code.
45. Casino Newsletter Subscription: Subscribers to the casino's newsletter receive periodic Advantage Spins. Redeemed through a code in the newsletter.
46. Survey Participation: Completing customer feedback surveys. Redeemed by entering a code provided at the end of the survey.
47. Casino Anniversary: Advantage Spin offered on the casino's founding anniversary. Redeemed by a code distributed to all patrons on that day.
48. VIP Member Exclusive Offers: Exclusive spins for VIP members. Redeemed by VIP card verification.
49. Cross-Promotion with Local Businesses: Collaborations with local businesses where patrons receive spins for shopping at these businesses. Redeemed by scanning business receipts.
50. Online Gaming Milestones: Achieving certain levels or points in the casino's online gaming platform. Redeemed by linking the online account to the slot machine.
51. Parking Validation Rewards: Advantage Spins for using the casino's parking facilities. Redeemed via a code on the parking ticket.
52. Foreign Currency Exchange Bonus: Offered to patrons exchanging a significant amount of foreign currency at the casino. Redeemed by a special receipt code.
53. Consecutive Visit Rewards: Awarded for visiting the casino a certain number of consecutive days. Redeemed by daily check-ins with a casino attendant.
54. Sportsbook Participation: Placing bets in the casino's sportsbook may earn Advantage Spins. Redeemed by scanning the sportsbook ticket.
55. Environmental Initiatives: Rewards for participating in casino's environmental initiatives like recycling. Redeemed via a participation voucher.
56. Live Performance Ticket Purchases: Buying tickets for live performances at the casino. Redeemed by scanning the performance ticket.
57. Arcade Game Play: Spending a set amount in the casino's arcade section. Redeemed through a receipt code.
58. Golf Course Offers: Playing a round of golf at the casino's course. Redeemed by scanning the golf course receipt.
59. Pool or Spa Services: Utilizing the casino's pool or spa services. Redeemed through a service receipt code.
60. Special Themed Days: Participating in the casino's themed dress-up days. Redeemed by receiving a code from a casino attendant.
61. The casino or EGM may award a patron an Advantage Spin each time the player buys $20 in casino chips or gaming credits. The player may receive an Advantage Spin by way of a paper ticket or coupon, which has a scannable code which may be scanned at the slot machine for the player to redeem the Advantage Spin during gameplay.

Each of these triggers is designed to promote positive, engaging, and responsible behaviors among casino patrons, aligning with the establishment's goals of enhancing customer experience, encouraging a variety of activities, and fostering a positive community within the casino environment.

Example in-Game Condition/Event Triggers for Earning and/or Consuming Advantage Spin Opportunities

Below is a list of unique/novel triggering events or conditions which may be used to trigger the “Advantage Spin” feature. Each different triggering event/condition is related to some aspect of game play or bonus play associated with the slot machine.
1. Achieving a predefined pattern of symbols on non-winning spins.
2. Completing a set number of spins within a specified time frame.
3. Triggering a mini-game within the slot game, which upon completion, awards an Advantage Spin.
4. Landing on a specific combination of symbols that do not traditionally result in a win.
5. Accumulating a specific number of loyalty points during a session.
6. Spinning a secondary bonus wheel that lands on an Advantage Spin segment.
7. Activating a special mode where every nth spin results in an Advantage Spin.
8. Hitting a rare symbol combination that is unique to each slot machine.
9. Completing a sequence of button presses or interactions in a given order.
10. Engaging in a quick ‘pick-me’ style game that randomly awards Advantage Spins.
11. Landing a special ‘Advantage Spin’ token that appears sporadically on the reels.
12. Achieving a ‘full stack’ of a particular symbol on any reel.
13. Reaching a milestone in cumulative bets placed during a session.
14. Unlocking a hidden game feature or level that grants Advantage Spins.
15. Matching symbols in a specific shape or form, like a zigzag or diagonal.
16. Landing a combination of symbols that spell out a word related to the game theme.
17. Playing during specific times of day or days of the week that activate Advantage Spins.
18. Successfully guessing an outcome in a secondary prediction game.
19. Activating a random ‘mystery spin’ feature that occasionally awards Advantage Spins.
20. Engaging in a social media interaction related to the casino or game.
21. Completing a challenge set by the slot machine, such as hitting a certain symbol five times.
22. Triggering a sequential series of non-winning spins, which then awards an Advantage Spin.
23. Landing a special combination that normally activates a feature, in reverse order.
24. Reaching the top tier in a tiered reward system within the game.
25. Activating a ‘memory match’ mini-game within the slot that may award Advantage Spins.
26. Collecting a set of special symbols that accumulate over time to trigger Advantage Spins.
27. Successfully completing a skill-based challenge presented within the game.
28. Triggering a rare, game-specific cinematic sequence that ends with awarding an Advantage Spin.
29. Earning a ‘spin-back’ for every x amount of currency bet over a threshold.
30. Activating a community jackpot feature that randomly awards players with Advantage Spins.

Each of these triggering events or conditions is aligned with various aspects of gameplay or bonus features in slot machines, enhancing player engagement and offering novel experiences.

### Example Types of Advantage Spin Offers/Event(s)

Below is a list is a list of unique and novel ways of implementing the “Advantage Spin” feature for providing players the opportunity to initiate an additional spin of a slot machine reel or symbol:
1. Advantage Spin of a diagonal reel representing a diagonal line of symbols.
2. Advantage Spin of a zig-zag pattern across multiple reels.
3. Advantage Spin of a randomly selected symbol on a specific reel.
4. Advantage Spin triggered by achieving a predefined pattern of symbols.
5. Advantage Spin of all symbols except for wilds or special symbols.
6. Advantage Spin of a reel to achieve a full stack of matching symbols.
7. Advantage Spin of reels containing no bonus or scatter symbols.
8. Advantage Spin of a reel with a progressive multiplier for subsequent wins.
9. Advantage Spin with symbols that change to higher value symbols only.
10. Advantage Spin where one randomly chosen symbol becomes a sticky wild.
11. Advantage Spin where selected symbols expand to fill the entire reel.
12. Advantage Spin with a chance to turn a losing spin into a winning combination.
13. Advantage Spin with the option to lock in certain reels and spin others.
14. Advantage Spin where symbols may split into multiple smaller symbols.
15. Advantage Spin with a mystery symbol that reveals after the spin completes.
16. Advantage Spin where specific symbols may merge into a single high-value symbol.
17. Advantage Spin with an increasing chance of triggering a jackpot.
18. Advantage Spin with symbols that cascade down after a win, potentially triggering new wins.
19. Advantage Spin with a symbol transformation feature, where random symbols transform into a chosen symbol.
20. Advantage Spin that guarantees the appearance of at least one wild or scatter symbol.
21. Advantage Spin with a reel nudge feature, allowing the player to nudge one reel up or down after the spin.
22. Advantage Spin where selected symbols have a chance to duplicate across the reels.
23. Advantage Spin with a random reel swap feature, where two reels swap places.
24. Advantage Spin where landing a special symbol may trigger a mini bonus game.
25. Advantage Spin with the introduction of a new high-value symbol not present in the regular game.
26. Advantage Spin where each spin increases the chances of a rare symbol appearance.
27. Advantage Spin with an ‘avalanche’ feature, where winning symbols disappear and new symbols fall into place.
28. Advantage Spin that adds additional paylines or ways to win for that spin.
29. Advantage Spin with a ‘symbol scatter’ feature, where a symbol breaks into smaller symbols to create more wins.
30. Advantage Spin that activates a ‘reel mirror’ feature, where one reel copies another.

These implementations are designed to enhance player engagement and offer strategic depth to the gameplay of slot machines.

These examples highlight the diversity of near miss scenarios that may occur in slot machine gameplay, each designed to elicit a specific psychological response from players, encouraging continued engagement with the game. It's this fine line between winning and almost winning that keeps the excitement of slot games alive for many players.

In at least some embodiments, while near misses are a compelling aspect of slot machine design, their use may be subject to regulatory scrutiny. For example, regulators may ensure that near misses occur no more frequently than their mathematical probability, to avoid misleading players about their chances of winning. The psychological impact of near misses is a topic of interest in the study of gambling behavior, as they may significantly affect a player's decision to continue playing.

According to different embodiments, the Advantage Spin button may be implemented virtually via EGM touchscreen or virtual button interface, or may be implemented physically via physical spin advantage button on the gaming machine interface button panel.

In at least one embodiment, the Player Account System may be configured or designed to include functionality for allowing loyalty points/Advantage Spin credits to be awarded from a central system to a specific Player Account, and for enabling a player's loyalty points/Advantage Spin credits to be transferred or exchanged between the Player Account and one or more EGM's. Additionally, in at least one embodiment, the Player Account System may be configured or designed to enable EGMs to deposit any unused or unconsumed loyalty points/Advantage Spin credits from the EGM back to the player's tracking account or customer loyalty account.

In at least some embodiments, for each spin outcome, the player will receive any win amounts that are due to the player based on that particular outcome so the player will get paid based on the outcome of the initial spin of all reels, or subsequent individual re-spends of selected reels, and an outcome or the win amounts for each outcome will be paid to the player in addition to allowing the player to possibly keep re-spinning one or more reels using the Advantage Spin to try to obtain greater payouts when amounts

Extra-Spin Advantage: Elevate your slot gaming experience with “Advantage Spin,” a dynamic and strategic feature that adds an exciting twist to every spin. This innovative slot game add-on introduces a unique opportunity for players to take control of their gameplay, offering the chance to purchase Advantage Spins or choose specific lines or symbols for a respin.

Various ways of implementing Advantage Spin events, such as a diagonal real zigzag pattern, randomly selected things, near hit or near miss, full stack change with higher symbol values only, and expanding selected symbols.

Game design and bonus features for slot machines. In some embodiments, the Advantage Spin techniques may introduce new symbols in a slot machine game, including a diagonal line up symbol that may provide an extra bonus wildcard. In some embodiments, randomly generated symbols may be inserted into the main set of reels of the game during normal play, which may make the game more exciting and increase the chances of hitting jackpots. In some embodiments, safe symbols or loyalty symbols may be introduced into the symbol set(s) of one or more reels during normal gameplay, which may also enhance the gameplay experience.

Using external rewards in a game. Various ways to use external rewards within a game, including inviting friends and earning bonuses, earning and redeeming Advantage Spins credits in a casino game, including loyalty points, dining experience, and high roller bonus. Various ways to reward users with digital rewards, including barcodes, tokens, and mobile app redemption. In some embodiments, users may select specific lines or symbols to redeem for an Advantage Spin.

### Additional Example Advantage Spin Features:

Strategic Advantage Spin Option: When the “Advantage Spin” symbol appears, players are presented with a strategic decision-making opportunity. Players may choose to buy an Advantage Spin, injecting an element of control and strategy into their gaming session.
Line and Symbol Selection: For added customization, “Advantage Spin” allows players to select specific lines or symbols for a re-spin. This feature empowers players to target their preferred combinations, enhancing the overall gaming strategy.
Flexible Activation: The appearance of the “Advantage Spin” symbol may occur under certain defined circumstances, adding a strategic layer to the game. Additionally, the symbol may appear randomly, keeping players on their toes and introducing an element of surprise to each spin.
Opt-Out Option: Recognizing that every player has a unique approach to gameplay, “Advantage Spin” provides the option to decline the Advantage Spin and return to the regular game. This flexibility ensures that players may tailor their experience based on their risk appetite and strategic preferences.
Enhanced Player Engagement: The inclusion of “Advantage Spin” enhances player engagement by introducing a dynamic element that goes beyond standard slot mechanics. Players may experience the thrill of decision-making, adding a layer of excitement to every spin.
Balance of Chance and Strategy: “Advantage Spin” strikes a perfect balance between chance and strategy, appealing to players who enjoy both the unpredictability of slot games and the strategic element of decision-making.
Enhanced Replay Value: With the unpredictable nature of the “Advantage Spin” symbol, each spin becomes a unique and compelling experience. This feature adds replay value to slot games, encouraging players to explore different strategies and outcomes.
External triggers: Platinum Club member privileges, $$ deposit threshold; exchange of points for freespins, bet size threshold, any marketing related promo's.
Other features (not triggers): Player chooses which reel to respin (player's choice), spin directions (vertical, horizontal, zigzag, etc.). May also include player's choice on directions. Same with spin one or more reels—perhaps redeeming loyalty points/Advantage Spin credits for each reel the player chooses to spin.
Multiple rounds: an Advantage Spin that hits a special symbol may award additional Advantage Spins for future usage or current usage.
Not buying Advantage Spin or symbol, but spinning a particular reel (or symbol) without changing the other reels; We may allow players to buy Advantage Spin freely, or based on particular symbol to trigger.
Gaming machines with Advantage Spins. Gaming machine's Intelligent Game State Analysis And Advantage Spin Offer Engine recommends using an Advantage Spin based on specific events or conditions, and the player may choose to use it or not. The Engine calculates potential wins and makes a recommendation to the player, who may then decide to use the Advantage Spin or not.
Bonus symbols in casino games. Possibility of earning Advantage Spins on specific games, with limitations on redemption.

### Example Spin Advantage—Triggering Options.

The Advantage Spin system introduces a suite of triggering options that enhance player engagement by offering diverse pathways to initiate re-spin opportunities. This dynamic framework increases the interactive depth of slot gaming by incorporating player actions, game states, and external triggers to activate Advantage Spin features. Each option may be selectively integrated based on casino preferences, player loyalty tiers, or game-specific mechanics.

In at least one embodiment, players may initiate Advantage Spin at any point following a game spin by wagering additional credits. This player-directed approach provides continuous engagement, allowing players to influence the outcome even after the initial spin resolves. Such on-demand Advantage Spin opportunities foster strategic decision-making, encouraging players to stay invested in their current game session.

A near-hit scenario may serve as an automatic trigger for Advantage Spin. When a spin narrowly misses a winning combination or jackpot, the EGM may prompt the player with the option to engage in an Advantage Spin. This feature capitalizes on the psychological impact of near wins, maintaining excitement and prolonging gameplay by offering a second chance at securing a payout.

Advantage Spin may also be triggered after a predefined number of game spins, introducing a predictable cadence that encourages continued play. Similarly, the system may activate after a series of consecutive wins, reinforcing winning streaks and rewarding player momentum. These structured triggers add rhythm to gameplay, providing clear milestones for Advantage Spin engagement.

Symbol-based triggers represent another inventive mechanism. The appearance of specific symbols, combinations, or patterns during regular spins may unlock Advantage Spin opportunities. For example, landing three wild symbols or a particular bonus icon may activate the feature, introducing an element of surprise and anticipation tied directly to game mechanics.

High-stakes players may access Advantage Spin exclusively through maximum bets. This configuration caters to high rollers, incentivizing larger wagers by offering exclusive access to re-spin opportunities. Alternatively, the EGM may may require the player's credit balance to exceed a predefined threshold to enable Advantage Spin, aligning the feature with players exhibiting sustained engagement and higher wagering capacity.

Periodic or random Advantage Spin triggers introduce a mystery jackpot-like mechanic. EGMs with active credits may be randomly selected to receive Advantage Spin opportunities, creating a sense of unpredictability and community excitement similar to mystery progressive jackpots. This model enhances the entertainment value of the casino floor by offering Advantage Spin as a surprise reward distributed across machines.

In another embodiment, Advantage Spin may activate when a collective coin-in threshold is reached across linked EGMs. Similar to progressive jackpot triggers, once a specific contribution level is met, Advantage Spin opportunities are distributed to qualifying machines, fostering communal engagement and promoting extended play.

The system also supports a “hold and spin” feature, enabling players to lock selected reels using Advantage Spin credits while re-spinning the remaining reels. This hybrid mechanic blends skill with chance, granting players greater control over game outcomes by preserving favorable reel positions.

Advantage Spins and related power-ups, such as multipliers or extra wild symbols, may be stored in player loyalty cards or casino accounts. Players may redeem these stored power-ups by inserting or tapping their card at an EGM. The system may regulate the transfer, sale, or trade of these power-ups, ensuring they remain exclusive to the player who earned them. This integration deepens player investment in loyalty programs and extends the value of in-game rewards beyond a single session.

In a novel twist, Advantage Spin may extend horizontally across multiple reels, deviating from the traditional vertical reel spin format. This unconventional mechanic adds visual variety and alters gameplay dynamics, offering fresh and engaging slot machine experiences that differentiate from standard re-spin features.

### Advantage Spin Graphical User Interfaces

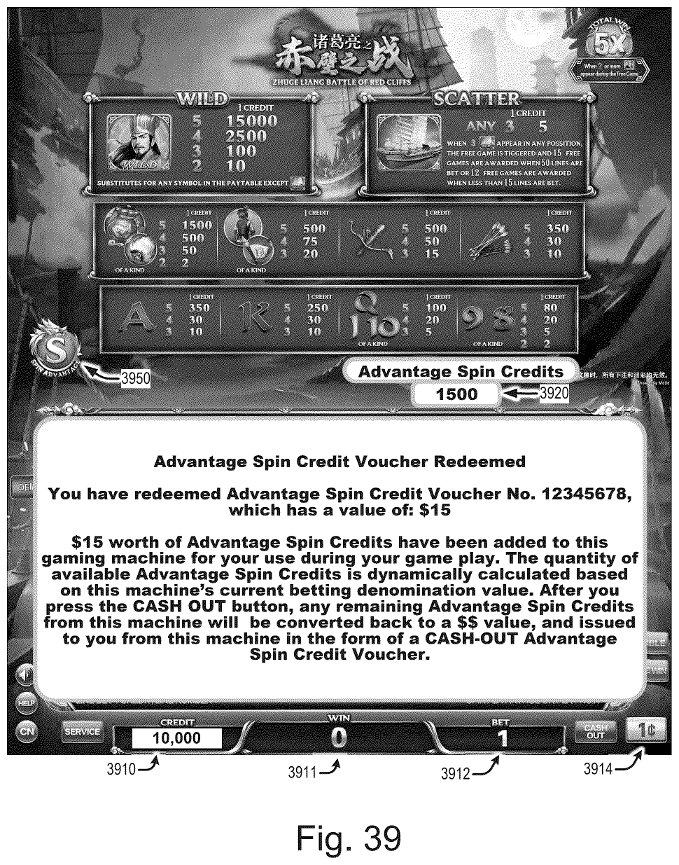

FIG. 39 illustrates an example embodiment of a graphical user interface (GUI) designed for a wager-based slot game, showcasing the integration of the Advantage Spin Credit system. The scenario depicted outlines the sequence of operations and dynamic updates performed by the EGM in response to the insertion and processing of an Advantage Spin Credit Voucher. The following details describe the GUI functionality and its interaction with the underlying systems.

### Scenario Workflow and System Interactions

1. Insertion of Advantage Spin Credit Voucher:
   The player inserts an Advantage Spin Credit Voucher into the bill validator of the EGM.
   The voucher includes encoded information such as a Voucher ID, Validation Code, and a credit value indicating the amount of Advantage Spin credits it represents (e.g., $15).
2. Voucher Reading and Authentication:
   The EGM reads the Advantage Spin Credit Voucher and extracts its identifying details.
   The EGM communicates with the Advantage Spin Credit Management System (ASCMS) to authenticate the voucher and validate its credit value. This process ensures that the voucher is genuine and that the stated credit amount is available for redemption.
3. Dynamic Credit Calculation:
   Upon successful validation, the EGM dynamically calculates the corresponding number of Advantage Spin credits to be added to the Advantage Spin credit meter.
   The calculation is based on the voucher's value (e.g., $15) and the game's Bet Denomination (Bet Denom), which represents the monetary value per credit (e.g., $0.01).
   In this example, the calculation determines that the voucher value of $15 translates to 1500 Advantage Spin credits, using the formula:

### Advantage Spin Credits=Voucher Value ($15)/Bet Denomination ($0.01)

4. Meter Update and GUI Refresh:
   The EGM adds the calculated 1500 Advantage Spin credits to the Advantage Spin credit meter.
   The GUI is dynamically updated to reflect the new Advantage Spin credit balance, ensuring that the player may immediately view the increase in credits.

### Graphical User Interface Elements

The GUI for this scenario is designed to provide clear, intuitive feedback to the player regarding the status and usage of their Advantage Spin credits. The interface includes the following elements:
Advantage Spin Credit Meter: Displays the total number of Advantage Spin credits available for gameplay. After processing the voucher, this meter shows the updated total, including the added 1500 credits.
Cash Credit Meter: Displays the balance of standard cash credits available for wagering. This meter remains unaffected by the Advantage Spin Credit Voucher transaction.
Voucher Transaction Status: Provides visual confirmation that the Advantage Spin Credit Voucher has been successfully processed, validated, and redeemed. This status may appear as a pop-up or a message integrated into the GUI.
Game Bet Denomination Display: Clearly indicates the current bet denomination (e.g., $0.01) used for the calculation of Advantage Spin credits. This information ensures transparency for the player regarding how the voucher value is converted into game credits.
Reel Display and Game Controls: The primary game interface remains visible and interactive, allowing the player to continue engaging with the slot game while managing their Advantage Spin credits.
Promotional and Informational Messages: The GUI may include additional messages or animations to celebrate the addition of Advantage Spin credits, further enhancing player engagement.

### Benefits of the System and Interface

Enhanced Transparency: The GUI clearly communicates the process and results of the Advantage Spin Credit Voucher transaction, ensuring the player understands how their credits are calculated and added.
Real-Time Feedback: Immediate updates to the Advantage Spin credit meter and associated GUI elements provide the player with real-time confirmation of their credit balance.
Seamless Integration: The process is integrated into the regular gameplay experience, minimizing disruptions and allowing the player to transition smoothly between managing credits and engaging with the slot game.
Flexibility and Engagement: By incorporating Advantage Spin credits into the GUI, the system encourages players to utilize their credits strategically, potentially increasing their engagement and satisfaction.

The graphical user interface (GUI) of an Electronic Gaming Machine (EGM), as illustrated in FIG. 39 and other related figures, incorporates a range of informational displays and interactive elements that support the execution and management of Advantage Spin credits. Various embodiments of the GUI may display one or more of the following features, enhancing the player experience and providing clarity regarding the available resources, gameplay parameters, and outcomes:

Quantity of Cash/Game Credits Available (3910, FIG. 39): The GUI prominently displays the current value of the EGM's Cash Credit Meter. This field informs the player of the total cash or game credits available for wagering, providing a clear starting point for any gameplay decisions. For instance, if the meter displays “3910,” it indicates that the player has 3910 cash credits available to wager.

Quantity of Advantage Spin Credits Available (3920, FIG. 39): The GUI includes a dedicated display for the current value of the Advantage Spin Credit Meter(s). This meter allows players to monitor their accumulated Advantage Spin credits, which may be used for engaging in specialized gameplay activities such as re-spinning individual reels or symbols.

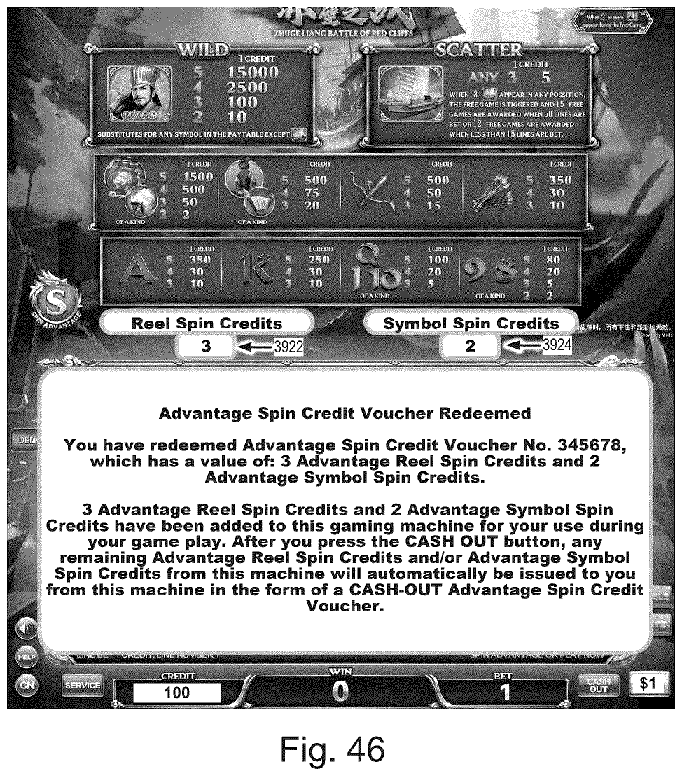

Display of Different Types of Advantage Spin Credits (e.g., FIG. 46): In some embodiments, the GUI may be configured to display various types of Advantage Spin credits, such as Advantage Reel Spin Credits (3922), Advantage Symbol Spin Credits (3924), and loyalty points (3926). Each type of credit serves a distinct purpose and allows players to tailor their gameplay strategy. For example, loyalty points may be accrued through broader casino interactions, while specific spin credits apply directly to reel or symbol re-spin activities.

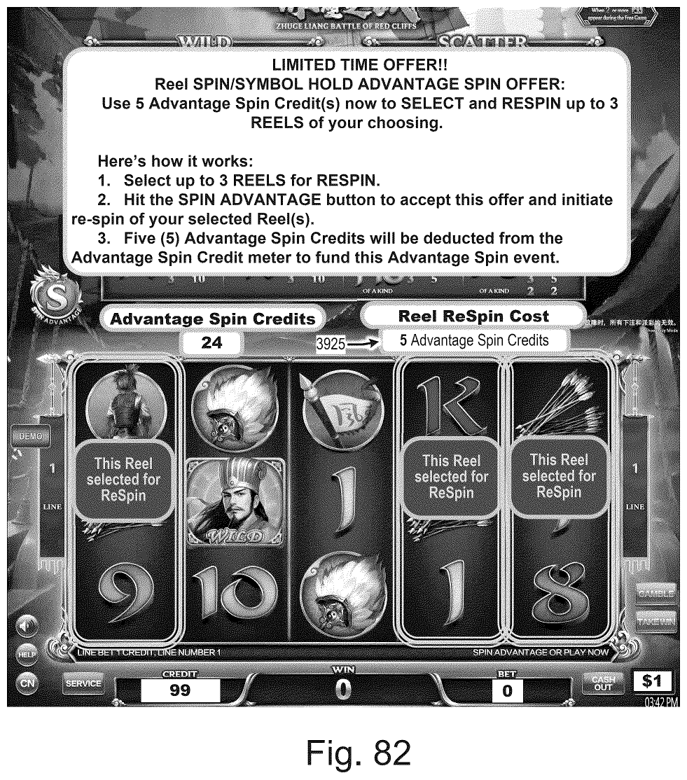

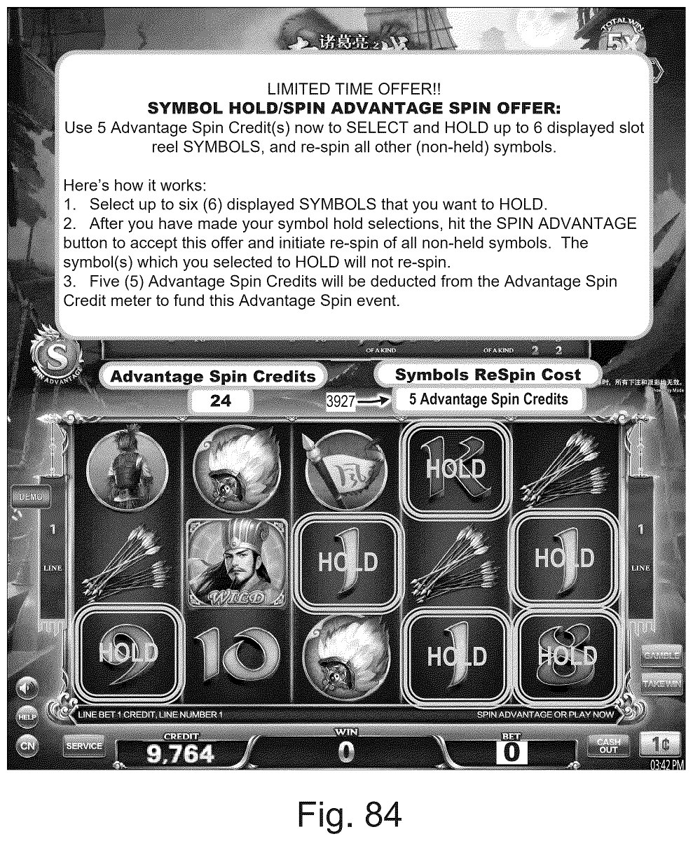

Display of Advantage Spin Costs (e.g., FIG. 82, FIG. 84): The GUI is designed to present clear and concise information about the costs associated with initiating Advantage Spin activities. For instance, the “Selected Reel ReSpin Cost” (3925) and “Selected Symbol ReSpin Cost” (3927) indicate the specific quantity of Advantage Spin credits required to execute the corresponding activities. This enables players to make informed decisions about the strategic use of their resources.

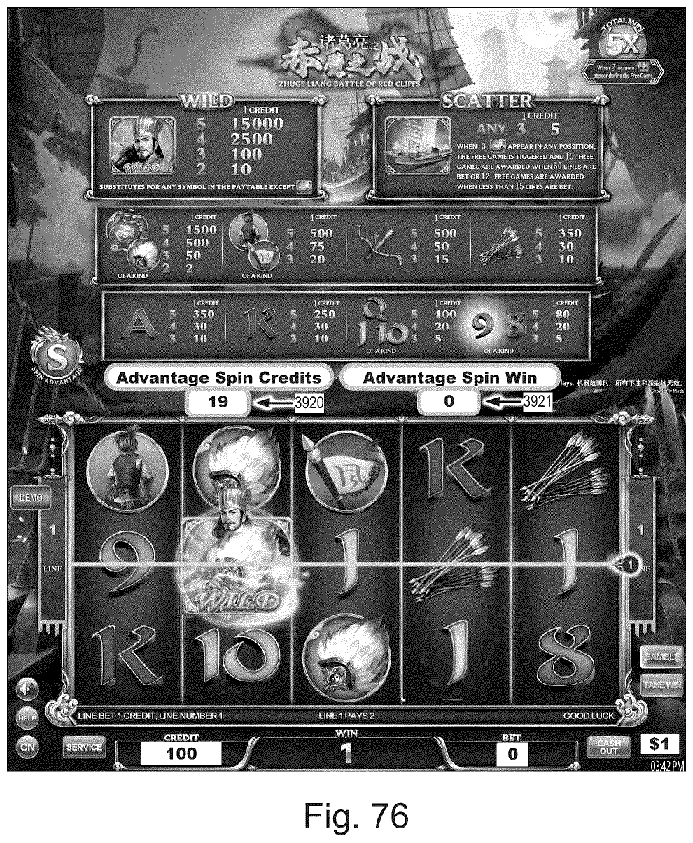

Advantage Spin Win Amount Value (3921, FIG. 76): The GUI provides feedback on the outcomes of Advantage Spin activities by displaying the win amount in Advantage Spin credits. For example, if a player completes an Advantage Spin and achieves a favorable outcome, the value (e.g., “3921?”) reflects the credits awarded as a result of the activity.

Win Amount Value (3911, FIG. 39): To provide transparency regarding gameplay outcomes, the GUI displays the win amount in cash credits resulting from the most recent game event, such as a spin of the slot reels. This information is presented in a dedicated field, ensuring that players may easily discern their earnings from specific gameplay actions.

Bet Amount Value (3912, FIG. 39): The GUI includes a display indicating the bet amount in cash credits for the upcoming game event. For example, “3912” reflects the player's wager for the next spin, providing clear feedback to confirm their bet configuration.

Bet Denomination Value (3914, FIG. 39): The “denom” value indicates the monetary value assigned to each cash credit wagered. This base value determines the worth of individual credits and influences calculations such as the total Advantage Spin credits derived from a voucher. For example, a denomination of $0.01 implies that each cash credit is equivalent to one cent.

Advantage Spin Button (3950, FIG. 39): The GUI integrates an interactive virtual button labeled as the “Advantage Spin Button.” This button serves as the primary interface for players to accept Advantage Spin Offers and/or initiate Advantage Spin activities. Designed for ease of use, the button enables players to seamlessly engage with the Advantage Spin functionality, fostering a more interactive gaming experience.

Through the incorporation of these features, the GUI in various embodiments provides an intuitive and information-rich environment for players. It enhances transparency, supports strategic decision-making, and facilitates efficient resource management while maintaining a focus on clarity and usability. By presenting real-time updates and actionable options, the GUI elevates the overall user experience and aligns with the objectives of the Advantage Spin system.

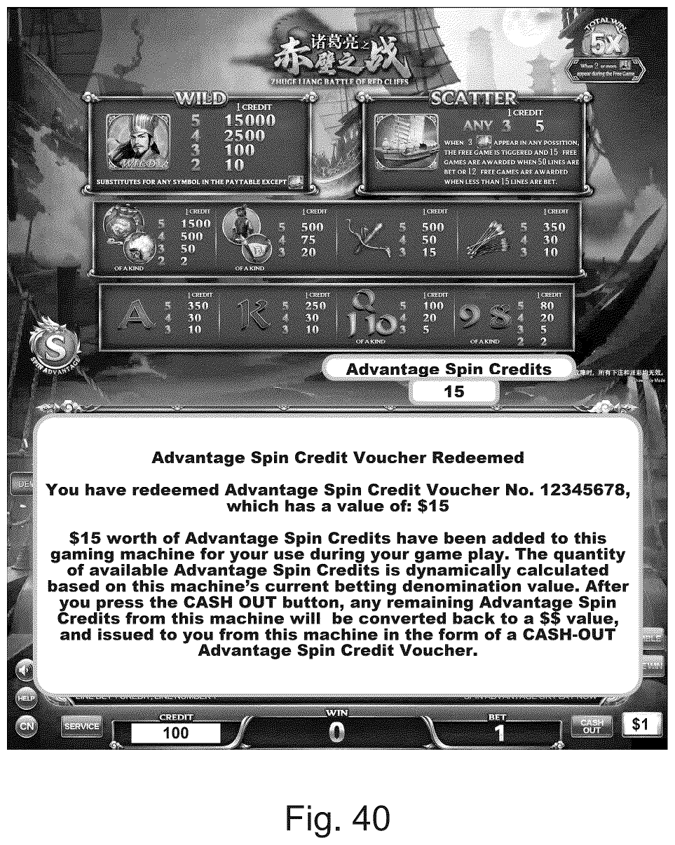

FIG. 40 illustrates an example graphical user interface (GUI) of an Electronic Gaming Machine (EGM) in a wager-based slot game environment, showcasing the display and processing features associated with Advantage Spin credits. The GUI reflects the specific operations and results derived from the scenario where a player interacts with the system through the insertion of an Advantage Spin Credit Voucher.

Upon initiating gameplay, the player inserts an Advantage Spin Credit Voucher into the EGM's bill validator. The voucher serves as a mechanism for adding Advantage Spin credits to the player's credit meter. The EGM reads the voucher using its integrated hardware, extracting notable identifiers such as the Voucher ID and the associated Validation Code. These unique data points are desirable for verifying the authenticity and value of the voucher.

The EGM establishes a secure communication channel with the Advantage Spin Credit Management System to authenticate the voucher. During this process, the voucher's identifiers are transmitted to the system, which performs a validation check and confirms the monetary value of the credits associated with the voucher. In the described scenario, the voucher is validated to contain $15 worth of Advantage Spin credits.

Once the voucher is authenticated, the EGM dynamically calculates the quantity of Advantage Spin credits to add to the Advantage Spin Credit Meter. This calculation is based on the monetary value of the voucher ($15) and the game's current bet denomination value. The bet denomination specifies the monetary value of a single credit, which in this case is set to $1. The system determines that 15 Advantage Spin credits should be added to the Advantage Spin credit meter using the formula:

### Credits to Add=Voucher Value/Bet Denom

The GUI updates in real-time to reflect the updated Advantage Spin credit balance, prominently displaying the total of 15 Advantage Spin credits in the Advantage Spin Credit Meter field. This visual feedback ensures that the player is fully informed about the successful addition of the credits. The interface is designed to clearly communicate this update through visually distinct and easy-to-read elements.

Additional fields on the GUI may include supporting information such as the cash credit balance, bet amount, bet denomination, and win amounts from prior game events. These elements are integrated to provide the player with a comprehensive view of their resources and gameplay status. For instance, the cash credit meter and bet denomination values are updated in conjunction with Advantage Spin credit adjustments, ensuring consistency across all displayed metrics.

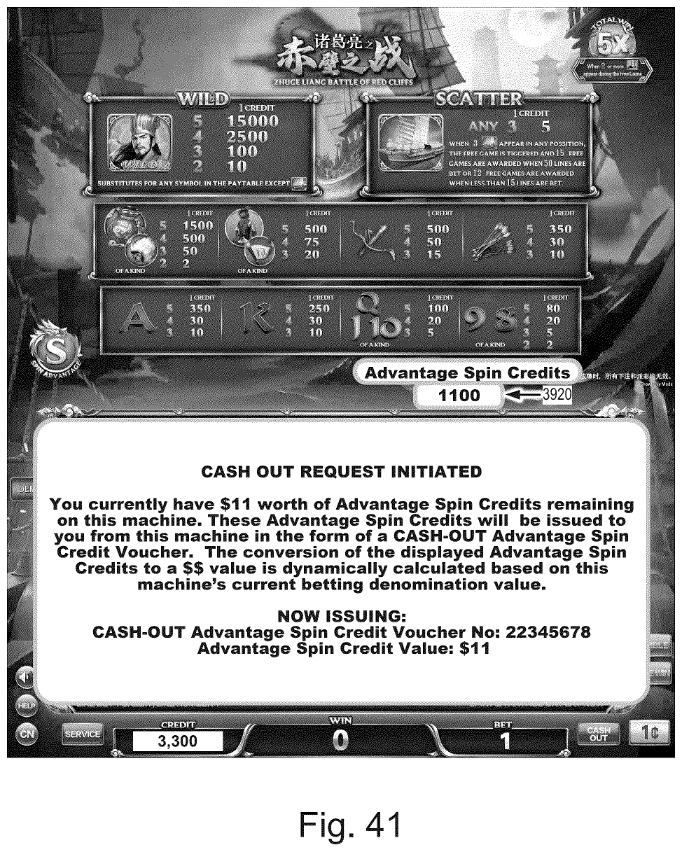

FIG. 41 presents an example graphical user interface (GUI) of an Electronic Gaming Machine (EGM) during a cash-out scenario involving Advantage Spin credits. The interface illustrates the flow of events and displayed information as the player initiates a cash-out request and the EGM processes the transaction.

During an active gaming session, the player decides to redeem their remaining Advantage Spin credits by pressing the “CASH OUT” button on the GUI. This action triggers the EGM to assess the current state of the Advantage Spin Credit Meter. The EGM reads the meter's value, which in this case indicates 1100 Advantage Spin credits. Concurrently, the EGM identifies the current bet denomination (Bet Denom) value, which specifies the monetary equivalent of a single credit. For this example, the Bet Denom value is $0.01.

Using these parameters, the EGM calculates the monetary value of the Advantage Spin credits eligible for cash-out. The formula for determining the cash-out value is:

### Cash-Out Value=Credit Meter Value×Bet Denom

Substituting the values from this scenario:

1100 advantage spin credits×$0.01=$11.00 worth of advantage spin credits.

After calculating the cash-out value, the EGM initiates procedures to generate a physical CASH-OUT Advantage Spin Credit Voucher in the amount of $11. This process involves communication with the Advantage Spin Credit Management System (ASCMS) and/or the Casino Management System (CMS) to create and authenticate the voucher. The systems verify the transaction details, ensure compliance with gaming regulations, and log the transaction for auditing purposes.

Once the CASH-OUT Advantage Spin Credit Voucher is prepared, the EGM activates its integrated ticket printer to dispense the voucher. The GUI updates to notify the player of the successful completion of the cash-out process. The voucher typically contains details such as the voucher ID, validation code, and the credited amount, ensuring secure redemption by the player at a cashier or kiosk.

Following the successful cash-out, the EGM resets its Advantage Spin Credit Meter to zero, preparing the machine for subsequent gameplay sessions or new Advantage Spin credit inputs. The GUI reflects this update, showing a cleared Advantage Spin Credit Meter to indicate that all credits have been cashed out.

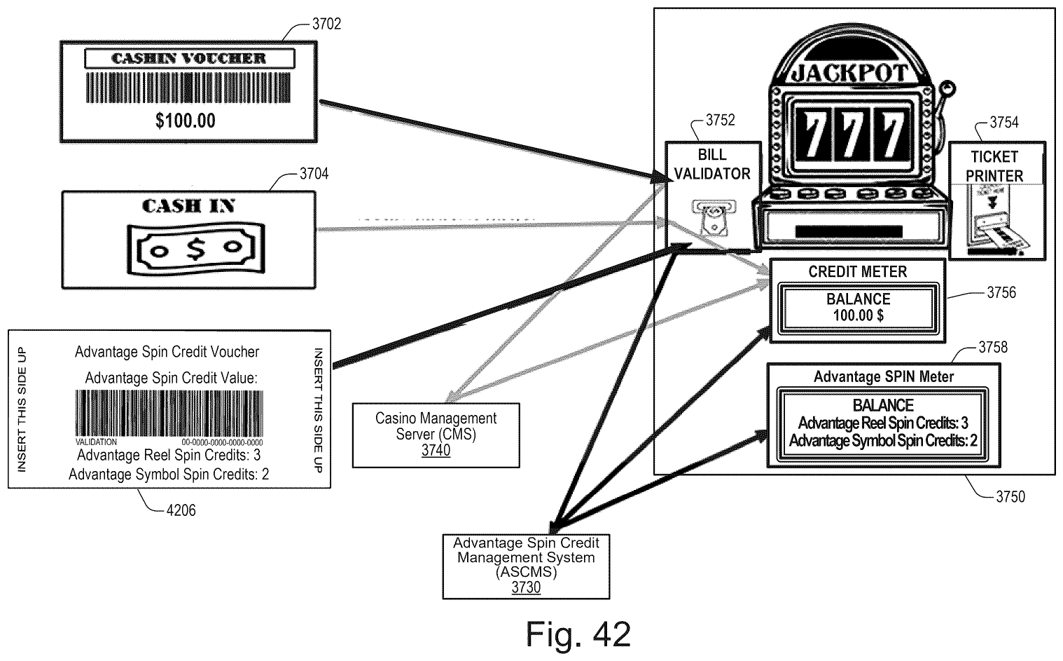

FIG. 42 illustrates a process and system configuration for depositing both a cash credit voucher and an Advantage Spin credit voucher into an Electronic Gaming Machine (EGM). This example highlights the integration of dual credit types, ensuring accurate allocation of funds to the appropriate meters within the EGM.

### Scenario Workflow

1. Insertion of Cash Credit Voucher:
   A player inserts a cash credit voucher valued at $100 into the EGM's bill validator.
   The EGM reads the voucher details, including the Voucher ID, Validation Code, and the credit value.
2. Cash Credit Voucher Authentication:
   The EGM communicates with the Casino Management Server (CMS) to authenticate the cash credit voucher.
   Once validated, the EGM credits the $100 value to the cash credit meter.
   The updated cash credit meter balance is displayed on the EGM's graphical user interface (GUI).
3. Insertion of Advantage Spin Credit Voucher:
   The player subsequently inserts an Advantage Spin credit voucher into the EGM's bill validator.
   This voucher contains encoded information indicating a value of 3 Advantage Reel Spin credits and 2 Advantage Symbol Spin credits.
4. Advantage Spin Credit Voucher Authentication:
   The EGM communicates with the Advantage Spin Credit Management System (ASCMS) to authenticate and validate the Advantage Spin credit voucher.
   Upon successful validation, the voucher's credits are allocated to the appropriate categories within the Advantage Spin credit meter:
      3 Advantage Reel Spin credits are credited for potential re-spins of reels.
      2 Advantage Symbol Spin credits are credited for potential re-spins of specific symbols.
5. Meter Updates:
   The EGM dynamically updates its Advantage Spin credit meter to reflect the new balances for reel spin credits and symbol spin credits.
   These updated values are displayed prominently on the EGM's GUI, ensuring transparency for the player.

### Graphical User Interface (GUI) Elements

The GUI for this scenario is designed to provide players with a clear and comprehensive view of their credit balances. Notable elements include:
1. Cash Credit Meter:
   Displays the current cash credit balance, including the newly deposited $100.
2. Advantage Spin Credit Meter:
   Tracks and separately displays balances for:
      Advantage Reel Spin credits (e.g., 3 credits added).
      Advantage Symbol Spin credits (e.g., 2 credits added).
3. Transaction Status Messages:
   Provides confirmation for each deposited voucher, indicating successful validation and the amount of credits added to the respective meters.
4. Voucher Information:
   Briefly displays details of the inserted vouchers, such as their type (cash or Advantage Spin), value, and the resulting meter updates.
5. Interactive Gameplay Display:
   Ensures that the main game screen remains visible and operational, allowing the player to seamlessly transition from depositing vouchers to resuming gameplay.

### Technical Integration and Benefits

1. Seamless Credit Management:
   The EGM efficiently processes both cash and Advantage Spin credit vouchers through integrated communication with the CMS and ASCMS, ensuring accurate credit allocation.
2. Enhanced Player Transparency:
   The GUI provides real-time feedback, clearly showing the updated credit balances and their specific categories.
3. Flexibility in Credit Usage:
   The separation of Advantage Reel Spin and Symbol Spin credits within the Advantage Spin credit meter offers players tailored options for utilizing their credits during gameplay.
4. Improved Player Experience:
   The ability to deposit and manage multiple credit types within a single session reduces friction for players, fostering a more engaging and user-friendly gaming experience.

### Summary of Scenario Dynamics

The cash credit voucher ($100) is authenticated and credited to the cash credit meter.
The Advantage Spin credit voucher is authenticated and its credits (3 Advantage Reel Spin credits and 2 Advantage Symbol Spin credits) are allocated to the respective categories within the Advantage Spin credit meter.

The updated meters are displayed on the GUI, ensuring transparency and providing the player with a clear understanding of their available credits for both standard wagers and Advantage Spin opportunities.

FIG. 42 depicts a detailed example scenario illustrating the process for depositing both a cash credit voucher and an Advantage Spin credit voucher into an Electronic Gaming Machine (EGM). This embodiment highlights the seamless integration of dual credit types, ensuring that each credit type is accurately allocated to its respective meter within the EGM. The sequence of events described in this figure demonstrates how the system validates and credits the vouchers while providing clear feedback to the player through the EGM's graphical user interface (GUI).

In this scenario, the player begins by inserting a cash credit voucher valued at $100 into the bill validator of the EGM. Upon insertion, the EGM reads the voucher's encoded details, including its unique Voucher ID, Validation Code, and the monetary value it represents. The EGM then initiates communication with the Casino Management Server (CMS) to authenticate the voucher. Once the CMS validates the voucher, the EGM credits the full $100 value to the cash credit meter. Immediately following this transaction, the updated balance is displayed on the EGM's GUI, ensuring the player may see the new total cash credit amount available for gameplay.

Following the cash credit transaction, the player inserts an Advantage Spin credit voucher into the EGM's bill validator. This voucher contains specific encoded information indicating it represents three Advantage Reel Spin credits and two Advantage Symbol Spin credits. The EGM processes the voucher by reading its encoded data and initiating communication with the Advantage Spin Credit Management System (ASCMS). The ASCMS performs the necessary authentication and validation of the voucher, ensuring its legitimacy and confirming the associated credit amounts. Upon successful validation, the EGM allocates the three Advantage Reel Spin credits and the two Advantage Symbol Spin credits to their respective categories within the Advantage Spin credit meter.

After the credits from the Advantage Spin credit voucher are allocated, the EGM dynamically updates its Advantage Spin credit meter to reflect the new balances. The meter now displays separate quantities for Advantage Reel Spin credits and Advantage Symbol Spin credits, providing clarity to the player. Simultaneously, the EGM's GUI updates to showcase the new Advantage Spin credit totals alongside the cash credit balance, ensuring transparency and a seamless user experience. To further enhance the interaction, the GUI may display a confirmation message for each transaction, affirming that the vouchers have been successfully processed and their values accurately credited.

The graphical user interface is designed to provide players with intuitive feedback and clear visibility into their credit balances. The cash credit meter prominently displays the $100 balance resulting from the first transaction. The Advantage Spin credit meter, divided into separate categories, shows three credits for reel spins and two credits for symbol spins, corresponding to the values derived from the Advantage Spin credit voucher. Additionally, the GUI may briefly display details about the vouchers, including their types, values, and the resulting updates to the credit meters. This ensures that players have full transparency regarding the allocation of their deposited credits.

Technically, the system demonstrates robust integration between the EGM, the CMS, and the ASCMS. The EGM communicates with both management systems independently to validate the cash and Advantage Spin credit vouchers, ensuring the accuracy and security of each transaction. This integration also ensures that the credit allocation processes comply with regulatory standards and maintain the integrity of the casino's accounting systems.

The ability to process and manage both cash credit vouchers and Advantage Spin credit vouchers within a single EGM session provides significant benefits. Players enjoy a seamless and efficient mechanism for depositing and utilizing their credits, enhancing their overall gaming experience. The clear separation of Advantage Reel Spin and Symbol Spin credits within the Advantage Spin credit meter allows players to utilize these specialized credits strategically during gameplay. Furthermore, the transparent feedback provided by the GUI ensures that players have complete confidence in the accuracy of the credit transactions.

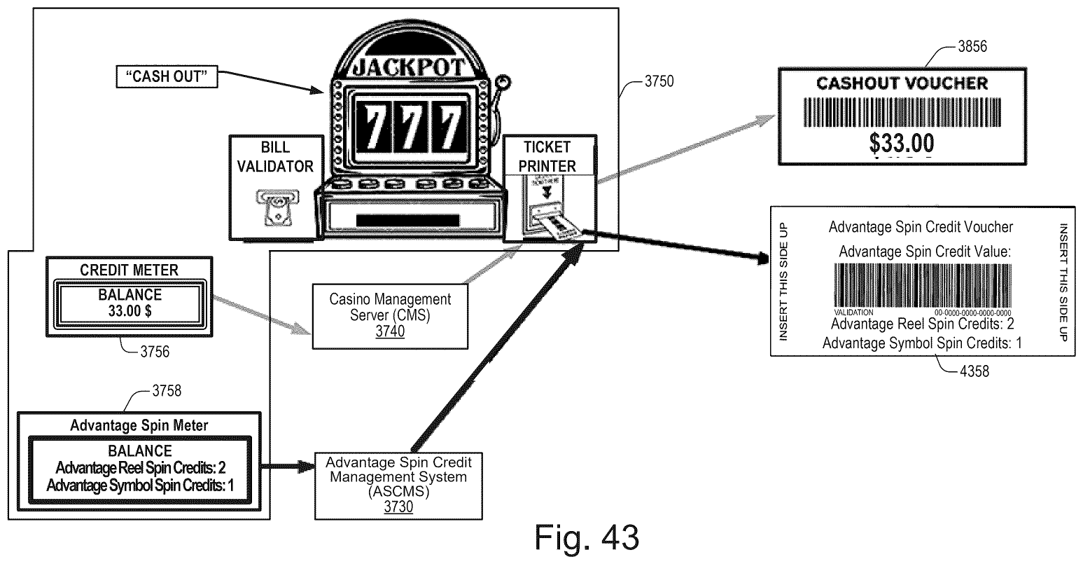

FIG. 43 illustrates a graphical user interface (GUI) for a wager-based slot game, presenting the process of executing a cash-out request by transferring balances from the Cash Credit Meter and Advantage Spin Credit Meters to separate vouchers. This embodiment showcases the integration of credit management systems to handle distinct credit types efficiently while providing clear feedback to the player.

### Scenario Description

The scenario begins when the player initiates a cash-out request by pressing the CASH OUT button on the EGM interface. In response, the EGM performs the following actions:
1. Detection of Cash-Out Condition:
2. The system identifies that a cash-out request has been initiated by the player. This triggers the EGM to prepare for the transfer of credit balances from the respective meters to appropriate vouchers.
3. Coordination with the Advantage Spin Credit Management System (ASCMS):
4. The EGM communicates with the ASCMS to validate the credit balances and execute the withdrawal process. Specifically:
   Cash Credit Meter: The EGM transfers $33 from the Cash Credit Meter to a Cash Credit Voucher (e.g., voucher ID 3856).
   Advantage Spin Credit Meters: The EGM transfers:
      2 Advantage Reel Spin Credits
      1 Advantage Symbol Spin Credit
      These credits are recorded on a separate Advantage Spin Credit Voucher (e.g., voucher ID 4358).
5. Voucher Generation:
6. The EGM's ticket printer produces two distinct vouchers:
   A Cash Credit Voucher for $33, representing standard monetary credits.
   An Advantage Spin Credit Voucher detailing the remaining Advantage Spin Credits (2 Advantage Reel Spin Credits and 1 Advantage Symbol Spin Credit), enabling future use or redemption.

### GUI Updates and Feedback

Throughout the cash-out process, the GUI provides real-time updates to ensure transparency and maintain player engagement. Notable elements include:
1. Transaction Confirmation:
2. A dedicated panel displays a summary of the cash-out process, such as:
3. “Cash-Out Completed: $33 transferred to Cash Credit Voucher (3856), 2 Reel Spin Credits and 1 Symbol Spin Credit transferred to Advantage Spin Credit Voucher (4358).”
4. Meter Updates:
   The Cash Credit Meter is decremented by $33, reflecting the transfer to the Cash Credit Voucher.
   The Advantage Spin Credit Meters are decremented by 2 Reel Spin Credits and 1 Symbol Spin Credit, respectively.
   The GUI dynamically updates these meters to show their new balances in real time.
5. Voucher Details:
6. A visual representation or text-based confirmation of the generated vouchers is displayed, including their unique identifiers and the credited amounts. For example:
   Cash Credit Voucher (ID 3856): $33
   Advantage Spin Credit Voucher (ID 4358): 2 Reel Spin Credits, 1 Symbol Spin Credit
7. Completion Notification:
8. A message confirms that the cash-out process has been successfully completed and that the vouchers are ready for collection.

### Technical Integration

The execution of this scenario relies on coordinated communication between the EGM and the ASCMS:
1. Credit Validation: The ASCMS validates the balances in the Cash Credit Meter and Advantage Spin Credit Meters to ensure accurate transfers.
2. Voucher Generation: The EGM generates the Cash Credit Voucher and Advantage Spin Credit Voucher based on the validated balances and assigns unique identifiers to each voucher.
3. Real-Time Synchronization: The system synchronizes the decrements in credit meters with the issuance of vouchers, maintaining consistency and regulatory compliance.

### Benefits and Player Engagement

This embodiment provides several advantages:
Clear Separation of Credit Types: The system distinguishes between standard cash credits and specialized Advantage Spin Credits, ensuring proper handling and tracking of each type.
Transparency: Real-time GUI updates and detailed transaction summaries provide players with confidence in the accuracy of the cash-out process.

Flexibility: The issuance of an Advantage Spin Credit Voucher allows players to retain and use their remaining Advantage Spin Credits in future gameplay sessions.

FIG. 43 illustrates an example embodiment of a procedural flow for the withdrawal or “cash-out” of credit meter balances from an Electronic Gaming Machine (EGM), detailing the issuance of two distinct types of vouchers: a Cash Credit Voucher and an Advantage Spin Credit Voucher. This process is specifically designed to enable seamless credit management for both monetary credits and Advantage Spin credits, ensuring that players receive their entitlements in a structured and transparent manner.

In at least one embodiment, the process is initiated when a Cash Out condition is detected by the EGM. This condition may arise in response to a player pressing a “Cash Out” button or selecting a cash-out option via the graphical user interface. Once the Cash Out request is recognized, the EGM coordinates with the Advantage Spin Credit Management System (ASCMS) to facilitate the transfer and withdrawal of the respective credit types.

The first phase involves the transfer of cash credits from the EGM's cash credit meter to a printed Cash Credit Voucher. For instance, if the cash credit balance is $33, the EGM will generate a voucher (e.g., labeled with reference ID 3856) reflecting this amount. The voucher is printed by the EGM's integrated ticket printer and issued to the player. The process is executed with validation checks to ensure the accuracy and legitimacy of the voucher through the ASCMS or the casino's central management system.

Simultaneously, the EGM processes the transfer of Advantage Spin credits, segregating the credits into distinct categories based on their functionality. For example, the system may detect a balance of 2 Advantage Reel Spin credits and 1 Advantage Symbol Spin credit. These credits are transferred to a separately generated Advantage Spin Credit Voucher (e.g., labeled with reference ID 4358). Similar to the cash credit process, the Advantage Spin Credit Voucher is printed and issued to the player. The voucher details the specific type and quantity of Advantage Spin credits, enabling players to utilize them in future gaming sessions or redeem them per the casino's terms.

This dual-voucher issuance mechanism provides multiple advantages:
1. Efficient Credit Management: Players may separately manage their cash credits and Advantage Spin credits, promoting clarity in their gaming activities.
2. Enhanced Player Flexibility: By issuing Advantage Spin credits as vouchers, players are not confined to immediate usage. They may carry forward these credits to other EGMs or gaming sessions, enhancing their overall experience.
3. Casino Operational Benefits: The use of the ASCMS ensures accurate tracking and validation of credits, reducing the potential for errors or disputes while enabling comprehensive reporting for regulatory compliance.

This system integrates seamlessly with the broader casino management infrastructure, leveraging real-time communication between the EGM, ASCMS, and the central casino server system. Such an arrangement ensures that all transactions are recorded, validated, and retrievable for both player satisfaction and operational audits.

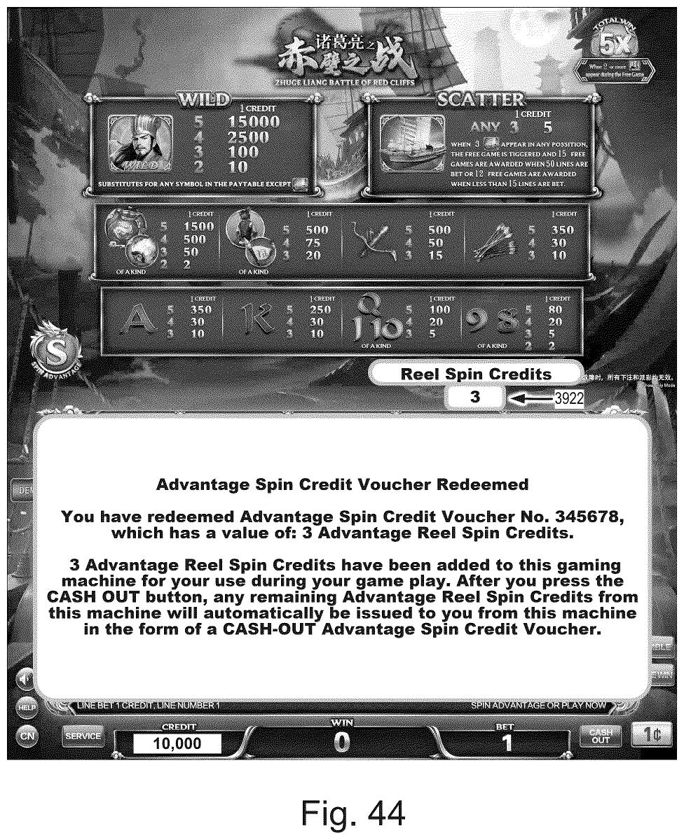

FIG. 44 depicts a graphical user interface (GUI) for a wager-based slot game, illustrating the interaction between the player and the system when an Advantage Spin Credit Voucher is inserted into an Electronic Gaming Machine (EGM). This example highlights the system's ability to authenticate the voucher and allocate its value accurately to the EGM's Advantage Reel Spin Credit Meter, ensuring seamless integration of specialized credits into gameplay.

The scenario begins when the player inserts an Advantage Spin Credit Voucher into the EGM's bill validator. The voucher includes specific encoded information, such as a unique Voucher ID, a Validation Code, and the quantity of Advantage Reel Spin Credits it represents. In this example, the voucher indicates that it provides 3 Advantage Reel Spin Credits. Once the voucher is inserted, the EGM processes its details by reading the encoded data to extract the Voucher ID, Validation Code, and the indicated credit amount.

Following the initial reading of the voucher, the EGM communicates with the Advantage Spin Credit Management System (ASCMS). This communication serves to authenticate and validate the voucher by cross-referencing the provided Voucher ID and Validation Code against the database managed by the ASCMS. The system ensures the legitimacy of the voucher and confirms the exact value or quantity of Advantage Reel Spin Credits to be credited to the EGM. In this case, the validation confirms that 3 Advantage Reel Spin Credits should be added to the EGM's reel spin credit meter.

Upon successful validation, the EGM updates the reel spin credit meter by adding the specified 3 Advantage Reel Spin Credits. The updated credit balance is immediately reflected on the EGM's GUI. The GUI prominently displays the updated reel spin credit meter, providing the player with a clear and transparent view of their available credits for Advantage Reel Spins. This ensures the player is fully informed of their credit status and may plan their gameplay accordingly.

The graphical user interface is designed to enhance the player experience by offering intuitive feedback and real-time updates. The notable GUI elements include the Reel Spin Credit Meter, which now displays the total credits available after the voucher transaction. Additionally, the interface may show a confirmation message or animation indicating that the Advantage Spin Credit Voucher has been successfully processed and that 3 Advantage Reel Spin Credits have been added to the meter. This visual feedback reassures the player that their voucher has been handled correctly and encourages continued engagement.

From a technical perspective, this embodiment demonstrates a robust integration between the EGM and the ASCMS. The EGM's ability to securely communicate with the ASCMS ensures that all voucher transactions are validated and tracked accurately, reducing the risk of errors or fraud. The dynamic updating of the reel spin credit meter in real-time further enhances system reliability and player trust.

This scenario also highlights the versatility of the Advantage Spin Credit system. By segregating specialized credits such as Advantage Reel Spin Credits into a dedicated meter, the system allows players to utilize these credits specifically for re-spins of reels. This targeted functionality provides players with greater strategic options and increases the depth of the gameplay experience.

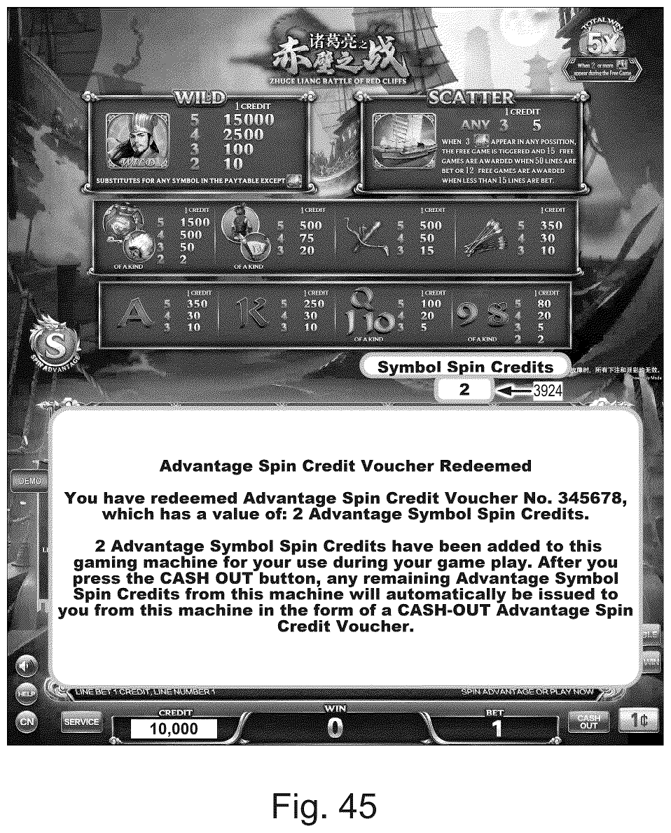

FIG. 45 illustrates a graphical user interface (GUI) for a wager-based slot game, showcasing the processing and integration of an Advantage Spin Credit Voucher that adds Advantage Symbol Spin Credits to the EGM. This scenario highlights the system's capability to manage specialized credits, providing players with dedicated resources for symbol-specific re-spin opportunities.

In this scenario, the player inserts an Advantage Spin Credit Voucher into the EGM's bill validator. The voucher is encoded with notable details, including a Voucher ID, a Validation Code, and the specific quantity of Advantage Symbol Spin Credits it represents. In this example, the voucher specifies a value of 2 Advantage Symbol Spin Credits. Upon insertion, the EGM reads the voucher's encoded data to extract and interpret these details.

After reading the voucher, the EGM initiates communication with the Advantage Spin Credit Management System (ASCMS). This communication involves transmitting the Voucher ID and Validation Code for verification. The ASCMS authenticates the voucher by comparing the provided information against its database, ensuring that the voucher is legitimate and confirming the credit value it represents. In this instance, the ASCMS validates that 2 Advantage Symbol Spin Credits should be added to the EGM's symbol spin credit meter.

Following successful validation, the EGM updates its symbol spin credit meter to reflect the newly added credits. The meter's updated balance, now including the 2 Advantage Symbol Spin Credits, is immediately displayed on the GUI. This real-time update provides the player with clear and transparent feedback regarding their available credits, enabling them to plan and execute symbol-specific re-spin strategies during gameplay.

The graphical user interface is designed with a focus on clarity and player engagement. The Symbol Spin Credit Meter prominently displays the updated balance of credits available for symbol-specific re-spin actions. Additionally, the GUI may feature confirmation messages or animations that visually reinforce the successful processing of the voucher. These elements ensure that players are fully informed about the outcome of their transaction and may confidently continue their gaming experience.

From a technical standpoint, this embodiment demonstrates the robust functionality of the Advantage Spin system. The seamless integration between the EGM and the ASCMS ensures secure authentication of Advantage Spin Credit Vouchers, safeguarding the integrity of the system. The EGM's ability to dynamically update the symbol spin credit meter in response to validated transactions further enhances system reliability and player trust.

This example also highlights the strategic flexibility provided by the Advantage Spin Credit system. By allowing players to deposit and utilize Advantage Symbol Spin Credits, the system introduces a targeted gameplay mechanic that enhances player agency and decision-making. Players may allocate these credits specifically toward symbol-based re-spin opportunities, tailoring their gameplay strategies to maximize potential winnings.

FIG. 46 illustrates a graphical user interface (GUI) for a wager-based slot game, showcasing the processing of an Advantage Spin Credit Voucher that contains both Advantage Reel Spin Credits and Advantage Symbol Spin Credits. This example highlights the system's capability to handle and allocate multiple credit types within the Advantage Spin system, providing players with enhanced flexibility and strategic options.

In this scenario, the player inserts an Advantage Spin Credit Voucher into the EGM's bill validator. The voucher is encoded with desirable details, including a Voucher ID, a Validation Code, and the specific quantities of Advantage Spin Credits it represents. In this case, the voucher indicates a value of 3 Advantage Reel Spin Credits and 2 Advantage Symbol Spin Credits. The EGM reads the encoded data, extracting the Voucher ID, Validation Code, and the associated credit details.

Upon reading the voucher, the EGM communicates with the Advantage Spin Credit Management System (ASCMS). This communication serves to authenticate the voucher by verifying the provided Voucher ID and Validation Code against the ASCMS database. Once authenticated, the ASCMS confirms the credit types and quantities specified in the voucher. In this example, the ASCMS validates the inclusion of 3 Advantage Reel Spin Credits and 2 Advantage Symbol Spin Credits to be allocated to the appropriate meters within the EGM.

Following validation, the EGM updates its Advantage Spin Credit Meters by adding the specified quantities. The Advantage Reel Spin Credit Meter is incremented by 3 credits, and the Advantage Symbol Spin Credit Meter is incremented by 2 credits. The GUI dynamically reflects these updates in real time, providing the player with clear and transparent information about their available Advantage Spin credits.

The graphical user interface is designed to prioritize clarity and player engagement. The Advantage Reel Spin Credit Meter and Advantage Symbol Spin Credit Meter are prominently displayed, showing their respective updated balances after the transaction. Additional visual cues, such as confirmation messages or animations, may be presented to reinforce the successful processing of the voucher. These GUI elements ensure that the player is fully informed about the transaction and may seamlessly transition back to gameplay.

Technically, this scenario demonstrates the sophisticated integration of the EGM with the ASCMS. The ability to process a single voucher containing multiple credit types reflects the robustness of the Advantage Spin system. The EGM's capacity to independently manage and allocate different credit types to their respective meters underscores its flexibility and precision. This ensures that players may access and utilize their credits as intended, whether for reel-specific or symbol-specific re-spin opportunities.

The inclusion of both Advantage Reel Spin Credits and Advantage Symbol Spin Credits within a single voucher adds strategic depth to the gameplay experience. Players may decide how to deploy their credits based on their gameplay strategy, selecting from reel-based or symbol-based re-spin opportunities. This dual-credit functionality enhances the value of the Advantage Spin system, fostering greater engagement and satisfaction.

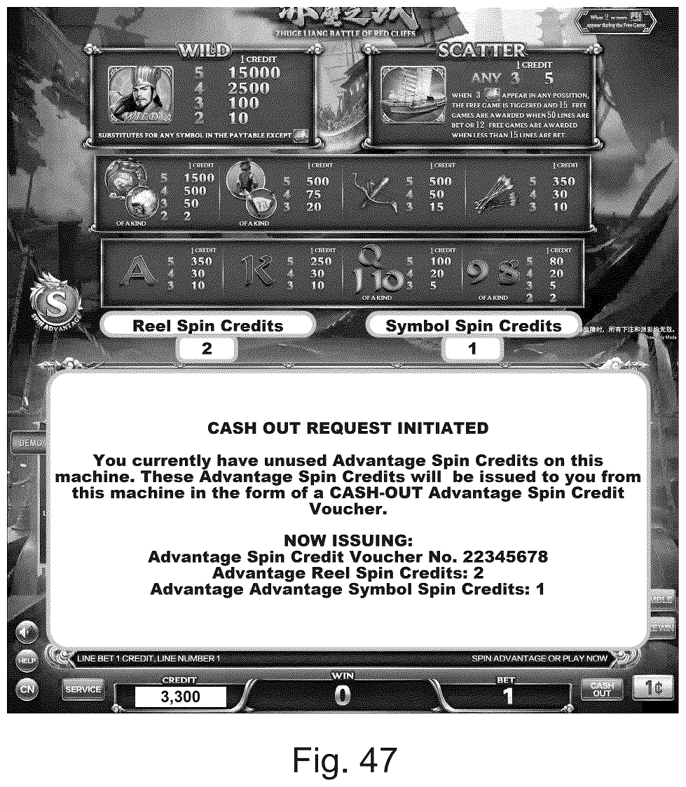

FIG. 47 illustrates a graphical user interface (GUI) for a wager-based slot game, depicting the process of cashing out Advantage Spin credits from an Electronic Gaming Machine (EGM). This scenario showcases the system's ability to handle cash-out requests involving specialized credit types, ensuring accurate redemption and resetting of credit meters.

In this scenario, the player is actively engaged in a wager-based gaming session on the EGM. At a certain point, the player chooses to initiate a cash-out request by pressing the CASH OUT button on the EGM's interface. The EGM immediately reads the current balances of its Advantage Spin Credit Meters. In this example, the Advantage Spin Credit Meters indicate a balance of 2 Advantage Reel Spin Credits and 1 Advantage Symbol Spin Credit.

Upon detecting the cash-out request, the EGM initiates procedures to create a CASH-OUT Advantage Spin Credit Voucher. To ensure accuracy and integrity, the EGM communicates with the Advantage Spin Credit Management System (ASCMS) and/or the Casino Management System (CMS) to validate the transaction and prepare the voucher. The system assigns the appropriate values to the voucher, reflecting the balances of the Advantage Spin Credit Meters. In this case, the voucher is configured to represent 2 Advantage Reel Spin Credits and 1 Advantage Symbol Spin Credit.

Once the CASH-OUT Advantage Spin Credit Voucher is successfully created, the EGM's ticket printer dispenses the physical voucher to the player. The GUI confirms the successful dispensing of the voucher by displaying a notification or animation, ensuring the player is aware that the transaction is complete. Following this, the EGM resets its Advantage Spin Credit Meters to zero, reflecting that all Advantage Spin credits have been redeemed and are no longer available for use on the machine.

The graphical user interface provides a clear and intuitive experience for the player throughout this process. The Advantage Spin Credit Meters prominently display the credit balances before the cash-out process begins, ensuring transparency. After the transaction, the meters are updated to show a balance of zero, providing visual confirmation that the credits have been successfully transferred to the CASH-OUT voucher. Additional GUI elements, such as a detailed transaction summary or a confirmation message, may be included to enhance clarity and reassure the player of the successful completion of their cash-out request.

From a technical perspective, this embodiment demonstrates the EGM's integration with the ASCMS and CMS to manage Advantage Spin credit transactions securely and accurately. The system's ability to validate and assign the correct values to the CASH-OUT voucher ensures that the redemption process is both fair and reliable. The automatic resetting of the Advantage Spin Credit Meters maintains the integrity of the system, preventing discrepancies or unauthorized reuse of credits.

The ability to cash out Advantage Spin credits provides significant flexibility and value to the player. By allowing these specialized credits to be converted into a tangible voucher, the system enhances the player's control over their gaming session. The CASH-OUT voucher may then be redeemed according to the casino's policies, potentially for use in future gaming sessions or other authorized purposes.

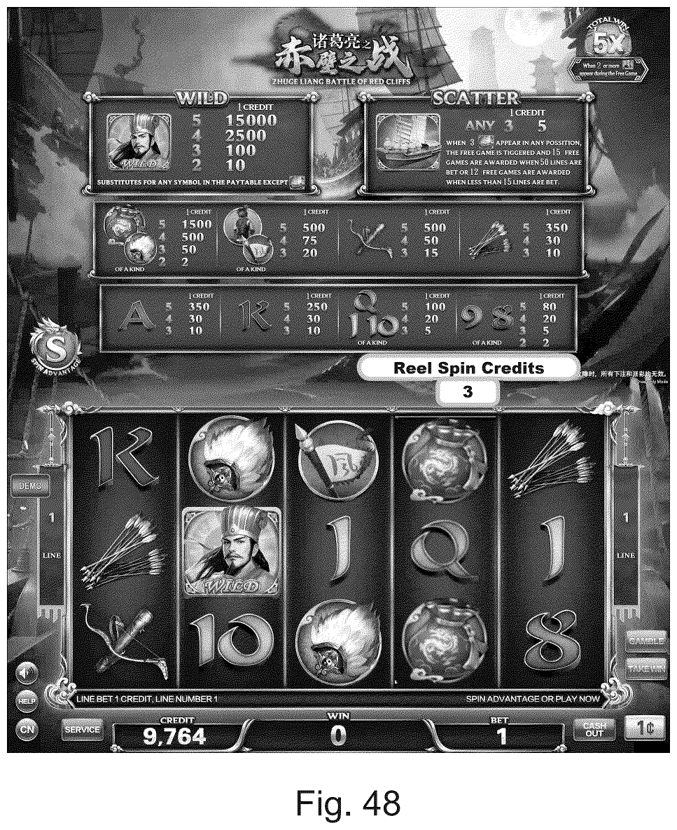

FIG. 48 illustrates a graphical user interface (GUI) designed for a wager-based slot game, depicting the display of results following the player's initiation of a first spin on the EGM. This example scenario showcases the interaction between the player and the slot game, focusing on the visual presentation of the spin outcome and the game state.

The scenario begins as the player engages in gameplay on the EGM and initiates a spin of the slot reels. The initiation of the spin is typically triggered through an interactive element on the GUI, such as a SPIN button or a touch-sensitive control. Upon activation, the EGM's random number generator (RNG) determines the outcome of the spin in accordance with the game's paytable and predefined probabilities, ensuring compliance with gaming regulations and fairness standards.

Once the RNG generates the outcome, the slot reels stop spinning to display the resulting arrangement of symbols on the screen. The GUI dynamically updates to show the final positions of the symbols across the reel matrix. These symbols are presented in a visually appealing manner, with animations or graphical effects enhancing the reveal of the spin outcome. Winning combinations, if any, are highlighted on the screen using distinct visual cues such as flashing symbols, colored outlines, or animations. This ensures that the player may easily identify their wins and understand the result of the spin.

The GUI also provides detailed feedback to the player regarding the spin outcome. If a winning combination is achieved, the win amount is prominently displayed on the screen, often accompanied by celebratory audio effects and animations. In the absence of a win, the GUI transitions smoothly to allow the player to initiate another spin without disruption. Additional GUI elements may display supplementary information, such as the current wager amount, the number of active paylines, and the remaining credit balance.

The graphical design of the interface prioritizes clarity and engagement. The reel matrix, which is the central focus of the GUI, occupies the majority of the screen, ensuring that players may clearly view the symbols and their positions. Adjacent to the reel matrix, notable metrics such as the credit meter, bet amount, and total win amount are displayed in a well-organized layout. These metrics are updated in real-time to reflect the player's current status in the game.

From a technical standpoint, the EGM integrates its RNG and reel control systems with the GUI to ensure seamless transitions and accurate displays. The RNG processes the player's wager and spin request to determine the result, while the reel control system synchronizes the visual movement of the reels with the generated outcome. The GUI then retrieves and presents this information in a user-friendly and visually appealing format, ensuring that the game remains immersive and interactive.

This scenario exemplifies the core functionality of wager-based slot games, providing players with an engaging and transparent gaming experience. The detailed visualization of spin outcomes, combined with real-time updates to notable game metrics, enhances the player's understanding and enjoyment of the game. Furthermore, the interface's intuitive design allows players to focus on the excitement of the gameplay, fostering a positive and seamless interaction with the EGM.

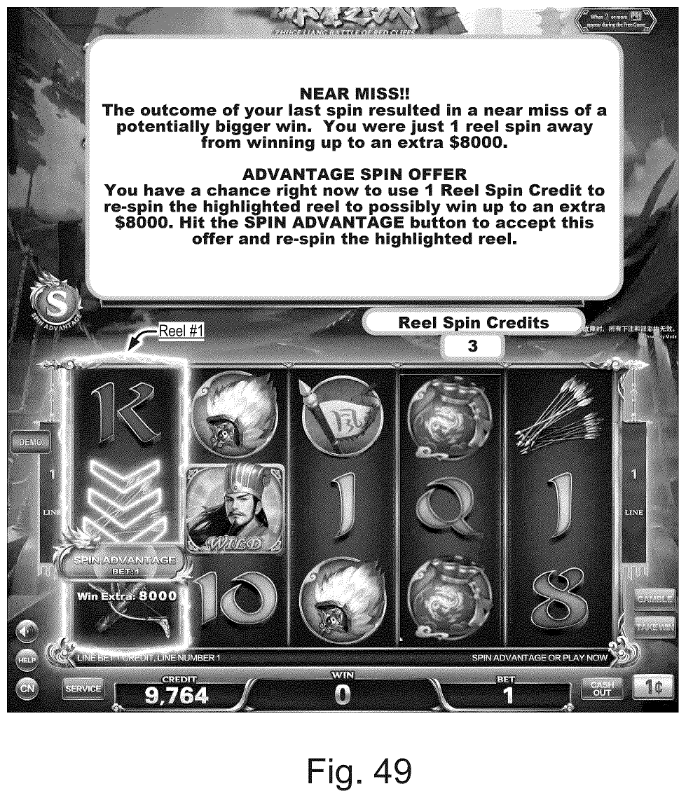

FIG. 49 illustrates a graphical user interface (GUI) for a wager-based slot game that dynamically presents an Advantage Spin Offer based on the real-time analysis of a near miss condition. This example highlights the integration of intelligent game state analysis within an EGM, enabling strategic re-spin opportunities that enhance player engagement and gameplay depth.

The scenario begins with the EGM automatically analyzing the outcome of the first spin of the slot reels. The EGM evaluates the currently displayed symbols to determine whether a near miss condition exists. A near miss condition is identified when a specific re-spin action may potentially convert a near-winning combination into a significant win. For example, the system detects that re-spinning reel #1 may result in a win amount of up to $8000, representing a valuable opportunity for the player.

To generate the Advantage Spin Offer, the EGM identifies notable parameters associated with the near miss condition. First, it determines the potential win amount for achieving a winning combination, which in this scenario is $8000. Next, the system pinpoints the specific reel(s) involved in the near miss condition, identifying reel #1 as the target for the re-spin. The EGM also calculates the cost of the re-spin, expressed in Advantage Reel Spin Credits or game credits. In this case, the system determines that 1 Advantage Reel Spin Credit would be required to initiate the re-spin of reel #1.

Before presenting the Advantage Spin Offer to the player, the EGM checks its internal rules and policies to ensure that such an offer is permitted under the current game state and regulatory constraints. The EGM also reads the current balance of the Advantage Reel Spin Credit Meter to confirm the availability of sufficient credits. In this example, the system verifies that the player has at least 1 Advantage Reel Spin Credit available, meeting the cost requirement for the offer.

Once these validations are complete, the EGM generates the Advantage Spin Offer in real-time and presents it to the player through the GUI. The offer is displayed prominently and may include the following elements:
A description of the near miss opportunity, such as: “Use 1 Reel Spin Credit to re-spin the highlighted reel (reel #1) to win up to an extra $8000.”
Visual cues highlighting the relevant reel (e.g., reel #1) to emphasize its importance in the re-spin opportunity.
Interactive controls, such as an Advantage Spin Button, allowing the player to accept the offer. Depending on the embodiment, this button may be implemented virtually on a touchscreen interface or as a physical button on the EGM's control panel.

If the player accepts the Advantage Spin Offer, the EGM executes the re-spin process. First, it decrements the Advantage Reel Spin Credit Meter by the required amount (e.g., 1 credit). The system then initiates the re-spin of reel #1, leaving the positions of all other reels unchanged. The result of the re-spin is displayed on the GUI, with any winning combinations highlighted and the corresponding payout credited to the player's balance.

The graphical interface is designed to ensure a seamless and engaging player experience throughout this process. The Advantage Spin Offer is displayed in an intuitive and visually appealing manner, with animations or color highlights drawing attention to the offer and the relevant reel. The player's available credit balances and other notable metrics, such as the current wager and total winnings, are displayed prominently to maintain transparency and enhance decision-making.

From a technical perspective, this embodiment demonstrates the advanced capabilities of the Advantage Spin system, integrating real-time game state analysis with intelligent offer generation. The system leverages data from the EGM's random number generator (RNG), reel control mechanisms, and credit management components to identify and execute strategic re-spin opportunities. This ensures that the Advantage Spin Offers are both meaningful to the player and compliant with regulatory requirements.

This functionality provides significant benefits for both players and casino operators. Players gain access to strategic re-spin opportunities that increase their engagement and potential rewards. For casino operators, the Advantage Spin system enhances player retention by introducing interactive and decision-driven elements to the gameplay, thereby increasing time spent on the machine.

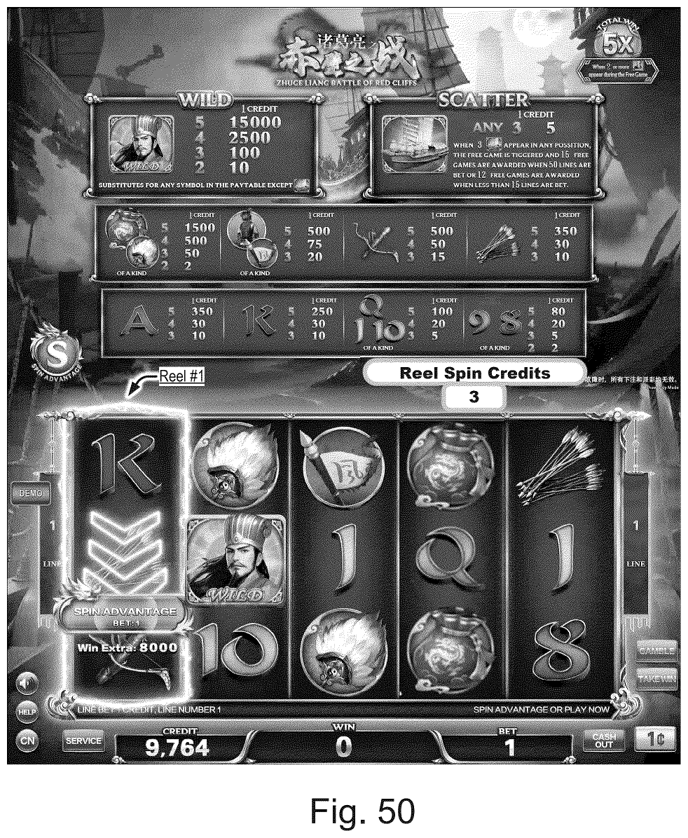

FIG. 50 depicts an example embodiment of an alternate Advantage Spin Offer graphical user interface (GUI) designed for a wager-based slot game. This alternate GUI configuration focuses on presenting Advantage Spin Offers in a manner that enhances player comprehension, interactivity, and engagement while providing flexibility in design and customization.

In this embodiment, the GUI presents an Advantage Spin Offer that integrates seamlessly into the overall game interface. The offer appears dynamically when triggered by specific game state conditions, such as a near miss, a bonus trigger, or another predefined event. This alternate design emphasizes clarity, interactivity, and a visually appealing presentation.

The alternate GUI embodiment introduces the following design elements and functionalities:
1. Centralized Offer Display Panel:
2. The Advantage Spin Offer is displayed prominently in a dedicated panel that occupies a central or easily visible area of the screen. This panel includes clear textual descriptions of the offer, such as:
   “Re-spin reel #3 using 1 Advantage Reel Spin Credit to win up to $5000!”
   The panel provides concise, actionable information, ensuring players may quickly understand the opportunity and the potential rewards.
3. Interactive Visual Cues:
4. The GUI highlights the specific reel or symbol involved in the Advantage Spin Offer using animations, glowing outlines, or color accents. For example, if the offer pertains to re-spinning reel #3, the GUI visually emphasizes reel #3 by illuminating it or applying a motion effect to draw the player's attention.
5. Offer Confirmation and Interaction Buttons:
6. The alternate GUI features clearly labeled interactive buttons for players to accept or decline the offer. Examples include:
   “Accept Offer”: Initiates the Advantage Spin and deducts the required credits.
   “Decline Offer”: Closes the offer panel and returns the player to standard gameplay.
   These buttons may be implemented as part of a touchscreen interface or as physical buttons on the EGM's control panel.
7. Dynamic Meter Updates:
8. Adjacent to the offer panel, the GUI displays real-time information about the player's current Advantage Spin credit balances. The system dynamically updates these meters as credits are consumed or added, ensuring transparency. For instance, after the player accepts the offer, the Advantage Reel Spin Credit Meter decrements by the required credit amount, and the updated balance is shown immediately.
9. Customizable Offer Designs:
10. This alternate GUI allows for enhanced customization of the offer's presentation. Casino operators or game designers may tailor the colors, animations, and layout of the offer panel to align with specific game themes, branding, or promotional campaigns.
11. Integrated Gameplay Information:
12. The GUI maintains visibility of desirable gameplay metrics such as the player's credit balance, current wager, and any active paylines. These elements are positioned around the Advantage Spin Offer panel, ensuring that players remain informed about their overall game state while considering the offer.

From a technical standpoint, this alternate GUI design leverages the same backend systems as the standard Advantage Spin Offer interface. The EGM's random number generator (RNG) and reel control mechanisms generate the offer's potential outcomes, while the Advantage Spin Credit Management System (ASCMS) ensures accurate validation and tracking of credits. This ensures that the alternate GUI provides the same reliability and regulatory compliance as other embodiments of the Advantage Spin system.

This embodiment is particularly beneficial for enhancing player engagement. The use of visual and interactive elements makes the offer more compelling, while the clear and concise presentation reduces decision-making friction for players. The ability to customize the GUI also allows casinos to align the interface with their marketing strategies, creating unique experiences that may attract and retain players.

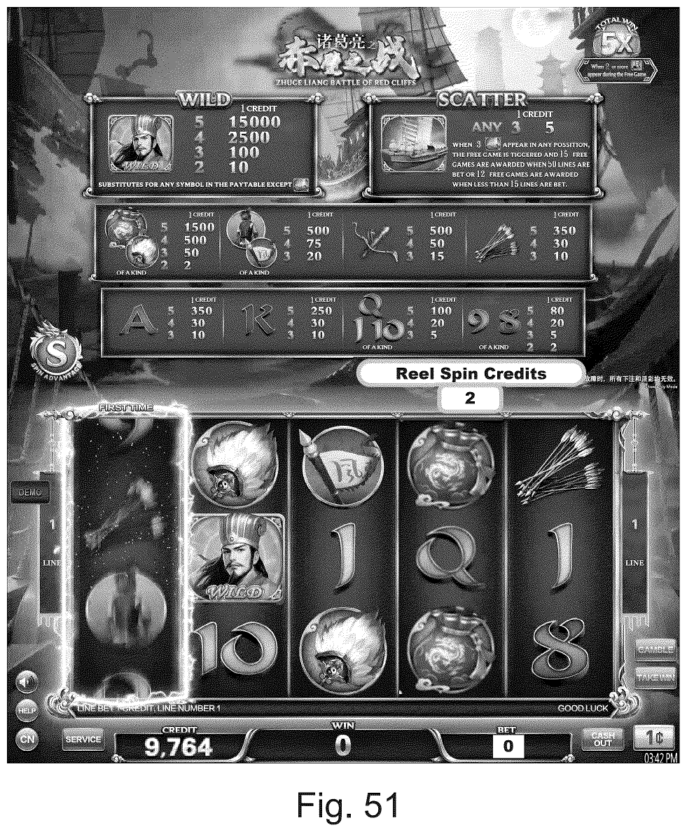

FIG. 51 depicts a graphical user interface (GUI) for a wager-based slot game, illustrating the system response and interface updates following the player's acceptance of an Advantage Spin Offer. This scenario highlights the initiation and execution of a re-spin of a specific reel using an Advantage Reel Spin Credit, without impacting the player's standard Game Credit Meter.

In this scenario, the player has accepted an Advantage Spin Offer that may may require the consumption of 1 Advantage Reel Spin Credit to re-spin a highlighted reel. Upon accepting the offer, the EGM executes the following sequence of actions, reflected in the GUI:
1. Consumption of Advantage Spin Credit:
2. The EGM decrements the Advantage Reel Spin Credit Meter by 1 credit to account for the re-spin. This action ensures the accurate tracking of Advantage Spin credits. The updated balance is displayed in real time on the GUI, providing transparency to the player. Importantly, the Game Credit Meter remains unchanged in this scenario, as the re-spin is funded exclusively through the Advantage Spin system.
3. Initiation of Reel Re-Spin:
4. The EGM initiates the re-spin of the specific reel highlighted in the Advantage Spin Offer. In this case, Reel #1 undergoes the re-spin process while the other reels and symbols remain fixed in their previous positions. This selective re-spin mechanism is visually represented on the GUI, with Reel #1 spinning independently while the static reels are dimmed or visually differentiated.
5. Dynamic Reel Animation and Interactivity:
6. The GUI displays the spinning motion of Reel #1, incorporating dynamic animations to emphasize the re-spin action. Highlighting effects or animations on Reel #1 may further reinforce its importance to the re-spin. These visual cues enhance the player's immersion and ensure a clear understanding of the re-spin process.
7. Retention of Other Metrics:
8. Throughout the re-spin, the GUI maintains the visibility of other notable gameplay metrics, including the Game Credit Meter, total wager, and active paylines. This consistent presentation reassures the player of their current game state and reinforces the separation of Advantage Spin Credits from standard game credits.
9. Integration of Symbol-Specific Re-Spin Logic:
10. The system ensures that the re-spin mechanics adhere to the Advantage Spin Offer parameters. For instance, the re-spin of Reel #1 may focus on improving a near miss condition or achieving a specific winning combination. The GUI visually represents the outcome of the re-spin, highlighting any resulting winning combinations or payouts.

From a technical perspective, the EGM's internal systems manage the seamless execution of this process. The Advantage Spin Credit Management System (ASCMS) validates the availability of Advantage Spin Credits before authorizing the re-spin. The EGM's reel control mechanism isolates Reel #1 for the targeted re-spin, ensuring that the game's random number generator (RNG) and payout calculations remain compliant with regulatory requirements.

This embodiment offers significant benefits for player engagement and satisfaction. By enabling re-spins through Advantage Spin Credits, the system provides a strategic gameplay element that encourages players to consider tactical use of their credits. The independence of the Game Credit Meter from the re-spin transaction reinforces the distinct value of Advantage Spin Credits, allowing players to preserve their standard credits for other gameplay actions.

The GUI design emphasizes clarity and interactivity, ensuring that the player may easily follow the re-spin process and its impact on their game state. The use of animations, real-time updates to credit meters, and highlighted reel actions fosters a seamless and engaging experience.

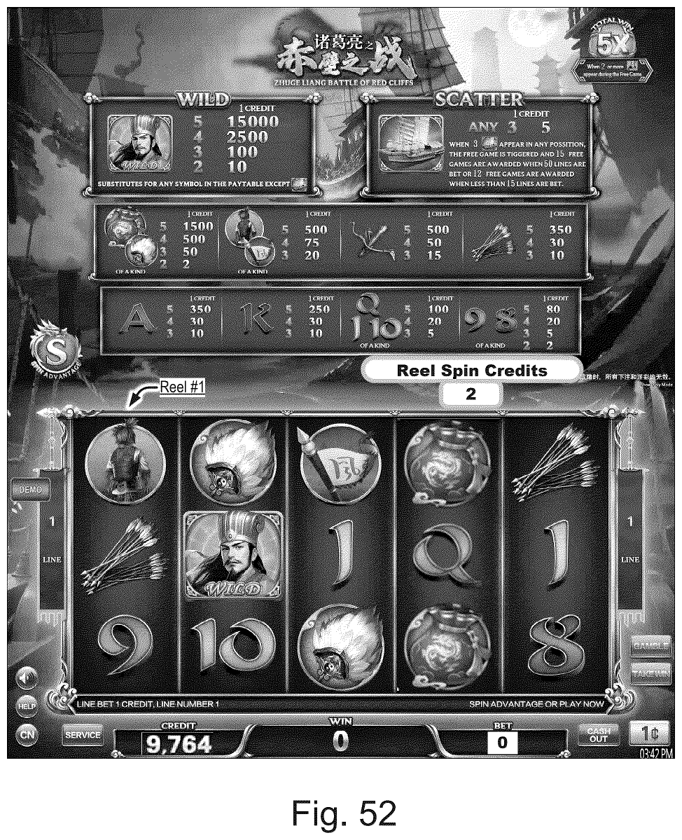

FIG. 52 illustrates the graphical user interface (GUI) for a wager-based slot game, showcasing the display of the outcome following the execution of a first re-spin of Reel #1. This scenario highlights the conclusion of a targeted re-spin initiated as part of an Advantage Spin Offer, emphasizing the clear presentation of results to the player.

In this scenario, the player has previously accepted an Advantage Spin Offer to consume one Advantage Reel Spin Credit to re-spin Reel #1. After executing the re-spin, the GUI updates to reflect the final position of Reel #1 and the resulting game state.

Upon the conclusion of the re-spin, the GUI dynamically displays the symbols that now occupy the positions on Reel #1. This updated reel configuration is seamlessly integrated with the fixed positions of the remaining reels to form a complete reel matrix. The system evaluates the new arrangement of symbols against the game's paytable to determine if any winning combinations are formed. If the re-spin results in a win, the GUI highlights the winning symbols and paylines using distinct visual effects such as flashing outlines, animations, or color changes.

The win amount resulting from the re-spin, if any, is prominently displayed on the GUI. This amount may be shown in a designated area of the interface, such as a Win Meter, or as a temporary overlay near the reel matrix for maximum visibility. In addition to the visual feedback, celebratory audio effects may accompany the win, enhancing the player's sense of achievement.

If the re-spin does not produce a winning combination, the GUI transitions smoothly to the default game state, allowing the player to continue gameplay without disruption. Regardless of the outcome, the Advantage Reel Spin Credit Meter reflects the decrement from the previous re-spin transaction, and its updated balance remains visible to the player.

The GUI retains notable gameplay metrics, including the player's Game Credit Meter, total wager, and active paylines, ensuring that the overall game state is consistently presented. This continuity helps the player maintain a clear understanding of their current status within the game.

From a technical perspective, the EGM's random number generator (RNG) and reel control systems ensure that the re-spin adheres to the game's mathematical model and regulatory requirements. The results of the re-spin are calculated in real time, and the GUI updates promptly to display the new reel positions and associated outcomes.

This embodiment underscores the flexibility and strategic depth introduced by the Advantage Spin system. By enabling targeted re-spins through Advantage Reel Spin Credits, the system provides players with opportunities to influence game outcomes while preserving the fundamental randomness of slot gameplay.

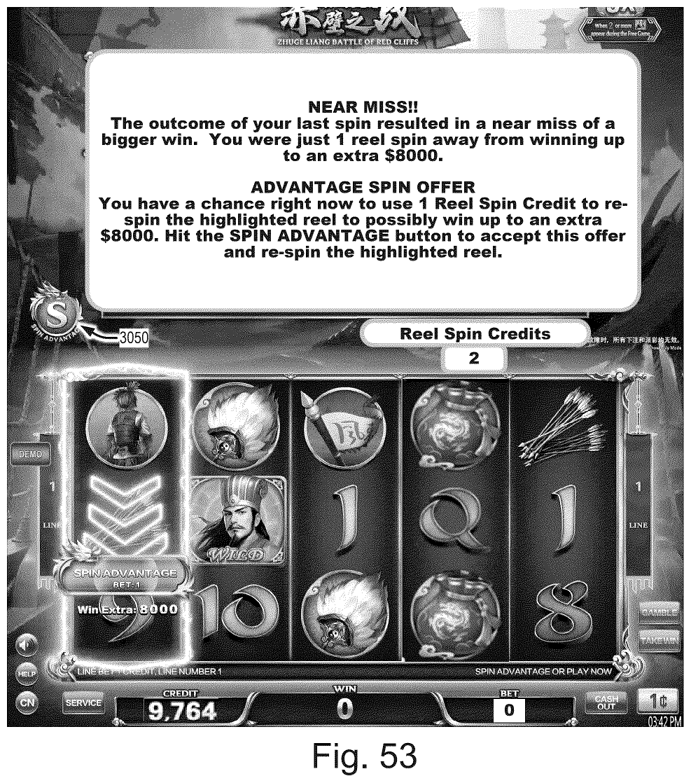

FIG. 53 illustrates a graphical user interface (GUI) for a wager-based slot game that dynamically presents a new Advantage Spin Offer based on the real-time analysis of the outcome from a previously initiated re-spin of Reel #1. This embodiment highlights the system's ability to continuously identify near miss conditions and provide tailored re-spin opportunities to players, enhancing strategic gameplay and engagement.

### Scenario Description

The sequence begins after the conclusion of the first re-spin of Reel #1. The EGM automatically analyzes the displayed reel symbols to determine whether a near miss condition is present. This analysis involves evaluating the current game state and identifying potential opportunities where a subsequent re-spin may convert a near miss into a significant win.

In this example, the EGM identifies a near miss condition with a potential win amount of $8000. The system determines that re-spinning Reel #1 offers a possibility to achieve this win. It calculates the required cost for the re-spin, which is 1 Advantage Reel Spin Credit, ensuring that the cost is appropriately aligned with the potential reward. These details are prepared to form the basis of the new Advantage Spin Offer.

### Validation and Offer Generation

Before presenting the Advantage Spin Offer, the EGM performs a series of validations:
The system checks the internal rules and policies to confirm that presenting another Advantage Spin Offer is permitted in the current game context. In this case, the rules allow the offer to proceed.
The EGM reads the current value of the Advantage Reel Spin Credit Meter to ensure that the player has sufficient credits to accept the offer. For this example, the player's credit balance is adequate to fund the re-spin.

With these validations complete, the EGM generates the Advantage Spin Offer and presents it to the player in real time. The GUI prominently displays the offer, which includes:
A clear description of the opportunity, such as: “Use 1 Reel Spin Credit to re-spin the highlighted reel (Reel #1) to possibly win up to $8000.”
Visual highlights on Reel #1 to emphasize its role in the potential win, using animations, glowing outlines, or color accents.
Interactive elements, such as a virtual “Accept Offer” button, allowing the player to choose whether to proceed with the re-spin. Depending on the implementation, the offer may also be accepted via a physical button on the EGM interface.

### Re-Spin Execution

If the player accepts the Advantage Spin Offer, the EGM proceeds to execute the re-spin as follows:
1. Consumption of Advantage Spin Credit:
2. The system decrements the Advantage Reel Spin Credit Meter by 1 credit to fund the re-spin. The updated balance is displayed in real time on the GUI.
3. Initiation of Reel Re-Spin:
4. The EGM isolates Reel #1 for the targeted re-spin, leaving the positions of the other reels unchanged. The GUI dynamically animates the spinning motion of Reel #1, with visual cues reinforcing the re-spin action.
5. Outcome Display:
6. Upon completion of the re-spin, the GUI updates to display the new configuration of Reel #1 alongside the static symbols of the other reels. The system evaluates the new arrangement for winning combinations and highlights any resulting wins with animations or special effects.

### GUI Design and Player Engagement

The GUI in this scenario is designed to maximize player engagement and comprehension. The Advantage Spin Offer is presented in a prominent panel with clear, concise language describing the opportunity and its potential reward. Reel #1 is visually emphasized, drawing the player's attention to the re-spin focus. The interactive elements, including buttons for accepting or declining the offer, are designed to facilitate seamless decision-making.

Notable gameplay metrics, such as the Game Credit Meter, Advantage Reel Spin Credit Meter, and the player's total win amount, remain visible throughout the process. These metrics provide transparency and ensure that the player remains informed about their current status and resources.

### Technical Integration

The execution of this scenario relies on the EGM's integration with its internal systems, including:
Random Number Generator (RNG): Ensures the randomness and fairness of the re-spin outcome.
Advantage Spin Credit Management System (ASCMS): Validates the availability of credits and tracks their consumption.
Reel Control Mechanisms: Isolates and re-spins the targeted reel while maintaining the integrity of the game state.

The system's ability to generate Advantage Spin Offers in real time, based on dynamic game state analysis, exemplifies the sophistication of the Advantage Spin framework. This functionality not only enhances the strategic depth of gameplay but also provides players with additional opportunities to engage with the game.

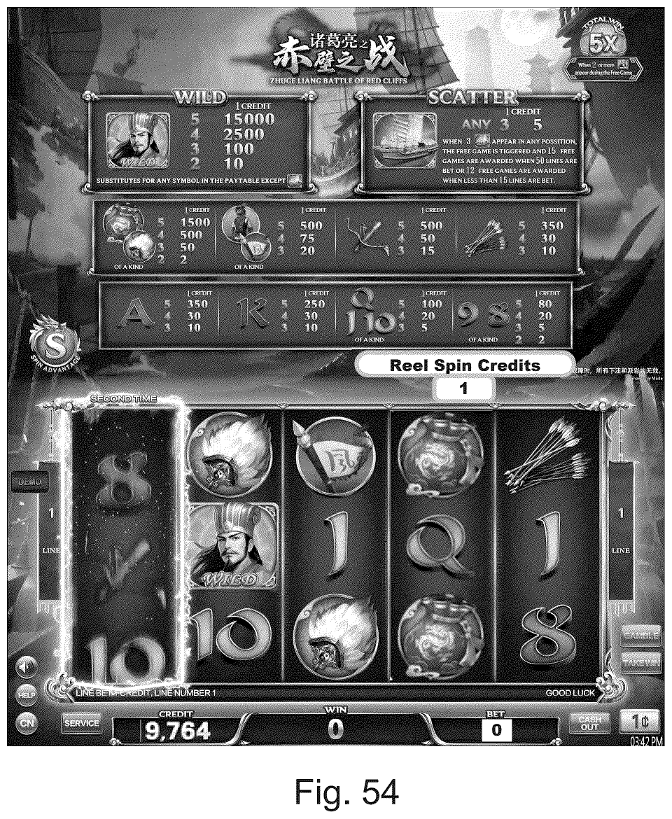

FIG. 54 illustrates a graphical user interface (GUI) for a wager-based slot game, presenting the execution of a second re-spin of Reel #1 after the player has accepted an Advantage Spin Offer. This example highlights the system's capability to consume Advantage Spin Credits exclusively for targeted re-spins, ensuring the preservation of the player's standard Game Credit Meter balance.

### Scenario Description

The scenario begins after the player accepts an Advantage Spin Offer to initiate a second re-spin of Reel #1. The system initiates the re-spin sequence as follows:
1. The Advantage Reel Spin Credit Meter is decremented by 1 credit to account for the cost of the re-spin. The updated balance is displayed on the GUI in real time, providing transparency to the player.
2. The Game Credit Meter, identified as Meter 2014, remains unaffected. The system ensures that the re-spin is funded solely through Advantage Reel Spin Credits, preserving the player's regular game credits for other gameplay actions.
3. The EGM isolates Reel #1 and initiates the re-spin while maintaining the fixed positions of the other reels. The visual motion of Reel #1 is animated on the GUI, providing dynamic feedback and emphasizing the targeted nature of the re-spin.

### Dynamic Reel Animation and Gameplay Metrics

The GUI prominently features Reel #1 as it undergoes the re-spin process. Visual effects, such as glowing borders or motion trails, may be applied to the reel to enhance player focus and engagement. The remaining reels are dimmed or visually differentiated to highlight the active reel.

Adjacent to the reel matrix, the GUI displays notable gameplay metrics, including:
The Advantage Reel Spin Credit Meter, which reflects the updated credit balance after the consumption of 1 credit.
The Game Credit Meter (2014), which remains unchanged to reinforce the separation between standard game credits and Advantage Spin Credits.
Other metrics, such as total wager and paylines, which remain visible to ensure continuity in gameplay information.

### Technical Execution

The execution of the second re-spin is managed by the EGM's internal systems, which ensure the integrity and fairness of the process:
1. The Advantage Spin Credit Management System (ASCMS) validates the availability of Advantage Spin Credits before authorizing the re-spin.
2. The EGM's random number generator (RNG) determines the outcome of the re-spin in accordance with the game's predefined mathematical model and regulatory requirements.
3. The reel control mechanism isolates Reel #1 and executes the re-spin while preserving the state of the other reels.

### User Feedback and Visual Design

The GUI provides continuous feedback to the player during the re-spin process. The spinning animation of Reel #1 transitions seamlessly into the final stop position, displaying the updated symbol configuration. If the re-spin results in a winning combination, the GUI highlights the winning symbols and paylines using celebratory animations or flashing outlines. The corresponding win amount is prominently displayed on the screen, along with audio effects to enhance the player's experience.

If the re-spin does not result in a win, the GUI smoothly returns to the default game state, allowing the player to proceed with their next action. Throughout this process, the interface maintains clarity and transparency, ensuring the player is fully informed of the impact of their decisions.

### Benefits and Engagement

This embodiment highlights the strategic depth introduced by the Advantage Spin system. By enabling targeted re-spins funded exclusively through Advantage Spin Credits, the system provides players with additional gameplay options without depleting their standard credits. The clear separation of credit types, as reflected in the GUI, reinforces the distinct value of Advantage Spin Credits and encourages their strategic use.

The visual design of the GUI, with its emphasis on dynamic animations and real-time updates, fosters an engaging and immersive experience. The seamless integration of gameplay metrics ensures that players remain informed and confident in their decisions throughout the re-spin process.

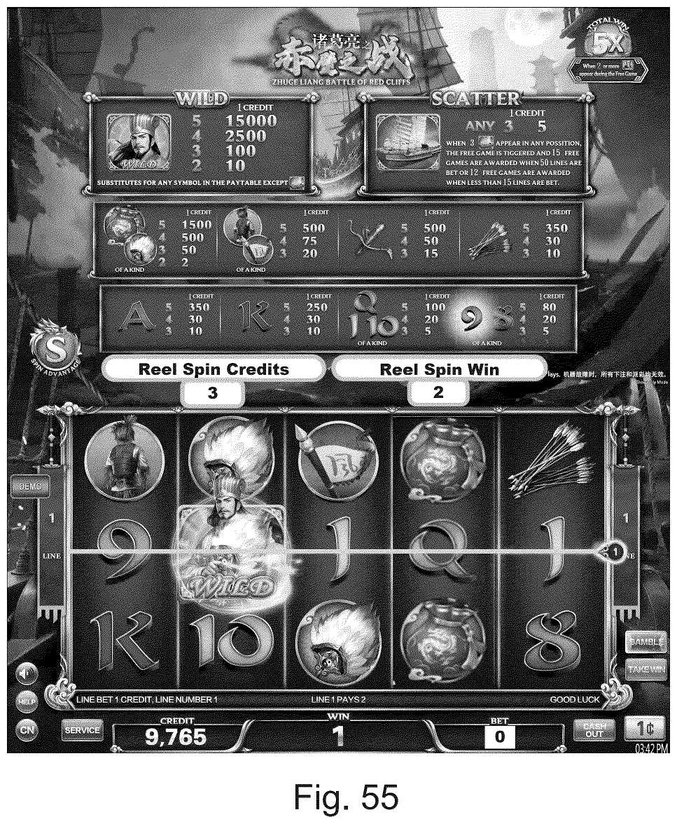

FIG. 55 illustrates a graphical user interface (GUI) for a wager-based slot game, presenting the outcome of a second re-spin of Reel #1 executed using an Advantage Spin Credit. This example highlights the game results, updates to the player's credit meters, and the potential for additional Advantage Spin opportunities based on the outcome.

### Scenario Description

In this scenario, the second re-spin of Reel #1 results in a combination that yields multiple outcomes:
1. A win of 1 Game Credit, which is added to the Game Credit Meter.
2. A win of 2 Advantage Reel Spin Credits, which are added to the Advantage Reel Spin Credit Meter. The GUI dynamically updates to reflect these wins, providing clear and immediate feedback to the player.

### Outcome Presentation and Credit Updates

The interface prominently displays the results of the re-spin in an intuitive and visually appealing manner. Notable updates include:
The Game Credit Meter is incremented by 1 credit to reflect the addition of the game credit won during the re-spin.
The Advantage Reel Spin Credit Meter is incremented by 2 credits, displaying the new balance of Advantage Reel Spin Credits available for future gameplay. This real-time update ensures the player is fully informed of their current resources.

In addition to updating the meters, the GUI may present a summary of the re-spin outcome in a dedicated results panel or overlay. For example, a message may read:
“Congratulations! You won: 1 Game Credit and 2 Advantage Reel Spin Credits.”

This message is typically accompanied by celebratory animations or sound effects to enhance player engagement and satisfaction.

### Additional Advantage Spin Opportunities

In at least one embodiment, the game may offer the player additional Advantage Spin opportunities based on the outcome of the second re-spin. If such an offer is generated, it is presented through the GUI as a clear and actionable prompt, such as:
“Use 1 Advantage Reel Spin Credit to re-spin Reel #2 for a chance to win up to $5000!”

The GUI highlights the relevant reel(s) and provides interactive buttons for the player to accept or decline the offer. This dynamic integration of follow-up opportunities encourages continued engagement and provides the player with additional strategic choices.

### Technical Integration

The execution of this scenario relies on the following components of the EGM:
1. Random Number Generator (RNG): Ensures the randomness and fairness of the second re-spin outcome.
2. Advantage Spin Credit Management System (ASCMS): Tracks the addition of the 2 Advantage Reel Spin Credits to the respective meter, ensuring accurate credit management.
3. Game Controller: Updates the Game Credit Meter and Advantage Reel Spin Credit Meter in real time, synchronizing the display with the GUI.

The system's ability to recognize and present additional Advantage Spin opportunities based on the current outcome demonstrates its dynamic and adaptive nature. These follow-up offers are generated in compliance with predefined rules and policies, maintaining fairness and regulatory compliance.

### Visual Design and Engagement

The GUI emphasizes clarity and player engagement by utilizing:
Dynamic Animations: The updated credit meters may include animated increments, and celebratory effects may accompany the display of wins.
Highlighting and Messaging: Winning symbols, paylines, and outcomes are visually emphasized, ensuring players may easily understand the results of the re-spin.
Interactive Elements: If additional Advantage Spin offers are presented, the interface includes clearly labeled buttons or touchpoints for players to accept or decline the offer.

### Player Benefits

This embodiment enhances the player experience by providing multiple layers of rewards and opportunities:
The immediate addition of game credits and Advantage Reel Spin Credits incentivizes continued play.

The potential for follow-up Advantage Spin opportunities adds strategic depth and excitement, encouraging players to remain engaged with the game.

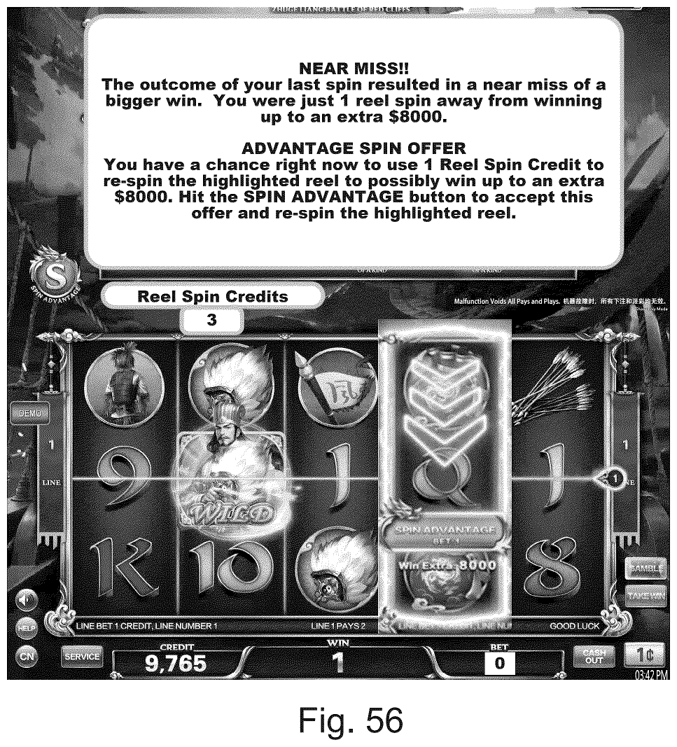

FIG. 56 illustrates a graphical user interface (GUI) for a wager-based slot game, showcasing the system's ability to dynamically present an Advantage Spin Offer following the real-time analysis of game events to identify a near miss condition. This example highlights the seamless integration of game state monitoring, intelligent offer generation, and player interaction, enabling targeted re-spin opportunities funded through Advantage Spin Credits.

### Scenario Description

The scenario begins with the EGM monitoring the current game state during the player's gameplay. As part of its continuous analysis, the EGM evaluates the outcome of the most recent spin or game event to determine whether any near miss or near hit conditions exist. A near miss condition is identified when a minor adjustment, such as a re-spin of one or more reels, may convert the current arrangement of symbols into a significant winning combination.

Upon identifying a near miss event, the EGM dynamically determines the parameters of a potential Advantage Spin opportunity. These parameters include:
1. The Type(s) of Advantage Spin Credits Required: For instance, Advantage Reel Spin Credits or Advantage Symbol Spin Credits.
2. The Quantity of Credits Needed: The number of credits required to fund the re-spin or re-spin sequence, based on predefined game rules and the potential reward.

The EGM then reads the current balances of its Advantage Spin Credit Meters to verify that the player possesses sufficient credits of the required type(s) to execute the identified re-spin opportunity. If the available balance is sufficient, the system proceeds to generate an Advantage Spin Offer.

### Advantage Spin Offer Presentation

The Advantage Spin Offer is presented to the player through the GUI in an intuitive and engaging manner. Notable elements of the offer include:
A concise description of the opportunity, such as:
“Use 1 Advantage Reel Spin Credit to re-spin Reel #2 for a chance to win up to $5000!”
Visual cues highlighting the relevant reel(s) involved in the re-spin, such as glowing outlines or animations applied to the identified reel(s).
Real-time updates to the Advantage Spin Credit Meters, displaying the current credit balances and the quantity of credits required for the offer.

The offer also includes interactive options for the player, such as buttons or touchpoints labeled “Accept” or “Decline”, enabling the player to make a quick and informed decision.

### Player Interaction and Re-Spin Execution

If the player accepts the Advantage Spin Offer, the EGM executes the following steps:
1. Consumption of Advantage Spin Credits:
2. The determined quantity and type(s) of Advantage Spin Credits are deducted from the respective Advantage Spin Credit Meters. The updated balances are displayed on the GUI in real time.
3. Initiation of Re-Spin:
4. The EGM isolates the identified reel(s) or symbol(s) for the Advantage Spin and initiates the re-spin sequence. The GUI visually emphasizes the spinning reel(s) with dynamic animations, while non-active elements remain static or dimmed for clarity.
5. Outcome Display:
6. The GUI updates to show the results of the re-spin. If the re-spin results in a winning combination, the relevant symbols and paylines are highlighted, and the win amount is displayed prominently on the screen. Additional celebratory effects, such as flashing animations or sound effects, may accompany the win to enhance player satisfaction.

### Technical Integration

The system's operation is underpinned by robust technical components:
Game State Monitoring and Analysis: Real-time monitoring and evaluation of the current game state are conducted using the EGM's game controller and random number generator (RNG), ensuring accurate identification of near miss conditions.
Advantage Spin Credit Management System (ASCMS): Verifies the availability of the required Advantage Spin Credits and tracks their consumption during the transaction.
Reel and Symbol Control Mechanisms: Isolates and manages the re-spin of specific reels or symbols while preserving the integrity of the overall game state.

### Benefits and Player Engagement

The seamless integration of Advantage Spin Offers into the gameplay provides several benefits:
Enhanced Strategic Opportunities: Players gain additional control over their gameplay by leveraging Advantage Spin Credits to pursue specific re-spin opportunities.
Dynamic and Engaging Gameplay: The use of real-time analysis to generate targeted offers keeps players engaged and invested in their gaming sessions.

Transparency and Clarity: The GUI ensures players are fully informed about the offer details, the cost in credits, and the potential rewards, fostering trust and satisfaction.

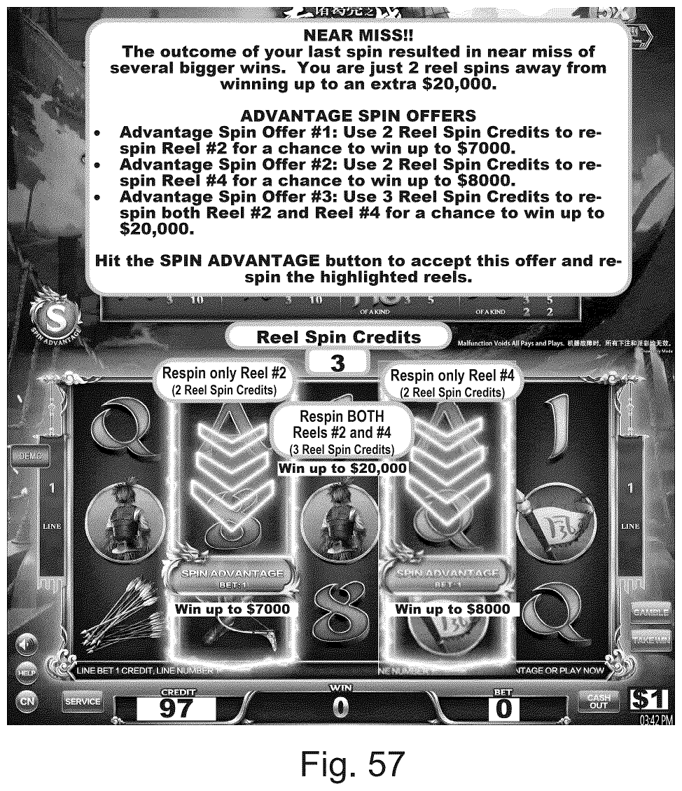

FIG. 57 illustrates a graphical user interface (GUI) for a wager-based slot game, showcasing the presentation of multiple Advantage Spin Offers generated dynamically based on the outcome of a prior spin event. This embodiment emphasizes player choice, enabling the selection of one or more targeted re-spin opportunities funded through Advantage Reel Spin Credits or, optionally, standard game credits.

### Scenario Description

The scenario begins with the EGM analyzing the outcome of a prior spin or re-spin event. Based on this analysis, the EGM identifies opportunities for strategic re-spins of specific reels that may lead to significant wins. In this example, the system generates three distinct Advantage Spin Offers, allowing the player to choose from the following options:
1. Re-spin Reel #2 for 2 Advantage Reel Spin Credits with a potential win of up to $7000.
2. Re-spin Reel #4 for 2 Advantage Reel Spin Credits with a potential win of up to $8000.
3. Re-spin both Reels #2 and #4 for 3 Advantage Reel Spin Credits with a potential win of up to $20,000.

The offers are dynamically presented to the player via the GUI, enabling a clear understanding of the costs, potential rewards, and strategic implications of each option.

### Presentation of Multiple Advantage Spin Offers

The GUI is designed to prominently display the Advantage Spin Offers in an organized and engaging manner.

Notable elements include:
Offer Descriptions: Each option is described in detail, specifying the reel(s) involved, the cost in credits, and the maximum potential win. For example:
   “Re-spin Reel #2 for 2 Reel Spin Credits; win up to $7000.”
   “Re-spin Reel #4 for 2 Reel Spin Credits; win up to $8000.”
   “Re-spin BOTH Reels #2 and #4 for 3 Reel Spin Credits; win up to $20,000.”
Visual Highlights: The relevant reels (Reel #2, Reel #4, or both) are visually emphasized on the reel matrix using animations, glowing borders, or color accents to draw the player's attention.
Interactive Selection Mechanism: The GUI provides interactive controls, such as buttons or touch-enabled panels, for the player to select their preferred Advantage Spin Offer. Each button is labeled clearly to match the corresponding offer description.

### Verification of Credits and Alternate Funding Options

Before presenting the offers, the EGM reads the balances of the Advantage Reel Spin Credit Meter to confirm the player has sufficient credits to fund the selected option. If the player does not have enough Advantage Spin Credits to select a specific offer—such as the option to re-spin both Reels #2 and #4 for 3 credits—the system may present an alternate funding method. In this embodiment, the player is allowed to use standard game credits to supplement or fully fund the re-spin. The GUI dynamically updates to display this option, ensuring the player may make an informed decision.

### Execution of Selected Re-Spin Option

Once the player makes a selection, the EGM executes the following steps:
1. Consumption of Credits:
2. The required Advantage Reel Spin Credits (and/or game credits, if applicable) are deducted from the respective credit meters. The GUI updates these meters in real time to reflect the new balances.
3. Initiation of Re-Spin:
4. The selected reel(s) are re-spun while the remaining reels remain static. The spinning action is animated dynamically on the GUI, with additional effects emphasizing the selected reels.
5. Outcome Display:
6. The final positions of the re-spun reels are displayed, and any resulting wins are evaluated against the paytable. If a win occurs, the GUI highlights the winning combinations and displays the associated payout prominently.

### Benefits and Player Engagement

The presentation of multiple Advantage Spin Offers provides significant benefits for player engagement:
Strategic Decision-Making: Players may choose from a range of options, weighing the costs and potential rewards to align with their gameplay strategy.
Flexibility in Funding: The option to use standard game credits when Advantage Spin Credits are insufficient ensures that players may participate in the offers even with limited resources.
Dynamic Visuals and Feedback: The GUI's use of animations, highlights, and real-time updates enhances the player's immersive experience, making the gameplay more engaging.

### Technical Integration

The system's ability to generate and present multiple offers relies on sophisticated backend processes:
Real-Time Game State Analysis: The EGM evaluates the current game state to identify opportunities and generate targeted offers.
Advantage Spin Credit Management System (ASCMS): Tracks the availability and consumption of Advantage Reel Spin Credits, ensuring accuracy in credit transactions.

Reel Control Mechanisms: Facilitates isolated or simultaneous re-spins of the targeted reels while maintaining the integrity of the overall game state.

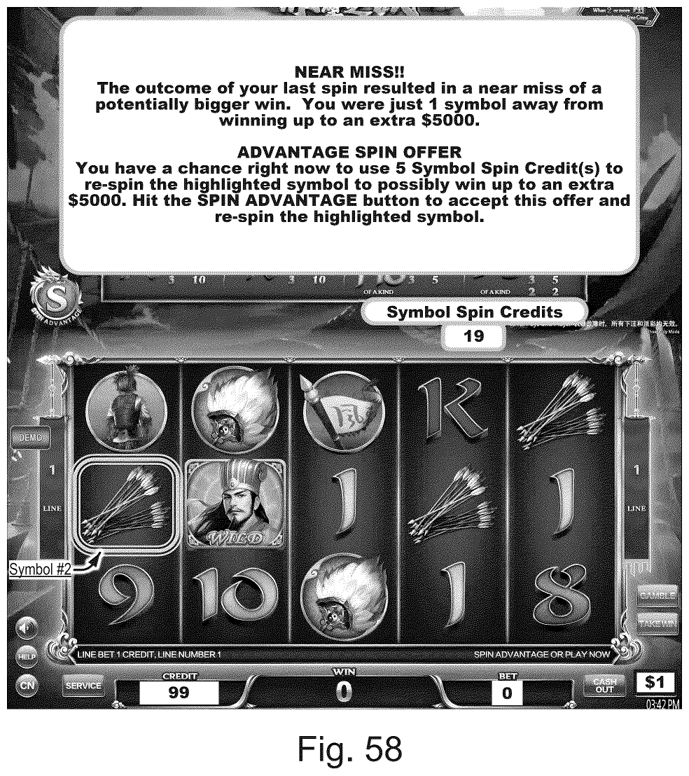

FIG. 58 illustrates a graphical user interface (GUI) for a wager-based slot game, showcasing the execution of an Advantage Spin Offer generated in response to the detection of a near miss or near hit condition during an active gaming session. This embodiment highlights the seamless integration of real-time game state analysis, player interaction, and credit management for targeted re-spin opportunities.

### Scenario Description

The scenario begins with the Electronic Gaming Machine (EGM) monitoring and analyzing the current game state during gameplay. As part of its continuous evaluation, the EGM identifies a near miss condition, where a specific re-spin opportunity may transform the existing game outcome into a potentially significant win. This analysis is conducted in real time, leveraging the EGM's internal logic and random number generator (RNG).

Once a near miss condition is identified, the EGM dynamically determines the parameters for an Advantage Spin opportunity. These parameters include:
1. The value or amount of Advantage Spin Credits and/or game credits required to execute the identified re-spin opportunity. For instance, a re-spin of a specific reel or symbol may cost 1 Advantage Reel Spin Credit.
2. The potential reward associated with the re-spin, as determined by the game's paytable and the identified near miss configuration.

### Generation and Presentation of Advantage Spin Offer

The EGM generates an Advantage Spin Offer based on the analysis. This offer is presented to the player through the GUI with the following details:
Description of the Re-Spin Opportunity: For example:
“Use 1 Advantage Reel Spin Credit to re-spin Reel #3 for a chance to win up to $5000.”
Cost of the Re-Spin: Specifies the required number of Advantage Spin Credits or, in some embodiments, game credits that may be consumed if Advantage Spin Credits are insufficient.
Interactive Button for Acceptance: Provides a clearly labeled button for the player to accept the offer, such as “Re-Spin Now”.

Visual elements enhance the clarity and appeal of the offer:
The targeted reel or symbol (e.g., Reel #3) is highlighted on the reel matrix using glowing outlines, animations, or color changes.
Credit meters are displayed prominently, showing the current balances of the Advantage Spin Credit Meter and the Game Credit Meter for transparency.

### Player Acceptance and Funding Execution

If the player accepts the Advantage Spin Offer, the EGM proceeds with the following actions:
1. Securing Required Funding:
2. The system verifies the availability of the required type and quantity of credits from the Advantage Spin Credit Meter. If Advantage Spin Credits are insufficient, the offer may allow the use of game credits as an alternate funding source.
3. Consumption of Credits:
4. The determined amount of Advantage Spin Credits (or game credits) is deducted from the respective meter(s). The GUI updates the credit balances in real time to reflect the transaction.
5. Initiation of Re-Spin:
6. The EGM isolates the identified reel or symbol for the re-spin and initiates the re-spin process. The GUI dynamically animates the re-spin, ensuring the player is visually engaged.

### Virtual and Physical Advantage Spin Buttons

The system offers flexibility in player interaction. The Advantage Spin Button used to accept the offer may be implemented as:
A virtual button integrated into the EGM's touchscreen interface, providing an intuitive and interactive user experience.
A physical button on the EGM's button panel, offering a tactile method for initiating the Advantage Spin.

### Outcome and Gameplay Continuation

Once the re-spin is completed, the GUI displays the updated reel or symbol configuration. Any resulting wins are calculated and prominently displayed, accompanied by celebratory animations or sound effects to enhance player satisfaction. The system then transitions smoothly back to the default gameplay state, allowing the player to continue their session.

### Technical Integration and Benefits

The execution of this scenario is supported by the EGM's technical infrastructure:
1. Real-Time Game State Analysis: The EGM's game controller continuously evaluates outcomes to identify strategic re-spin opportunities.
2. Advantage Spin Credit Management System (ASCMS): Tracks and validates the availability and consumption of Advantage Spin Credits.
3. Reel and Symbol Control: Isolates the targeted game element for precise and efficient re-spin execution.

This embodiment provides several benefits to players and operators:
Enhanced Strategic Options: Players may influence game outcomes through targeted Advantage Spins, increasing engagement and satisfaction.
Transparency and Control: The clear presentation of costs and rewards ensures players remain informed and confident in their decisions.
Seamless Gameplay Integration: Real-time credit updates and dynamic animations maintain immersion and interactivity.

### CONCLUSION

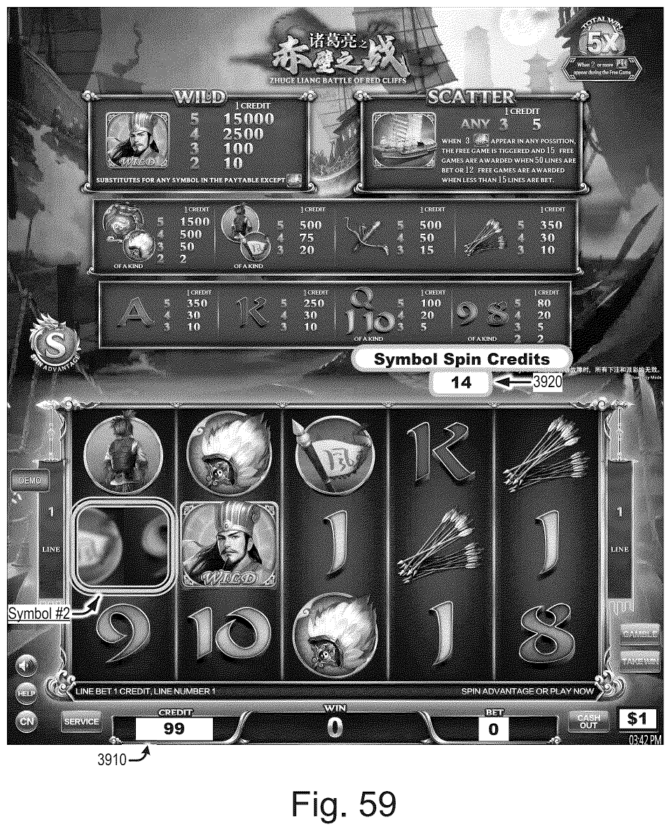

FIG. 59 illustrates a graphical user interface (GUI) for a wager-based slot game, presenting the process and outcome of executing a symbol-specific re-spin using Advantage Symbol Spin Credits. This example highlights the system's capability to handle targeted re-spin opportunities, focusing on the consumption of specialized credits while preserving the player's standard game credits.

### Scenario Description

In this scenario, the player has accepted an Advantage Spin Offer to re-spin Symbol #2 by consuming 5 Advantage Symbol Spin Credits. Upon accepting the offer, the EGM initiates the re-spin process as follows:
1. The EGM decrements the Advantage Symbol Spin Credit Meter by 5 credits, reflecting the cost of the re-spin. The updated balance is displayed in real time on the GUI.
2. The EGM isolates Symbol #2 within its reel or game matrix and initiates the re-spin sequence, leaving all other symbols and reels static.
3. The Game Credit Meter remains unaffected, as the re-spin is fully funded by the Advantage Symbol Spin Credits.

### Re-Spin Execution and Animation

The GUI prominently highlights Symbol #2 during the re-spin process to ensure the player's focus remains on the targeted game element. Notable visual effects include:
Dynamic Animation: Symbol #2 is animated independently of the other game elements, with motion effects emphasizing its isolated re-spin action.
Highlighted Presentation: The re-spinning symbol is visually differentiated using glowing outlines, color changes, or motion trails, reinforcing its role in the Advantage Spin Offer.

The remaining symbols and reels are dimmed or displayed in a static state to avoid visual distractions, ensuring a clear and immersive experience for the player.

### Real-Time Updates to Credit Meters

The GUI dynamically reflects changes to the player's Advantage Spin Credits throughout the process:
The Advantage Symbol Spin Credit Meter decrements by 5 credits immediately after the offer is accepted. This ensures transparency and reinforces the transaction's accuracy.
The Game Credit Meter remains unchanged, clearly indicating that standard game credits are not involved in funding this specific re-spin.

These real-time updates help maintain player trust and understanding of their available resources.

### Outcome Display and Continuation

Once the re-spin of Symbol #2 is completed, the GUI updates to display its final position within the game matrix. The system evaluates the new configuration for any winning combinations or payouts:
1. If the re-spin results in a win, the GUI highlights the winning symbols or paylines and displays the corresponding payout amount. Additional celebratory animations and sound effects enhance player satisfaction.
2. If the re-spin does not produce a win, the GUI transitions smoothly to the default game state, allowing the player to continue gameplay without interruption.

### Technical Execution

The execution of this symbol-specific re-spin is supported by several components of the EGM:
1. Symbol Control Mechanisms: The system isolates Symbol #2 and executes its re-spin while maintaining the static state of other game elements.
2. Advantage Spin Credit Management System (ASCMS): Validates the availability of Advantage Symbol Spin Credits and tracks their consumption.
3. Game Controller and RNG: Ensures the randomness and fairness of the re-spin outcome in compliance with the game's mathematical model and regulatory requirements.

### Visual Design and Player Interaction

The GUI design emphasizes clarity, interactivity, and engagement:
Interactive Elements: Players interact with the Advantage Spin Offer through a touchscreen button or physical input, initiating the re-spin.
Celebratory Visuals: Winning outcomes are highlighted with flashing symbols, glowing paylines, and accompanying audio effects, enhancing the player experience.
Resource Transparency: The GUI consistently displays credit balances and updates them in real time to reinforce transparency and player confidence.

### Benefits and Strategic Gameplay

This scenario exemplifies the strategic depth offered by the Advantage Spin system:
Targeted Gameplay: Players may leverage Advantage Symbol Spin Credits to pursue specific re-spin opportunities, enhancing control over game outcomes.
Preservation of Game Credits: By using specialized credits, players may conserve their standard game credits for other wagers or gameplay actions.

Immersive Experience: The isolated re-spin of a single symbol provides a unique and engaging gameplay element, differentiating the Advantage Spin system from traditional slot mechanics.

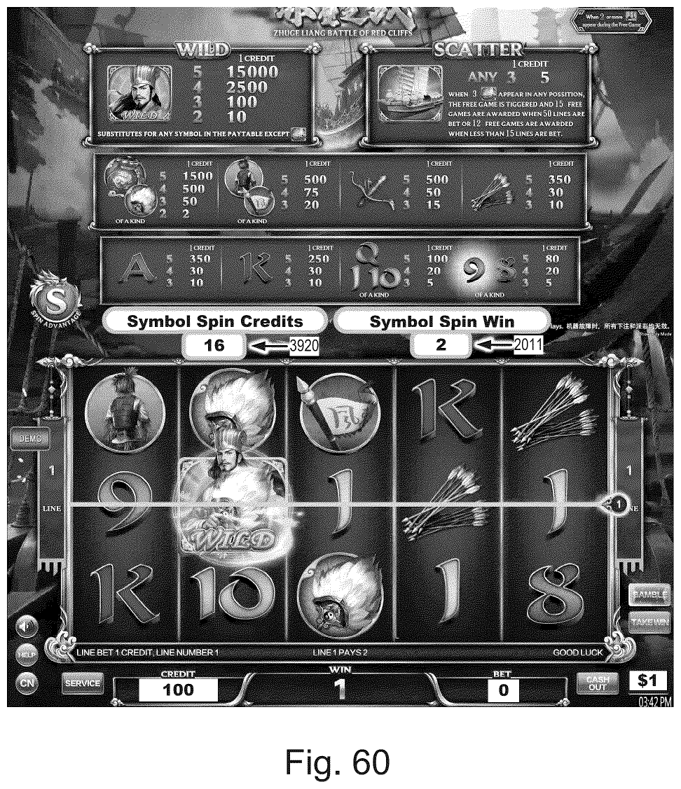

FIG. 60 illustrates a graphical user interface (GUI) for a wager-based slot game, presenting the outcomes following the re-spin of Symbol #2. This example highlights the system's ability to handle multiple reward types, including game credits and Advantage Symbol Spin Credits, while also offering the potential for follow-up Advantage Spin opportunities based on the result.

### Scenario Description

The scenario involves the execution of a re-spin for Symbol #2, previously initiated by the player using Advantage Symbol Spin Credits. After the re-spin, the game evaluates the outcome and determines the following rewards for the player:
1 Game Credit, which is added to the Game Credit Meter.
2 Symbol Spin Credits, which are added to the Advantage Symbol Spin Credit Meter.

In some embodiments, the EGM may also award additional Symbol Spin Credits based on predefined criteria, such as the Advantage Spin event outcome or other promotional rules. The GUI dynamically updates to reflect these rewards, ensuring the player is informed of the impact of their re-spin.

### Presentation of Game Outcome

The GUI displays the results of the re-spin prominently and intuitively, incorporating the following elements:
1. Win Notification:
2. A message summarizing the outcome of the re-spin is shown, such as:
3. “Congratulations! You won: 1 Game Credit and 2 Symbol Spin Credits!”
4. This message is typically displayed in a dedicated results panel, accompanied by celebratory visual effects and sound animations to enhance the player experience.
5. Updated Credit Meters:
   The Game Credit Meter is incremented by 1 credit to reflect the game credit win.
   The Advantage Symbol Spin Credit Meter is incremented by 2 credits to reflect the newly awarded Symbol Spin Credits.
   The updated values are displayed in real time on the GUI to maintain transparency and player confidence.
6. Advantage Spin Win Meter (Optional):
7. In some embodiments, the GUI includes an Advantage Spin Win Meter specifically designed to track Symbol Spin Credits awarded through Advantage Spin events. This meter provides a clear and centralized view of these credits, helping players monitor their Advantage Spin resources.

### Additional Advantage Spin Opportunities

Based on the re-spin outcome, the EGM may analyze the result and generate follow-up Advantage Spin Offers. For example, if the new game state presents another near miss condition or strategic re-spin opportunity, the system generates and presents a tailored Advantage Spin Offer.

The offer is displayed prominently on the GUI and includes details such as:
The cost in credits required to initiate the new re-spin opportunity.
The potential reward associated with the re-spin, such as a high-value win or access to bonus features.
Interactive options for the player to accept or decline the offer using a touchscreen or physical button.

This dynamic approach ensures that the gameplay remains engaging and immersive.

### Technical Integration

The execution of this scenario relies on robust technical infrastructure:
1. Game Controller: Manages the reel and symbol configurations, evaluates outcomes, and calculates rewards based on the game's paytable and Advantage Spin rules.
2. Advantage Spin Credit Management System (ASCMS): Tracks the addition of new Symbol Spin Credits to the Advantage Symbol Spin Credit Meter, ensuring accuracy in credit management.
3. Dynamic Offer Generation: Analyzes the updated game state to determine whether additional Advantage Spin Offers should be presented.

### Visual and Interactive Design

The GUI is designed to enhance player engagement and comprehension:
Dynamic Animations: Visual effects, such as flashing symbols or glowing paylines, highlight winning combinations and credit increments.
Clear Resource Tracking: The interface provides a consistent and transparent view of both the Game Credit Meter and the Advantage Symbol Spin Credit Meter, allowing players to monitor their resources effectively.
Interactive Opportunities: Follow-up offers are integrated seamlessly into the GUI, ensuring a smooth transition between re-spin outcomes and subsequent gameplay actions.

### Benefits and Engagement

This embodiment provides several advantages:
Layered Rewards: Players benefit from multiple types of rewards, including game credits and Symbol Spin Credits, enhancing the perceived value of the re-spin.
Strategic Gameplay: The possibility of follow-up Advantage Spin Offers adds depth to the gameplay, encouraging players to make strategic decisions.

Immersive Experience: The combination of dynamic visuals, real-time updates, and celebratory effects fosters a highly engaging and satisfying player experience.

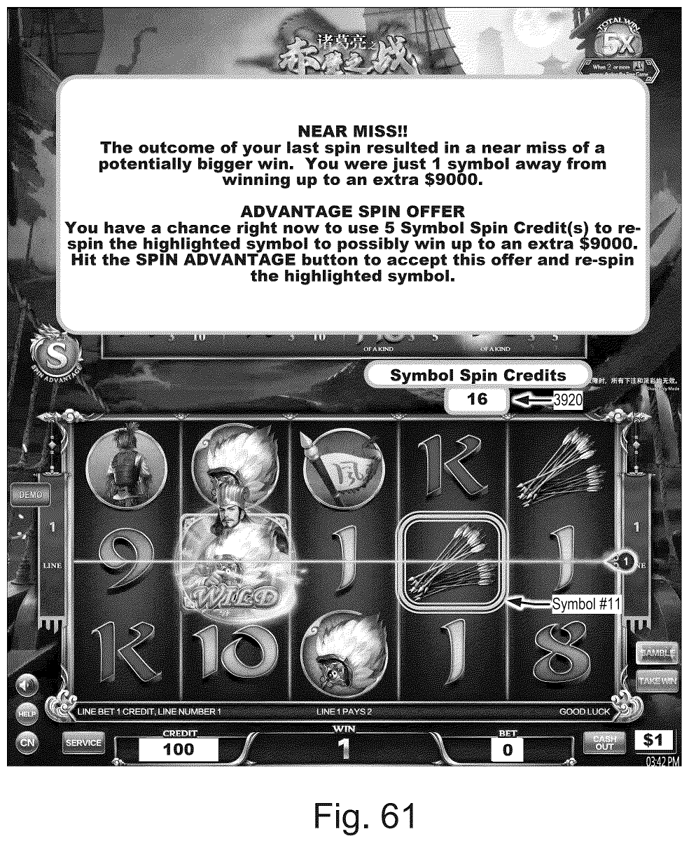

FIG. 61 depicts a graphical user interface (GUI) for a wager-based slot game, presenting an Advantage Spin Offer generated in response to a near miss condition identified after the re-spin of Symbol #2. This example highlights the system's ability to analyze game outcomes dynamically, detect near miss events, and generate targeted offers to engage the player in further gameplay.

### Scenario Description

The scenario begins with the EGM evaluating the outcome of the most recent Advantage Spin event, specifically the re-spin of Symbol #2. The analysis reveals that the result of the re-spin constitutes a near miss condition, where a minor adjustment may transform the current outcome into a significant win. In this case, the system determines that the player was just 1 symbol away from winning up to $9000.

Based on this analysis, the EGM generates a new Advantage Spin Offer, providing the player with the opportunity to re-spin the highlighted symbol again to pursue the potential win. The offer details are dynamically presented on the GUI, ensuring clarity and engagement.

### Presentation of the Advantage Spin Offer

The GUI prominently displays the new Advantage Spin Offer with the following notable elements:
1. Near Miss Alert:
2. The interface includes a bold and attention-grabbing message, such as:
3. “NEAR MISS!!”
4. This message emphasizes the proximity of the player's previous result to a significant win, increasing the perceived value of the new offer.
5. Explanation of the Near Miss:
6. The system provides a detailed explanation of the near miss condition to contextualize the offer. For example:
7. “The outcome of your last spin resulted in a near miss of a potentially bigger win. You were just 1 symbol away from winning up to an extra $9000.”
8. Advantage Spin Offer Details:
9. The offer description specifies the action required to pursue the potential win, the cost in credits, and the potential reward. For example:
10. “You have a chance right now to use 5 Symbol Spin Credits to re-spin the highlighted symbol to possibly win up to an extra $9000.”
11. Interactive Action Button:
12. A clearly labeled button, such as “Spin ADVANTAGE”, allows the player to accept the offer and initiate the re-spin. The button is prominently displayed and easily accessible, reinforcing the immediacy of the opportunity.

### Visual and Interactive Enhancements

The GUI uses visual cues and animations to enhance the presentation of the offer:
Highlighted Symbol: The symbol targeted for the re-spin (e.g., Symbol #2) is visually emphasized using glowing borders, pulsing animations, or color changes, drawing the player's focus to its importance.
Credit Meter Display: The Advantage Symbol Spin Credit Meter is prominently shown, reflecting the current balance of credits available for the re-spin. This ensures transparency and helps the player make an informed decision.
Dynamic Messaging: The near miss alert and Advantage Spin Offer are displayed in a dedicated panel with dynamic animations or transitions to capture the player's attention.

### Execution of the Offer

If the player accepts the offer by pressing the Spin ADVANTAGE button, the EGM proceeds with the following actions:
1. Consumption of Credits:
2. The system deducts 5 Advantage Symbol Spin Credits from the Advantage Symbol Spin Credit Meter. The GUI updates the meter in real time to reflect the new balance.
3. Re-Spin of the Highlighted Symbol:
4. The EGM isolates Symbol #2 and initiates its re-spin. The GUI dynamically animates the re-spin, ensuring a smooth and engaging transition from the offer acceptance to the spin execution.

### Outcome Display and Follow-Up Opportunities

Once the re-spin is completed, the GUI displays the final position of Symbol #2 and evaluates the result for any winning combinations:
If the re-spin results in the $9000 win, the GUI highlights the winning symbols and displays the payout prominently with celebratory animations and sound effects.
If the re-spin does not result in the maximum win, the system may analyze the new outcome to determine whether additional near miss conditions exist. If so, another Advantage Spin Offer may be generated, keeping the player engaged.

### Benefits and Player Engagement

This embodiment leverages the emotional impact of near miss conditions to enhance player engagement:
Emotional Connection: By highlighting how close the player came to a major win, the system creates a sense of excitement and motivation to pursue the new opportunity.
Transparency and Choice: The detailed offer presentation, including costs and potential rewards, empowers the player to make an informed decision.
Dynamic and Immersive Gameplay: The use of animations, highlighted symbols, and real-time updates fosters an interactive and immersive experience.

### Technical Integration

The EGM's backend systems support the generation and execution of Advantage Spin Offers:
1. Real-Time Game State Analysis: Continuously evaluates outcomes to detect near miss conditions and generate relevant offers.
2. Advantage Spin Credit Management System (ASCMS): Tracks and validates the availability of Advantage Symbol Spin Credits and handles their consumption during the transaction.

Symbol Control Mechanisms: Isolates and re-spins targeted symbols while maintaining the integrity of the overall game state.

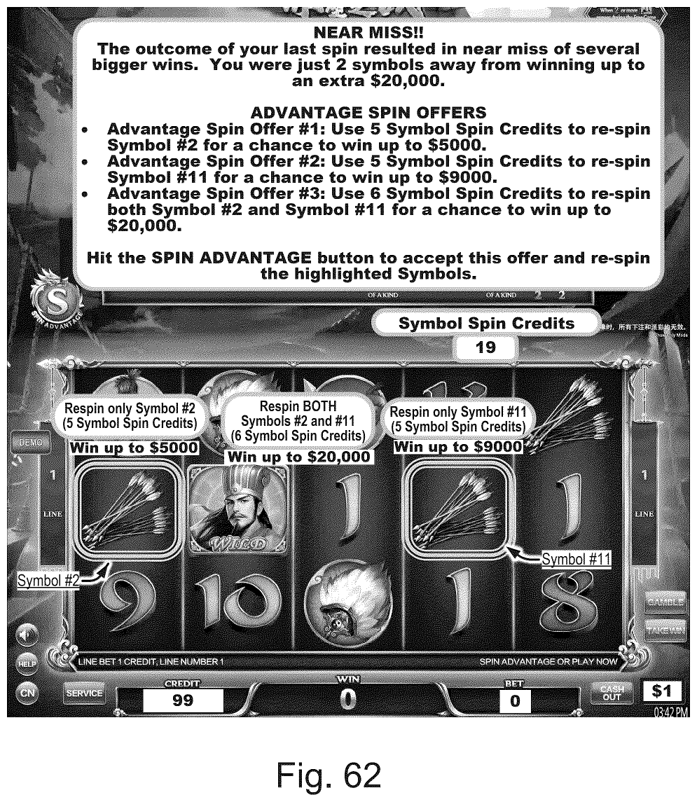

FIG. 62 depicts an example embodiment of a graphical user interface (GUI) for a wager-based slot game that showcases multiple concurrent Advantage Spin offers. This interface enhances player engagement by providing tailored opportunities to re-spin specific symbols based on the outcome of a previous game spin. In the described scenario, the player is presented with three distinct re-spin options, each with different costs and potential rewards.

In at least one embodiment, the GUI presents the following options to the player:
1. Re-spin Symbol #2 for 5 Symbol Spin Credits: This option allows the player to re-spin Symbol #2 with the possibility of winning up to $5000.
2. Re-spin Symbol #11 for 5 Symbol Spin Credits: This option enables a re-spin of Symbol #11, offering the chance to win up to $9000.
3. Re-spin both Symbols #2 and #11 for 6 Symbol Spin Credits: This combined re-spin option presents the opportunity to win up to $20000.

The GUI is designed to display these offers prominently, utilizing clear visual elements such as highlighted symbols and interactive buttons for each offer. The interface ensures that the player understands the credit cost and potential reward for each option, allowing for an informed decision.

If the player does not have sufficient Advantage Spin credits to select the third option, which involves re-spinning both symbols, the system may allow the player to use standard game credits to fund the Advantage Spin activity. This flexibility enhances accessibility and ensures that players may participate in the feature regardless of their available Advantage Spin credit balance.

The underlying system leverages real-time game state analysis to generate these offers. It calculates the credit cost and potential rewards based on factors such as the current game state, symbol configurations, and the casino's payout table. This approach ensures that the offers are dynamically tailored to the specific game context and player behavior.

To accept an offer, the player interacts with an intuitive virtual button labeled “Spin ADVANTAGE,” which executes the selected re-spin. Upon selection, the required credits are deducted from the player's Advantage Spin credit meter or standard game credit meter, and the re-spin is performed. The interface then updates dynamically to reflect the new game outcome and any resulting changes to the player's credit balance.

The GUI also incorporates supporting elements to enhance usability and player satisfaction:
Credit Meters: Separate displays for standard game credits and Advantage Spin credits provide transparency regarding the player's available resources.
Offer Details: Clear and concise text explains the cost and reward of each re-spin option.
Interactive Elements: Highlighted symbols and buttons guide the player's attention and facilitate easy interaction.
Feedback Mechanisms: Real-time updates ensure that players are immediately informed of the results of their actions, reinforcing trust in the system.

By offering multiple concurrent re-spin options and integrating them seamlessly into the gameplay experience, this interface provides players with greater strategic control and enhances their overall engagement. The system's adaptability to different credit types further broadens its appeal and utility, fostering prolonged player interaction and satisfaction.

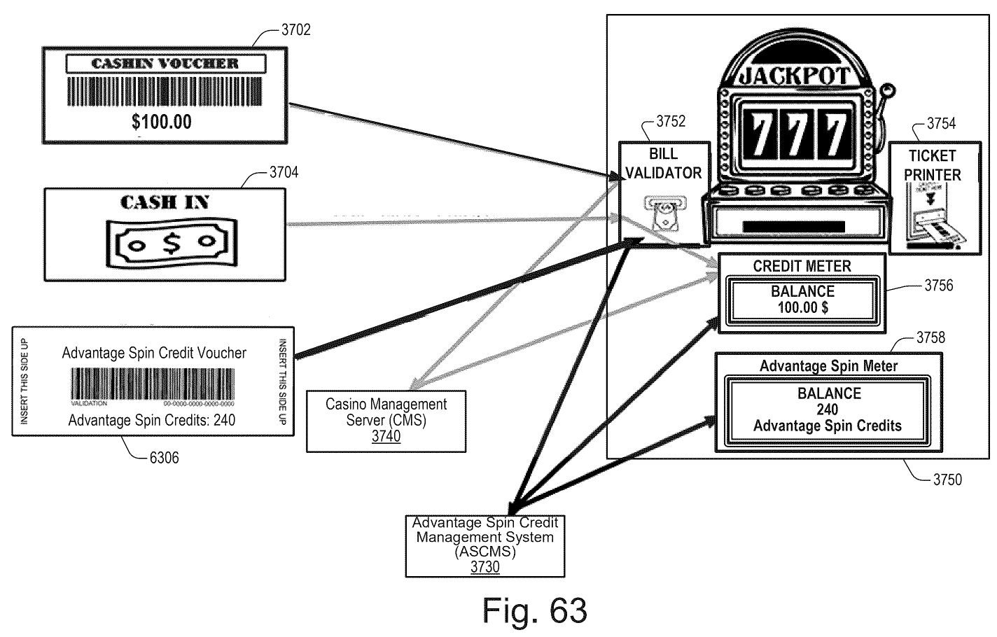

FIG. 63 illustrates an example embodiment of a graphical user interface (GUI) and system process for the simultaneous deposit of a Cash Credit Voucher and an Advantage Spin Credit Voucher into an Electronic Gaming Machine (EGM). The scenario emphasizes the seamless handling of multiple credit types within a single gaming session, ensuring transparency and efficiency in credit allocation.

In at least one embodiment, the process begins with the player inserting two vouchers into the EGM:
1. $100 Cash Credit Voucher: This voucher represents standard monetary credits that are intended for general gameplay.
2. Advantage Spin Credit Voucher with 240 Advantage Spin Credits: This voucher is designated for specific Advantage Spin gameplay features, such as targeted re-spins of symbols or reels.

Upon insertion, the EGM employs the following sequence of operations:

### Voucher Authentication and Processing

Voucher Reading: The EGM's integrated bill validator scans each voucher to extract identifying information, including a Voucher ID and a Validation Code.
Authentication: The EGM communicates with relevant back-end systems:
   The Casino Management Server (CMS) validates the Cash Credit Voucher to confirm its monetary value.
   The Advantage Spin Credit Management System (ASCMS) verifies the Advantage Spin Credit Voucher to authenticate the stated 240 Advantage Spin credits.

### Credit Allocation

Cash Credit Allocation:
   Once validated by the CMS, the $100 from the Cash Credit Voucher is credited to the EGM's cash credit meter.
   The cash credit meter is dynamically updated to reflect this new balance, which is prominently displayed on the GUI.
Advantage Spin Credit Allocation:
   Upon successful validation by the ASCMS, the 240 Advantage Spin credits from the Advantage Spin Credit Voucher are credited to the EGM's Advantage Spin meter.
   The GUI updates to show the added Advantage Spin credits, ensuring the player may see their availability for gameplay.

### Graphical User Interface (GUI) Features

The GUI provides clear and intuitive feedback to the player during and after the voucher deposit process:
Credit Meters:
   A Cash Credit Meter prominently displays the total monetary balance, updated to include the $100 from the Cash Credit Voucher.
   An Advantage Spin Meter displays the total number of Advantage Spin credits, updated to reflect the 240 credits added from the Advantage Spin Credit Voucher.
Transaction Status:
   A message or status indicator confirms the successful validation and crediting of each voucher.
   Details such as the Voucher ID and associated values may be displayed briefly for player verification.
Interactive Feedback:
   Visual animations or highlights may signal the completion of the deposit process, enhancing the user experience.
   The GUI seamlessly transitions to the standard gameplay interface, showing the updated credit meters and maintaining continuity.

### Benefits and Advantages

This implementation delivers several notable benefits:
1. Efficient Multi-Credit Handling: By enabling simultaneous processing of both cash and Advantage Spin credits, the system reduces transaction time and complexity.
2. Transparency: The GUI provides clear, real-time updates on the status of each credit type, ensuring players are informed and confident in their transactions.
3. Enhanced Engagement: The integration of Advantage Spin credits into the gameplay encourages players to explore unique gaming features, such as targeted re-spins, fostering a richer gaming experience.
4. System Reliability: The use of CMS and ASCMS for voucher authentication ensures secure, accurate credit handling, maintaining player trust and regulatory compliance.

By supporting the deposit of diverse credit types into a single EGM, this system exemplifies the flexibility and sophistication of modern casino gaming technology, enhancing both player convenience and operational efficiency.

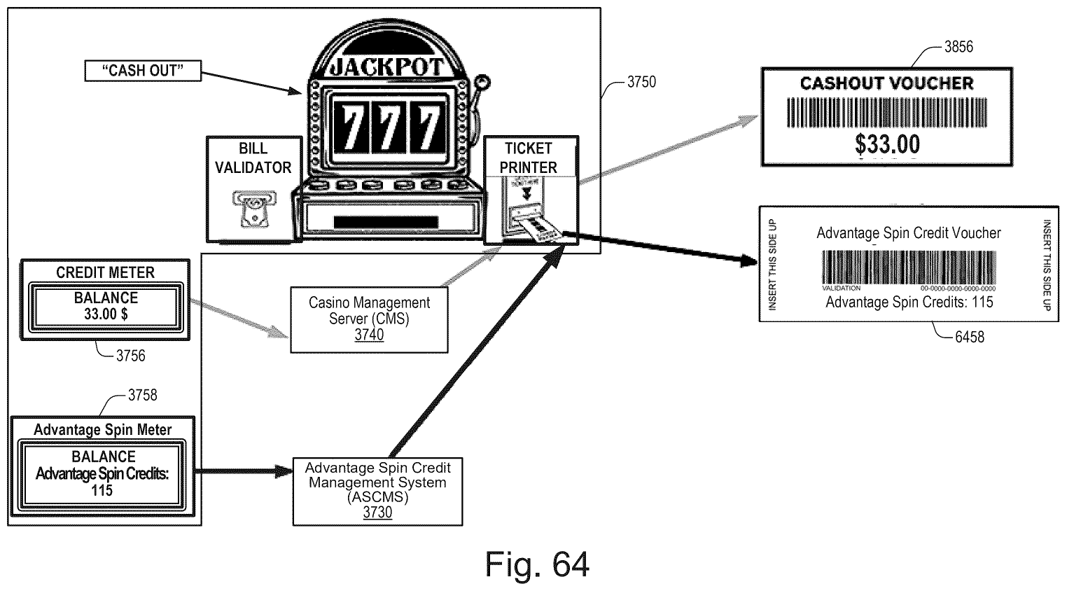

FIG. 64 illustrates an example embodiment of the graphical user interface (GUI) and system process for withdrawing credit balances from an Electronic Gaming Machine (EGM). In this scenario, a player initiates a “Cash Out” request, leading to the issuance of two distinct vouchers: a Cash Credit Voucher and an Advantage Spin Credit Voucher. This procedure ensures accurate credit tracking and enables seamless withdrawal of both monetary and Advantage Spin credits.

### Process Overview

The withdrawal process begins with the detection of a Cash Out condition at the EGM. This condition may be triggered by the player pressing the “Cash Out” button on the machine interface. The system then executes the following steps:

Coordination with the Cash Credit Management System (CMS)
1. Cash Credit Meter Transfer:
   The EGM reads the current balance of its cash credit meter, which in this scenario is $33.
   The EGM communicates with the Casino Management Server (CMS) to validate the transfer of this balance.
   Upon validation, the CMS authorizes the EGM to issue a Cash Credit Voucher for $33.
2. Voucher Issuance:
   The EGM's ticket printer generates and dispenses a Cash Credit Voucher (e.g., identified as voucher 3856).
   This voucher includes a unique identifier, validation code, and the monetary amount ($33) for player use.
      Coordination with the Advantage Spin Credit Management System (ASCMS)
1. Advantage Spin Meter Transfer:
   The EGM reads the current balance of its Advantage Spin credit meter, which in this scenario is 240 credits.
   The EGM communicates with the Advantage Spin Credit Management System (ASCMS) to validate this balance.
   Upon validation, the ASCMS authorizes the EGM to issue an Advantage Spin Credit Voucher for 240 credits.
2. Voucher Issuance:
   The EGM's ticket printer generates and dispenses an Advantage Spin Credit Voucher (e.g., identified as voucher 4358).
   This voucher specifies the quantity of Advantage Spin credits (240) and includes a unique identifier and validation code for future redemption.

### Graphical User Interface (GUI) Features

The GUI dynamically updates to provide clear feedback to the player throughout the Cash Out process:
Credit Meters:
   The Cash Credit Meter displays the updated balance after deducting the $33 withdrawal.
   The Advantage Spin Credit Meter displays the updated balance after deducting the 240 credits withdrawal.
Transaction Confirmation:
   The GUI displays a confirmation message for each voucher issuance, detailing the amount and type of credits withdrawn.
   Animated feedback may accompany the printing and dispensing of vouchers to enhance user experience.
Voucher Details:
   The GUI may briefly display information about the printed vouchers, including their identifiers and values, for player verification.

### Benefits and Advantages

This withdrawal mechanism provides several advantages:
1. Integrated Credit Management: The coordination between the EGM, CMS, and ASCMS ensures accurate and seamless processing of both monetary and Advantage Spin credits.
2. Player Convenience: The simultaneous issuance of Cash Credit and Advantage Spin Credit Vouchers allows players to manage their credits efficiently and flexibly.
3. Transparency and Trust: Real-time GUI updates and clear transaction confirmations foster player confidence in the system's reliability and accuracy.
4. Regulatory Compliance: The involvement of CMS and ASCMS in validating transactions ensures adherence to gaming regulations and audit requirements.

### Use Case Significance

The ability to issue distinct vouchers for cash and Advantage Spin credits provides a versatile tool for player engagement and credit management. Players may redeem the Cash Credit Voucher for standard monetary use and utilize the Advantage Spin Credit Voucher for targeted gameplay opportunities, such as re-spins, at participating EGMs. This flexibility enhances the overall gaming experience while supporting casino operational efficiency.

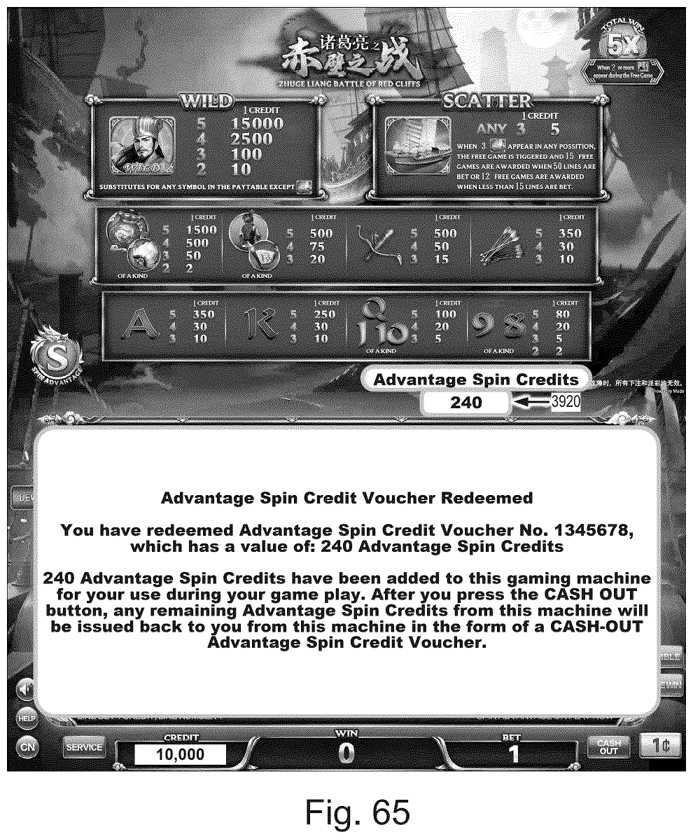

FIG. 65 illustrates an example embodiment of a graphical user interface (GUI) and system process for handling the insertion and processing of an Advantage Spin Credit Voucher within an Electronic Gaming Machine (EGM). This scenario demonstrates the seamless integration of non-monetary credits into the gaming system, enabling players to enhance their gaming experience with Advantage Spin credits.

### Process Overview

In this scenario, the player inserts an Advantage Spin Credit Voucher into the EGM's bill validator. The voucher represents a specific quantity of Advantage Spin credits that may be utilized for targeted gameplay features such as re-spins. The EGM executes the following sequence of operations:
1. Voucher Reading:
   The EGM's bill validator reads the inserted Advantage Spin Credit Voucher.
   Notable details, including the Voucher ID and Validation Code, are extracted for verification.
2. Communication with Advantage Spin Credit Management System (ASCMS):
   The EGM communicates with the ASCMS to authenticate the voucher.
   The ASCMS validates the voucher's authenticity and confirms the associated value of 240 Advantage Spin credits.
3. Credit Allocation:
   Upon successful validation, the EGM adds 240 Advantage Spin credits to its Advantage Spin credit meter.
   This updated balance is prominently displayed on the GUI, allowing the player to immediately view their available credits.

### Graphical User Interface Features

The GUI is designed to provide clear, real-time feedback throughout the voucher processing workflow. Notable features include:
Advantage Spin Credit Meter:
   The meter dynamically updates to reflect the addition of 240 Advantage Spin credits.
   The total credit balance is prominently displayed, ensuring transparency for the player.
Transaction Confirmation:
   The GUI provides a confirmation message indicating the successful processing of the Advantage Spin Credit Voucher.
   Details such as the voucher's validated value and updated meter balance may be displayed temporarily for player verification.
Interactive and Informative Elements:
   Visual indicators, such as animations or highlights, guide the player through the voucher processing sequence.
   Informational prompts explain the significance of the added Advantage Spin credits and their potential uses within the game.

### Benefits and Advantages

This system and GUI implementation deliver multiple benefits:
1. Enhanced Usability:
   Players may easily deposit Advantage Spin credits without interrupting their gaming session.
   The clear and intuitive interface ensures that players understand the outcome of their actions.
2. Real-Time Transparency:
   Immediate updates to the Advantage Spin credit meter provide players with confidence in the system's reliability.
3. Integration with Gameplay:
   The added credits are seamlessly integrated into the player's balance, enabling immediate utilization for Advantage Spin features such as symbol or reel re-spins.
4. Security and Compliance:
   The validation process via the ASCMS ensures the authenticity of vouchers and adherence to gaming regulations.
5. Player Engagement:
   By facilitating the use of non-monetary credits, the system encourages players to explore unique gameplay features, increasing their engagement and satisfaction.

### Use Case Significance

The depicted process highlights the operational efficiency and user-centric design of the Advantage Spin Credit system. By enabling the deposit of specialized credits through a simple and transparent interface, this system enhances the overall gaming experience while maintaining secure and accurate credit management. Players benefit from greater flexibility in how they engage with the game, fostering loyalty and prolonged interaction with the gaming platform.

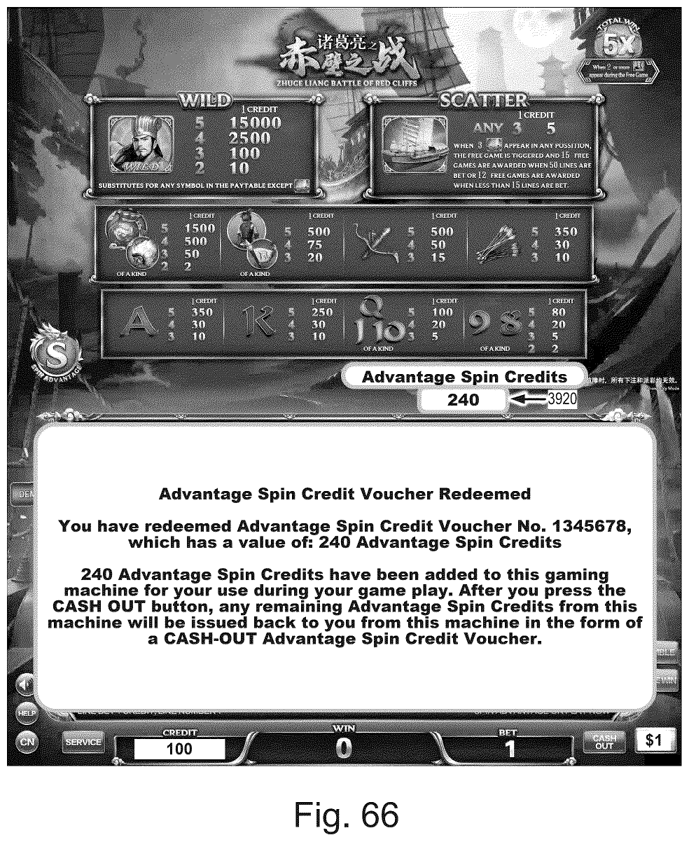

FIG. 66 illustrates an example embodiment of a graphical user interface (GUI) for a wager-based slot game, specifically designed to process and display transactions involving Advantage Spin Credit Vouchers. This interface highlights the seamless interaction between the player, the Electronic Gaming Machine (EGM), and the Advantage Spin Credit Management System (ASCMS), emphasizing transparency and efficiency.

In the depicted scenario, the player initiates the transaction by inserting an Advantage Spin Credit Voucher into the EGM's bill validator. The voucher encodes notable information, including a unique Voucher ID, Validation Code, and a specified value of 240 Advantage Spin credits. Upon insertion, the GUI immediately acknowledges the transaction, displaying a message indicating that the voucher is being read and processed.

The EGM then communicates with the ASCMS to authenticate and validate the Advantage Spin Credit Voucher. The system confirms the voucher's legitimacy and verifies the stated value of 240 Advantage Spin credits. During this validation process, the GUI may display a progress indicator or status notification, ensuring the player is informed throughout the transaction.

After successful validation, the EGM adds the 240 Advantage Spin credits to the Advantage Spin credit meter. The GUI dynamically updates to reflect the new credit balance, with the Advantage Spin credit meter prominently displayed for easy visibility. This immediate feedback allows the player to confirm the successful addition of their Advantage Spin credits.

Notable features and elements of the GUI include:
1. Advantage Spin Credit Meter: The updated balance of 240 Advantage Spin credits is prominently displayed, providing the player with a clear view of their available credits for specialized gameplay features such as re-spins or targeted Advantage Spin opportunities.
2. Cash Credit Meter: This meter, separate from the Advantage Spin credit meter, remains unaffected by the voucher transaction, maintaining a clear distinction between monetary and non-monetary credits.
3. Transaction Status Notification: A notification confirms the successful validation and processing of the Advantage Spin Credit Voucher. This message may appear as a pop-up or a dedicated section within the GUI, enhancing player trust and satisfaction.
4. Interactive Game Display: The primary game interface, including slot reels, paylines, and other game elements, remains active and visually engaging. The player retains full control over the game while the transaction is seamlessly integrated into the background.
5. Re-spin and Advantage Spin Features: The GUI may include additional interactive elements, such as buttons or prompts, to guide the player in utilizing their Advantage Spin credits. These elements encourage strategic engagement with the game.

This GUI design ensures a smooth and intuitive experience for players, combining transparency, efficiency, and real-time updates. By allowing the player to monitor their Advantage Spin credits and seamlessly integrate these credits into their gameplay, the system fosters a more interactive and rewarding gaming experience. The clear delineation between credit types and the dynamic updates to the interface enhance user satisfaction, making Advantage Spin credits a compelling feature in modern wager-based slot games.

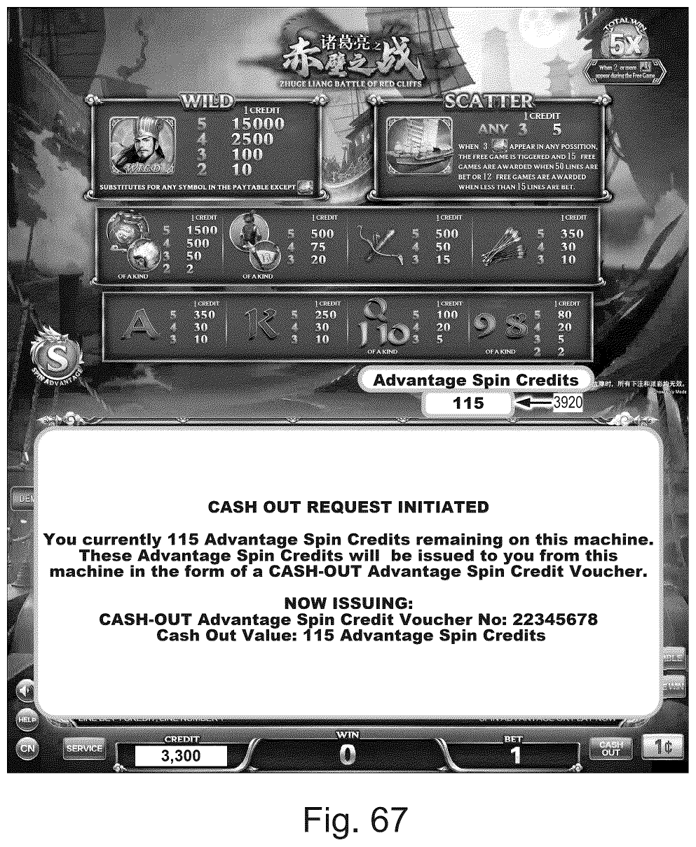

FIG. 67 illustrates an example embodiment of a graphical user interface (GUI) for a wager-based slot game, specifically depicting the cash-out process for Advantage Spin credits initiated during an active gaming session. This interface demonstrates the seamless interaction between the Electronic Gaming Machine (EGM), the Advantage Spin Credit Management System (ASCMS), and/or the Casino Management System (CMS) during the cash-out process.

In the scenario shown, the player initiates a cash-out request by pressing the CASH OUT button on the EGM interface. Upon detecting this request, the EGM reads the current value of the Advantage Spin credit meter, which in this example indicates a balance of 115 Advantage Spin credits.

The EGM then communicates with the ASCMS and/or CMS to create a CASH-OUT Advantage Spin Credit Voucher. This voucher represents the equivalent value of the Advantage Spin credits, ensuring accurate accounting and secure transaction processing. Once the voucher is prepared, the EGM prints the CASH-OUT Advantage Spin Credit Voucher via its integrated ticket printer. After dispensing the voucher, the EGM resets the Advantage Spin credit meter to zero, readying the machine for the next session.

Notable features of the GUI in this scenario include:
1. Advantage Spin Credit Meter: The current balance of 115 Advantage Spin credits is prominently displayed before the cash-out process begins. After the voucher is dispensed, the meter dynamically updates to reflect a balance of zero, providing real-time feedback to the player.
2. Cash-Out Confirmation Message: The GUI provides a confirmation message or notification indicating that the CASH-OUT Advantage Spin Credit Voucher has been successfully dispensed. This ensures the player is informed of the transaction's completion.
3. Voucher Issuance Details: The interface may display the value of the CASH-OUT voucher (e.g., 115 Advantage Spin credits) and additional information, such as a unique Voucher ID or timestamp, enhancing transparency and accountability.
4. Interactive Controls: The CASH OUT button remains the focal point of the interface during this process, clearly labeled and easy to identify. This intuitive design minimizes player confusion and streamlines the cash-out request.
5. Status Updates: During communication with the ASCMS and/or CMS, the GUI may display a progress indicator or status message (e.g., “Processing Cash-Out Request”) to keep the player informed of the ongoing process.
6. Primary Game Interface: The core game interface remains visible and interactive, ensuring that the player's gaming experience is not interrupted during the cash-out process.

This GUI design supports a transparent and efficient cash-out procedure for Advantage Spin credits, enhancing player trust and satisfaction. By clearly displaying the credit balance, processing status, and successful issuance of the CASH-OUT voucher, the interface ensures a seamless and user-friendly experience. The inclusion of dynamic updates and actionable controls reinforces the integration of Advantage Spin credits into the broader gaming ecosystem, promoting player engagement and operational efficiency.

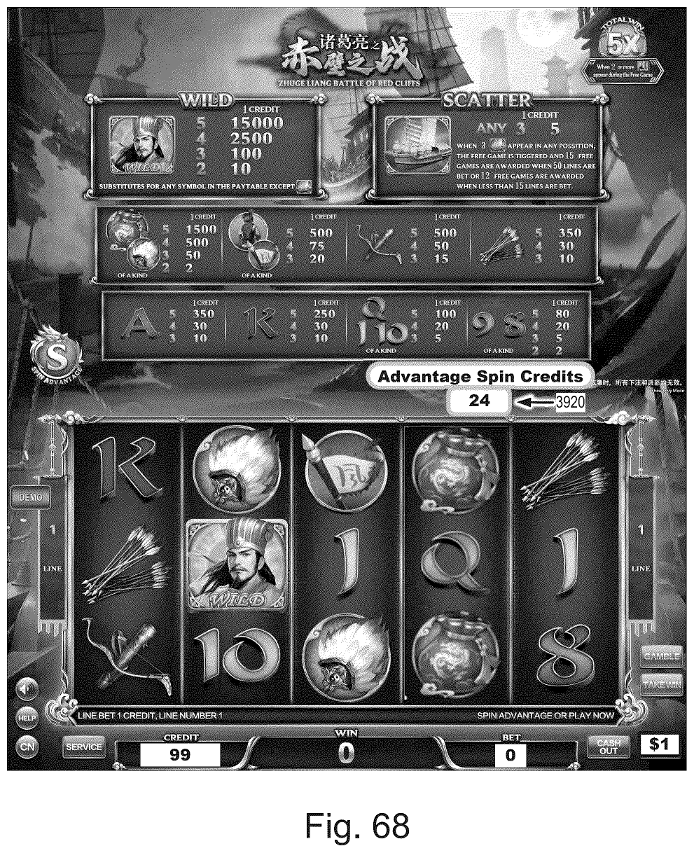

FIG. 68 illustrates an example embodiment of a graphical user interface (GUI) for a wager-based slot game, highlighting the presentation of gameplay outcomes following the initiation of a slot reel spin. This interface demonstrates the interaction between the player and the Electronic Gaming Machine (EGM), emphasizing clarity, responsiveness, and engagement.

In the depicted scenario, the player engages in a wager-based gameplay session on the EGM and initiates the first spin of the slot reels. Following the spin, the GUI dynamically updates to display the resulting game outcome, including the arrangement of symbols, any associated winning combinations, and potential rewards.

Notable features and elements of the GUI in this scenario include:
1. Reel Display Area: The central portion of the GUI prominently showcases the slot reels. The outcome of the first spin is displayed as a static arrangement of symbols across the reels, with any winning combinations visually highlighted (e.g., flashing symbols, glowing outlines, or animations). This ensures that the player may easily identify their results.
2. Winning Combination Details: If the spin results in a win, the GUI provides clear feedback on the winning combination. This may include highlighting the specific paylines or symbols involved in the win and displaying the corresponding payout amount.
3. Cash Credit Meter: The updated balance in the cash credit meter is shown, reflecting any winnings from the spin. This real-time adjustment ensures that the player remains informed about their current credit total.
4. Bet Information: The GUI includes a section displaying details about the player's wager for the spin. This information may include the bet amount, number of paylines played, and the denomination of each credit wagered.
5. Interactive Controls: The interface retains interactive controls, such as the Spin button, enabling the player to initiate subsequent spins. The presence of additional buttons for adjusting bet configurations or accessing game settings ensures a customizable gameplay experience.
6. Visual and Audio Feedback: The GUI incorporates visual and auditory elements to enhance engagement. For example, a winning spin may trigger celebratory animations and sound effects, while a non-winning spin may simply reset the reels for the next play.
7. Game Theme and Design Elements: The GUI reflects the thematic design of the slot game, incorporating graphics, colors, and animations consistent with the game's storyline or motif. These elements contribute to a cohesive and immersive gaming experience.

This GUI effectively combines functionality and aesthetics, ensuring that players receive clear and immediate feedback on their gameplay outcomes. By prominently displaying the results of each spin and updating relevant metrics, such as credits and payouts, the interface enhances player engagement and satisfaction. The intuitive layout and interactive controls further support a seamless and enjoyable gaming experience.

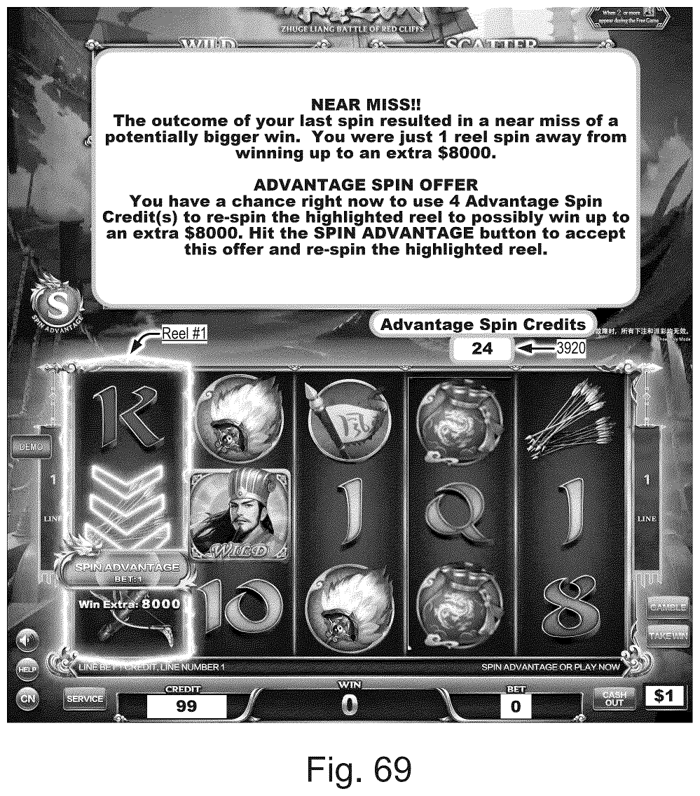

FIG. 69 depicts an example embodiment of a graphical user interface (GUI) for a wager-based slot game, highlighting the processes and interactions involved in identifying and executing an Advantage Spin (or re-spin) opportunity triggered by a “near miss” or “near hit” condition. This interface showcases the seamless integration of intelligent game analysis, dynamic offer generation, and player decision-making within an Electronic Gaming Machine (EGM).

During an active gaming session, the EGM continuously monitors and analyzes real-time game outcomes to detect specific game state conditions. These conditions include “near miss” or “near hit” events, where the displayed outcome narrowly misses forming a high-value winning combination or another predefined rewarding result. Upon detecting such an event, the EGM identifies the occurrence as an opportunity to present an Advantage Spin offer to the player, aimed at leveraging the near-miss condition to enhance engagement and reward potential.

Following the identification of a near-miss event, the EGM dynamically calculates the types and quantities of Advantage Spin credits required to execute the Advantage Spin opportunity. This calculation considers multiple factors, including the current game configuration, the potential outcome of the re-spin, and the associated credit costs as defined by the casino's system parameters. The EGM generates a tailored Advantage Spin Offer, specifying the credit cost (in terms of Advantage Spin credits and/or game credits) and the potential rewards for the re-spin. This detailed offer provides the player with a transparent understanding of the requirements and potential benefits of accepting the opportunity.

The EGM presents the Advantage Spin Offer to the player through the GUI, ensuring clarity and ease of interaction. The GUI prominently displays the details of the offer, including the credit cost, potential reward, and a countdown timer. The countdown timer is used in at least one embodiment to indicate that the offer is a limited-time proposition, requiring the player to respond within a specified interval. The addition of the timer introduces a sense of urgency, encouraging prompt decision-making and heightened engagement.

To accept the Advantage Spin Offer, the player may use an interactive control integrated into the GUI. Depending on the embodiment, this control may be implemented as a virtual button on the EGM's touchscreen interface or as a physical button on the gaming machine's button panel. Upon acceptance of the offer, the EGM initiates procedures to secure the required funding for the Advantage Spin. This involves deducting the determined types and quantities of Advantage Spin credits from the EGM's Advantage Spin credit meter. The GUI dynamically updates to reflect the reduced credit balance, providing immediate feedback to the player.

Once the credits are deducted, the EGM executes the Advantage Spin opportunity. The GUI transitions to display the re-spin process, visually emphasizing the affected reels or symbols. This display highlights the dynamic nature of the re-spin and reinforces the significance of the player's decision to accept the offer. Upon completion of the re-spin, the resulting game outcome is prominently displayed, with any winning combinations clearly highlighted. The system automatically adjusts the relevant credit meters to account for the outcome, ensuring that the player's current balances are accurately reflected.

The GUI design in this embodiment is carefully structured to enhance player interaction and engagement. Notable features include a dedicated section for displaying the Advantage Spin Offer details, a clear and interactive control interface for accepting or declining the offer, and real-time feedback on credit balances and game outcomes. The integration of animations, sound effects, and thematic visuals further enriches the gaming experience, making it both immersive and rewarding.

This interface and process emphasize transparency, strategic decision-making, and player satisfaction. By leveraging near-miss conditions to create dynamic re-spin opportunities, the system enhances the interactive nature of the game while maintaining fairness and clarity. Through the seamless coordination of game state analysis, credit management, and user interface design, the EGM delivers an engaging and technically advanced gaming experience.

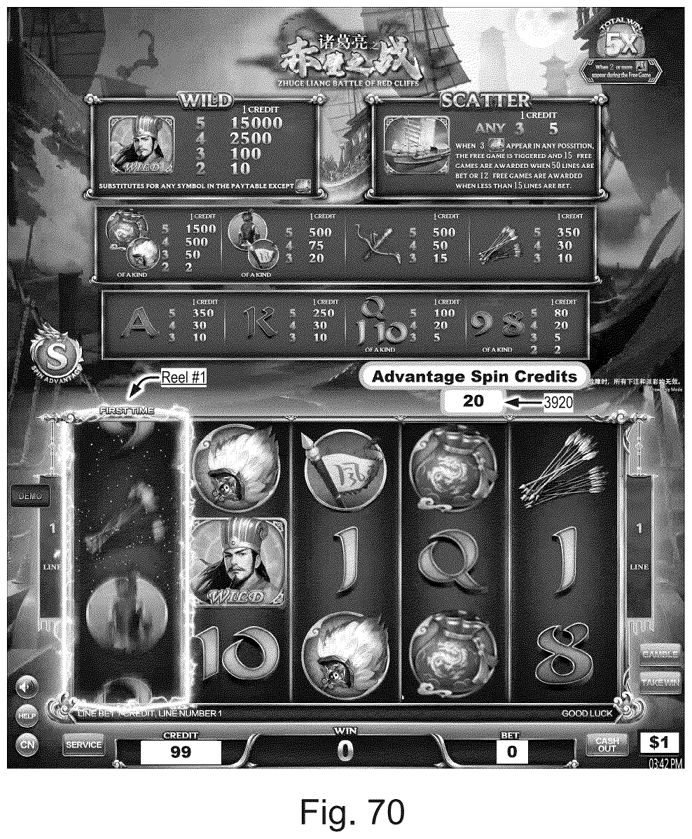

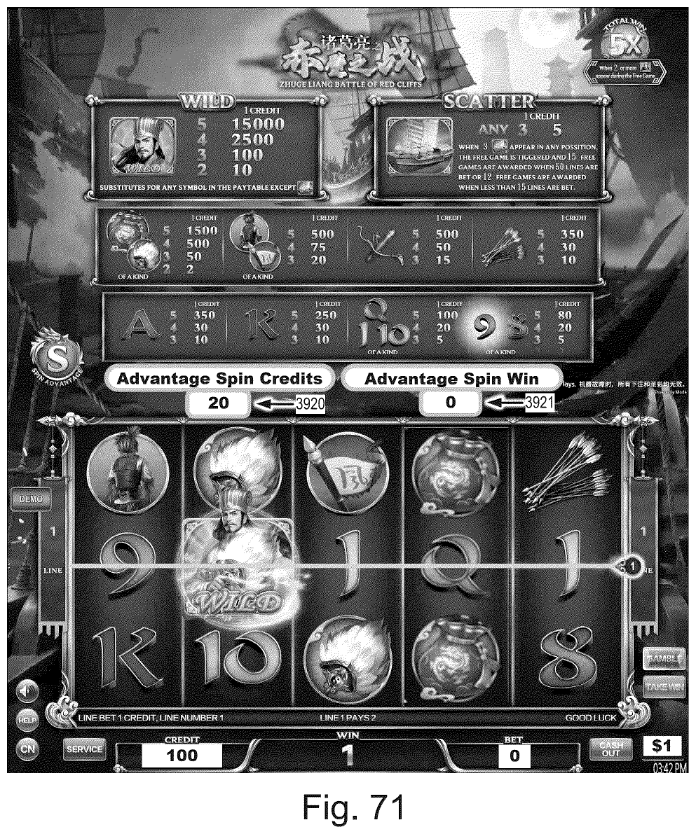

FIG. 70 illustrates an example embodiment of a graphical user interface (GUI) for a wager-based slot game, focusing on the execution of an Advantage Spin re-spin opportunity. This scenario involves a player accepting an Advantage Spin Offer to re-spin a specific highlighted reel (#1) using Advantage Spin credits. The interface emphasizes transparency, player engagement, and efficient credit management, seamlessly integrating the re-spin into the gameplay experience.

In the depicted scenario, the player has accepted an Advantage Spin Offer to consume four Advantage Spin credits to re-spin the highlighted reel, Reel #1. Upon the player's acceptance, the Electronic Gaming Machine (EGM) initiates the necessary procedures to execute the re-spin. The first step involves deducting the specified quantity of Advantage Spin credits—four credits—from the EGM's Advantage Spin credit meter. This deduction is processed instantly, and the updated credit balance is dynamically reflected on the GUI, ensuring the player is informed of their remaining credits.

Following the credit deduction, the EGM initiates the re-spin of Reel #1. The GUI transitions to a visually engaging display, highlighting Reel #1 while it undergoes the re-spin process. The focus on the affected reel reinforces the player's choice and adds to the immersive nature of the gameplay. During this process, the remaining reels and symbols remain static, preserving the game state and maintaining clarity.

In this example, the Game Credit Meter is not decremented to initiate the re-spin, as the cost is exclusively covered by the Advantage Spin credits. The separation of Advantage Spin credits from traditional game credits ensures a clear distinction between these resources, which is visually represented on the GUI through distinct and prominently displayed meters for each credit type.

The GUI design includes several notable elements to enhance player interaction and experience:
1. Highlighted Reel Display:
   Reel #1 is prominently emphasized on the GUI, visually distinguishing it from the other static reels. This highlighting reinforces the player's action and keeps the focus on the re-spin.
2. Advantage Spin Credit Meter:
   The meter tracks the player's available Advantage Spin credits. After the deduction of four credits, the updated balance is displayed in real-time, ensuring transparency.
3. Game Credit Meter:
   This meter remains unchanged during the re-spin process, clearly indicating that the re-spin cost is covered by Advantage Spin credits and not traditional game credits.
4. Interactive Feedback:
   The GUI provides immediate feedback on the player's actions, including notifications or animations confirming the deduction of credits and the initiation of the re-spin.
5. Thematic Design and Visual Effects:
   Animations and sound effects accompany the re-spin, enhancing engagement. For example, Reel #1 may feature spinning animations, dynamic lighting, or sound cues to emphasize its motion.
6. Re-spin Outcome Display:
   Once the re-spin is completed, the GUI displays the updated outcome of Reel #1, seamlessly integrating it with the static positions of the other reels. Any winning combinations resulting from the re-spin are prominently highlighted, with corresponding rewards reflected in the relevant meters.

This GUI design ensures a seamless and engaging gaming experience, emphasizing the player's decision-making and the integration of Advantage Spin credits into the gameplay. By clearly separating Advantage Spin credits from traditional game credits and providing real-time feedback, the interface fosters trust and enhances transparency. The focus on interactive and thematic elements further elevates the overall player experience, making the re-spin process both rewarding and immersive. Through its intuitive design and technical efficiency, this interface highlights the versatility and appeal of the Advantage Spin system within a modern wager-based slot game.

FIG. 71 illustrates an example embodiment of a graphical user interface (GUI) for a wager-based slot game, focusing on the presentation of outcomes resulting from an Advantage Spin event, such as the first re-spin of Reel #1. This interface highlights the integration of rewards, credit tracking, and additional gameplay opportunities, enhancing the player's engagement and interaction with the Electronic Gaming Machine (EGM).

The scenario begins with the completion of the Advantage Spin event. In this case, Reel #1 has been re-spun, and the updated outcome of the reels is displayed on the GUI. The re-spin result is prominently shown in the reel display area, with any winning combinations highlighted to draw the player's attention. For example, winning paylines may be outlined with dynamic animations or glowing effects, providing a clear and visually engaging representation of the win.

In some embodiments, the EGM evaluates the Advantage Spin outcome against predefined criteria to determine if additional Advantage Spin credits should be awarded. These criteria may include achieving specific winning combinations, aligning with promotional conditions, or meeting loyalty thresholds. If additional Advantage Spin credits are awarded, the Advantage Spin Win meter is updated to reflect the new balance. This meter is a dedicated display element within the GUI, providing real-time feedback on the player's accumulated Advantage Spin credits.

The GUI may also offer the player additional Advantage Spin opportunities based on the outcome of the Advantage Spin event. These opportunities are presented through dynamic prompts or offers, specifying the cost and potential rewards for further Advantage Spins. For instance, the player may receive an offer to re-spin another reel or symbol, with the details clearly outlined in the offer panel. These follow-up offers may encourage strategic decision-making and sustained engagement by leveraging the momentum of the current gameplay session.

Notable features of the GUI in this scenario include:
1. Reel Display Area:
   The updated reel configuration is prominently displayed, showcasing the outcome of the Advantage Spin event. Winning combinations are highlighted with animations, colors, or sound effects to emphasize the result.
2. Advantage Spin Win Meter:
   This meter tracks any additional Advantage Spin credits awarded as a result of the Advantage Spin outcome. The updated credit balance is dynamically displayed, ensuring transparency and player awareness.
3. Dynamic Offer Panel:
   If additional Advantage Spin opportunities are presented, the GUI includes a panel detailing the cost, potential rewards, and conditions for the offer. This panel may include a countdown timer to create urgency and encourage prompt decision-making.
4. Win/Payout Display:
   The GUI includes a section displaying the payout or reward resulting from the Advantage Spin event. This may include monetary credits or other forms of in-game rewards, prominently shown to enhance player satisfaction.
5. Interactive Controls:
   The interface retains interactive elements, such as buttons for accepting or declining additional offers. These controls are intuitively placed and clearly labeled to facilitate seamless player interaction.
6. Thematic Enhancements:
   Visual and auditory elements, such as celebratory animations or sounds, accompany the outcome presentation and any additional offers, enhancing the immersive nature of the gameplay experience.

In embodiments where additional Advantage Spin credits are awarded, the GUI ensures a clear and intuitive representation of these rewards. By dynamically updating the Advantage Spin Win meter and providing immediate feedback, the system reinforces the player's sense of progression and reward. Furthermore, the option to engage in additional Advantage Spin opportunities creates a layered and strategic gameplay experience, allowing players to make decisions based on their current credits, potential rewards, and gameplay preferences.

This interface design integrates outcome presentation, reward tracking, and follow-up opportunities into a cohesive and engaging system. The focus on clarity, interactivity, and real-time updates ensures that players remain informed and engaged throughout their gaming session. By enhancing the transparency and strategic depth of the Advantage Spin system, this GUI fosters a rewarding and immersive gaming experience, seamlessly blending gameplay outcomes with ongoing player interaction.

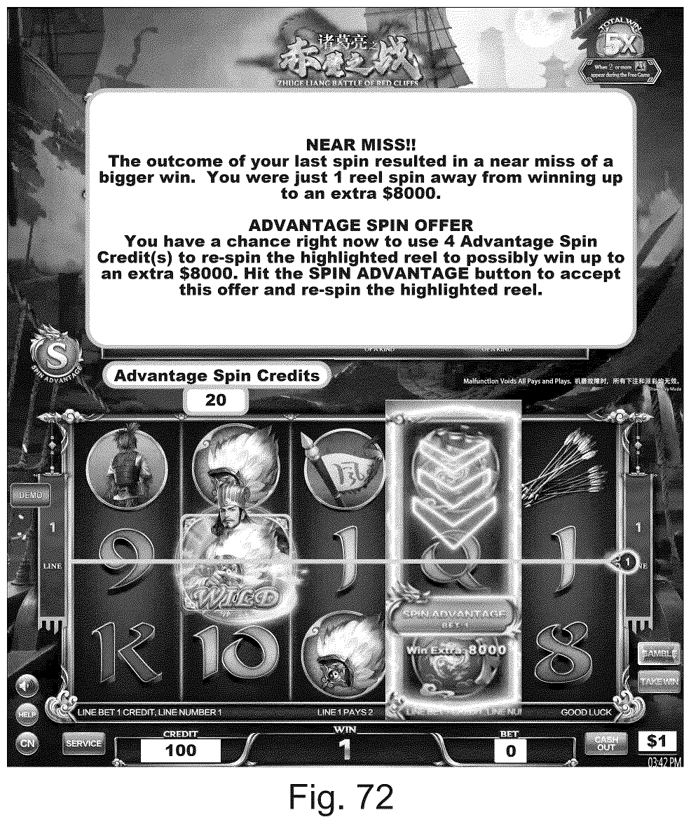

FIG. 72 illustrates an example embodiment of a graphical user interface (GUI) for a wager-based slot game, demonstrating the presentation of a new Advantage Spin Offer following the outcome of a prior Advantage Spin event, such as the first re-spin of Reel #1. This scenario highlights the dynamic and interactive nature of the Advantage Spin system, where subsequent offers are generated and presented based on real-time game state analysis and player engagement.

The GUI dynamically responds to the outcome of the initial Advantage Spin event by generating and presenting a new Advantage Spin Offer tailored to the updated game state. The EGM analyzes the current reel configuration and game conditions, such as symbol alignments and near-miss opportunities, to determine the most strategic and appealing re-spin option. This analysis includes identifying the specific reel(s) or symbol(s) that may benefit from re-spinning and calculating the corresponding cost in Advantage Spin credits or game credits.

The new Advantage Spin Offer is prominently displayed within a dedicated section of the GUI, ensuring clarity and ease of interaction. This offer includes detailed information, such as the targeted reel or symbol, the credit cost for the re-spin, and the potential maximum reward that may result from accepting the offer. In at least one embodiment, the offer is presented as a limited-time opportunity, accompanied by a countdown timer to create a sense of urgency and encourage prompt player decision-making.

Notable features of the GUI in this scenario include:
1. Dynamic Offer Panel:
   A prominently placed panel displays the new Advantage Spin Offer, specifying the reel or symbol targeted for re-spin, the required credits (e.g., Advantage Spin credits or game credits), and the potential reward. The panel ensures that players have all the necessary information to make an informed decision.
2. Countdown Timer:
   The GUI includes a visible countdown timer, indicating the limited-time nature of the offer. This feature enhances engagement by adding urgency to the decision-making process.
3. Interactive Controls:
   The GUI provides clearly labeled buttons for accepting or declining the offer. Depending on the implementation, these controls may be presented as virtual buttons on a touchscreen or as physical buttons on the gaming machine's interface.
4. Advantage Spin Credit Meter:
   The current balance of Advantage Spin credits is prominently displayed, allowing players to evaluate whether they have sufficient credits to accept the new offer. This transparency ensures that players may manage their resources effectively.
5. Outcome Display Integration:
   The GUI retains the display of the previous Advantage Spin event outcome, maintaining continuity and reinforcing the progression of the gameplay. Any highlighted symbols or winning combinations from the prior event remain visible, providing context for the new offer.
6. Visual and Audio Enhancements:
   The new Advantage Spin Offer is accompanied by animations, sound effects, or other visual cues to draw the player's attention and enhance the excitement of the gameplay.
7. Game Theme Integration:
   The GUI design aligns with the thematic elements of the slot game, incorporating colors, graphics, and motifs consistent with the game's overall aesthetic. This ensures a cohesive and immersive player experience.

The dynamic generation and presentation of the new Advantage Spin Offer demonstrate the system's ability to adapt to ongoing gameplay and provide tailored opportunities that align with the player's current game state. By integrating clear information, interactive elements, and thematic enhancements, the GUI fosters an engaging and strategic gaming experience.

This interface supports player decision-making by transparently presenting the cost and potential rewards of the new Advantage Spin opportunity. The inclusion of a countdown timer and real-time updates to credit meters further enhances the immediacy and interactivity of the system, encouraging players to remain actively involved in their gaming session. Through its intuitive and visually engaging design, this GUI exemplifies the seamless integration of advanced gameplay mechanics within a modern wager-based slot game.

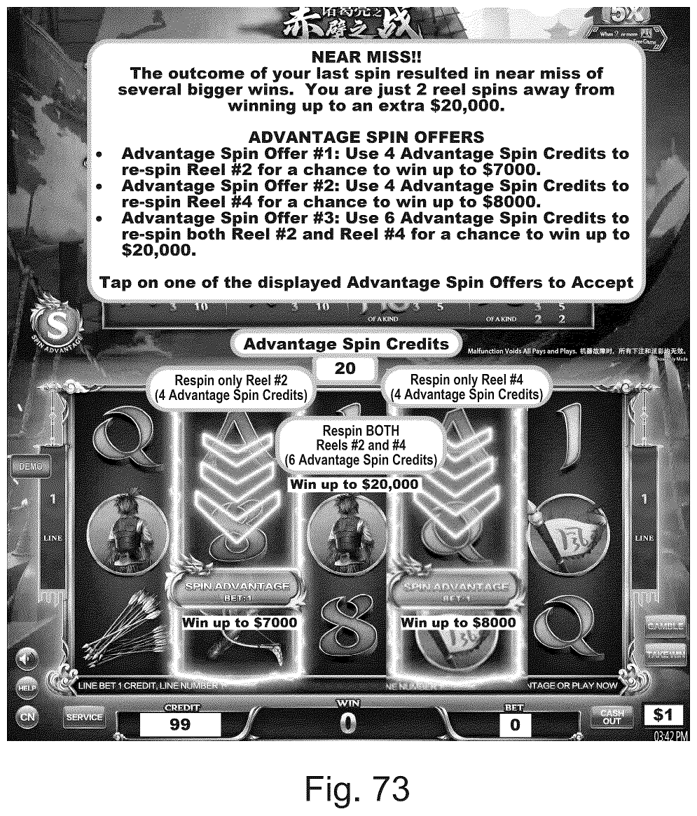

FIG. 73 illustrates an example embodiment of a graphical user interface (GUI) for a wager-based slot game, showcasing the presentation of multiple Advantage Spin Offers following the outcome of a prior Advantage Spin event, such as the first re-spin of Reel #2. This scenario emphasizes flexibility and strategic decision-making by providing players with a range of tailored re-spin opportunities, each with distinct costs and potential rewards.

In this alternate embodiment, the EGM generates multiple Advantage Spin Offers based on real-time analysis of the updated game state after the initial Advantage Spin event. The player is presented with three Advantage Spin offers targeting specific reels identified as having the highest potential impact on gameplay outcomes. The GUI prominently displays these offers, each specifying the reel(s) eligible for re-spin, the cost in Advantage Spin credits, and the maximum potential reward for the re-spin.

In this scenario, the player is given the option to re-spin Reel #2, Reel #4, or both reels. The GUI clearly delineates the costs and potential rewards for each option. For example, the re-spin of Reel #2 may may require 4 Advantage Spin credits and offers a potential maximum win of up to $7,000. Similarly, the re-spin of Reel #4 also costs 4 Advantage Spin credits but offers a higher potential maximum win of up to $8,000. The option to re-spin both reels simultaneously may may require 6 Advantage Spin credits and offers a maximum potential win of up to $20,000, presenting the player with a high-risk, high-reward opportunity.

If the player does not have sufficient Advantage Spin credits to fund their selected re-spin option, the GUI supports additional flexibility by allowing the player to use game credits to complete the transaction. This feature ensures inclusivity, allowing players with insufficient Advantage Spin credits to continue engaging with the Advantage Spin opportunities. The GUI dynamically updates to reflect the use of game credits, maintaining clarity and transparency throughout the process.

Notable Elements of the GUI in this Embodiment Include:

Dynamic Offer Panel: The GUI prominently features a panel displaying the three Advantage Spin Offers. Each offer includes detailed information such as the reel(s) eligible for re-spin, the associated cost in Advantage Spin credits, and the potential maximum reward. The panel ensures that all options are clearly visible and easily comparable, enabling strategic decision-making.

Interactive Selection Mechanism: The GUI provides an intuitive interface for selecting a re-spin option. Players may interact with virtual buttons on a touchscreen or physical controls on the EGM's interface to choose their desired reel(s). The system highlights the selected option, providing visual confirmation of the player's choice.

Credit Management Integration: The GUI displays the current balances for both Advantage Spin credits and game credits, allowing players to assess their available resources. If the selected option exceeds the available Advantage Spin credits, the system prompts the player to confirm the use of game credits to complete the transaction. This integration ensures transparency and enables informed decision-making.

Countdown Timer for Decision: In some embodiments, the GUI incorporates a countdown timer, emphasizing the limited-time nature of the offers. This feature creates a sense of urgency, encouraging players to make prompt decisions while maintaining engagement.

Outcome Continuity: The GUI retains the display of the prior Advantage Spin event outcome, providing context for the new offers. The highlighted reels and symbols from the previous spin ensure continuity and reinforce the progression of the gameplay.

Enhanced Visual and Audio Feedback: The presentation of Advantage Spin Offers is accompanied by animations, sound effects, and thematic graphics, drawing the player's attention and enhancing the overall gaming experience. For example, highlighted reels may glow or pulsate, emphasizing their availability for re-spin.

Win Amount and Credit Balances: The GUI displays the player's current cash credit balance, Advantage Spin credit balance, and any recent win amounts. These metrics are updated in real-time, ensuring that players have a comprehensive understanding of their resources and outcomes.

This GUI design effectively integrates flexibility, strategic depth, and interactivity, allowing players to tailor their gameplay experience based on their preferences and available resources. By offering multiple Advantage Spin opportunities with varying costs and rewards, the system caters to a broad spectrum of player strategies, from cautious play to high-stakes risk-taking. The seamless inclusion of game credits as an alternative funding option further enhances the accessibility of the Advantage Spin system, ensuring that all players may participate in the dynamic gameplay opportunities it provides. Through its intuitive layout and engaging design, this GUI elevates the player experience, fostering sustained engagement and satisfaction.

In some embodiments, the wager-based slot game system is designed to enhance gameplay efficiency and maximize player engagement by incorporating a feature that automatically accepts Advantage Spin Offers on behalf of the player under certain conditions. This functionality addresses scenarios where the player may be momentarily distracted or otherwise unable to respond within a designated timeframe. By configuring the game to automatically accept and execute a presented Advantage Spin Offer unless the player explicitly declines it within a predetermined time interval, the system ensures continuous gameplay and minimizes disruptions.

When an Advantage Spin Offer is presented, the system provides the player with a clear notification of the offer details, including the cost in Advantage Spin credits or game credits, the reel(s) or symbol(s) eligible for re-spin, and the potential maximum reward. A countdown timer is prominently displayed on the graphical user interface (GUI), indicating the remaining time within which the player must provide input to either accept or decline the offer. If the player does not provide input to decline the offer before the timer expires, the system automatically accepts and executes the Advantage Spin Offer.

One significant advantage of this automatic acceptance feature is its ability to expedite gameplay, which is particularly desirable for casinos seeking to maximize the throughput of gaming activities. By reducing idle time caused by delayed player responses, the system helps maintain a steady pace of play, ensuring a more engaging and seamless experience for all participants. Additionally, this feature prevents players from inadvertently missing valuable Advantage Spin opportunities due to momentary distractions, thereby enhancing player satisfaction and increasing the perceived value of the gaming experience.

In embodiments where multiple Advantage Spin Offers are presented concurrently, the system incorporates an Intelligent Game State Analysis and Advantage Spin Offer Engine to select a default offer for automatic acceptance. This engine evaluates the presented Advantage Spin Offers in substantially real-time, leveraging advanced algorithms and probability analysis to determine the offer most to result in an increased win amount for the player. The evaluation process considers factors such as the current game state configuration, the potential outcomes of re-spinning the eligible reel(s) or symbol(s), and the relative costs and rewards associated with each offer.

The default offer selected by the Intelligent Game State Analysis and Advantage Spin Offer Engine is designated as the primary offer to be automatically accepted if the player does not respond within the allocated time interval. This ensures that the system prioritizes the option with the highest calculated probability of enhancing the player's winnings, aligning with the overall goal of creating a rewarding and engaging gaming experience. The other concurrently presented offers remain available for manual selection within the designated timeframe, providing players with the flexibility to make their own decisions if they wish.

The GUI is carefully designed to support this functionality, incorporating visual and auditory cues to draw the player's attention to the active Advantage Spin Offer(s). Dynamic animations, countdown timers, and highlighted buttons for accepting or declining the offers ensure clarity and ease of interaction. In cases where the default offer is automatically accepted, the GUI provides immediate feedback, displaying a confirmation message and transitioning to the execution of the Advantage Spin event.

By integrating this feature, the system enhances gameplay efficiency, minimizes missed opportunities, and provides a layer of intelligent decision-making that optimizes outcomes for the player. The ability to analyze and prioritize Advantage Spin Offers in real-time underscores the system's sophistication and adaptability, fostering a dynamic and immersive gaming environment. This functionality not only benefits the player by ensuring timely and advantageous actions but also supports the casino's operational goals by maintaining a high tempo of gameplay and maximizing engagement.

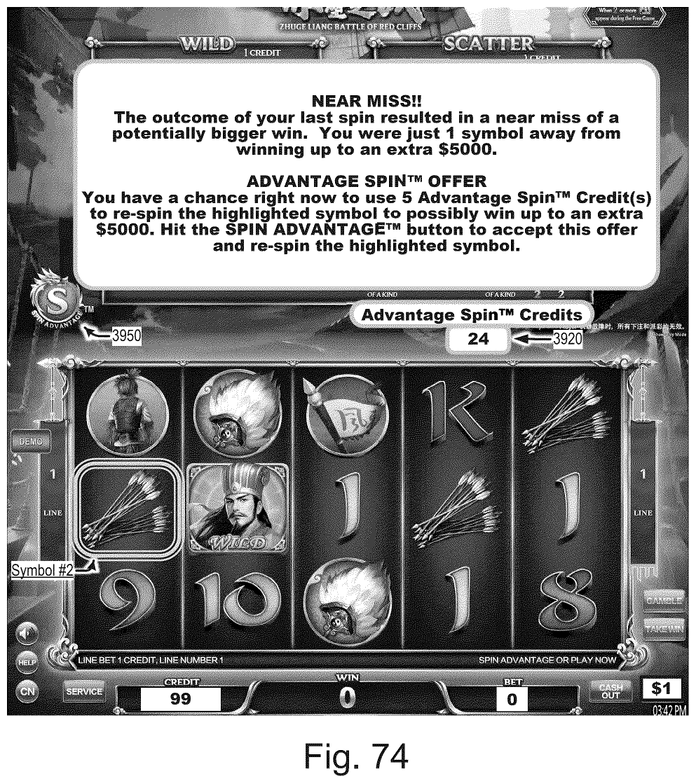

FIG. 74 illustrates an example embodiment of a graphical user interface (GUI) for a wager-based slot game, detailing the presentation and execution of an Advantage Spin™ opportunity triggered by the detection of a near-miss (or near-hit) condition during an active gaming session. This interface demonstrates the integration of real-time game state analysis, dynamic offer generation, and interactive player decision-making.

During the gaming session, the Electronic Gaming Machine (EGM) continuously analyzes the outcomes of game events in real-time to identify specific conditions, such as a near-miss or near-hit event. These conditions occur when the displayed outcome narrowly misses achieving a high-value winning combination or another predefined rewarding configuration. Upon identifying such an event, the EGM determines that an Advantage Spin opportunity may provide a strategic enhancement to the gameplay experience.

Following the detection of the near-miss condition, the EGM dynamically calculates the cost associated with executing the identified Advantage Spin opportunity. This cost is expressed in terms of Advantage Spin credits and/or game credits, with the specific value determined based on various factors, including the current game state, the potential outcomes of the re-spin, and the game's payout structure. The system ensures that the calculated cost aligns with the potential rewards of the Advantage Spin opportunity, offering a balanced and transparent proposition to the player.

The EGM generates an Advantage Spin™ Offer detailing the cost and potential rewards of the identified re-spin opportunity. This offer is prominently displayed within the GUI, ensuring that the player has all the necessary information to make an informed decision. The offer includes details such as the reel(s) or symbol(s) targeted for the Advantage Spin, the credit cost required to fund the spin, and the maximum potential reward achievable from the re-spin.

The GUI incorporates interactive elements that allow the player to accept the Advantage Spin™ Offer, for example, by tapping or pressing the Spin Advantage™ button 3950. Depending on the embodiment, the player may interact with a virtual button on the EGM's touchscreen or use a physical button on the gaming machine's button panel. Upon accepting the offer, the system initiates procedures to secure the required funding for the Advantage Spin. The determined value of Advantage Spin credits is deducted from the EGM's Advantage Spin credit meter, and this deduction is dynamically reflected in the GUI, providing immediate feedback to the player.

Once the required credits are secured, the EGM executes the Advantage Spin™ opportunity. The GUI transitions to a visually engaging display, highlighting the affected reel(s) or symbol(s) as they spin again. The focus remains on the gameplay action, ensuring that the player remains engaged and immersed in the gaming experience. Upon completion of the re-spin, the updated outcome is prominently displayed, with any resulting winning combinations clearly highlighted. The system automatically adjusts the relevant credit meters and provides real-time updates to reflect the new game state.

Notable Features of the GUI in this Embodiment Include:

Dynamic Offer Display: The Advantage Spin Offer is prominently displayed, including detailed information about the re-spin cost and potential rewards. This transparency ensures that players may make informed decisions.

Interactive Controls: The interface includes intuitive and clearly labeled buttons for accepting or declining the offer. Depending on the machine configuration, these controls may be virtual or physical.

Credit Meter Integration: The GUI dynamically updates the Advantage Spin™ credit meter to reflect the deduction of credits for the re-spin. The cash credit meter remains unchanged unless game credits are used to supplement the cost.

Visually Enhanced Re-spin Execution: The GUI highlights the targeted reel(s) or symbol(s) during the re-spin, accompanied by animations and sound effects that enhance player engagement.

Outcome Display and Continuity: After the re-spin, the updated outcome is integrated seamlessly into the existing game state. Winning combinations are emphasized with dynamic visuals, ensuring clarity and excitement.

This GUI design effectively combines real-time analysis, interactive decision-making, and engaging visuals to create a rewarding and immersive gaming experience. By leveraging near-miss conditions to generate tailored Advantage Spin™ opportunities, the system fosters strategic gameplay and maximizes player engagement. Through its intuitive layout and dynamic feedback, the GUI ensures transparency and enhances the overall satisfaction of the player.

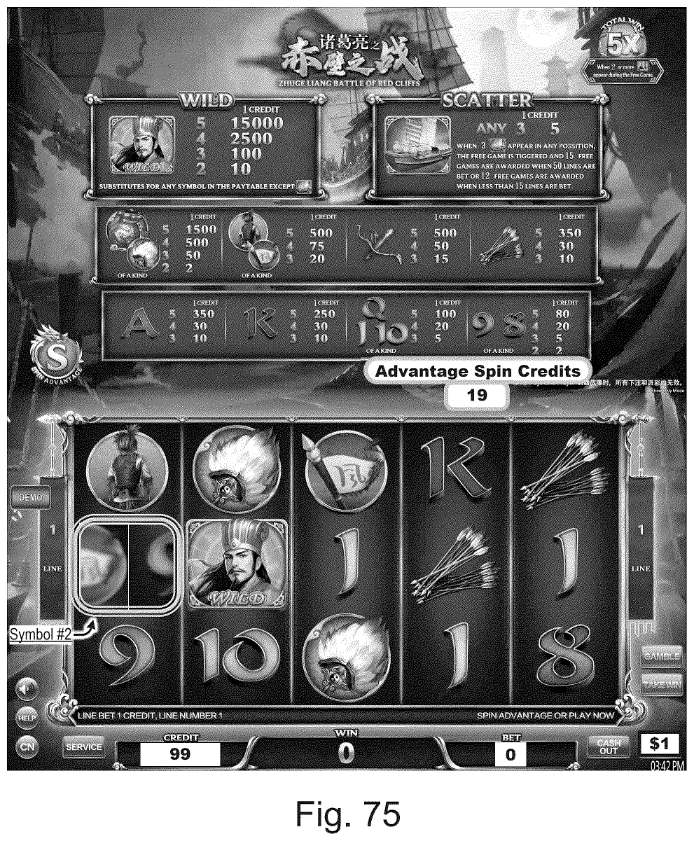

FIG. 75 illustrates an example embodiment of a graphical user interface (GUI) for a wager-based slot game, focusing on the execution of an Advantage Spin event targeting a specific symbol, Symbol #2. This scenario showcases the integration of player decision-making, credit management, and visually engaging gameplay features within the Electronic Gaming Machine (EGM).

In the depicted scenario, the player has accepted an Advantage Spin Offer to consume five Advantage Spin credits in order to re-spin Symbol #2. Upon the player's acceptance of the offer, the EGM initiates the necessary steps to execute the re-spin. The first action involves deducting five Advantage Spin credits from the EGM's Advantage Spin credit meter. This deduction is processed immediately, and the GUI dynamically updates to display the new balance of the Advantage Spin credit meter, providing real-time feedback to the player. The Game Credit Meter remains unaffected, as the re-spin is funded exclusively through Advantage Spin credits.

The re-spin process begins with the EGM focusing on the highlighted Symbol #2. The GUI visually emphasizes this symbol by isolating it with animations or highlights, ensuring the player's attention is drawn to the action. Unlike a full-reel spin, this targeted re-spin affects only the designated symbol while preserving the positions of all other symbols on the reels. This targeted approach introduces an additional layer of strategy, allowing players to influence the game outcome in a controlled manner.

The GUI incorporates several notable features to enhance the player's experience during this process:

Highlighted Symbol Display: The GUI prominently emphasizes Symbol #2, visually distinguishing it from the static symbols on the other reels. This focus ensures clarity and reinforces the player's action in accepting the Advantage Spin Offer.

Advantage Spin Credit Meter Updates: The updated balance of the Advantage Spin credit meter is displayed in real-time following the deduction of five credits. This transparency allows players to monitor their remaining resources and manage their gameplay strategy effectively.

Interactive and Visual Feedback: The initiation of the re-spin is accompanied by dynamic animations and sound effects. The targeted symbol may pulsate, glow, or animate during the re-spin process, enhancing engagement and maintaining the player's immersion in the game.

Unchanged Game Credit Meter: The GUI retains the display of the Game Credit Meter, clearly indicating that no game credits were used to fund this Advantage Spin event. This separation of credit types reinforces the distinct nature of Advantage Spin credits within the gameplay ecosystem.

Outcome Display: Once the re-spin is completed, the GUI transitions to display the updated outcome of Symbol #2. If the re-spin results in a winning combination or enhances an existing win, the relevant paylines or symbols are highlighted, and the corresponding payout is displayed. Any adjustments to cash credits or other rewards are dynamically reflected in the appropriate meters.

Seamless Continuity: The GUI integrates the re-spin result into the overall game state, maintaining the continuity of gameplay. The other symbols on the reels remain static throughout the process, ensuring a clear and focused presentation.

This embodiment of the GUI highlights the versatility and precision of the Advantage Spin system. By enabling players to target specific symbols for re-spin opportunities, the system introduces a strategic dimension to gameplay, allowing players to exert greater control over their potential outcomes. The real-time updates to credit meters, combined with the visually engaging re-spin process, ensure transparency and enhance player satisfaction. The intuitive design and dynamic feedback mechanisms make this GUI a powerful tool for creating a rewarding and immersive gaming experience.

FIG. 76 illustrates an example embodiment of a graphical user interface (GUI) for a wager-based slot game, focusing on the presentation of the outcome of a re-spin targeting a specific symbol, Symbol #2. This scenario showcases the integration of outcome feedback, credit tracking, and potential follow-up opportunities within the Advantage Spin system.

The scenario begins with the conclusion of the Advantage Spin event, during which Symbol #2 was re-spun. The updated outcome of Symbol #2 is prominently displayed in the reel area of the GUI, seamlessly integrated with the static positions of the other symbols on the reels. If the re-spin results in a winning combination or enhances an existing win, the GUI emphasizes the outcome by highlighting the relevant symbols and paylines with animations, colors, or other visual effects. Additionally, the corresponding win or payout amount is displayed prominently, ensuring that the player receives immediate feedback on the results of their Advantage Spin.

In some embodiments, the EGM evaluates the re-spin outcome against predefined criteria to determine if additional Advantage Spin credits should be awarded. For example, specific winning combinations or thresholds may trigger a reward of extra Advantage Spin credits, providing an added incentive for engaging with the Advantage Spin system. If awarded, these additional credits are tracked and displayed on the Advantage Spin Win meter, a dedicated interface element that dynamically updates to reflect the player's growing credit balance. This transparency reinforces the player's sense of progression and reward.

The GUI also supports the presentation of follow-up Advantage Spin opportunities. Based on the outcome of the re-spin, the EGM may generate and present new Advantage Spin Offers, allowing the player to continue engaging with the game in a strategic manner. These offers are tailored to the updated game state and may include details such as the reel(s) or symbol(s) eligible for re-spin, the credit cost, and the potential maximum reward. The player is provided with interactive controls to accept or decline these opportunities, fostering an immersive and decision-driven gaming experience.

Notable Features of the GUI in this Embodiment Include:

Outcome Display Area: The reel area prominently showcases the updated result of Symbol #2 following the re-spin. Any resulting winning combinations are highlighted with animations, dynamic lighting, or sound effects, drawing the player's attention to the outcome.

Win/Payout Display: The GUI includes a dedicated section that clearly displays the win or payout amount resulting from the Advantage Spin event. This information is presented in real-time to ensure immediate feedback and transparency.

Advantage Spin Win Meter: This dedicated meter tracks additional Advantage Spin credits awarded to the player based on the re-spin outcome or other predefined criteria. The meter dynamically updates to reflect any credits earned, providing real-time visibility into the player's resources.

Dynamic Offer Panel: If new Advantage Spin opportunities are presented, the GUI includes an offer panel detailing the options. Each offer specifies the cost in Advantage Spin credits or game credits, the targeted reel(s) or symbol(s), and the potential rewards, ensuring the player may make an informed decision.

Interactive Controls: Intuitive buttons for accepting or declining follow-up offers are integrated into the GUI.

Depending on the embodiment, these controls may be virtual buttons on a touchscreen or physical buttons on the EGM's interface.

Continuity and Immersion: The GUI seamlessly integrates the outcome of the Advantage Spin event into the broader gameplay narrative. The static symbols and other elements of the game state remain visible, maintaining continuity and immersion for the player.

Thematic Enhancements: Visual and auditory effects, such as celebratory animations or sound cues, accompany significant outcomes or awards, enhancing the overall entertainment value of the gaming experience.

This embodiment of the GUI exemplifies the dynamic and rewarding nature of the Advantage Spin system. By transparently presenting outcomes, tracking rewards, and offering follow-up opportunities, the interface fosters sustained engagement and satisfaction. The combination of strategic decision-making, real-time updates, and immersive visuals ensures that players remain actively involved and invested in their gaming experience. This design emphasizes both the technical sophistication and player-centric focus of the Advantage Spin system, delivering a comprehensive and enjoyable gaming environment.

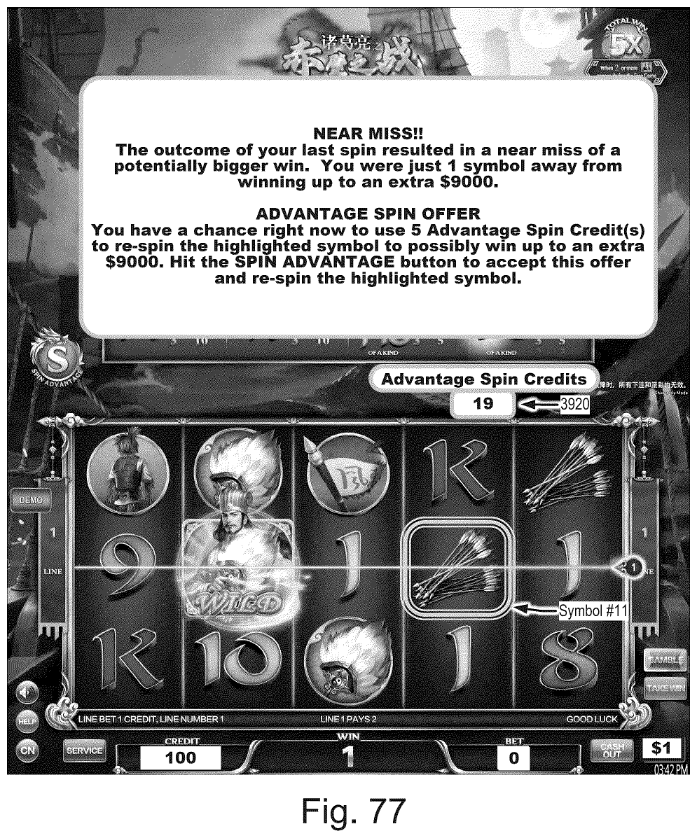

FIG. 77 illustrates an example embodiment of a graphical user interface (GUI) for a wager-based slot game, focusing on the presentation of a new Advantage Spin Offer generated following the outcome of a prior Advantage Spin event, such as the first re-spin of Reel #1. This interface highlights the system's ability to dynamically adapt to gameplay by analyzing the updated game state and generating tailored offers to sustain player engagement and interaction.

In the depicted scenario, the EGM evaluates the outcome of the initial Advantage Spin event and identifies the potential for additional gameplay opportunities. Using real-time game state analysis, the EGM determines the most strategic options for re-spin activities and calculates the associated costs and potential rewards. These considerations inform the generation of a new Advantage Spin Offer, which is prominently displayed within the GUI for the player's consideration.

The new Advantage Spin Offer includes detailed information about the reel(s) or symbol(s) eligible for re-spin, the Advantage Spin credits required to fund the opportunity, and the potential maximum reward that may result. This information is presented in a structured and visually engaging format, ensuring that the player may quickly and easily evaluate the offer.

In at least one embodiment, the Advantage Spin Offer is presented as a limited-time opportunity, accompanied by a countdown timer to create urgency and encourage prompt decision-making. The GUI features interactive controls that allow the player to accept or decline the offer, facilitating seamless interaction and maintaining the flow of gameplay.

Notable Features of the GUI in this Embodiment Include:

Dynamic Offer Panel: The GUI prominently displays the new Advantage Spin Offer in a dedicated panel. The panel outlines the details of the opportunity, including the eligible reel(s) or symbol(s), the required Advantage Spin credits, and the potential rewards. The layout is designed to be clear and easily readable, ensuring that the player may make an informed decision.

Countdown Timer: A countdown timer is integrated into the offer panel, emphasizing the limited-time nature of the Advantage Spin Offer. This feature adds urgency to the player's decision-making process while maintaining engagement.

Interactive Controls: The interface includes intuitive buttons for accepting or declining the Advantage Spin Offer. Depending on the configuration, these controls may be implemented as virtual buttons on a touchscreen or physical buttons on the EGM's button panel. The selected option is highlighted, providing immediate feedback to the player.

Advantage Spin Credit Meter: The current balance of the Advantage Spin credits is prominently displayed, allowing the player to assess their available resources before deciding whether to accept the offer. This transparency ensures that the player remains informed and confident in their decision-making.

Outcome Continuity: The GUI retains the display of the prior Advantage Spin event outcome, ensuring continuity and reinforcing the progression of the gameplay. Highlighted reels, symbols, or winning combinations from the previous event remain visible, providing context for the new offer.

Enhanced Visual and Audio Feedback: The presentation of the new Advantage Spin Offer is accompanied by thematic animations, sound effects, or visual cues that draw the player's attention and enhance the overall gaming experience.

Thematic and Aesthetic Design: The GUI's design elements align with the game's overall theme, incorporating consistent colors, graphics, and motifs to create a cohesive and immersive gaming environment.

This embodiment demonstrates the sophistication of the Advantage Spin system, which leverages real-time analysis to generate tailored offers that align with the player's current game state and strategic goals. By transparently presenting the details of the Advantage Spin Offer and providing clear, interactive controls, the GUI fosters a sense of empowerment and engagement. The inclusion of a countdown timer and dynamic feedback further enhances the immediacy and interactivity of the system, encouraging players to remain actively involved in their gaming experience. This design exemplifies the Advantage Spin system's focus on delivering dynamic, rewarding, and immersive gameplay.

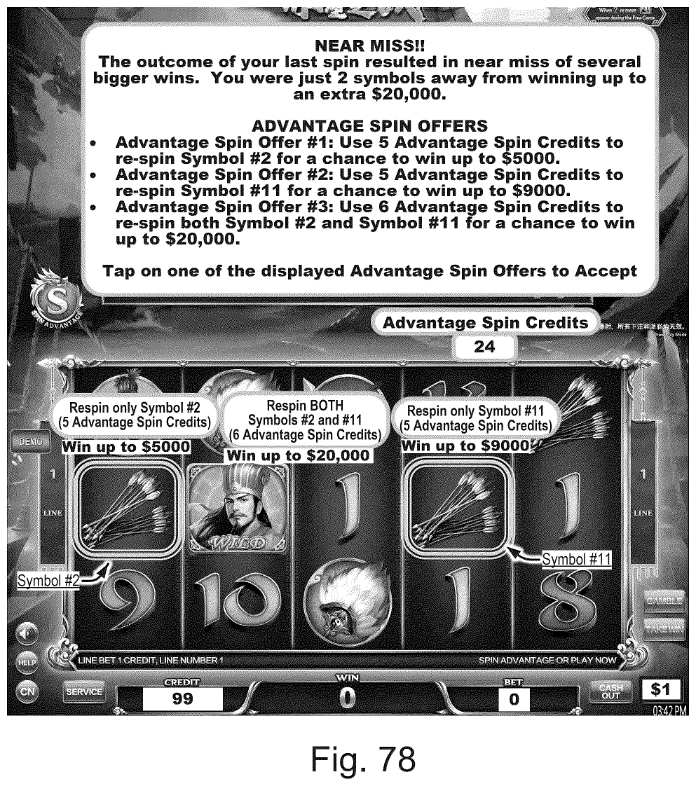

FIG. 78 illustrates an example embodiment of a graphical user interface (GUI) for a wager-based slot game, showcasing an alternate implementation of Advantage Spin Offers generated based on the outcome of a previous spin. This embodiment emphasizes flexibility, strategic decision-making, and targeted gameplay by allowing players to select specific symbols for re-spin opportunities. The scenario demonstrates the system's ability to adapt dynamically to gameplay conditions and provide tailored options for players.

Following the outcome of the previous spin, the EGM evaluates the updated game state and identifies symbols with high potential to impact gameplay. In this example, the system generates three Advantage Spin Offers targeting Symbol #2, Symbol #11, or both symbols. Each offer is customized to reflect the cost in Symbol Spin credits and the potential maximum reward. These offers are prominently displayed on the GUI, allowing the player to compare the options and make an informed decision.

The first offer allows the player to re-spin Symbol #2 for five Symbol Spin credits, with a potential maximum win of $5,000. The second offer targets Symbol #11 for the same cost but offers a higher maximum reward of $9,000. The third option permits the player to re-spin both symbols simultaneously for six Symbol Spin credits, presenting a high-risk, high-reward opportunity with a potential maximum win of $20,000. The cost structure and reward tiers are designed to appeal to various player strategies, from cautious play to more aggressive, high-stakes decision-making.

If the player lacks sufficient Symbol Spin credits to fund their selected option, the system provides an alternative by allowing the use of game credits to cover the cost. This flexibility ensures that all players, regardless of their current credit balances, may participate in Advantage Spin opportunities, enhancing inclusivity and engagement.

Notable Features of the GUI in this Embodiment Include:

Dynamic Offer Panel: The GUI prominently displays the three Advantage Spin Offers in a structured panel. Each offer specifies the targeted symbol(s), the cost in Symbol Spin credits, and the potential maximum reward. The layout is designed for clarity, enabling players to quickly evaluate and compare their options.

Interactive Selection Mechanism: Players may select their preferred option using intuitive controls, such as virtual buttons on a touchscreen or physical buttons on the EGM interface. The GUI highlights the selected option, providing visual confirmation of the player's choice.

Credit Management Integration: The current balance of Symbol Spin credits is prominently displayed, allowing players to assess their resources before making a selection. If the selected option exceeds the available Symbol Spin credits, the system prompts the player to use game credits to fund the remaining cost. This integration ensures transparency and seamless credit management.

Countdown Timer for Decision: In some embodiments, the GUI includes a countdown timer to emphasize the limited-time nature of the offers, encouraging prompt decision-making and maintaining gameplay momentum.

Outcome Continuity: The GUI retains the display of the previous spin's outcome, including the positions and results of Symbol #2 and Symbol #11. This continuity provides context for the new offers, reinforcing the relevance of the options presented.

Enhanced Visual and Audio Feedback: The presentation of Advantage Spin Offers is accompanied by thematic animations, sound effects, or other visual cues that draw the player's attention and enhance the gaming experience.

Win Amounts and Credit Displays: The GUI updates dynamically to reflect the player's available credits, as well as any wins resulting from subsequent spins. This transparency ensures that players are consistently informed about their resources and potential outcomes.

Thematic and Aesthetic Integration: The GUI design aligns with the game's overarching theme, incorporating consistent colors, motifs, and animations to create a cohesive and immersive experience.

This embodiment highlights the strategic depth and interactivity of the Advantage Spin system. By providing players with multiple symbol-specific re-spin options, the system fosters a tailored and engaging gaming experience. The integration of flexible credit usage and real-time feedback ensures that all players may participate in and enjoy the dynamic opportunities provided by the Advantage Spin system. The intuitive design and engaging presentation of the GUI enhance player satisfaction, making this feature a valuable addition to modern wager-based slot games.

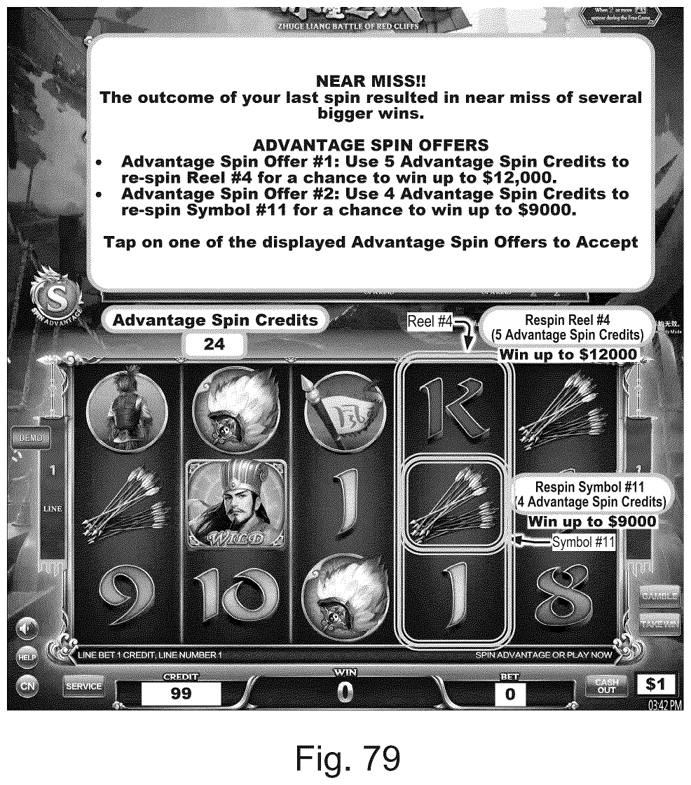

FIG. 79 illustrates an example embodiment of a graphical user interface (GUI) for a wager-based slot game, showcasing a hybrid approach to Advantage Spin Offers. In this scenario, the player is presented with multiple re-spin opportunities targeting either an entire reel or a specific symbol, allowing for strategic decision-making based on their gameplay preferences and available resources.

Following the outcome of a previous spin, the Electronic Gaming Machine (EGM) evaluates the updated game state and identifies high-impact opportunities for re-spin activities. The system dynamically generates two tailored Advantage Spin Offers, one targeting Reel #4 and the other focusing on Symbol #11. Both options are displayed prominently on the GUI, with detailed information about the associated costs and potential rewards.

The first offer enables the player to re-spin Reel #4 for five Advantage Spin credits, with a potential maximum win of up to $12,000. This option allows the player to refresh the entire reel, creating a broader impact on the game state. The second offer focuses on Symbol #11, also requiring five Advantage Spin credits, but offering a slightly lower potential maximum reward of $9,000. This targeted approach may appeal to players seeking precise control over specific symbols.

If the player lacks sufficient Advantage Spin credits to fund their chosen option, the system supports flexibility by allowing the use of game credits to supplement the cost. This ensures that all players, regardless of their current Advantage Spin credit balance, may engage with the Advantage Spin system and take advantage of the presented opportunities.

Notable Features of the GUI in this Embodiment Include:

Dynamic Offer Panel: The GUI prominently displays both Advantage Spin Offers, each clearly labeled with the targeted reel or symbol, the required Advantage Spin credits, and the maximum potential reward. The structured layout ensures clarity, enabling the player to compare the options and make an informed decision.

Interactive Selection Mechanism: Players may select their preferred option using intuitive controls, such as virtual buttons on a touchscreen or physical buttons on the EGM's interface. The GUI highlights the selected option, providing visual confirmation of the player's choice.

Credit Management Integration: The current balance of Advantage Spin credits is prominently displayed, allowing players to assess their available resources. If the selected option exceeds the available Advantage Spin credits, the system prompts the player to confirm the use of game credits to cover the remaining cost. This integration ensures seamless credit management and transparency.

Outcome Continuity: The GUI retains the display of the previous spin's outcome, including the positions of Reel #4 and Symbol #11. This continuity provides context for the new offers, reinforcing the relevance and strategic potential of each option.

Enhanced Visual and Audio Feedback: The presentation of the Advantage Spin Offers is accompanied by animations, sound effects, or other visual cues that draw the player's attention and enhance the overall gaming experience.

Win Amounts and Credit Displays: The GUI updates dynamically to reflect the player's available credits, as well as any winnings resulting from subsequent re-spin events. This real-time feedback ensures that players remain informed about their resources and outcomes.

Thematic and Aesthetic Integration: The GUI design aligns with the overall theme of the slot game, incorporating consistent colors, graphics, and motifs to create a cohesive and immersive experience.

This embodiment demonstrates the versatility and adaptability of the Advantage Spin system by offering hybrid re-spin opportunities targeting both reels and individual symbols. By presenting players with distinct options tailored to their gameplay strategy, the system enhances engagement and decision-making. The integration of flexible credit usage and dynamic feedback ensures accessibility and transparency, fostering a rewarding and interactive gaming experience. The intuitive design and strategic depth of the GUI make this feature an invaluable component of modern wager-based slot games.

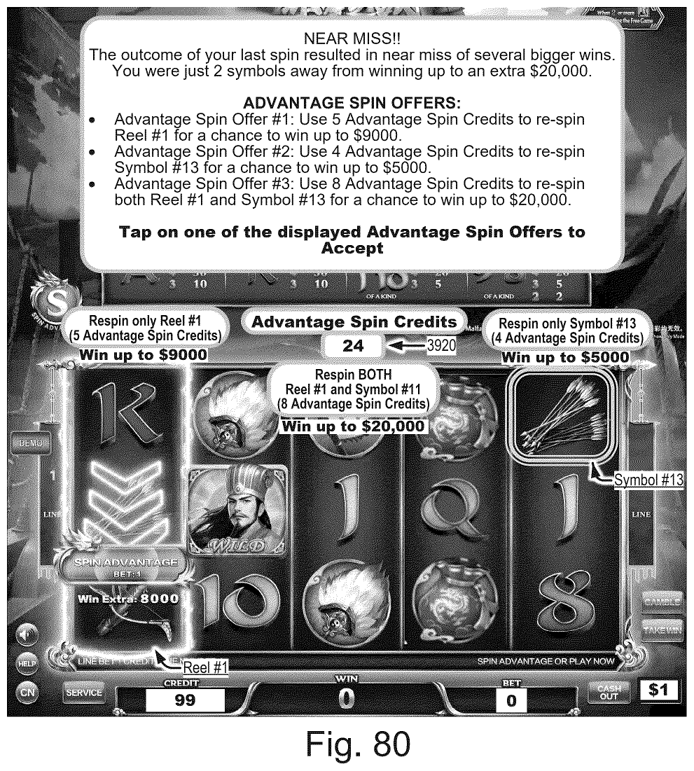

FIG. 80 illustrates an example embodiment of a graphical user interface (GUI) for a wager-based slot game, showcasing a dynamic presentation of multiple Advantage Spin Offers. This scenario emphasizes strategic decision-making, providing players with tailored options to re-spin either an entire reel, a specific symbol, or both. The interface demonstrates the system's adaptability, offering clear and transparent options for players to maximize their gameplay potential.

Following the outcome of a previous game event, the Electronic Gaming Machine (EGM) analyzes the updated game state in real-time to identify high-impact opportunities for re-spin activities. Based on this analysis, the EGM dynamically generates three Advantage Spin Offers targeting Reel #1, Symbol #13, or a combination of both. These options are prominently displayed in the GUI, allowing players to compare costs, risks, and potential rewards before making a selection.

Advantage Spin Offer #1 invites the player to use five Advantage Spin credits to re-spin Reel #1, with the potential to win up to $9,000. This option offers a broader scope of change, as re-spinning the entire reel has the potential to significantly alter the game state.

Advantage Spin Offer #2 focuses on Symbol #13, allowing the player to use four Advantage Spin credits for a chance to win up to $5,000. This targeted approach appeals to players looking for precise control over specific symbols.

Advantage Spin Offer #3 provides a high-risk, high-reward option to re-spin both Reel #1 and Symbol #13 for eight Advantage Spin credits, with a maximum potential win of $20,000. This comprehensive option combines the benefits of the previous two offers, offering the greatest potential impact on gameplay.

If the player lacks sufficient Advantage Spin credits to fund their selected option, the system incorporates flexibility by allowing game credits to supplement the cost. This ensures accessibility and inclusivity, enabling players to participate regardless of their current Advantage Spin credit balance.

Notable Features of the GUI in this Embodiment Include:

Dynamic Offer Panel: The GUI prominently displays all three Advantage Spin Offers in a structured panel. Each offer is clearly labeled with the targeted reel or symbol, the required Advantage Spin credits, and the maximum potential reward. The layout is intuitive, allowing players to evaluate their options quickly and efficiently.

Interactive Selection Mechanism: Players may select their preferred option using virtual buttons on a touchscreen or physical buttons on the EGM interface. The GUI highlights the chosen offer, providing immediate visual confirmation of the selection.

Credit Management Integration: The GUI displays the current balance of Advantage Spin credits and game credits, enabling players to assess their available resources. If the chosen option exceeds the available Advantage Spin credits, the system prompts the player to use game credits to fund the remaining cost, ensuring seamless credit management.

Countdown Timer for Decision: In some embodiments, a countdown timer emphasizes the limited-time nature of the Advantage Spin Offers, creating urgency and encouraging prompt decision-making.

Enhanced Visual and Audio Feedback: The presentation of the Advantage Spin Offers is accompanied by thematic animations, sound effects, and visual cues that draw the player's attention and enhance engagement.

Outcome Continuity: The GUI retains the display of the previous game state, including the positions of Reel #1 and Symbol #13, providing context for the new offers and reinforcing their strategic relevance.

Thematic Integration: The design of the GUI aligns with the slot game's overall theme, incorporating consistent graphics, colors, and motifs to create a cohesive and immersive player experience.

This embodiment underscores the strategic depth and flexibility of the Advantage Spin system. By offering multiple re-spin options targeting different aspects of the game state, the system caters to a wide range of player strategies and preferences. The integration of credit management, interactive controls, and dynamic feedback ensures transparency and accessibility, fostering a rewarding and engaging gaming experience. This GUI exemplifies the sophistication and adaptability of modern wager-based slot games, delivering an intuitive and immersive interface that enhances player satisfaction and interaction.

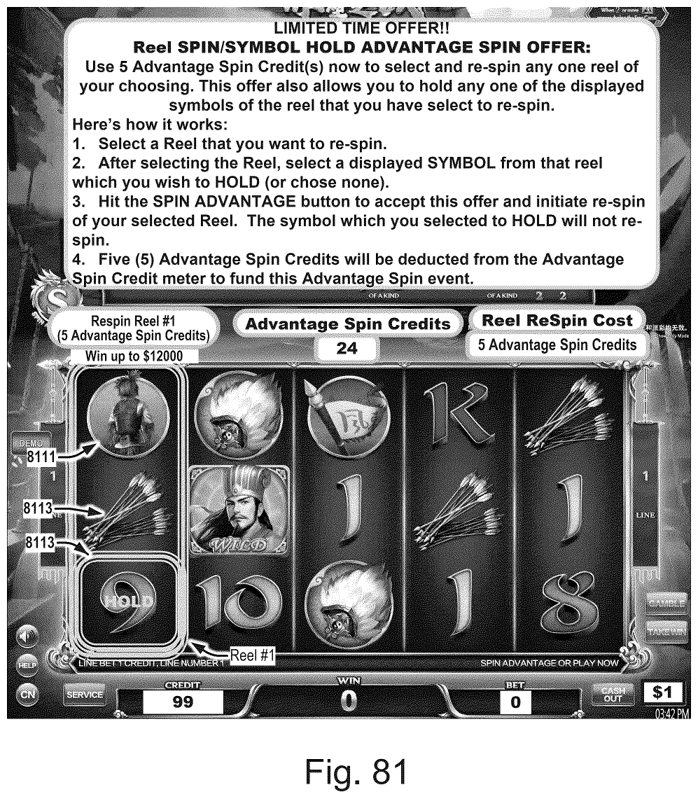

FIG. 81 illustrates an example embodiment of a graphical user interface (GUI) for a wager-based slot game, showcasing a feature-rich Advantage Spin Offer allowing players to re-spin a selected reel while holding a specific symbol displayed on that reel. This scenario highlights the interactive and strategic capabilities of the Advantage Spin system, offering players greater control over gameplay outcomes.

In this example scenario, the Advantage Spin Offer enables players to use five Advantage Spin credits to re-spin a reel of their choice while holding one symbol on that reel. The GUI guides the player through the process, ensuring clarity and ease of interaction. The steps are detailed as follows:
1. Reel Selection: The player selects the reel they wish to re-spin. In this scenario, the player has chosen Reel #1, which is prominently highlighted in the GUI to confirm their selection. The visual emphasis on the selected reel ensures the player is aware of their choice before proceeding.
2. Symbol Selection: After selecting the reel, the player chooses a displayed symbol from that reel to hold during the re-spin. In this example, Symbol #8115 has been selected to hold, as indicated by a visual highlight, such as a glowing outline or distinct animation around the symbol. The GUI allows the player to skip holding a symbol if they wish, providing additional flexibility.
3. Initiation of Re-Spin: The player confirms their choices by pressing the “Spin Advantage” button, either as a virtual button on the touchscreen or as a physical button on the EGM interface. This action initiates the re-spin of the selected reel while ensuring that the held symbol remains static.

During the re-spin event, the non-held symbols on Reel #1 (Symbols #8111 and #8113) are spun, introducing a dynamic and engaging visual element. The GUI prominently displays the spinning motion of the non-held symbols, accompanied by animations and sound effects to enhance the excitement of the event. Once the re-spin concludes, the updated outcomes for the non-held symbols are displayed, seamlessly integrated into the game state.

Notable Features of the GUI in this Scenario:

Dynamic Reel and Symbol Selection: The GUI provides an intuitive interface for selecting the reel to re-spin and the symbol to hold. Highlighting the selected reel and held symbol with animations or visual markers ensures that the player remains confident in their choices throughout the process.

Advantage Spin Credit Meter: The GUI prominently displays the current balance of Advantage Spin credits. Upon accepting the offer and initiating the re-spin, the meter is dynamically updated to reflect the deduction of five Advantage Spin credits, ensuring transparency.

Interactive “Spin Advantage” Button: The “Spin Advantage” button is clearly labeled and placed prominently within the interface, serving as the final step for initiating the re-spin event. This interactive element reinforces player engagement and control.

Real-Time Re-Spin Feedback: During the re-spin event, the GUI emphasizes the motion of the non-held symbols while keeping the held symbol static. This visual distinction enhances the strategic aspect of the feature, as players see the immediate impact of their decision to hold a specific symbol.

Outcome Display: Once the re-spin concludes, the GUI updates to display the new configuration of Reel #1, seamlessly integrating the results with the rest of the game state. Winning combinations or enhanced outcomes are highlighted to ensure clarity and player satisfaction.

Credit Management and Transparency: The deduction of Advantage Spin credits is reflected in real-time on the Advantage Spin credit meter, ensuring that the player remains informed about their remaining resources.

Enhanced Visual and Audio Feedback: The re-spin event is accompanied by thematic animations, sound effects, and other dynamic visual elements that heighten the excitement and immersion of the gaming experience.

### Advantages of the Feature:

This Advantage Spin Offer provides players with a powerful and engaging tool for influencing game outcomes. By allowing reel-specific re-spins and symbol holds, the feature introduces a layer of strategy and personalization to gameplay. Players gain a sense of agency, as their choices directly impact the re-spin results. The integration of visual and audio feedback ensures an immersive experience, while the transparency of the credit management system fosters trust and satisfaction.

By combining interactivity, strategy, and dynamic gameplay, this embodiment exemplifies the innovative and player-centric design of the Advantage Spin system, delivering a highly engaging and rewarding gaming experience.

FIG. 82 illustrates an example embodiment of a graphical user interface (GUI) for a wager-based slot game, showcasing a flat-rate Advantage Spin Offer that enables players to select and re-spin up to a specified maximum number of reels for a fixed cost. This scenario emphasizes flexibility, strategic decision-making, and value-driven gameplay.

In the depicted scenario, the EGM generates an Advantage Spin Offer allowing the player to select and re-spin up to three reels of their choice for a flat rate of five Advantage Spin credits. This offer is prominently displayed within the GUI, ensuring clarity and ease of interaction. The steps involved in this process are as follows:
1. Reel Selection:
   The player is prompted to select up to three reels for the re-spin. The GUI visually highlights the reels as the player selects them, ensuring that the chosen reels are clearly distinguishable from the unselected ones. For example, selected reels may be outlined in a glowing animation or marked with a distinctive icon, reinforcing the player's decisions.
2. Confirmation of Selections:
   After selecting the desired reels, the player presses the “Spin Advantage” button to confirm their choices and accept the Advantage Spin Offer. This interactive button is clearly labeled and positioned prominently within the GUI, facilitating seamless user interaction.
3. Initiation of Re-Spin:
   Upon confirmation, the EGM deducts five Advantage Spin credits from the Advantage Spin credit meter. The meter dynamically updates in real-time to reflect the new balance, ensuring transparency.
   The selected reels spin simultaneously, introducing dynamic visuals and sound effects to heighten the excitement of the event. The non-selected reels remain static, preserving the game state and focusing attention on the active reels.
4. Completion and Outcome Display:
   Once the re-spin is completed, the GUI updates to display the new outcomes of the selected reels. Any winning combinations or enhanced outcomes are prominently highlighted with animations, colors, or other visual effects, ensuring clarity and emphasizing the impact of the player's strategic choices.

In at least one embodiment, this Advantage Spin Offer is limited to a single Advantage Spin event, meaning the selected reels are re-spun once, and the offer concludes upon completion of the event.

Notable Features of the GUI in this Embodiment:

Dynamic Offer Panel: The GUI prominently displays the Advantage Spin Offer, including the flat rate of five Advantage Spin credits, the maximum number of reels that may be selected (three in this case), and clear instructions for accepting the offer. The structured layout ensures that players may easily understand and evaluate the offer.

Interactive Reel Selection Mechanism: The GUI incorporates an intuitive interface for reel selection. Players may click or tap on the reels they wish to re-spin, with visual indicators such as glowing outlines or dynamic animations confirming their selections. This interactive feature enhances the strategic nature of the offer.

Advantage Spin Credit Meter: The current balance of Advantage Spin credits is prominently displayed. The GUI dynamically updates the meter to reflect the deduction of five credits upon acceptance of the offer, ensuring transparency and real-time feedback.

Interactive “Spin Advantage” Button: The “Spin Advantage” button is a central interactive element, serving as the final step for initiating the re-spin. Its placement and labeling ensure ease of use and encourage player engagement.

Dynamic Re-Spin Feedback: During the re-spin event, the GUI emphasizes the motion of the selected reels while keeping the non-selected reels static. This visual distinction maintains clarity and focus, enhancing the overall player experience.

Outcome Highlighting: The GUI seamlessly integrates the outcomes of the re-spin into the game state. Winning combinations or enhanced outcomes are visually highlighted, ensuring that players may immediately see the results of their Advantage Spin.

Enhanced Visual and Audio Feedback: The re-spin event is accompanied by thematic animations, sound effects, and other dynamic visuals that heighten excitement and immersion.

Advantages of this Flat-Rate Feature:

The flat-rate Advantage Spin Offer provides a straightforward and value-driven gameplay opportunity, appealing to players who seek flexibility and control over their gaming strategy. By allowing players to select multiple reels for re-spin at a fixed cost, the feature introduces a layer of customization and strategic depth. The clear and interactive GUI ensures that players may make informed decisions and enjoy a seamless and engaging experience.

This embodiment exemplifies the innovative design of the Advantage Spin system, combining dynamic interactivity, strategic gameplay, and transparent credit management to create a rewarding and immersive gaming environment. By offering a flat-rate option for multiple reel re-spins, the system caters to a broad range of player preferences and enhances overall satisfaction.

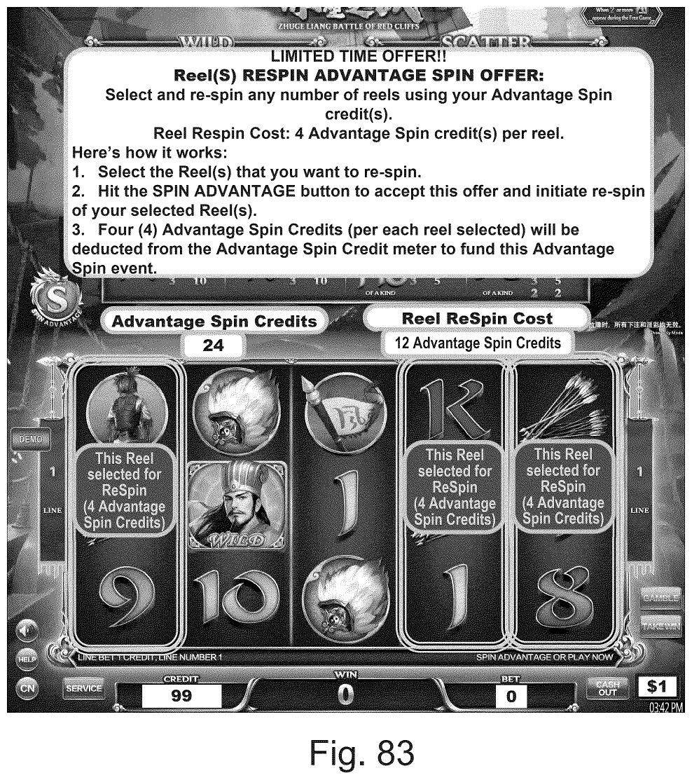

FIG. 83 illustrates an example embodiment of a graphical user interface (GUI) for a wager-based slot game, featuring an Incremental Cost Advantage Spin Offer that allows players to select and re-spin up to a specified maximum number of reels at a fixed cost per reel. This embodiment emphasizes flexibility, player agency, and transparent credit management, enabling players to customize their gameplay strategy.

In the depicted scenario, the EGM generates an Advantage Spin Offer with an incremental cost structure, allowing the player to select any number of reels for re-spin, up to a predefined maximum. The offer specifies a cost of four Advantage Spin credits per reel re-spin, which is clearly displayed within the GUI to ensure transparency. The steps involved in the process are as follows:
1. Reel Selection:
   The player is prompted to select the reels they wish to re-spin. The GUI provides an interactive interface where players may select individual reels by clicking or tapping on them. Each selected reel is highlighted with a glowing outline or animation, visually confirming the player's choices.
2. Cost Calculation:
   As reels are selected, the GUI dynamically updates to display the total cost of the re-spin event. For example, if two reels are selected, the GUI calculates and displays a total cost of eight Advantage Spin credits (4 credits per reel×2 reels). This real-time feedback ensures that players are fully informed of the cost associated with their selections.
3. Initiation of Re-Spin:
   Once the desired reels are selected, the player presses the “Spin Advantage” button to accept the offer and initiate the re-spin. This interactive button is prominently displayed and clearly labeled, facilitating seamless user interaction.
4. Credit Deduction and Re-Spin Execution:
   The EGM deducts the required number of Advantage Spin credits from the Advantage Spin credit meter based on the player's selections. For instance, if three reels are selected, a total of 12 credits are deducted (4 credits×3 reels). The GUI dynamically updates the credit meter to reflect the new balance.
   The selected reels spin simultaneously, accompanied by dynamic animations and sound effects that enhance the excitement of the event. Non-selected reels remain static, preserving the game state and focusing attention on the active reels.
5. Outcome Display:
   Upon completion of the re-spin, the GUI updates to display the new outcomes of the selected reels. Any winning combinations or enhanced outcomes are prominently highlighted with animations, colors, or other visual effects, ensuring clarity and emphasizing the impact of the player's choices.

In at least one embodiment, this Advantage Spin Offer is limited to a single re-spin event, meaning that all selected reels are spun once, and the offer concludes upon completion.

Notable Features of the GUI in this Embodiment:

Dynamic Offer Panel: The GUI prominently displays the Advantage Spin Offer, including the per-reel cost (4 Advantage Spin credits), the maximum number of reels that may be selected, and clear instructions for accepting the offer. This structured layout ensures that players may quickly understand and evaluate the offer.

Interactive Reel Selection Mechanism: The GUI provides an intuitive interface for selecting reels. Players may easily click or tap on their desired reels, with visual indicators such as glowing outlines or animations confirming their selections. The interface updates dynamically to reflect the total cost of the re-spin event.

Credit Management Integration: The GUI displays the current balance of Advantage Spin credits, enabling players to assess their resources before making selections. The real-time cost calculation further ensures transparency and informed decision-making.

Interactive “Spin Advantage” Button: The “Spin Advantage” button serves as the final step for confirming selections and initiating the re-spin. Its prominent placement and clear labeling encourage player engagement and streamline the process.

Dynamic Re-Spin Feedback: During the re-spin event, the GUI emphasizes the motion of the selected reels, while non-selected reels remain static. This distinction ensures clarity and maintains focus on the gameplay action.

Outcome Highlighting: The GUI integrates the results of the re-spin into the broader game state. Winning combinations or enhanced outcomes are visually highlighted, providing immediate feedback on the success of the Advantage Spin.

Enhanced Visual and Audio Feedback: The re-spin event is accompanied by thematic animations, sound effects, and other dynamic visuals that heighten the excitement and immersion of the gaming experience.

Advantages of this Incremental Cost Feature:

This Advantage Spin Offer provides players with a customizable and transparent gameplay option, enabling them to select the number of reels to re-spin based on their strategy and available credits. The incremental cost structure ensures fairness and flexibility, while the dynamic GUI enhances the player experience through real-time updates, intuitive controls, and engaging visuals.

By offering tailored re-spin opportunities with clear cost feedback, this embodiment exemplifies the Advantage Spin system's focus on delivering a rewarding and strategic gaming environment. The combination of player choice, transparent credit management, and immersive design fosters satisfaction and engagement, making this feature a compelling addition to modern wager-based slot games.

FIG. 84 illustrates an example embodiment of a graphical user interface (GUI) for a wager-based slot game, highlighting a flat-rate Advantage Spin Offer that allows players to strategically select and hold up to a specified maximum number of displayed slot reel symbols while re-spinning all non-held symbols. This embodiment emphasizes customization, strategic depth, and a player-driven approach to gameplay.

In this scenario, the Electronic Gaming Machine (EGM) generates an Advantage Spin Offer that enables the player to hold up to six displayed slot reel symbols for a flat cost of five Advantage Spin credits. The offer is prominently displayed within the GUI, clearly outlining the cost, selection options, and instructions for initiating the re-spin. The process is structured as follows:
1. Symbol Selection:
   The player is prompted to select up to six symbols from the currently displayed slot reel configuration to hold. The GUI provides an intuitive interface for symbol selection, where players may click or tap on the desired symbols. Each selected symbol is visually highlighted with animations, glowing outlines, or markers to confirm the selection and differentiate it from non-held symbols.
2. Confirmation of Selections:
   After completing the selection process, the player presses the “Spin Advantage” button to accept the offer and confirm their choices. This button is clearly labeled and prominently positioned within the interface, ensuring ease of interaction.
3. Initiation of Re-Spin:
   Upon confirmation, the EGM deducts five Advantage Spin credits from the Advantage Spin credit meter. The meter dynamically updates to reflect the deduction, ensuring transparency and real-time feedback.
   The re-spin event is initiated, during which all non-held symbols spin while the held symbols remain static. The GUI visually emphasizes the spinning motion of the non-held symbols, creating a dynamic and engaging display.
4. Outcome Display:
   Once the re-spin is completed, the GUI updates to display the new outcomes of the non-held symbols, seamlessly integrating them with the held symbols. Any resulting winning combinations or enhanced outcomes are prominently highlighted with animations, colors, or other visual effects, providing immediate feedback to the player.
      Notable Features of the GUI in this Embodiment:

Dynamic Offer Panel: The GUI prominently displays the Advantage Spin Offer, detailing the flat rate of five Advantage Spin credits, the maximum number of symbols that may be held (six), and clear instructions for accepting the offer. This structured layout ensures clarity and allows players to quickly understand the offer and its benefits.

Interactive Symbol Selection Mechanism: The interface supports intuitive symbol selection, allowing players to click or tap on their desired symbols. Visual indicators, such as glowing outlines or dynamic animations, confirm the selections and distinguish held symbols from non-held ones. This interactivity enhances the strategic element of the feature.

Advantage Spin Credit Meter: The GUI displays the current balance of Advantage Spin credits, enabling players to assess their resources before making selections. The meter updates dynamically to reflect the deduction of five credits upon acceptance of the offer, ensuring transparency.

Interactive “Spin Advantage” Button: The “Spin Advantage” button serves as the final step for confirming selections and initiating the re-spin. Its prominent placement and clear labeling streamline the process and encourage player engagement.

Dynamic Re-Spin Feedback: During the re-spin event, the GUI emphasizes the motion of the non-held symbols while keeping the held symbols static. This visual distinction maintains clarity and focus, enhancing the player's experience.

Outcome Highlighting: The GUI integrates the results of the re-spin into the broader game state. Winning combinations or enhanced outcomes are visually highlighted, ensuring that players may immediately see the results of their Advantage Spin.

Enhanced Visual and Audio Feedback: The re-spin event is accompanied by thematic animations, sound effects, and other dynamic visuals that heighten the excitement and immersion of the gaming experience.

Advantages of this Flat-Rate Feature:

This Advantage Spin Offer introduces a unique layer of strategy by allowing players to hold specific symbols while re-spinning others. The flat-rate cost structure ensures simplicity and accessibility, while the ability to select and hold up to six symbols provides significant customization and control over gameplay. This feature appeals to players seeking to optimize their outcomes by preserving notable symbols while introducing variability through the re-spin of non-held symbols.

By combining strategic decision-making, transparent credit management, and dynamic visuals, this embodiment exemplifies the Advantage Spin system's focus on creating engaging and rewarding gameplay. The GUI's intuitive design, interactive elements, and real-time feedback foster player satisfaction and immersion, making this feature a valuable addition to modern wager-based slot games.

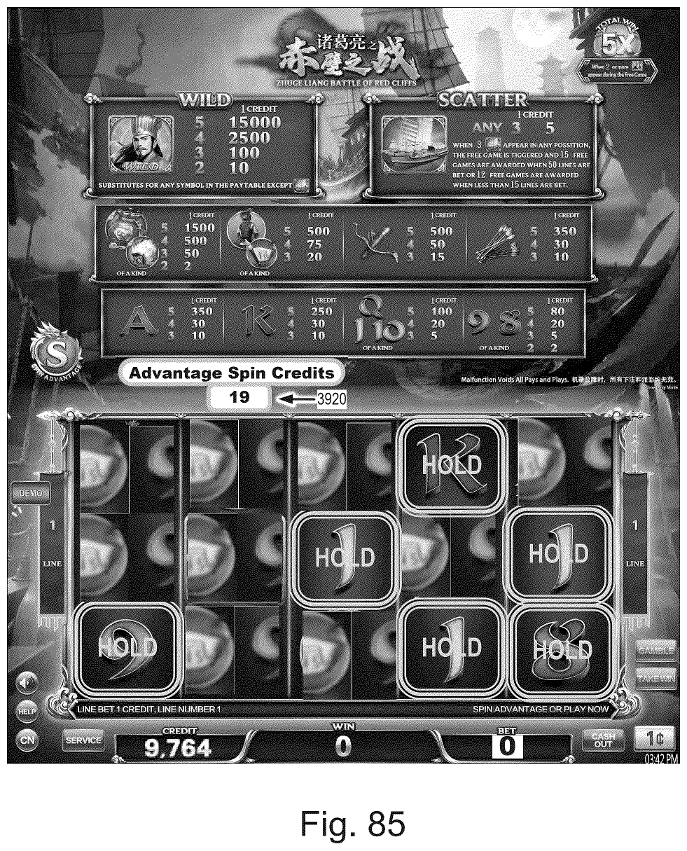

FIG. 85 illustrates an example embodiment of a graphical user interface (GUI) for a wager-based slot game, showcasing the execution phase of a Symbol Hold/Spin Advantage Spin Offer. In this scenario, the player has accepted the offer to hold specific symbols while spinning the remaining non-held symbols. This interface emphasizes the interactive, dynamic, and engaging nature of the Advantage Spin system during active gameplay.

After the player accepts the Symbol Hold/Spin Advantage Spin Offer, the Electronic Gaming Machine (EGM) deducts five Advantage Spin credits from the Advantage Spin credit meter. The GUI immediately updates to reflect the new balance, ensuring transparency and real-time feedback. The EGM then initiates the spinning of all reel symbols that were not selected for hold, creating a visually engaging and strategic gameplay moment.

Notable Features and Actions in this Scenario:

Held Symbol Display: The GUI prominently highlights the held symbols selected by the player during the offer acceptance phase. These symbols remain static and are visually distinguished from the spinning symbols through animations, glowing outlines, or other markers. This visual clarity ensures that players may easily identify which symbols are being preserved throughout the re-spin event.

Dynamic Reel Re-Spin Display: All non-held symbols begin spinning simultaneously, creating an engaging and dynamic display. The spinning symbols are animated to emphasize their motion, drawing the player's attention to the active reels while maintaining the static position of the held symbols. The motion of the non-held symbols introduces anticipation and excitement, enhancing the immersive nature of the gameplay.

Advantage Spin Credit Meter Update: The GUI displays the updated Advantage Spin credit meter, reflecting the deduction of five credits for funding the event. This real-time feedback reinforces the transparency and integrity of the credit management system, ensuring that players are consistently informed of their resource balances.

Interactive and Visual Feedback: The initiation of the re-spin is accompanied by thematic animations and sound effects. For instance, spinning symbols may feature dynamic lighting effects, while held symbols may pulsate or glow, emphasizing their preserved status. These elements enhance player engagement and immersion in the gaming experience.

Outcome Continuity: As the non-held symbols come to rest, the GUI seamlessly integrates the results into the overall game state. The newly spun symbols are displayed alongside the static held symbols, creating a unified visual representation of the updated reel configuration. Any resulting winning combinations or enhanced outcomes are prominently highlighted to ensure clarity and satisfaction.

Thematic and Aesthetic Integration: The GUI design aligns with the slot game's overall theme, incorporating consistent colors, motifs, and animations that contribute to a cohesive and visually appealing gaming environment.

Benefits and Advantages of this Feature:

This Symbol Hold/Spin Advantage Spin Offer introduces a layer of strategy and customization, allowing players to preserve specific symbols while introducing variability through the re-spin of non-held symbols. The ability to strategically hold symbols empowers players to influence game outcomes, creating a sense of agency and control. The integration of dynamic visuals and sound effects enhances the excitement of the re-spin event, while the transparent credit management system fosters trust and confidence.

By combining strategic depth, real-time feedback, and immersive design, this embodiment exemplifies the Advantage Spin system's focus on delivering an engaging and rewarding gaming experience. The GUI's intuitive and visually dynamic interface ensures that players remain actively involved and satisfied throughout the gameplay process. This feature highlights the innovative potential of the Advantage Spin system, making it a valuable addition to modern wager-based slot games.

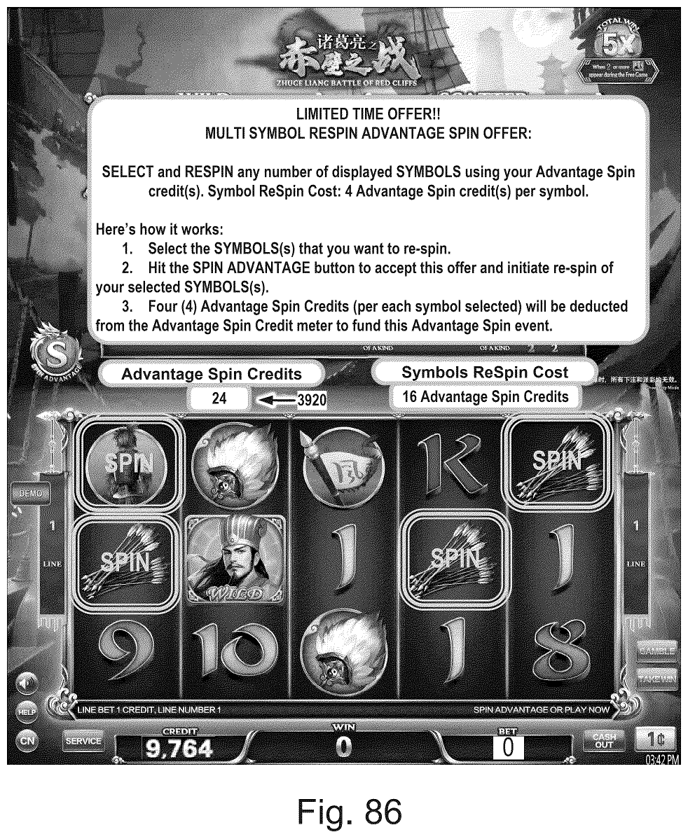

FIG. 86 depicts an example embodiment of a graphical user interface (GUI) for a wager-based slot game, demonstrating the functionality of the Advantage Spin system in an incremental cost embodiment. This embodiment enables players to use Advantage Spin credits to re-spin selected symbols displayed on the slot machine reels, allowing a player to strategically influence game outcomes by targeting specific symbols. The GUI dynamically presents an Advantage Spin Offer to the player, clearly outlining the terms of the offer, including the per-symbol cost of the re-spin and instructions for initiating the process.

The Advantage Spin Offer allows players to re-spin any number of symbols up to a defined maximum (M) using their Advantage Spin credits. The offer specifies the cost per symbol re-spin as four (4) Advantage Spin credits, and this information is prominently displayed on the interface. The GUI is designed to guide players through a simple and intuitive process, ensuring transparency and enhancing engagement. The system includes interactive features to assist players in selecting symbols, confirming their choices, and initiating the re-spin process.

The GUI begins by displaying the Advantage Spin Offer, encouraging players to choose specific symbols for re-spin. Players may interact with the displayed symbols directly through touch-based or other interactive inputs. The system highlights selected symbols visually, providing immediate feedback to confirm the player's choices. This selection mechanism ensures clarity and reduces the likelihood of errors in symbol selection. Once the desired symbols are selected, the GUI calculates the total cost of the re-spin based on the number of selected symbols and the predefined per-symbol cost. For instance, if a player selects three symbols, the interface will display the total cost as twelve (12) Advantage Spin credits, calculated by multiplying the three selected symbols by the four-credit cost per symbol.

After reviewing the cost and verifying their selection, the player may accept the Advantage Spin Offer by pressing the “SPIN ADVANTAGE” button. This control element is centrally located and designed for ease of use, serving as the final step to confirm and execute the re-spin action. Upon activation, the system deducts the corresponding number of Advantage Spin credits from the player's Advantage Spin Credit meter and executes the re-spin action for the selected symbols. Non-selected symbols on the reels remain in their current positions, preserving the integrity of the game state while allowing the player to target specific game elements for re-spin.

The GUI incorporates several notable features to enhance the player experience. The Advantage Spin Credit meter prominently displays the player's current balance of Advantage Spin credits, updating in real-time to reflect any deductions resulting from re-spin activities. Dynamic cost displays ensure that players are fully informed of the total credit requirement before initiating a re-spin. Additionally, the interface uses clear visual markers, such as highlighting or borders, to distinguish selected symbols from non-selected ones, ensuring that players understand which symbols will be re-spun. These features collectively provide transparency and facilitate informed decision-making.

The incremental cost embodiment shown in FIG. 86 introduces significant benefits for both players and casino operators. Players gain greater control over their gaming strategy by being able to target specific symbols for re-spin, thereby increasing the likelihood of achieving favorable outcomes. This level of customization adds strategic depth to the gameplay, transforming the traditional slot machine experience into a more interactive and engaging activity. The clear presentation of costs and mechanics reduces confusion and fosters player trust, while the interactive GUI design ensures a seamless and enjoyable gaming experience.

For casino operators, this embodiment represents an effective tool for increasing player engagement and retention. By integrating a customizable and dynamic gameplay mechanic, the system encourages longer gaming sessions and fosters a stronger connection between the player and the gaming environment. The use of Advantage Spin credits also provides opportunities for targeted promotional activities, as these credits may be awarded through loyalty programs or specific casino promotions, further enhancing the value of the system for both players and operators. This GUI exemplifies the Advantage Spin system's ability to merge strategy, engagement, and transparency into a unified and highly effective gaming feature.

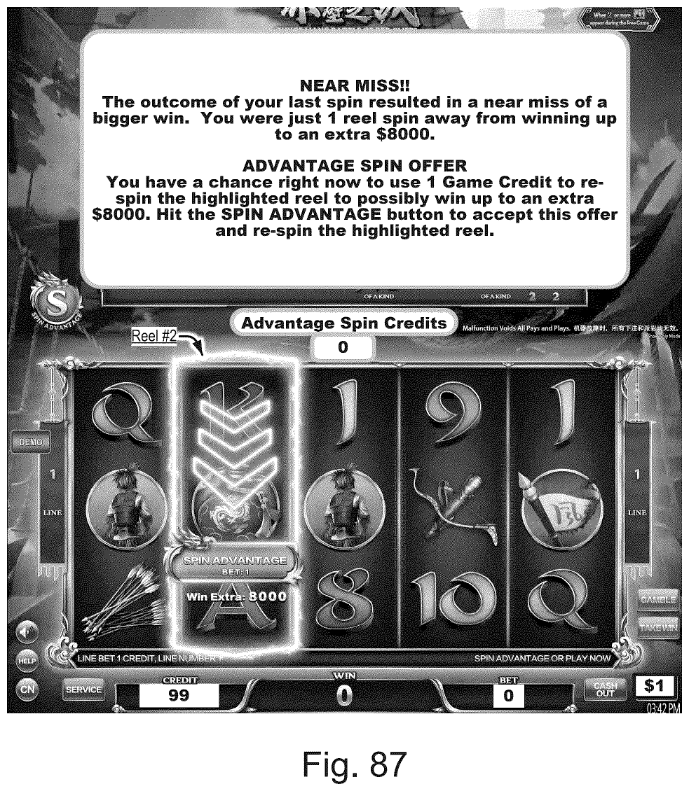

FIG. 87 illustrates a graphical user interface (GUI) designed for a wager-based slot game, demonstrating the dynamic capabilities of the Advantage Spin system to respond to near-miss scenarios. This example showcases a scenario where the outcome of the player's previous spin narrowly missed achieving a significantly higher win. The interface leverages this moment to present an Advantage Spin Offer, enticing the player to re-spin a specific reel (Reel #2) using a single Game Credit, with the potential to win up to an additional $8,000. This dynamic offer aims to heighten player engagement and capitalize on the emotional impact of the near-miss experience.

The interface prominently displays the “NEAR MISS!!” notification, drawing the player's attention to the significance of their last spin's outcome. This notification is accompanied by an explanatory message detailing the nature of the near miss, emphasizing that the player was just one reel spin away from a substantial reward. This message establishes the context for the Advantage Spin Offer and reinforces the perceived value of the opportunity being presented. The system highlights Reel #2, visually distinguishing it from the other reels, to indicate the specific game element that may be re-spun as part of the offer. This clear and intuitive design ensures that players immediately understand the targeted reel and the potential benefits of engaging with the Advantage Spin Offer.

The Advantage Spin Offer is prominently displayed in the GUI, specifying the terms of the opportunity. In this embodiment, the offer states that the player may use one (1) Game Credit to re-spin the highlighted reel for a chance to win up to an additional $8,000. The offer is time-sensitive and encourages immediate action, leveraging the player's emotional connection to the near-miss outcome. The “SPIN ADVANTAGE” button is clearly positioned within the interface as the primary interactive element for accepting the offer. By pressing this button, the player initiates the re-spin of the highlighted reel and commits one Game Credit from their balance.

Upon acceptance of the offer, the system deducts one Game Credit from the player's balance and executes the re-spin of Reel #2. The outcome of this re-spin determines whether the player secures the potential win associated with the near-miss scenario. The GUI dynamically updates to reflect the new game state, providing immediate feedback on the results of the re-spin and any resulting changes to the player's credit balance or win total.

Several notable design elements enhance the effectiveness of this interface. The visual distinction of the highlighted reel ensures that the player understands the specific target of the re-spin. The use of prominent text and dynamic colors for the “NEAR MISS!!” notification captures attention and amplifies the emotional impact of the offer. The Advantage Spin Offer's clear language and specific terms make it easy for the player to evaluate the opportunity, while the placement of the “SPIN ADVANTAGE” button facilitates a seamless transition from decision-making to action.

This embodiment of the Advantage Spin system provides multiple benefits. For players, it creates an engaging and emotionally resonant gaming experience by offering a second chance to capitalize on a near-miss outcome. The system encourages strategic decision-making by enabling players to weigh the cost of the re-spin against the potential reward. For casino operators, this feature increases player retention and engagement by extending the lifecycle of each spin and leveraging emotionally charged moments to drive additional gameplay. The use of Game Credits for the re-spin also integrates seamlessly with broader loyalty and reward programs, enhancing the overall value proposition of the Advantage Spin system.

The GUI in This example exemplifies the Advantage Spin system's ability to transform standard gameplay into a dynamic and interactive experience. By addressing near-miss scenarios with targeted offers, the system fosters deeper player involvement and creates memorable gaming moments that enhance both player satisfaction and casino revenue.

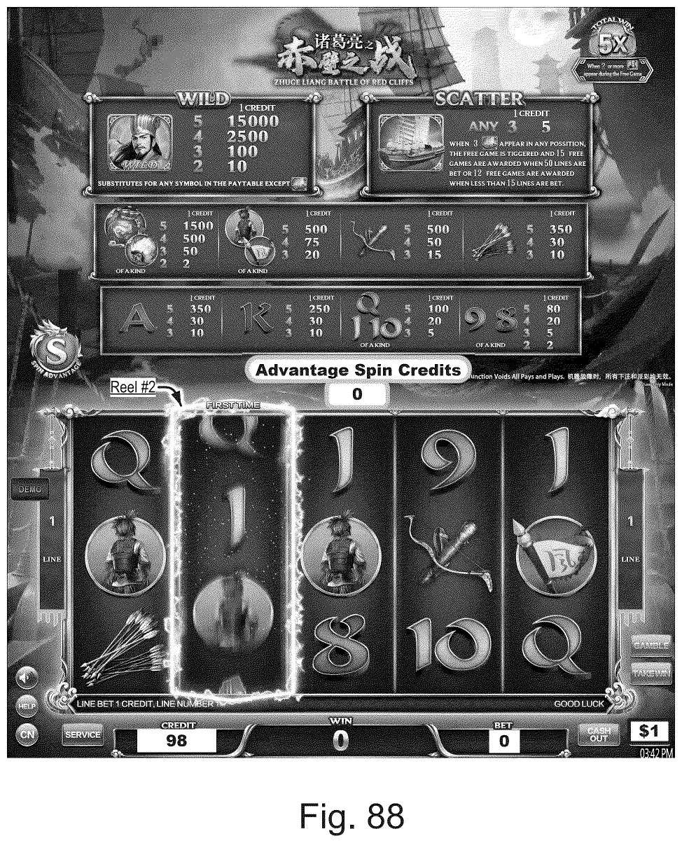

FIG. 88 illustrates a graphical user interface (GUI) designed for a wager-based slot game, demonstrating the execution phase of an Advantage Spin opportunity. This scenario captures the sequence of actions following the player's decision to consume an Advantage Spin credit to initiate a re-spin of Reel #2. The interface is designed to provide clear feedback and a seamless transition from the player's decision to the execution of the Advantage Spin opportunity, ensuring an engaging and transparent user experience.

The GUI begins by prominently indicating that the player has elected to use one Advantage Spin credit from the Electronic Gaming Machine's (EGM) Game Credit meter. This decision triggers the initiation of the identified Advantage Spin opportunity, which in this case involves re-spinning Reel #2. The interface clearly highlights Reel #2, visually distinguishing it from the other reels to reaffirm the targeted game element. This visual cue ensures that the player is fully aware of the scope of the re-spin and the associated game dynamics.

Upon consuming the Advantage Spin credit, the system updates the Game Credit meter to reflect the deduction. This real-time feedback is displayed prominently within the GUI, ensuring that the player immediately observes the impact of their decision on their available credits. The deduction of one Game Credit is dynamically rendered, reinforcing the transparency of the transaction and maintaining the player's confidence in the system's functionality.

As the re-spin is initiated, the GUI animates Reel #2 to indicate active gameplay. This animation is synchronized with the re-spin process, providing a visually engaging representation of the event. The other reels remain static, maintaining their prior positions and visually underscoring the selective nature of the Advantage Spin opportunity. This design choice preserves the integrity of the game state while emphasizing the player's strategic input in targeting specific reels.

During the execution phase, the GUI may temporarily display informational messages or animations to enhance player engagement. For instance, celebratory graphics or text may appear to build anticipation for the re-spin outcome. Once the re-spin concludes, the GUI updates to display the results of the re-spin, including any changes to the game state, potential winnings, or adjustments to other meters such as the cash credit meter.

The GUI also provides contextual information about the initiated Advantage Spin opportunity. Text overlays or highlighted sections in the interface communicate the cost of the re-spin, the targeted reel, and the potential rewards, ensuring that the player remains informed throughout the process. The placement of this information within the GUI is intuitive, minimizing distractions and allowing the player to focus on the gameplay.

This embodiment of the Advantage Spin system introduces several notable benefits. For players, it enhances the strategic and interactive elements of slot gameplay by allowing targeted actions with immediate visual and operational feedback. The clear presentation of costs and outcomes fosters trust and reinforces the value of using Advantage Spin credits. For casino operators, this feature increases player engagement by extending gameplay sessions and integrating dynamic credit-based mechanics into the gaming experience. The system also encourages the use of Advantage Spin credits as a strategic resource, aligning with broader goals of player retention and satisfaction.

The GUI in This example exemplifies the Advantage Spin system's capability to seamlessly integrate player-directed opportunities into slot gameplay. By focusing on real-time feedback, clear visual cues, and engaging animations, the interface ensures a compelling and enjoyable experience for the player while maintaining operational transparency and efficiency. This approach highlights the innovative nature of the Advantage Spin system, transforming traditional slot machine mechanics into an interactive and dynamic gaming platform.

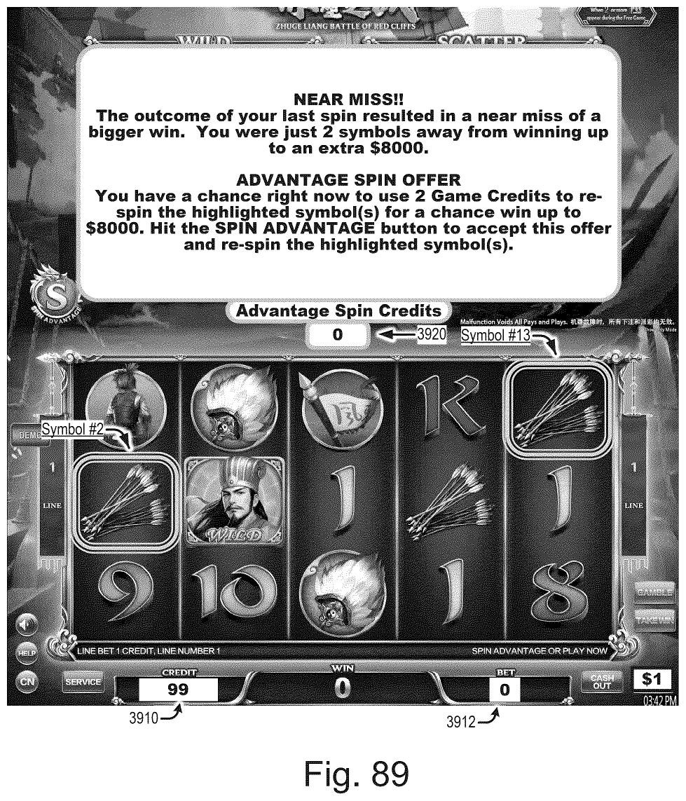

FIG. 89 illustrates a graphical user interface (GUI) for a wager-based slot game, showcasing the Advantage Spin system's ability to present a targeted offer following a near-miss event involving multiple symbols. This scenario demonstrates how the system dynamically generates an Advantage Spin Offer when the player's last spin narrowly missed a larger win. The offer allows the player to re-spin two specific symbols (Symbol #2 and Symbol #13) using two Game Credits for another chance to win up to $8,000. The GUI is designed to enhance player engagement by emphasizing the significance of the near-miss and providing an opportunity for strategic intervention.

The interface prominently displays a “NEAR MISS!!” notification, immediately capturing the player's attention. The notification explains that the outcome of the previous spin was only two symbols away from a significant win of up to $8,000. This messaging heightens the emotional impact of the near-miss event, making the subsequent Advantage Spin Offer more compelling. The system highlights the two targeted symbols, Symbol #2 and Symbol #13, using visual markers such as borders, color changes, or animation. These markers make it clear which symbols are eligible for the re-spin and reinforce the specificity of the offer.

The Advantage Spin Offer is prominently positioned within the GUI, detailing the terms of the opportunity. It specifies that the player may re-spin the highlighted symbols by using two Game Credits. The potential reward of up to $8,000 is clearly stated to encourage player participation. The offer is further accompanied by a “SPIN ADVANTAGE” button, which serves as the primary control for accepting the offer and initiating the re-spin of the highlighted symbols.

Once the player accepts the offer by pressing the “SPIN ADVANTAGE” button, the system deducts two Game Credits from the player's balance. This deduction is immediately reflected in the Game Credit meter, providing real-time feedback and maintaining transparency. The GUI animates the re-spin of the highlighted symbols while the remaining symbols on the reels remain static. This design emphasizes the targeted nature of the Advantage Spin and preserves the integrity of the game state.

During the execution phase, the GUI may display additional animations or messaging to build anticipation for the re-spin outcome. Once the re-spin concludes, the interface updates to reflect the new game state, including any changes to the player's credit balance, potential winnings, or other gameplay metrics. If the re-spin results in a win, celebratory graphics or text may be displayed to enhance the player's satisfaction and reinforce the value of the Advantage Spin system.

This embodiment provides multiple benefits for players. It allows for targeted intervention in gameplay, enabling strategic decisions that may improve outcomes. The clear presentation of the offer terms and costs ensures that players may make informed choices, while the emotional resonance of the near-miss scenario increases engagement. For casino operators, this feature extends player interaction with the game and promotes the use of Advantage Spin credits, potentially increasing revenue and player retention.

The GUI in This example exemplifies the Advantage Spin system's ability to transform near-miss events into dynamic gameplay opportunities. By integrating visual feedback, real-time updates, and strategic decision-making elements, the interface creates an engaging and memorable gaming experience that enhances both player enjoyment and operator profitability. This implementation highlights the system's innovative approach to combining emotional triggers with interactive gameplay mechanics.

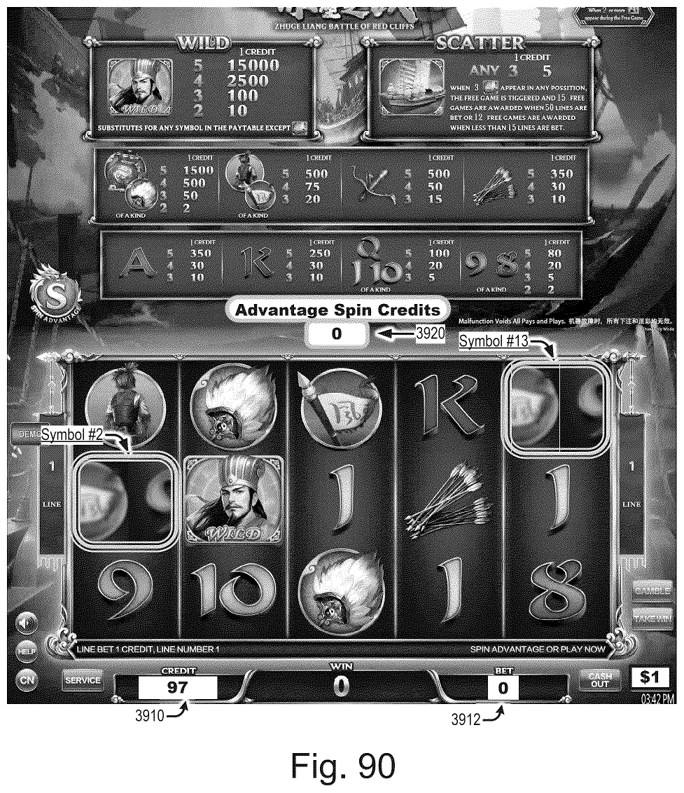

FIG. 90 illustrates a graphical user interface (GUI) for a wager-based slot game, demonstrating the execution phase of a multi-symbol Advantage Spin opportunity. This scenario builds upon the offer presented in FIG. 89, wherein the player has elected to consume two Advantage Spin credits to re-spin two highlighted symbols, Symbol #2 and Symbol #13, in pursuit of a potential win of up to $8,000. The interface is designed to seamlessly transition from the offer acceptance to the execution of the Advantage Spin, providing real-time feedback and visually engaging animations.

Upon the player's acceptance of the Advantage Spin offer, the GUI initiates the execution process by deducting two Game Credits from the EGM's Game Credit meter. This deduction is displayed in real-time, ensuring transparency and reinforcing the player's confidence in the system. The Game Credit meter is prominently positioned within the interface, and its updated balance reflects the transaction immediately.

The GUI highlights the two symbols selected for re-spin, Symbol #2 and Symbol #13, through visual markers such as distinct borders, color changes, or animations. These markers persist throughout the execution phase to maintain clarity regarding the targeted symbols. As the re-spin begins, dynamic animations are displayed to indicate that the two highlighted symbols are spinning independently of the other symbols on the reels. These animations are synchronized with the system's internal processes and are designed to captivate the player's attention, creating an immersive gaming experience.

The remaining symbols on the reels retain their positions, emphasizing the selective nature of the Advantage Spin opportunity. This design preserves the game state and highlights the player's strategic input in targeting specific symbols for re-spin. The animations for Symbol #2 and Symbol #13 are visually distinct, signaling their active participation in the Advantage Spin event while maintaining a cohesive aesthetic with the rest of the game interface.

As the re-spin animations conclude, the GUI updates to display the outcome of the re-spin for the two targeted symbols. If the re-spin results in a winning combination, the interface prominently highlights the win amount, accompanied by celebratory graphics or animations to enhance the player's sense of achievement. Any resulting changes to the player's credit balance or other game metrics are also updated in real-time. If no win occurs, the GUI smoothly transitions back to the standard gameplay interface, ensuring a seamless continuation of the player's session.

This embodiment of the Advantage Spin system offers significant benefits to players and casino operators. For players, it provides a visually engaging and interactive experience, emphasizing their role in influencing game outcomes. The dynamic animations and real-time feedback enhance the enjoyment and immersion of the gameplay. The targeted nature of the re-spin opportunity adds strategic depth, allowing players to focus their resources on high-value game elements.

For casino operators, this feature increases player retention by extending gameplay sessions and creating emotionally resonant moments tied to strategic decisions. The consumption of Advantage Spin credits further incentivizes participation in loyalty and promotional programs, enhancing the overall value of the gaming ecosystem.

This example exemplifies the Advantage Spin system's ability to integrate dynamic gameplay mechanics with transparent feedback and engaging visuals. By focusing on player choice and interaction, the interface transforms traditional slot machine gameplay into a strategic and immersive experience, reinforcing the innovative potential of the Advantage Spin technology.

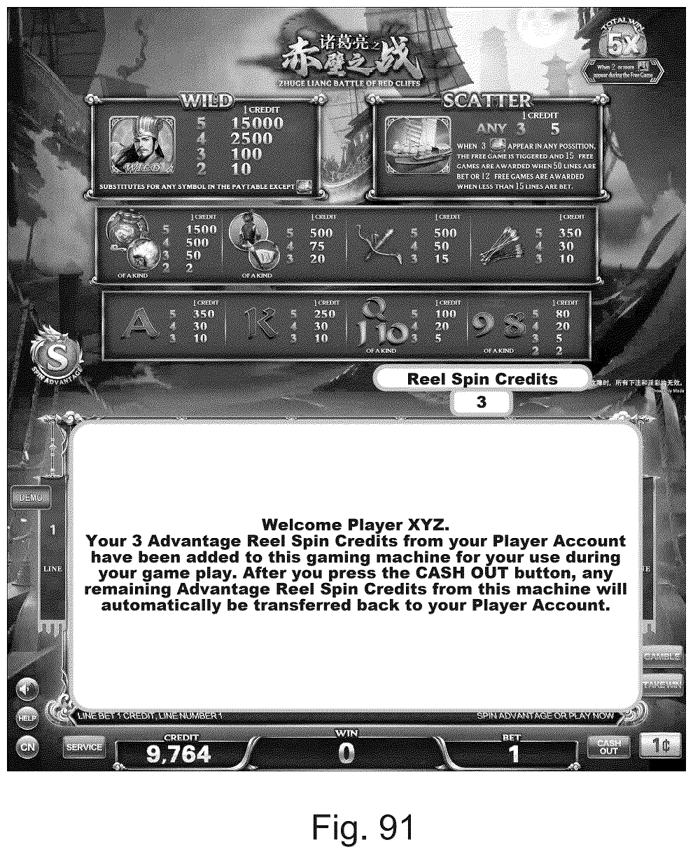

FIG. 91 illustrates a graphical user interface (GUI) designed for a wager-based slot game, showcasing the process by which an Electronic Gaming Machine (EGM) integrates Advantage Spin credits from a physical or digital Advantage Spin Credit Voucher into its credit system. This scenario demonstrates the seamless interaction between the player's account and the EGM, ensuring the accurate retrieval, deduction, and allocation of Advantage Spin credits. The GUI reflects real-time updates to the relevant credit meters, providing players with transparency and a streamlined experience.

The process begins when the player inserts an Advantage Spin Credit Voucher into the EGM's bill validator. The EGM reads the voucher and extracts notable details, including the Voucher ID, Validation Code, and associated credit information. Concurrently, the EGM identifies the player by reading their Player Account card or utilizing another authentication method to access the player's account. The GUI prominently displays a confirmation message indicating that the voucher has been successfully read and processed, reinforcing player confidence in the transaction.

Once the player's account is accessed, the system retrieves information related to the Advantage Reel Spin Credits available in the account. The GUI provides a clear and intuitive presentation of the retrieved account information, ensuring that the player is fully informed of their credit balance before any deductions or transfers are made. The interface visually distinguishes Advantage Reel Spin Credits from other credit types, such as standard Game Credits or Advantage Symbol Spin Credits, emphasizing the specificity of the transaction.

Following the retrieval of account information, the system deducts three (3) Advantage Reel Spin Credits from the player's account. Simultaneously, the same number of credits is added to the EGM's Advantage Reel Spin Credit meter. The GUI dynamically updates to reflect these changes, displaying the new balances in both the player's account and the EGM's credit meter. This real-time feedback ensures transparency and enhances the player's trust in the system's accuracy.

To further engage the player, the GUI may incorporate animations or visual effects to highlight the credit transfer process. For example, graphical representations of credits moving from the account to the meter may provide a visually engaging way to communicate the transaction. Additionally, the GUI includes confirmation messages summarizing the transaction, such as, “3 Advantage Reel Spin Credits successfully transferred to the EGM.”

The interface also maintains a clear and organized layout, with dedicated sections for each type of credit meter. The Advantage Reel Spin Credit meter is prominently displayed alongside other meters, such as the standard Game Credit meter, allowing players to easily monitor their available resources. This clarity ensures that players understand the distinction between different credit types and their respective uses in gameplay.

This embodiment of the Advantage Spin system provides significant benefits for both players and casino operators. For players, it offers a transparent and efficient method for managing and utilizing Advantage Spin credits, enhancing their overall gaming experience. The seamless integration of player accounts and EGM systems allows for quick and accurate transactions, reducing wait times and potential frustrations. Additionally, the visual design and real-time updates create an engaging and interactive experience that fosters player satisfaction.

For casino operators, this feature promotes the use of Advantage Spin credits as a valuable resource within the gaming ecosystem. By encouraging players to engage with loyalty programs and utilize their earned credits, operators may increase player retention and maximize the value of promotional activities. The integration of credit vouchers with the EGM also provides opportunities for targeted marketing and personalized offers, further enhancing player engagement.

This example exemplifies the Advantage Spin system's ability to combine innovative credit management with intuitive interface design. By focusing on transparency, efficiency, and engagement, this implementation transforms the traditional credit transaction process into a dynamic and player-friendly experience, reinforcing the value of the Advantage Spin technology.

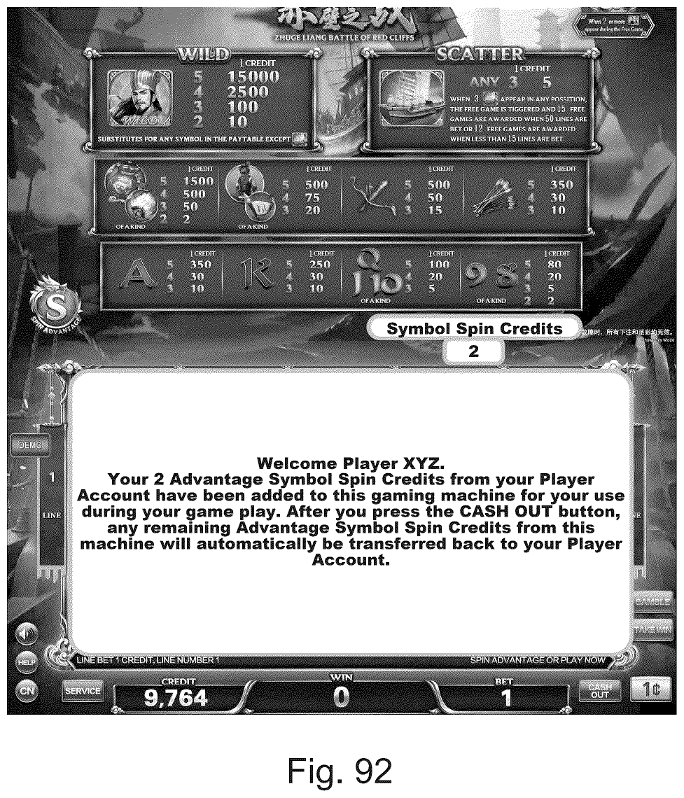

FIG. 92 illustrates a graphical user interface (GUI) designed for a wager-based slot game, depicting the integration and management of Advantage Symbol Spin Credits during an active gaming session. This scenario highlights the seamless interaction between a player's account and the Electronic Gaming Machine (EGM), where Advantage Symbol Spin Credits are transferred from the player's account to the EGM's Symbol Spin Credit meter. The GUI provides real-time feedback and ensures transparency throughout the transaction process, creating an intuitive and engaging experience for the player.

The scenario begins with the player initiating an active gaming session at the EGM. Upon starting the session, the EGM reads the player's account information through a Player Account card or an alternative identification method. This identification step ensures secure access to the player's associated account and enables the retrieval of account-specific data. The GUI prominently displays a confirmation message indicating that the player has been successfully identified, along with their account details.

Once the player's account is accessed, the EGM retrieves information related to the player's available Advantage Symbol Spin Credits. The GUI organizes this information clearly, distinguishing Advantage Symbol Spin Credits from other credit types such as Advantage Reel Spin Credits or Game Credits. This separation helps the player understand the specific credits available for use in symbol re-spin activities.

Following the retrieval of account data, the system deducts two (2) Advantage Symbol Spin Credits from the player's account. Simultaneously, the EGM adds two Advantage Symbol Spin Credits to its Symbol Spin Credit meter. These transactions are reflected in real-time on the GUI. The player's account balance for Advantage Symbol Spin Credits is updated to show the deduction, while the EGM's Symbol Spin Credit meter displays the corresponding increase. This immediate feedback enhances transparency and provides players with confidence in the system's functionality.

The GUI includes additional visual elements to enhance the transaction process. For example, animations may depict the transfer of credits from the player's account to the EGM's meter, creating a dynamic and engaging user experience. The interface also incorporates a confirmation message summarizing the transaction, such as, “2 Advantage Symbol Spin Credits successfully transferred to the EGM.” This message ensures that players are fully informed of the transaction details.

The layout of the GUI is designed to prioritize clarity and usability. The Advantage Symbol Spin Credit meter is prominently displayed alongside other credit meters, such as the Game Credit meter, allowing players to easily monitor their resources. The use of distinct sections for each credit type ensures that players may quickly identify their available credits and their specific applications in gameplay.

This embodiment provides significant benefits for both players and casino operators. For players, it offers a straightforward and efficient method for managing Advantage Symbol Spin Credits, enhancing the overall gaming experience. The real-time updates and transparent feedback foster trust in the system and create a sense of control over credit usage. The integration of player accounts with the EGM simplifies the process of utilizing earned credits, reducing friction and enabling seamless gameplay.

For casino operators, this feature supports broader player engagement and loyalty strategies. By encouraging the use of Advantage Symbol Spin Credits, operators may incentivize participation in loyalty programs and promotional activities. The ability to track and manage these transactions also provides valuable data for personalized marketing efforts and player retention initiatives.

This example demonstrates the Advantage Spin system's capability to integrate innovative credit management with user-friendly interface design. By focusing on real-time feedback, clear visuals, and engaging animations, this implementation enhances the player experience while supporting operational goals for casinos. The seamless transfer and transparent presentation of Advantage Symbol Spin Credits highlight the system's potential to transform traditional credit management into an interactive and dynamic component of slot gameplay.

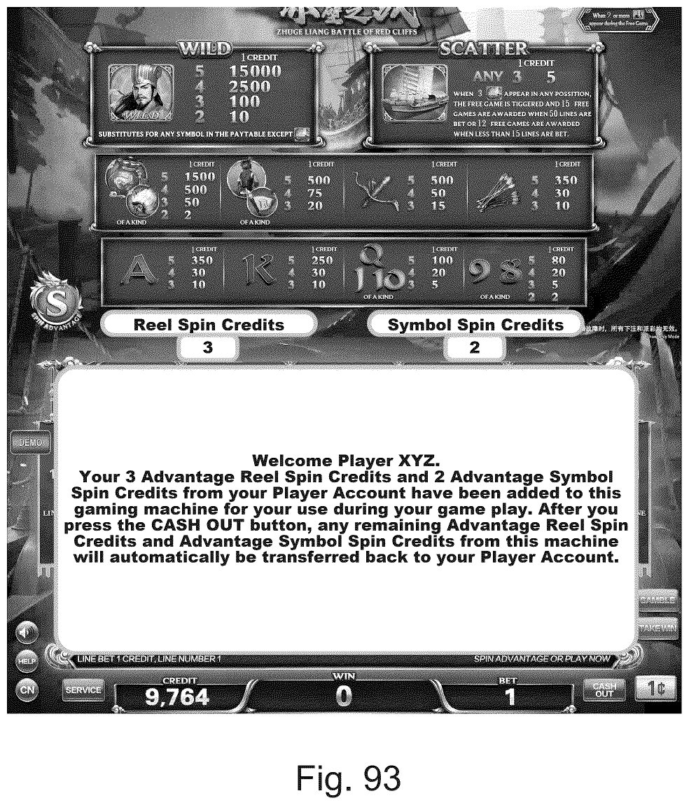

FIG. 93 illustrates a graphical user interface (GUI) for a wager-based slot game, demonstrating the simultaneous management of multiple credit types-Advantage Symbol Spin Credits and Advantage Reel Spin Credits. This scenario highlights the ability of an Electronic Gaming Machine (EGM) to access a player's account, retrieve credit balances for both types of Advantage Spin credits, and update the respective credit meters in real-time. The GUI ensures transparency and provides players with immediate feedback on these transactions, enhancing the gaming experience.

The process begins with the player initiating an active gaming session at the EGM. The EGM identifies the player by reading their Player Account card or through an alternative identification method, securely linking the session to the player's associated account. The GUI confirms the successful identification, displaying relevant account information to the player.

Once the player's account is accessed, the EGM retrieves data regarding the player's available Advantage Symbol Spin Credits and Advantage Reel Spin Credits. The GUI organizes and presents this information clearly, with separate sections for each credit type. This distinction ensures that players may easily understand the specific credits available and their respective applications in gameplay.

The system then performs two simultaneous transactions. First, two (2) Advantage Symbol Spin Credits are deducted from the player's account and added to the EGM's Symbol Spin Credit meter. Second, three (3) Advantage Reel Spin Credits are deducted from the player's account and added to the EGM's Advantage Reel Spin Credit meter. These transactions are displayed in real-time on the GUI, with updated balances for both the player's account and the respective EGM credit meters.

The GUI enhances this process through dynamic visual elements. Animations may depict the transfer of credits from the player's account to the EGM's meters, providing a visually engaging representation of the transactions. Separate confirmation messages are displayed for each credit type, summarizing the actions performed. For example, one message may state, “2 Advantage Symbol Spin Credits successfully transferred to the EGM,” while another indicates, “3 Advantage Reel Spin Credits successfully transferred to the EGM.”

The interface layout prioritizes clarity and usability. The Symbol Spin Credit meter and Reel Spin Credit meter are prominently displayed alongside other meters, such as the Game Credit meter, allowing players to monitor all their resources in one place. Each meter is visually distinct and clearly labeled, ensuring that players may quickly identify their available credits for specific gameplay activities.

This embodiment of the Advantage Spin system provides several benefits. For players, it offers a streamlined and efficient way to manage multiple credit types within a single gaming session. The real-time updates and clear visual feedback foster trust in the system and create a sense of control over credit usage. The ability to seamlessly transfer credits from the player's account to the EGM reduces friction and ensures a smooth gameplay experience.

For casino operators, this feature enhances engagement by encouraging the use of multiple credit types. By integrating both Symbol Spin and Reel Spin credits, operators may provide players with more diverse gameplay options, promoting longer sessions and increased participation in loyalty programs. The ability to track and manage these transactions also supports data-driven marketing strategies and personalized player experiences.

This example exemplifies the Advantage Spin system's capability to handle complex credit transactions with transparency and efficiency. By incorporating real-time feedback, dynamic visuals, and intuitive interface design, this implementation enhances the player experience while supporting operational objectives for casinos. The integration of multiple credit types into a single session demonstrates the system's flexibility and its potential to elevate traditional slot gameplay into a more interactive and rewarding experience.

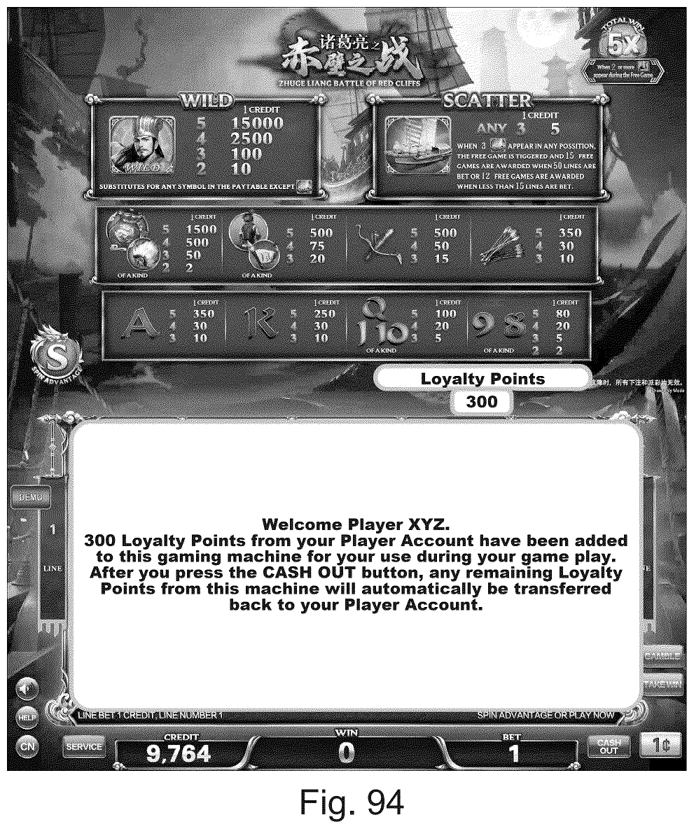

FIG. 94 illustrates a graphical user interface (GUI) for a wager-based slot game, showcasing the process of transferring Loyalty Points from a player's account to the Electronic Gaming Machine's (EGM) Advantage Spin Loyalty Point meter. This scenario highlights the integration of Loyalty Points into the Advantage Spin system, enabling players to utilize these points for gameplay enhancements. The GUI provides a seamless and transparent experience, ensuring real-time updates and visual feedback for the player.

The scenario begins with the player inserting an Advantage Spin Credit Voucher into the EGM's bill validator. The EGM reads the voucher and simultaneously identifies the player by accessing their Player Account card or using an alternative identification method. This step securely links the transaction to the player's account and ensures accurate processing. The GUI confirms the successful reading of the voucher and player identification, displaying relevant details on the screen.

Upon accessing the player's account, the system retrieves information related to the Loyalty Points balance earned by the player. This data is clearly presented in the GUI, separated from other credit types such as Advantage Symbol Spin Credits or Advantage Reel Spin Credits, to ensure clarity and prevent confusion. The interface provides a clear visual representation of the available Loyalty Points, preparing the player for the subsequent transaction.

The system then deducts 300 Loyalty Points from the player's account and transfers them to the EGM's Advantage Spin Loyalty Point meter. This transaction is reflected in real-time on the GUI. The player's account balance for Loyalty Points is updated to show the deduction, while the Advantage Spin Loyalty Point meter on the EGM displays the corresponding increase. This immediate feedback ensures transparency and reassures the player of the transaction's accuracy.

The GUI incorporates dynamic visual elements to enhance the transaction process. For example, animations may depict the movement of Loyalty Points from the player's account to the EGM's meter, providing a visually engaging representation of the transfer. A confirmation message is displayed on the screen, summarizing the action, such as, “300 Loyalty Points successfully transferred to the EGM's Advantage Spin Loyalty Point meter.” This message reinforces the transparency of the transaction and ensures the player remains informed.

The layout of the GUI is designed for ease of use and clarity. The Advantage Spin Loyalty Point meter is prominently displayed alongside other credit meters, such as the Game Credit meter or Advantage Spin meters for Symbol and Reel Spins. This arrangement allows players to monitor their resources in one unified interface. Each meter is clearly labeled, ensuring that players may quickly identify their available Loyalty Points and their specific applications in gameplay.

This embodiment offers significant benefits for players and casino operators. For players, it provides a convenient and efficient way to utilize Loyalty Points for gameplay, enhancing the overall gaming experience. The real-time updates and visual feedback foster trust in the system, while the integration of Loyalty Points expands the range of options available for engaging with the Advantage Spin system.

For casino operators, this feature supports loyalty programs by incentivizing players to earn and redeem Loyalty Points during gameplay. The integration of these points into the EGM system enhances player engagement and promotes extended gaming sessions. Additionally, the ability to track and manage these transactions provides valuable data for personalized marketing strategies and player retention efforts.

This example exemplifies the Advantage Spin system's ability to incorporate diverse credit types, such as Loyalty Points, into a unified and engaging gameplay experience. By focusing on real-time feedback, dynamic visuals, and intuitive interface design, this implementation enhances the player experience while supporting operational goals for casinos. The seamless integration of Loyalty Points into the Advantage Spin system highlights its flexibility and potential to enrich traditional slot gameplay.

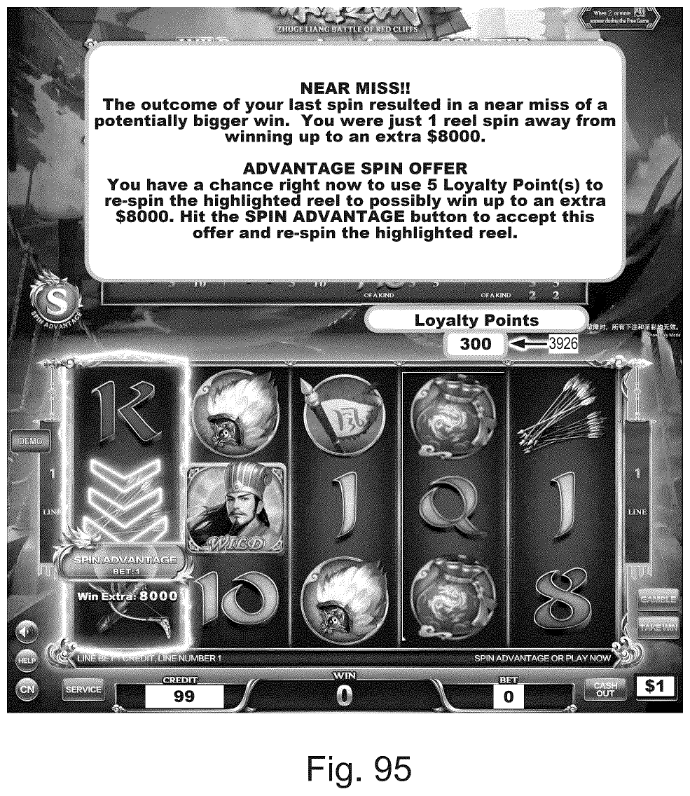

FIG. 95 depicts a graphical user interface (GUI) for a wager-based slot game, showcasing the dynamic presentation of an Advantage Spin Offer in response to a near-miss event. In this scenario, the player's previous spin resulted in a near miss of a significant win, narrowly missing a chance to win up to $8,000. The system leverages this moment to present an offer that allows the player to re-spin a specific highlighted reel using Loyalty Points. The GUI is designed to capture the player's attention, emphasize the significance of the near-miss, and facilitate an engaging and seamless interaction.

The interface prominently displays a “NEAR MISS!!” notification to alert the player to the notable game event. This notification is accompanied by an explanatory message indicating that the player was just one reel spin away from a potentially larger win. The highlighted reel, visually distinguished through animations, borders, or color changes, indicates the target for the Advantage Spin Offer. This clear visual marker ensures the player understands the specific game element associated with the offer.

The Advantage Spin Offer is prominently displayed below the notification, detailing the terms of the opportunity. The offer specifies that the player may use five (5) Loyalty Points to re-spin the highlighted reel for another chance to win up to $8,000. This explicit cost and reward structure enables the player to make an informed decision. The inclusion of the “SPIN ADVANTAGE” button provides a straightforward mechanism for accepting the offer and initiating the re-spin. Its prominent placement within the GUI ensures ease of access, encouraging immediate player action.

If the player accepts the offer, the system deducts five Loyalty Points from their Advantage Spin Loyalty Point meter. This deduction is reflected in real-time on the GUI, which updates the meter to display the adjusted balance. Simultaneously, the highlighted reel is animated to indicate the start of the re-spin process. The animation distinguishes the re-spinning reel from the static reels, reinforcing the targeted nature of the Advantage Spin.

During the re-spin execution, the GUI may display additional animations or celebratory graphics to enhance the player's anticipation. Upon completion of the re-spin, the GUI updates to display the results, including any changes to the player's winnings, credit balances, or game state. If the re-spin results in a win, the interface highlights the reward with prominent graphics or messages to celebrate the achievement.

This embodiment of the Advantage Spin system introduces significant benefits for both players and casino operators. For players, it transforms a near-miss moment into an opportunity for strategic engagement, creating a heightened sense of excitement and control. The use of Loyalty Points as currency for the re-spin expands the range of options for participating in Advantage Spin offers, fostering a sense of value and flexibility. The clear presentation of the offer and the real-time feedback throughout the process ensure transparency and build trust in the system.

For casino operators, this feature leverages emotional triggers associated with near-miss events to drive player engagement and extend gaming sessions. By integrating Loyalty Points into the Advantage Spin system, operators may incentivize player participation in loyalty programs and encourage the redemption of earned points. The dynamic and visually engaging interface further enhances the player experience, promoting repeat play and increased retention.

This example exemplifies the Advantage Spin system's ability to blend strategic decision-making with emotionally resonant gameplay moments. Through its intuitive interface, transparent transactions, and visually engaging features, this implementation elevates the traditional slot machine experience, creating a compelling and rewarding environment for players while supporting the operational goals of casinos.

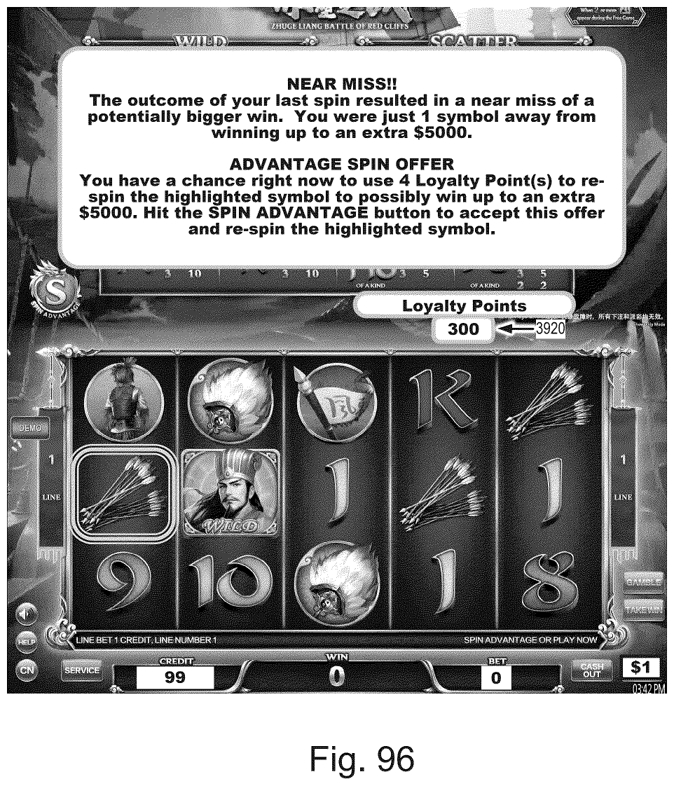

FIG. 96 illustrates a graphical user interface (GUI) for a wager-based slot game, presenting an Advantage Spin Offer in response to a near-miss event. This scenario captures a notable gameplay moment where the player narrowly missed winning up to $5,000 by just one symbol. The system dynamically generates an offer that enables the player to re-spin the highlighted symbol using Loyalty Points, providing an interactive and engaging opportunity to revisit the near-miss outcome.

The interface prominently displays a “NEAR MISS!!” notification, immediately drawing the player's attention to the significance of their last spin. The notification is accompanied by a detailed message explaining that the player was one symbol away from a potentially larger win. The GUI highlights the specific symbol eligible for re-spin using distinct visual cues such as animation, a glowing border, or a unique color overlay. This visual distinction ensures the player clearly understands the target of the Advantage Spin Offer.

The Advantage Spin Offer is centrally positioned within the GUI and clearly communicates the terms of the opportunity. It specifies that the player may use four (4) Loyalty Points to re-spin the highlighted symbol, with the potential to win up to $5,000. The interface emphasizes the immediacy of the opportunity and encourages the player to act promptly by prominently featuring the “SPIN ADVANTAGE” button. This button serves as the primary mechanism for accepting the offer and initiating the re-spin process.

Upon accepting the offer, the system deducts four Loyalty Points from the player's Advantage Spin Loyalty Point meter. The GUI updates in real time to reflect the adjusted balance, ensuring transparency in the transaction. The highlighted symbol begins a re-spin animation, visually signaling the execution of the Advantage Spin opportunity. Other symbols on the reels remain static, reinforcing the targeted nature of the action and preserving the integrity of the game state.

The execution phase is enhanced with animations or celebratory graphics, heightening the player's anticipation and engagement. Once the re-spin is complete, the GUI updates to display the outcome, including any changes to the player's winnings, credit balances, or other gameplay metrics. If the re-spin results in a win, the interface celebrates the achievement with visually appealing feedback, such as flashing graphics, congratulatory text, or sound effects.

This embodiment of the Advantage Spin system offers several benefits for players. It transforms the disappointment of a near-miss event into an exciting second chance, creating a heightened sense of control and engagement. The use of Loyalty Points as currency for the re-spin expands the options available to players, fostering a sense of flexibility and value. The clear presentation of the offer, combined with real-time feedback and intuitive visual elements, ensures a smooth and satisfying user experience.

For casino operators, this feature effectively leverages the emotional impact of near-miss events to encourage extended gameplay. By incorporating Loyalty Points into the Advantage Spin system, operators may drive participation in loyalty programs and incentivize the redemption of accumulated points. The visually engaging interface promotes repeat play and enhances overall player satisfaction, supporting retention and revenue growth.

This example demonstrates the Advantage Spin system's ability to blend strategic gameplay opportunities with emotionally resonant moments. Through its intuitive design, transparent mechanics, and dynamic visual feedback, this implementation enhances the traditional slot machine experience, delivering value to both players and casino operators while showcasing the innovative capabilities of the Advantage Spin system.

### Technical Improvements/Innovations which Address Real-World Technological Problems

The technological features, systems, and processes underlying the Advantage Spin techniques go beyond abstract ideas by delivering specific, technical advancements over prior art. These innovations tackle real-world technological challenges, including static slot mechanics, disjointed credit systems, and limited player interaction. By integrating seamlessly into gaming systems, these solutions enhance functionality in a tangible and practical manner-evolving slot machines into interactive, dynamic platforms that operate across multiple devices and environments. The following examples illustrate these advancements.

### 1. Real-Time Game Analysis and Dynamic Advantage Spin Offers

(a) Specific Improvement Over Prior Art: Traditional gaming systems merely execute random outcomes without analyzing in-game events or dynamically responding to player interaction. This concept introduces a real-time analysis engine that evaluates game outcomes to detect near-miss conditions or other predefined triggers. By doing so, the system generates targeted spin offers, enhancing player engagement and creating a more interactive gaming experience. This marks a clear advancement over static slot machine operations, incorporating dynamic game progression features.
(b) Improvement in Computer Functionality: The computerized game analysis engine improves the speed and efficiency of gaming systems by automating the detection of advantageous game conditions. It reduces latency in offer generation and allows for immediate player feedback, which was not feasible in traditional systems. This advancement solves the technological problem of static game flow by creating a system that dynamically adapts to in-game events, increasing both entertainment value and technical complexity.
(c) Integration into Practical Application: This feature is integrated directly into the slot machine's core operating system, enabling seamless interaction between the gaming display, credit management, and player input interfaces. Players receive tailored offers based on real-time game states, transforming slot machine gameplay into an interactive, evolving experience. The system's practical application lies in enhancing user retention, engagement, and increasing revenue for casinos, thereby representing a significant technological advancement in electronic gaming.

### 2. Execution of Targeted Re-Spins of Selected Symbols

(a) Specific Improvement Over Prior Art: In conventional slot machines, players must re-spin the entire reel set, resulting in a lack of strategic options. This concept introduces the ability to select and re-spin specific symbols within the slot array, enabling more targeted gameplay and higher strategic involvement. This reduces randomness, giving players a greater sense of control and engagement. Such functionality deviates from traditional slot machine mechanics, thereby providing a distinct technological improvement.
(b) Improvement in Computer Functionality: The system's ability to segregate individual symbols for re-spin activities enhances processor efficiency and resource allocation by avoiding redundant re-spins. This optimization improves the overall performance of the gaming machine, reducing computational overhead while enhancing game fluidity. The targeted symbol re-spin feature addresses the problem of excessive game lag and player frustration caused by unnecessary full-reel re-spins.
(c) Integration into Practical Application: By allowing players to selectively engage specific symbols, the system offers a novel, practical layer of interactivity that increases player decision-making and prolongs gameplay sessions. This practical application contributes directly to player satisfaction and enhances monetary returns for gaming establishments, demonstrating a clear advancement in gaming technology.

### 3. Credit-Based Game Modification System

(a) Specific Improvement Over Prior Art: Traditional gaming systems operate using cash credits alone, limiting the forms of engagement available to players. This innovation introduces a dual credit system that distinguishes between cash credits and advantage spin credits (non-cash credits). By allowing different credit types to fund distinct gameplay activities, the invention broadens the range of player interactions and introduces new monetization pathways.
(b) Improvement in Computer Functionality: The integration of multiple credit meters requires enhanced credit management software capable of tracking different credit types simultaneously without overlap. This increases the system's capacity to handle diverse transactions and reduces the likelihood of credit mismanagement, solving a critical problem in the efficient handling of complex financial instruments within the gaming environment.
(c) Integration into Practical Application: The practical benefit of a dual credit system lies in providing new promotional and loyalty reward mechanisms. Casinos can offer non-cash credits as promotional rewards, thereby incentivizing continued gameplay without depleting cash balances. This practical integration enhances player loyalty and increases engagement, driving higher revenue generation.

### 4. Graphical User Interface (GUI) for Interactive Gameplay Decisions

(a) Specific Improvement Over Prior Art: Standard slot machines offer minimal interactivity during gameplay. The inclusion of a GUI specifically designed for player decision-making represents a significant leap forward by allowing players to accept or reject spin offers directly from the interface. This real-time player interaction enhances the overall gaming experience by introducing elements of strategy and control.
(b) Improvement in Computer Functionality: The GUI is programmed to interface with multiple system modules (credit meters, spin processors, and display devices), enabling seamless real-time decision processing. This integration optimizes user interaction, reduces input lag, and streamlines system resource usage. Such improvements resolve the problem of static gameplay and lack of player engagement.
(c) Integration into Practical Application: The GUI functions as the primary means for conveying dynamic game offers and collecting user input, fostering a more immersive experience. By directly influencing gameplay outcomes, the GUI bridges the gap between player agency and machine operations, providing a clear, marketable technological advantage for casino operators.

### 5. Dynamic Credit Pricing and Calculations for Advantage Spins

(a) Specific Improvement Over Prior Art: Static credit pricing mechanisms fail to account for real-time gameplay dynamics. This innovation introduces dynamic pricing algorithms that adjust spin costs based on factors like bet denomination, paylines, and game state. By tailoring pricing structures to the current game environment, the system enhances fairness and promotes strategic engagement.
(b) Improvement in Computer Functionality: Dynamic credit pricing systems necessitate complex algorithmic processing and real-time resource allocation, significantly enhancing the system's computational capability. This allows for adaptive pricing strategies that vary with gameplay conditions, addressing the technological limitation of fixed pricing models.
(c) Integration into Practical Application: Players benefit from variable-cost gameplay options, fostering an environment where strategic play is rewarded. This system incentivizes higher levels of player interaction and offers casinos a scalable pricing model, enhancing both profitability and user experience.

### 6. Multi-Device Advantage Spin Synchronization

(a) Specific Improvement Over Prior Art: Historically, gaming credits were confined to a single machine. This innovation enables cross-device credit synchronization, allowing players to redeem advantage spins across multiple machines.
(b) Improvement in Computer Functionality: Synchronization requires networked communication between devices and central servers, expanding the system's technical architecture. This improvement addresses the technical challenge of fragmented credit systems by creating a unified credit ecosystem.
(c) Integration into Practical Application: Players can seamlessly transfer credits between machines, increasing player flexibility and extending time on the casino floor. This enhances overall player satisfaction and promotes longer gaming sessions, resulting in greater revenue.

### 7. Player-Driven Symbol Selection and Modification

(a) Specific Improvement Over Prior Art: Traditional slot machines do not permit player-driven modifications to game mechanics beyond basic wager adjustments. This innovation allows players to select and modify specific slot symbols for participation in advantage spins, introducing strategic decision-making into gameplay. This capability transforms slot machines from purely chance-based systems into partially skill-based experiences.
(b) Improvement in Computer Functionality: To enable selective symbol re-spins, the system utilizes advanced tracking algorithms and interface modules that dynamically adjust reel configurations based on player input. This functionality resolves the technological problem of static reel configurations, providing dynamic symbol re-spin capabilities that improve overall game responsiveness and fluidity.
(c) Integration into Practical Application: By empowering players to select symbols, the system increases player engagement and retention. The opportunity to manipulate game outcomes through strategic symbol selection creates a more immersive experience, leading to longer gameplay sessions and higher revenue potential. This feature also enables casinos to offer skill-based promotions, further enhancing player interest.

### 8. Hardware and Platform-Agnostic Gaming System

(a) Specific Improvement Over Prior Art: Conventional slot systems are limited to specific physical configurations, often confined to large-scale slot machines. This invention extends gaming functionality across multiple platforms—including smartphones, tablets, desktops, and traditional EGMs—allowing for consistent player experiences across devices.
(b) Improvement in Computer Functionality: Implementing platform-agnostic gaming requires scalable architecture and adaptable software frameworks capable of running on varying hardware configurations. This enhancement resolves the problem of device-dependent systems by creating uniform performance and user experiences across different platforms.
(c) Integration into Practical Application: Players can transition seamlessly between devices, ensuring consistent gameplay across mobile and land-based environments. This integration increases accessibility and enhances player engagement, while casinos benefit from cross-platform monetization. The system promotes remote play opportunities, broadening market reach.

### 9. Advantage Spin Credit Vouchers and Redemption

(a) Specific Improvement Over Prior Art: Traditional slot systems rely solely on cash-based transactions. The introduction of advantage spin credit vouchers allows players to store, redeem, and transfer credits across machines and venues, addressing player loyalty and credit portability challenges.
(b) Improvement in Computer Functionality: The voucher system leverages advanced encryption and authentication protocols to ensure secure credit transfers. It also interfaces with EGM meters and casino management systems to synchronize credit balances in real-time. This feature addresses the technical challenge of managing multi-system credit transactions.
(c) Integration into Practical Application: Players can redeem credits at different machines or across casino networks, enhancing gaming flexibility and user satisfaction. This system increases retention and incentivizes repeat visits, providing practical benefits for players and operators alike.

### 10. Automated Advantage Spin Criteria and Restrictions

(a) Specific Improvement Over Prior Art: Conventional slot machines lack adaptive control over gameplay eligibility. This innovation introduces automated spin eligibility criteria that dynamically restrict or enable spin activities based on game type, player history, or machine settings.
(b) Improvement in Computer Functionality: By integrating predefined rule sets and automated decision-making algorithms, the system enhances the accuracy and responsiveness of credit management. This advancement resolves operational inefficiencies by ensuring spin offers are only presented under qualifying conditions, preventing unintended credit expenditure and improving system integrity.
(c) Integration into Practical Application: The system's practical application lies in reducing unnecessary spin offers and ensuring compliance with casino rules and regulations. By automatically enforcing criteria, it improves player trust and regulatory compliance, leading to a more controlled and secure gaming environment.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A computerized gaming system for facilitating enhanced gaming sessions using advantage spin mechanics, comprising:
at least one hardware processor;
a non-transient memory storing instructions;
a display device coupled to the hardware processor;
at least one input interface for receiving input from a user;
the processor being configured to execute instructions stored in the memory for causing the gaming system to carry out:
initiating, at the system, a first active gaming session of a wager-based first slot game, the first slot game including a first set of slot reels, wherein each slot reel includes a respective plurality of symbols;
executing a first spin of the first set of slot reels in response to a first input from a first player;
determining and displaying, on the display device, a first game outcome of the first spin of the first set of slot reels, the first game outcome comprising a first array of slot game symbols arranged in a first configuration;
causing a computerized game analysis engine to analyze the first game outcome in substantially real-time to identify a first advantage spin activity which may be initiated by the first player in response to the first game outcome;
determining and selecting, in substantially real-time, a first set of selected symbols from the first array of slot game symbols for participation in the first advantage spin activity, wherein the first set of selected symbols includes at least one selected symbol from the first array of slot game symbols, wherein the first advantage spin activity includes executing a randomized spin of only the first set of selected symbols;
calculating, in substantially real-time, a first credit type and a first quantity of credits to be consumed in order to fund execution of the first advantage spin activity during the first active gaming session;
generating, by the gaming system in substantially real-time, a first advantage spin offer for allowing the first player to execute the first advantage spin activity, wherein the first advantage spin offer includes: (i) a first offer to execute the randomized spin of only the first set of selected symbols, and (ii) a first advantage spin offer price specifying the first credit type and the first quantity of credits to be consumed for funding execution of the first advantage spin activity;
displaying details relating to the first advantage spin offer to the first player, including the first offer and the first advantage spin offer price;
causing the gaming system to execute the first advantage spin activity, wherein execution of the first advantage spin activity includes executing the randomized spin of only the first set of selected symbols;
causing the gaming system to consume the first quantity of credits of the first credit type for funding execution of the first advantage spin activity; and
determining and displaying, on the display device, a second game outcome resulting from the execution of the first advantage spin activity, the second game outcome comprising a second array of slot game symbols arranged in a second configuration.

2. The gaming system of claim 1 being further operable to cause the at least one processor to execute additional instructions for:
causing the computerized game analysis engine to analyze the first game outcome in substantially real-time to identify a second advantage spin activity which may be initiated by the first player in response to the first game outcome;
determining and selecting, in substantially real-time, a second set of selected symbols from the first array of slot game symbols for participation in the second advantage spin activity, wherein the second set of selected symbols includes at least one selected symbol from the first array of slot game symbols, wherein the second advantage spin activity includes executing a randomized spin of only the second set of selected symbols;
calculating, in substantially real-time, a second credit type and a second quantity of credits to be consumed in order to fund execution of the second advantage spin activity during the first active gaming session;
generating, by the gaming system in substantially real-time, a second advantage spin offer for allowing the first player to execute the second advantage spin activity, wherein the second advantage spin offer includes: (i) a second offer to execute the randomized spin of only the second set of selected symbols, and (ii) a second advantage spin offer price specifying the second credit type and the second quantity of credits to be consumed for funding execution of the second advantage spin activity;
displaying details relating to the second advantage spin offer to the first player, including the second offer and the second advantage spin offer price;
displaying a graphical user interface configured or designed to enable the first player to provide at least one second input to the gaming system, wherein the at least one second input includes at least one of:
accepting the first advantage spin offer;
accepting the second advantage spin offer;
declining the first advantage spin offer; and/or
declining the second advantage spin offer.

3. The gaming system of claim 1 further comprising a cash credit meter and an advantage spin credit meter;
the gaming system being further operable to cause the at least one processor to execute additional instructions for:
adjusting at least one cash credit of the first cash credit meter as a result of the execution of the first spin of the first set of slot reels;
adjusting at least one advantage spin credit of the first advantage spin credit meter as a result of the execution of the first advantage spin activity.

4. The gaming system of claim 1 being further operable to cause the at least one processor to execute additional instructions for:
managing and tracking transactions at a first electronic gaming device (“first EGD”) involving a plurality of different credit types, including a cash credit type which is redeemable for cash, and an advantage spin credit type having no cash value;
wherein the first advantage spin offer price specifies the first quantity of advantage spin credits to be consumed for funding execution of the first advantage spin activity; and
wherein the first EGD is configured or designed to accept the use of advantage spin credits to facilitate additional gameplay actions not executable with cash credits, including targeted advantage spin opportunities presented via a graphical user interface.

5. The gaming system of claim 1 further comprising a plurality of hardware components, including at least one of: a tablet computing device; a mobile computing device; a smartphone device; a desktop computer system; a laptop computer system; and/or an electronic gaming machine.

6. The gaming system of claim 1 being further operable to cause the at least one processor to execute additional instructions for:
enabling the first player to modify the selection of the first set of selected symbols from the first array of slot game symbols for participation in the first advantage spin activity; and
modifying, before execution of the first advantage spin activity, the selection of the first set of selected symbols for participation in the first advantage spin activity in response to a second set of input from the first player.

7. The gaming system of claim 1 being further operable to cause the at least one processor to execute additional instructions for:
enabling the first player to modify the selection of the first set of selected symbols from the first array of slot game symbols for participation in the first advantage spin activity;
modifying, before execution of the first advantage spin activity, the selection of the first set of selected symbols for participation in the first advantage spin activity in response to a second set of input from the first player; and
wherein the first set of selected symbols are arranged in a vertical column of the of the first array of slot game symbols.

8. The gaming system of claim 1 being further operable to cause the at least one processor to execute additional instructions for:
calculating a first win amount based on the first configuration of the first array of slot game symbols representing first game outcome; and
wherein the selection of the of the first set of selected symbols for participation in the first advantage spin activity is determined based on a probability of increasing a win amount for the first player based on possible outcomes of the randomized spin of only the first set of selected symbols.

9. The gaming system of claim 1 being further operable to cause the at least one processor to execute additional instructions for:
calculating the first advantage spin offer price based, at least in part, on at least one of: a current bet denomination value, and/or a number of lines played in the active game.

10. The gaming system of claim 1 being further operable to cause the at least one processor to execute additional instructions for:
causing the gaming system to determine, using a first set of predefined criteria, whether advantage spin game play activity is permitted to be conducted in the first active gaming session;
preventing advantage spin game play activity from being conducted in the first active gaming session in response to determining, based on the first set of predefined criteria, that advantage spin game play activity is not permitted to be conducted in the first active gaming session.

11. The gaming system of claim 1 being further operable to cause the at least one processor to execute additional instructions for:
causing the gaming system to determine, using a first set of predefined criteria, whether advantage spin game play activity is permitted to be conducted in the first active gaming session;
identifying a first game theme or first game title associated with the first active gaming session;
determining, using the first set of predefined criteria and the first game theme or first game title, whether advantage spin game play activity is permitted to be conducted during the first active gaming session.

12. A computer-implemented method for facilitating Advantage Spin functionalities within a casino gaming network, the method comprising steps for causing at least one processor to execute instructions stored within non-transient memory, effectuating operations including:
initiating, at the method, a first active gaming session of a wager-based first slot game, the first slot game including a first set of slot reels, wherein each slot reel includes a respective plurality of symbols;
executing a first spin of the first set of slot reels in response to a first input from a first player;
determining and displaying, on a display device, a first game outcome of the first spin of the first set of slot reels, the first game outcome comprising a first array of slot game symbols arranged in a first configuration;
causing a computerized game analysis engine to analyze the first game outcome in substantially real-time to identify a first advantage spin activity which may be initiated by the first player in response to the first game outcome;
determining and selecting, in substantially real-time, a first set of selected symbols from the first array of slot game symbols for participation in the first advantage spin activity, wherein the first set of selected symbols includes at least one selected symbol from the first array of slot game symbols, wherein the first advantage spin activity includes executing a randomized spin of only the first set of selected symbols;
calculating, in substantially real-time, a first credit type and a first quantity of credits to be consumed in order to fund execution of the first advantage spin activity during the first active gaming session;
generating, by the gaming method in substantially real-time, a first advantage spin offer for allowing the first player to execute the first advantage spin activity, wherein the first advantage spin offer includes: (i) a first offer to execute the randomized spin of only the first set of selected symbols, and (ii) a first advantage spin offer price specifying the first credit type and the first quantity of credits to be consumed for funding execution of the first advantage spin activity;
displaying details relating to the first advantage spin offer to the first player, including the first offer and the first advantage spin offer price;
causing the gaming method to execute the first advantage spin activity, wherein execution of the first advantage spin activity includes executing the randomized spin of only the first set of selected symbols;
causing the gaming method to consume the first quantity of credits of the first credit type for funding execution of the first advantage spin activity; and
determining and displaying, on the display device, a second game outcome resulting from the execution of the first advantage spin activity, the second game outcome comprising a second array of slot game symbols arranged in a second configuration.

13. The method of claim 12 further comprising causing the at least one processor to execute additional instructions for:
causing the computerized game analysis engine to analyze the first game outcome in substantially real-time to identify a second advantage spin activity which may be initiated by the first player in response to the first game outcome;
determining and selecting, in substantially real-time, a second set of selected symbols from the first array of slot game symbols for participation in the second advantage spin activity, wherein the second set of selected symbols includes at least one selected symbol from the first array of slot game symbols, wherein the second advantage spin activity includes executing a randomized spin of only the second set of selected symbols;
calculating, in substantially real-time, a second credit type and a second quantity of credits to be consumed in order to fund execution of the second advantage spin activity during the first active gaming session;
generating, by the gaming method in substantially real-time, a second advantage spin offer for allowing the first player to execute the second advantage spin activity, wherein the second advantage spin offer includes: (i) a second offer to execute the randomized spin of only the second set of selected symbols, and (ii) a second advantage spin offer price specifying the second credit type and the second quantity of credits to be consumed for funding execution of the second advantage spin activity;
displaying details relating to the second advantage spin offer to the first player, including the second offer and the second advantage spin offer price;
displaying a graphical user interface configured or designed to enable the first player to provide at least one second input to the gaming method, wherein the at least one second input includes at least one of:
accepting the first advantage spin offer;
accepting the second advantage spin offer;
declining the first advantage spin offer; and/or
declining the second advantage spin offer.

14. The method of claim 12 further comprising causing the at least one processor to execute additional instructions for:
adjusting at least one cash credit of a first cash credit meter ofas a result of the execution of the first spin of the first set of slot reels;
adjusting at least one advantage spin credit of the first advantage spin credit meter as a result of the execution of the first advantage spin activity.

15. The method of claim 12 further comprising causing the at least one processor to execute additional instructions for:
managing and tracking transactions at a first electronic gaming device (“first EGD”) involving a plurality of different credit types, including a cash credit type which is redeemable for cash, and an advantage spin credit type having no cash value;
wherein the first advantage spin offer price specifies the first quantity of advantage spin credits to be consumed for funding execution of the first advantage spin activity; and
wherein the first EGD is configured or designed to accept the use of advantage spin credits to facilitate additional gameplay actions not executable with cash credits, including targeted advantage spin opportunities presented via a graphical user interface.

16. The method of claim 12 further comprising causing the at least one processor to execute additional instructions for:
enabling the first player to modify the selection of the first set of selected symbols from the first array of slot game symbols for participation in the first advantage spin activity; and
modifying, before execution of the first advantage spin activity, the selection of the first set of selected symbols for participation in the first advantage spin activity in response to a second set of input from the first player.

17. The method of claim 12 further comprising causing the at least one processor to execute additional instructions for:
enabling the first player to modify the selection of the first set of selected symbols from the first array of slot game symbols for participation in the first advantage spin activity;
modifying, before execution of the first advantage spin activity, the selection of the first set of selected symbols for participation in the first advantage spin activity in response to a second set of input from the first player; and
wherein the first set of selected symbols are arranged in a vertical column of the of the first array of slot game symbols.

18. The method of claim 12 further comprising causing the at least one processor to execute additional instructions for:
calculating a first win amount based on the first configuration of the first array of slot game symbols representing first game outcome; and
wherein the selection of the of the first set of selected symbols for participation in the first advantage spin activity is determined based on a probability of increasing a win amount for the first player based on possible outcomes of the randomized spin of only the first set of selected symbols.

19. The method of claim 12 further comprising causing the at least one processor to execute additional instructions for:
calculating the first advantage spin offer price based, at least in part, on at least one of: a current bet denomination value, and/or a number of lines played in the active game.

20. The method of claim 12 further comprising causing the at least one processor to execute additional instructions for:
causing the gaming method to determine, using a first set of predefined criteria, whether advantage spin game play activity is permitted to be conducted in the first active gaming session;
preventing advantage spin game play activity from being conducted in the first active gaming session in response to determining, based on the first set of predefined criteria, that advantage spin game play activity is not permitted to be conducted in the first active gaming session.

21. The method of claim 12 further comprising causing the at least one processor to execute additional instructions for:
causing the gaming method to determine, using a first set of predefined criteria, whether advantage spin game play activity is permitted to be conducted in the first active gaming session;
identifying a first game theme or first game title associated with the first active gaming session;
determining, using the first set of predefined criteria and the first game theme or first game title, whether advantage spin game play activity is permitted to be conducted during the first active gaming session.
